(19) United States
(12) Patent Application Publication
(10) Pub. No.: US 2026/0332516 A1
(43) Pub. Date: Oct. 22, 2026

(54) WEIGHTED NETWORK TRAFFIC DISTRIBUTION

(71) Applicant: MELLANOX TECHNOLOGIES, LTD., Yokneam (IL)

(72) Inventors: Ilya Vershkov, Rishon LeZion (IL); Eran Gil Beracha, Tel Aviv (IL); Orel Hagag, Beer Sheva (IL); Amit Zvi Nishry, London (GB)

(21) Appl. No.: 19/186,352

(22) Filed: Apr. 22, 2025

(51) Int. Cl. H04L 45/24; H04L 45/02; H04L 45/748; H04L 47/122

(52) U.S. Cl. CPC H04L 45/24; H04L 45/04; H04L 45/748; H04L 47/122

(57) ABSTRACT

Example implementations provide a network device including one or more circuits to receive a network packet. The one or more circuits are to allocate the network packet to one port group of a plurality of port groups, according to a network traffic distribution policy that apportions network packets across the plurality of port groups in proportions based on a network parameter, and forward the network packet through a port of the one port group. In some aspects, the network traffic distribution policy comprises a multi-path data structure that maps different entries to different port groups of the plurality of port groups. In some aspects, the one or more circuits are further to: receive network condition information indicating a change in network capacity. In some aspects, the network condition information indicates a reduced capacity of a network path downstream from the network device.

### FIELD OF THE DISCLOSURE

The present disclosure is generally directed toward networking and, in particular, toward networking devices and methods of operating the same.

### BACKGROUND

Network topologies in modern computing environments, particularly data centers and cloud infrastructures, have grown increasingly complex to support high-bandwidth, low-latency applications. These networks may employ multi-tiered architectures such as leaf-spine or Clos designs, where multiple paths exist between any two endpoints. In such architectures, routing traffic efficiently across the available paths represents a challenge for maintaining optimal network performance. Traditional routing approaches, such as Equal-Cost Multi-Path (ECMP), have been adopted to distribute network traffic across multiple paths with the same cost metric, thereby maximizing bandwidth utilization and providing redundancy in the event of failures.

However, as networks scale and evolve, networks frequently develop asymmetric conditions where not all paths provide equal capacity or performance. Such asymmetry may arise from various factors, including partial link failures, heterogeneous hardware deployments, or deliberate design decisions based on traffic patterns. Some ECMP implementations handle path degradation through binary pruning decisions by either fully utilizing a path or completely avoiding it. Binary pruning may result in suboptimal network utilization, particularly when links partially degrade rather than fail. For instance, if a link's capacity decreases from 400 Gbps to 300 Gbps, existing ECMP implementations would either continue to send network traffic to the degraded link at full link capacity, causing congestion. Alternatively, existing ECMP implementations may remove the degraded link from consideration, wasting the remaining 300 Gbps capacity.

### SUMMARY

Aspects of the present disclosure relate to systems and methods for weighted adaptive multi-path routing in network environments. As networks become more dynamic and complex, there is a growing need for routing approaches that can proportionally allocate traffic across multiple paths based on their actual available capacity, thereby maximizing overall network performance without requiring costly hardware upgrades or significant infrastructure changes. In one aspect, a network device, such as a switch, includes multiple ports organized into port groups and routing circuitry/logic configured to allocate network packets across the port groups in proportions based on network parameters, where a network parameter may refer to a capacity of the network. Unlike conventional ECMP implementations, where routing decisions are binary (either fully utilizing or completely avoiding specific paths), aspects of the present approach are directed to providing non-binary, proportional traffic distribution that aligns with actual network conditions. Aspects of the disclosed approach enable traffic management through a combination of longest prefix match (LPM) operations, weighted multi-path data structures, and targeted congestion control, allowing the network device to dynamically adjust traffic proportions when network links experience partial capacity degradation rather than complete failure.

By implementing weighted traffic distribution across multiple paths, the network device can optimize bandwidth utilization in asymmetric topologies or scenarios involving partially degraded links. When receiving information about network conditions (such as link degradation from 400 Gbps to 300 Gbps) via protocols like Border Gateway Protocol (BGP), the network device can adjust its multi-path data structures to ensure traffic is distributed in proportions that reflect actual available capacity. Aspects of this approach minimize congestion, maximize throughput, and preserve network connectivity by avoiding the over-pruning that occurs with traditional binary routing decisions. Aspects of the disclosed techniques can be implemented without requiring hardware upgrades to existing network infrastructure, leveraging existing LPM, ECMP, and congestion control capabilities available in current networking equipment. By adapting traffic distribution to match real-time network parameters, aspects of the present disclosure can provide increased network efficiency, more predictable performance during partial failures, and improved utilization of network resources across complex data center fabrics and high-performance computing environments.

Example aspects of the present disclosure provide a network device. In some aspects, the network device may comprise one or more circuits to: receive a network packet; allocate the network packet to one port group of a plurality of port groups, according to a network traffic distribution policy that apportions network packets across the plurality of port groups in proportions based on a network parameter; and forward the network packet through a port of the one port group.

Aspects include wherein the network traffic distribution policy comprises a multi-path data structure that maps different entries to different port groups of the plurality of port groups.

Aspects include wherein the multi-path data structure comprises an ECMP table having a plurality of entries, wherein different percentages of the plurality of entries are mapped to different port groups of the plurality of port groups.

Aspects include wherein the one or more circuits are further to: perform an LPM operation based on a destination address of the network packet to select the multi-path data structure from a plurality of multi-path data structures.

Aspects include wherein the one or more circuits are further to: calculate a hash value based on information in the network packet; and select an entry from the plurality of entries in the multi-path data structure based on the hash value, wherein the selected entry determines a port group of the plurality of port groups for the network packet.

Aspects include wherein each entry in the multi-path data structure is associated with at least one of a rule or an action that identifies a corresponding port group of the plurality of port groups.

Aspects include wherein the rule or action indicates which ports of the network device are included in the corresponding port group.

Aspects include wherein the rule or action is updated based on network asymmetry information received via a BGP.

Aspects include wherein the plurality of port groups includes at least one port group configured to receive an oversubscribed traffic load according to the network parameter.

Aspects include wherein: the network parameter comprises available capacity information for the plurality of port groups; and the proportions are determined to direct more traffic to another port group than to the at least one port group based on the available capacity information.

Aspects include wherein the one or more circuits are further to perform congestion control to limit an amount of traffic directed through at least one port group of the plurality of port groups.

Aspects include wherein the congestion control is further to: oversubscribe at least one port in at least one port group of the plurality of port groups to create controlled congestion; and reduce a total traffic throughput by a specific amount corresponding to a reduced capacity condition in a network.

Aspects include wherein the one or more circuits are further to: receive network condition information indicating a change in network capacity; and adjust the proportions in which network packets are apportioned across the plurality of port groups based on the network condition information.

Aspects include wherein the network condition information indicates a reduced capacity of a network path downstream from the network device.

Aspects include wherein the network condition information is received via a BGP update message indicating at least one of a link failure or a link degradation.

Aspects include wherein to forward the network packet through the port of the one port group comprises to select the port from multiple available ports in the one port group using at least one of: adaptive routing, random selection, round-robin selection, or hash-based forwarding.

Aspects include wherein the network parameter comprises at least one of: an available bandwidth of network link; a network congestion level; link failure information; a quality of service requirement; or an administrative weight assigned to a network path.

Example aspects of the present disclosure provide a system. In some aspects, the system comprises a first network device; and a second network device connected to the first network device via a plurality of network links, wherein the first network device comprises one or more circuits to: receive network traffic destined for the second network device; distribute the network traffic across the plurality of network links according to a traffic distribution policy that allocates different proportions of the network traffic to different subsets of the plurality of network links based on capacity information associated with the plurality of network links; and adjust the different proportions in response to a change in the capacity information.

Example aspects of the present disclosure provide a network device. In some aspects, the network device comprises one or more circuits to: receive network packet flows; apportion network packets of the network packet flows across a plurality of port groups in proportions based on a network parameter; and forward the network packets through ports in the plurality of port groups.

Aspects include wherein the one or more circuits are further to adjust the proportions in which the network packets are apportioned across the plurality of port groups in response to a change in the network parameter.

Additional features and advantages are described herein and will be apparent from the following Detailed Description and the figures.

### BRIEF DESCRIPTION OF THE SEVERAL VIEWS OF THE DRAWINGS

The present disclosure is described in conjunction with the appended figures, which are not necessarily drawn to scale:

FIG. 1 is a block diagram depicting an illustrative configuration of a computing environment including processing devices interconnected by a fabric in accordance with at least some embodiments of the present disclosure;

FIG. 2A is a block diagram depicting an illustrative network topology implementing weighted adaptive routing in accordance with at least some embodiments of the present disclosure;

FIG. 2B is a block diagram depicting an illustrative network topology with a degraded link in accordance with at least some embodiments of the present disclosure;

FIG. 3A is a block diagram depicting an illustrative configuration of an interconnect device implementing weighted adaptive multi-path routing in accordance with at least some embodiments of the present disclosure;

FIG. 3B is a block diagram depicting illustrative components of processing circuitry for implementing weighted adaptive multi-path routing in accordance with at least some embodiments of the present disclosure;

FIG. 3C is a block diagram depicting illustrative memory components storing data structures for implementing weighted adaptive multi-path routing in accordance with at least some embodiments of the present disclosure;

FIG. 4A is a block diagram depicting an illustrative configuration of a weighted adaptive multi-path routing system in accordance with at least some embodiments of the present disclosure;

FIG. 4B is a block diagram depicting an illustrative implementation of a weighted adaptive multi-path routing system with balanced traffic distribution in accordance with at least some embodiments of the present disclosure;

FIG. 4C is a block diagram depicting an illustrative implementation of a weighted adaptive multi-path routing system with traffic distribution adjusted for path degradation in accordance with at least some embodiments of the present disclosure;

FIG. 4D is a block diagram depicting an illustrative implementation of a weighted adaptive multi-path routing system with asymmetric port group configuration in accordance with at least some embodiments of the present disclosure;

FIG. 4E is a block diagram depicting an illustrative implementation of a weighted adaptive multi-path routing system with asymmetric port group configuration adjusted for path degradation in accordance with at least some embodiments of the present disclosure;

FIG. 5A is a flowchart illustrating a method for weighted adaptive multi-path routing in accordance with at least some embodiments of the present disclosure;

FIG. 5B is a flowchart illustrating a method for determining a weighted traffic distribution policy based on network parameters in accordance with at least some embodiments of the present disclosure;

FIG. 5C is a flowchart illustrating a method for allocating packets to weighted adaptive routing groups based on a weighted traffic distribution policy in accordance with at least some embodiments of the present disclosure;

FIG. 5D is a flowchart illustrating a method for performing an LPM operation in accordance with at least some embodiments of the present disclosure;

FIG. 5E is a flowchart illustrating a method for determining an entry within a selected multi-path data structure based on packet-specific criteria in accordance with at least some embodiments of the present disclosure;

FIG. 5F is a flowchart illustrating a method for applying adaptive routing logic to select specific output ports within chosen routing groups in accordance with at least some embodiments of the present disclosure;

FIG. 6 is a flowchart depicting a method for weighted adaptive multi-path routing in a network device in accordance with at least some embodiments of the present disclosure;

FIG. 7 illustrates a block diagram of a system that includes switching circuitry positioned between first and second sets of devices, in accordance with at least one embodiment;

FIG. 8 illustrates a block diagram of an example system, in accordance with at least one embodiment;

FIG. 9 illustrates an example data center, in accordance with at least one embodiment;

FIG. 10 illustrates a processing system, in accordance with at least one embodiment;

FIG. 11 illustrates a computer system, in accordance with at least one embodiment;

FIG. 12 illustrates a system, in accordance with at least one embodiment;

FIG. 13 illustrates an example integrated circuit, in accordance with at least one embodiment;

FIG. 14 illustrates a computing system, according to at least one embodiment;

FIG. 15 illustrates an APU, in accordance with at least one embodiment;

FIG. 16 illustrates a CPU, in accordance with at least one embodiment;

FIG. 17 illustrates an example accelerator integration slice, in accordance with at least one embodiment;

FIGS. 18A-18B illustrate example graphics processors, in accordance with at least one embodiment;

FIG. 19A illustrates a graphics core, in accordance with at least one embodiment;

FIG. 19B illustrates a GPGPU, in accordance with at least one embodiment;

FIG. 20A illustrates a parallel processor, in accordance with at least one embodiment;

FIG. 20B illustrates a processing cluster, in accordance with at least one embodiment;

FIG. 20C illustrates a graphics multiprocessor, in accordance with at least one embodiment;

FIG. 21 illustrates a graphics processor, in accordance with at least one embodiment;

FIG. 22 illustrates a processor, in accordance with at least one embodiment;

FIG. 23 illustrates a processor, in accordance with at least one embodiment;

FIG. 24 illustrates a graphics processor core, in accordance with at least one embodiment;

FIG. 25 illustrates a PPU, in accordance with at least one embodiment;

FIG. 26 illustrates a GPC, in accordance with at least one embodiment;

FIG. 27 illustrates a streaming multiprocessor, in accordance with at least one embodiment;

FIG. 28 illustrates a software stack of a programming platform, in accordance with at least one embodiment;

FIG. 29 illustrates a CUDA implementation of a software stack of FIG. 28, in accordance with at least one embodiment;

FIG. 30 illustrates a ROCm implementation of a software stack of FIG. 28, in accordance with at least one embodiment;

FIG. 31 illustrates an OpenCL implementation of a software stack of FIG. 28, in accordance with at least one embodiment;

FIG. 32 illustrates software that is supported by a programming platform, in accordance with at least one embodiment;

FIG. 33 illustrates compiling code to execute on programming platforms of FIGS. 28-31, in accordance with at least one embodiment;

FIG. 34 illustrates in greater detail compiling code to execute on programming platforms of FIGS. 28-31, in accordance with at least one embodiment;

FIG. 35 illustrates translating source code prior to compiling source code, in accordance with at least one embodiment;

FIG. 36A illustrates a system configured to compile and execute CUDA source code using different types of processing units, in accordance with at least one embodiment;

FIG. 36B illustrates a system configured to compile and execute CUDA source code of FIG. 36A using a CPU and a CUDA-enabled GPU, in accordance with at least one embodiment;

FIG. 36C illustrates a system configured to compile and execute CUDA source code of FIG. 36A using a CPU and a non-CUDA-enabled GPU, in accordance with at least one embodiment;

FIG. 37 illustrates an example kernel translated by CUDA-to-HIP translation tool of FIG. 36C, in accordance with at least one embodiment;

FIG. 38 illustrates non-CUDA-enabled GPU of FIG. 36C in greater detail, in accordance with at least one embodiment;

FIG. 39 illustrates how threads of an example CUDA grid are mapped to different compute units of FIG. 38, in accordance with at least one embodiment; and

FIG. 40 illustrates how to migrate existing CUDA code to Data Parallel C++ code, in accordance with at least one embodiment.

Like reference numbers and designations in the various drawings indicate like elements.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It is understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not to be deemed “material.”

The terms “determine,” “calculate,” and “compute,” and variations thereof, as used herein, are used interchangeably, and include any appropriate type of methodology, process, operation, or technique.

Various aspects of the present disclosure will be described herein with reference to drawings that are schematic illustrations of idealized configurations. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

Systems and methods for weighted adaptive multi-path routing in network environments with asymmetric topologies are disclosed. In non-symmetrical network topologies, each path in the network should be given a different traffic capacity to optimize network utilization. Aspects of the present disclosure may provide a system comprising an LPM, ECMP, Congestion Control (CC), and BGP, which operate in conjunction to route traffic in a weighted way toward each destination in the network and enforce that each path receives only the traffic it is capable of routing.

In network clusters, unbalanced topologies can arise due to various factors such as dropped cables, uneven traffic distribution, or inherent structural asymmetries. These imbalances can lead to congestion and suboptimal network performance, particularly in large-scale clusters. Traditional routing algorithms may struggle to effectively manage traffic in such scenarios, as they typically do not account for bottlenecks that may exist along potential paths.

Current solutions for weighted routing often require expensive hardware upgrades or significant modifications to existing infrastructure. Accordingly, it would be desirable to provide a more efficient and cost-effective approach to implement weighted routing, especially one that can leverage existing hardware and be compatible with previous product generations. Advantageously, aspects of the present disclosure may require no additional hardware and may be implemented in software, providing a solution that is economical and backward compatible with existing network infrastructure.

In accordance with aspects of the present disclosure, a packet flow method for weighted adaptive multi-path routing may operate as follows:

A packet is initially generated at the host (which may comprise a Network Interface Controller (NIC) or Central Processing Unit (CPU)) and sent towards the destination through a switch. Upon receiving the packet, the switch routes the packet based on the packet's destination IP address and Virtual Router ID, utilizing an LPM algorithm.

For each destination, an ECMP data structure is configured within the network device. The LPM operation distributes the packets evenly over the ECMP data structure using hash functions or Linear Feedback Shift Register (LFSR) techniques to ensure balanced initial distribution.

In accordance with aspects of the present disclosure, each ECMP entry in the data structure is mapped to a corresponding set of routing rules. More specifically, X ECMP entries may point to a first set of rules (designated as set A), while Y ECMP entries may point to a second set of rules (designated as set B), and so forth. This mapping may enable proportional traffic distribution across different rule sets.

Each set of rules may contain different groups of ports, resulting in weighted routing between the different groups based on the proportion of ECMP entries assigned to each rule set. In some aspects, the set of rules is configured based on network asymmetry information, which may be received via BGP updates.

By controlling the amount of traffic going to each group of ports through proportional ECMP entry allocation and using congestion control algorithms to manage traffic flow, the amount of traffic going to each port is effectively enforced in accordance with desired distribution policies.

Once a packet is assigned to a specific group of ports based on the selected ECMP entry and corresponding rule set, the network device performs adaptive routing, random selection, round-robin selection, or hash-based forwarding on the given group of ports. The packet is then forwarded through the selected port to its next hop destination.

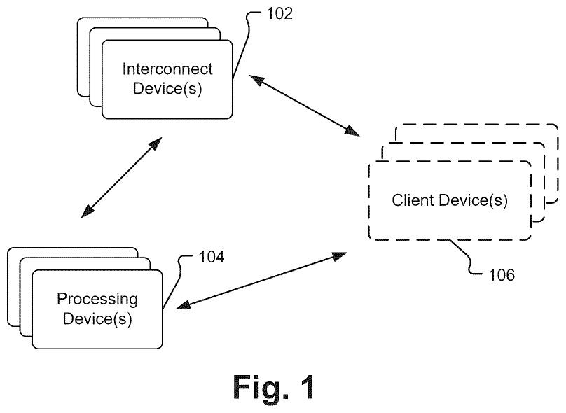

Referring now to FIGS. 1-6, various systems and methods for weighted adaptive multi-path routing in network environments with asymmetric topologies or partial link failures will be described. Aspects of the present disclosure provide apparatuses, methods, processing systems, and computer-readable mediums for weighted adaptive multi-path routing in network environments with asymmetric topologies or partial link failures.

Aspects of the present disclosure relate to a network routing system that enables fine-grained, non-binary traffic distribution across multiple network paths. When network links experience partial capacity degradation, the system may dynamically adjust traffic proportions using weighted adaptive routing based on real-time network conditions. By combining longest prefix matching, weighted multi-path data structures, and targeted congestion control, some aspects enable bandwidth management without requiring hardware upgrades to existing network infrastructure.

In modern data center networks, traditional routing approaches face limitations when dealing with asymmetric topologies or partial link failures. As previously described, ECMP implementations may use binary pruning, which either fully includes or excludes a path, leading to inefficient bandwidth utilization. When a link degrades to partial capacity (rather than completely failing), existing systems cannot proportionally reduce traffic—such systems may either overload the degraded link or completely avoid it, which may waste available capacity. Additionally, conventional adaptive routing may distribute traffic evenly across available ports without considering downstream capacity constraints. This may create congestion hotspots and underutilize healthy network segments.

Aspects of the present disclosure address these problems by implementing a weighted adaptive routing system that proportionally distributes network traffic based on actual link capacities. In some aspects, the system may perform LMP on incoming packets to select a multi-path data structure, where entries may be weighted according to network parameters received via routing protocols such as BGP. By mapping different percentages of multi-path table entries to different port groups, the system controls traffic distribution. For scenarios desiring traffic reduction, the system can intentionally oversubscribe specific port groups and utilize congestion control mechanisms to manage network throughput. In some aspects, intentionally oversubscribing specific port groups can enable non-binary pruning of network paths, allowing granular bandwidth adjustments rather than all-or-nothing routing decisions.

In some aspects, at least one technical solution provides several significant advantages. For example, in some aspects, traffic distribution can be proportioned based on available path capacities, improving network utilization in asymmetric topologies. In some aspects, the system can allow partial reduction of traffic along degraded paths instead of binary pruning, maintaining connectivity while respecting capacity constraints. In some aspects, the system may leverage existing LPM, ECMP, and congestion control capabilities in current networking equipment without requiring new hardware or hardware upgrades. In some aspects, the system may adapt dynamically to changing network conditions through network capacity updates (e.g., via BGP updates), automatically redistributing traffic when link capacities change. By strategically managing congestion through controlled oversubscription, the system provides predictable, stable network performance even during partial link degradation scenarios.

As illustrated in FIG. 1, a computing environment 100, as described herein, may include a network of processing devices 104, which may be interconnected by a fabric. A fabric, as described herein, may include one or more interconnect devices 102 and/or one or more processing devices 104. One or more interconnect devices 102 may be in communication with the processing devices 104 as well as one or more other computing systems such as client devices 106. Such a network of processing devices 104 and interconnect devices 102 may be useful in various settings, from data centers and cloud computing infrastructures to AI systems.

Processing devices 104 may be computing units, such as personal computers, servers, or other computing devices, and may be responsible for executing applications and performing data processing tasks. Processing devices 104, as described herein, can range from servers in a data center to desktop computers in a network or to devices such as Internet of Things (IoT) sensors and smart devices.

One or more of the processing devices 104 may include one or more processing circuits, such as GPUs, CPUs, application-specific integrated circuits (ASICs), field programmable gate arrays (FPGAs), or other circuitry capable of performing computations, as well as memory and storage resources to run software applications, handle data processing, and perform specific tasks as needed. In some implementations, processing devices 104 may also, or alternatively, include hardware, such as GPUs for handling computationally intensive tasks for machine learning, artificial intelligence (AI) workloads, or other complex processes.

For example, processing devices 104 may operate as a high-performance computing (HPC) cluster. A cluster of processing devices 104 may include many interconnected servers, each equipped with powerful CPUs and/or GPUs. The processing devices 104 may provide computational horsepower for, as an example, training large-scale AI models or running complex scientific simulations. For AI and machine learning tasks, the processing devices 104 may comprise one or more GPUs or other processing circuitry that may be capable of handling parallel processing requirements of neural networks and other applications.

Interconnect devices 102, as described in greater detail herein, may enable communication between processing devices 104 and/or client devices 106. An interconnect device 102 may be, for example, a network switch, a network interface card (NIC), or another device capable of receiving and sending data and may act as a central node in the network. Interconnect devices 102 may be wired in a topology, including spine switches and top-of-rack (TOR) switches, for example. Interconnect devices 102 may be capable of receiving, processing, and forwarding data, e.g., packets, to appropriate destinations within a network. In some aspects, such destinations may include but are not limited to processing devices 104 and/or client devices 106. In some implementations, an interconnect device 102, as described herein, may be included in a switch box, a platform, or a case that may contain one or more interconnect devices 102 and one or more power supply devices.

In some implementations, one or more processing devices 104 may be connected to one or more ports of one or more interconnect devices 102 via network cables. In some aspects, one or more processing devices 104 may be wirelessly connected to one or more ports of one or more interconnect devices 102. Processes, such as applications, executed by processing devices 104 may involve transmitting data to nodes of the network, such as to other processing devices 104 and/or to client devices 106. Data may flow through the network of processing devices 104 and interconnect devices 102 using one or more protocols such as transmission control protocol (TCP), user datagram protocol (UDP), or Internet protocol (IP), for example. One or more interconnect devices 102 may, upon receiving data from a processing device 104 or another interconnect device 102, examine the data to identify a destination for the data and route the data through the network.

Client devices 106, as described herein, may refer to computing devices that perform AI-related, research-related, and/or other processor-intensive tasks. To manage substantial computational loads and data throughput that may be needed for such applications, client devices 106 may utilize one or more processing devices 104. Examples of client devices 106 include but are not limited to workstations and personal computers used by researchers, data scientists, and/or professionals for developing, testing, and/or executing AI models and research simulations. While a client device 106 may be equipped with one or more CPUs and/or GPUs, one or more client devices 106 may need additional computational resources to perform complex tasks in an efficient manner. By interacting with processing devices 104, client devices 106 may be enabled to perform functions such as, for example, training machine learning models, performing data processing, running simulations, analyzing large datasets, and/or performing complex data processing tasks, such as data mining, pattern recognition, and/or predictive modeling.

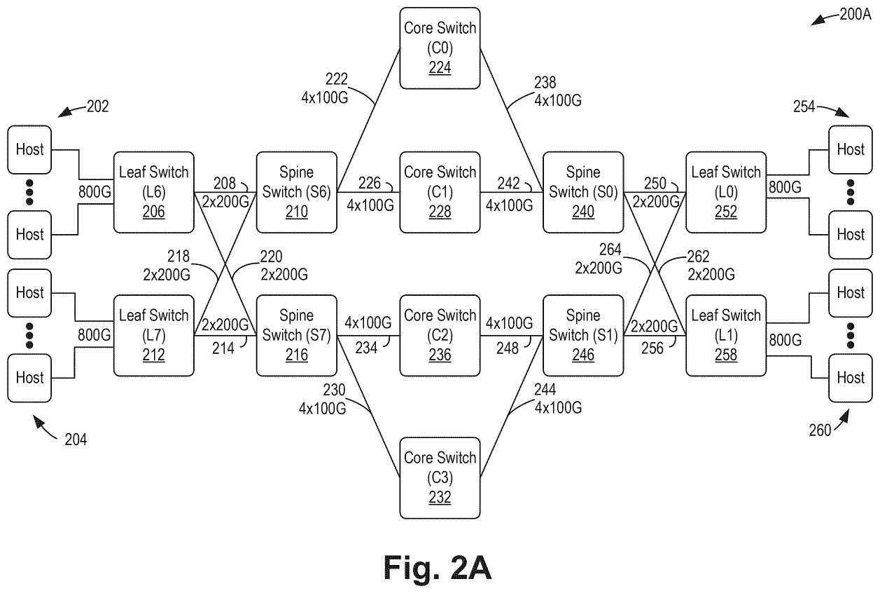

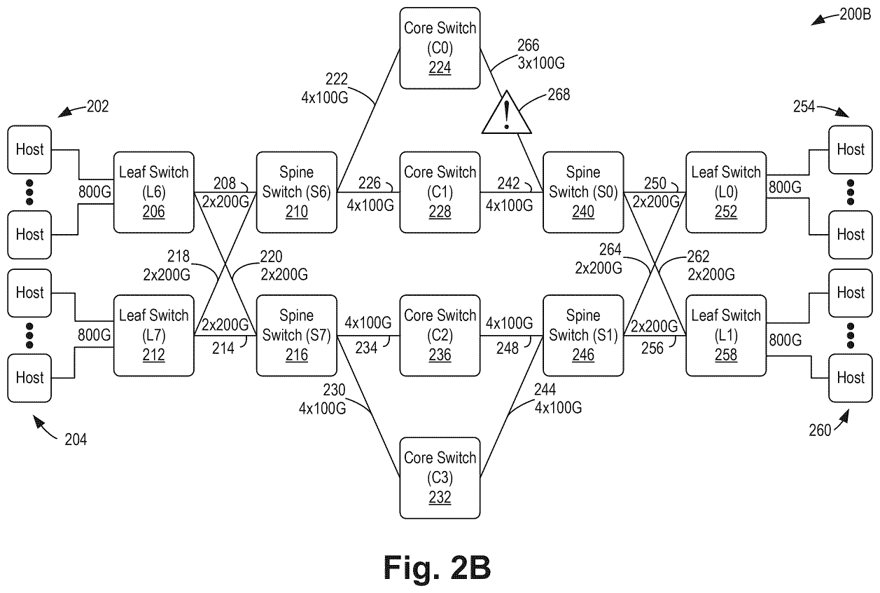

Referring now to FIG. 2A, an exemplary network topology 200a, is illustrated as implementing aspects of the weighted adaptive routing system in accordance with aspects of the present disclosure. In some aspects, the network topology 200a may represent a multi-tier Clos network architecture comprising multiple interconnected network devices arranged in a hierarchical design to facilitate data communication between various host devices. In some aspects, a Clos network architecture may refer to a class of non-blocking, multistage switching networks characterized by multiple stages of switches arranged in a specific pattern that allows any input to connect to any output, providing high bandwidth and fault tolerance. In some data center networks, Clos topologies may include three tiers of switches (leaf, spine, and core) organized in a way that creates multiple equal-cost paths between any two endpoints, making them well-suited for implementing ECMP routing techniques and a weighted adaptive routing approach in accordance with aspects described herein. Although a Clos network is illustrated in FIG. 2A, other network topologies are contemplated for implementing weighted adaptive routing techniques.

In some aspects, the network topology 200a may include a first group of hosts 202 and a second group of hosts 204 connected to leaf switches on a first side of the topology. A third group of hosts 254 and a fourth group of hosts 260 may be connected to leaf switches on a second side of the topology. These host groups (e.g., first group of hosts 202, second group of hosts 204, third group of hosts 254, and fourth group of hosts 260) may include computing devices such as servers, processors, storage systems, or other network-connected equipment that generate or consume network traffic. In some aspects, the network topology 200a enables communication between these various host groups through a network fabric. In some aspects, the network fabric may refer to the interconnected collection of leaf switches (e.g., leaf switch (L6) 206, leaf switch (L7) 212, leaf switch (L0) 252, and leaf switch (L1) 258, spine switches (e.g., spine switch (S6) 210, spine switch (S7) 216, spine switch (S0) 240, and spine switch (S1) 246), core switches (e.g., core switch (C0) 224, core switch (C1) 228, core switch (C2) 236, and core switch (C3) 232), and their connecting links (e.g., link 208, link 214, link 218, link 220, link 222, link 226, link 234, link 230, link 238, link 242, link 244, link 248, link 250, link 256, link 262, and link 264, that together provide multiple paths for data transmission between any two endpoints in the network.

In some aspects, leaf switch (L6) 206 represents a network switching device that provides connectivity between the first group of hosts 202 and the network fabric. In various implementations, leaf switch (L6) 206 may be a top-of-rack (ToR) switch that connects server racks or other computing equipment to the network. The leaf switch (L6) 206 may include circuitry configured to receive network packets, examine their headers, determine appropriate forwarding paths based on destination addresses, and route the packets accordingly. Leaf switch (L6) 206 can implement weighted adaptive routing techniques, including performing LPM operations on packet destination addresses, maintaining multi-path data structures (such as ECMP tables), and allocating packets to different port groups according to network traffic distribution policies that apportion traffic based on network parameters.

In some implementations, leaf switch (L6) 206 may include memory storing routing tables, port group configurations, and multi-path data structures that direct traffic to different paths based on current network conditions. The leaf switch (L6) 206 may also include processing circuitry configured to update these tables and structures based on information received via network protocols such as BGP. By implementing weighted adaptive routing at the leaf switch level, the network can optimize traffic distribution from the ingress point, potentially reducing congestion and improving overall network performance.

Leaf switch (L7) 212 functions analogously to leaf switch (L6) 206, providing connectivity between the second group of hosts 204 and the network fabric. Leaf switch (L7) 212 implements similar routing functionality and may independently adjust its traffic distribution based on network parameters.

Spine switch (S6) 210 represents a middle-tier device in the network hierarchy that aggregates traffic from multiple leaf switches and routes it toward appropriate core switches. In some aspects, spine switch (S6) 210 connects to leaf switch (L6) 206 and leaf switch (L7) 212, receiving traffic from the first and second groups of hosts and forwards this traffic toward core switches based on destination addresses. In some aspects, the spine switch (S6) 210 may implement weighted adaptive routing techniques whereby traffic is distributed across multiple uplinks in proportions that reflect available bandwidth or other network parameters.

Spine switch (S7) 216 provides functionality similar to spine switch (S6) 210, connecting to leaf switches and core switches to facilitate traffic flow through the network fabric. Spine switch (S7) 216 may implement independent adaptive routing decisions based on local congestion conditions or network-wide parameters.

In some aspects, a core switch (C0) 224 represents a top-tier network device that interconnects multiple spine switches, allowing traffic to traverse from one portion of the network to another. For example, core switch (C0) 224 connects to spine switch (S6) 210 and spine switch (S0) 240 via link 222 and link 238, respectively, each comprising four connections of 100 Gbps capacity for a total of 400 Gbps per link. Core switch (C0) 224 enables traffic to flow between hosts on opposite sides of the network topology, such as between the first group of hosts 202 and the third group of hosts 254.

The core switch (C1) 228 functions similarly to the core switch (C0) 224, which interconnects the spine switch (S6) 210 and the spine switch (S0) 240 via link 226 and link 242. Each of these links comprises four 100 Gbps connections for a total of 400 Gbps capacity per link. Core switches (C2) 236 and (C3) 232 complete the core layer of the network, providing additional paths and redundancy through connections to spine switches (S7) 216 and spine switch (S1) 246.

In some aspects, spine switch (S0) 240 connects core switch (C0) 224 and core switch (C1) 228 to leaf switch (L0) 252 via link 238, link 242, and link 250, respectively. Similarly, spine switch (S1) 246 connects core switch (C2) 236 and core switch (C3) 232 to leaf switch (L1) 258 via link 244, link 248, and link 256., respectively. These spine switches facilitate traffic flow from the core layer to the leaf layer on the destination side of the network.

Leaf switch (L0) 252 and leaf switch (L1) 258 provide connectivity between the network fabric and the third group of hosts 254 and the fourth group of hosts 260, respectively. These leaf switches may function analogously to leaf switch (L6) 206 and leaf switch (L7) 212 and implement similar routing and traffic distribution mechanisms.

The network topology 200a may include many links interconnecting the various network devices. These links represent physical or logical connections characterized by bandwidth parameters (e.g., 2×200 Gbps or 4×100 Gbps). These links enable scalable data transfer capabilities across different layers of the switching architecture. In some aspects, link 208 connects leaf switch (L6) 206 to spine switch (S6) 210 and comprises two connections of 200 Gbps each, providing a total bandwidth capacity of 400 G. Similarly, link 214 connects leaf switch (L7) 212 to spine switch (S7) 216, also comprising two 200 Gbps connections for a total of 400 Gbps capacity. Link 222, link 226, link 230, link 234, link 238, link 242, link 244, and link 248 connect spine switches to core switches. Each link may comprise four connections of 100 Gbps for a total of 400 Gbps capacity per link. This represents a transition from two 200 Gbps links at the leaf-to-spine layer to four 100 Gbps links at the spine-to-core layer, creating a potential asymmetry in the network that may benefit from weighted adaptive routing approaches.

In the network topology 200a depicted in FIG. 2A, link 250, link 256, link 262, and link 264 may connect spine switches to leaf switches on the destination side of the network, each comprising two 200 Gbps connections for a total of 400 Gbps capacity per link. Link bandwidths described herein (such as 2×200 Gbps and 4×100 Gbps) are provided as examples, and various other link capacities may be implemented in accordance with the weighted adaptive routing techniques of the present disclosure. The network topology 200a illustrates a configuration that provides multiple potential paths between any given source and destination hosts. For example, traffic from a host in the third group of hosts 254 destined for a host in the first group of hosts 202 might traverse any of several paths through the network fabric, including:
Path 1: 254→252→250→240→238→224→222→210→208→206→202
Path 2: 254→252→250→240→242→228→226→210→208→206→202
Path 3: 254→252→264→246→248→236→234→216→220→206→202
Path 4: 254→252→264→246→244→232→230→216→220→206→202

In some aspects, the multi-path, multi-tier topology, as depicted in FIG. 2A, may provide a foundation for implementing weighted adaptive routing techniques that can dynamically adjust traffic distribution in response to changing network conditions. The weighted adaptive routing functionality, as described herein, may be implemented at various points in the network, including at the leaf switches, which allows for optimized traffic distribution from the ingress points of the network fabric.

Referring now to FIG. 2B, a network topology 200b is illustrated that depicts a scenario involving a degraded link in accordance with aspects of the present disclosure. As depicted in FIG. 2B, a link 266 connecting core switch (C0) 224 to spine switch (S0) 240 has experienced a degradation, as indicated by symbol 268. While in FIG. 2A, the connection comprised four 100 Gbps links (4×100 Gbps), providing a total bandwidth of 400 Gbps in FIG. 2B, the connection has been reduced to three 100 Gbps links (3×100 Gbps), resulting in a total available bandwidth of 300 Gbps. Such degradation could occur due to various factors such as hardware failures, environmental conditions, or maintenance operations. It should be understood that this specific degradation pattern is provided as an example, and other degradation scenarios could occur, such as four connections operating at reduced capacity (e.g., 4×75 G) or two connections operating at increased but still insufficient capacity (e.g., 2×90 G).

In a traditional ECMP routing scenario, when a host in the third group of hosts 254 transmits data destined for a host in the first group of hosts 202, the network traffic would pass through leaf switch (L0) 252, spine switch (S0) 240, and potentially through the degraded link 266 to core switch (C0) 224. With traditional ECMP, a routing system may make binary decisions regarding link inclusions that include either fully utilizing a link or completely pruning the link from consideration. In some aspects, a binary decision approach can lead to several issues when faced with partially degraded links, such as link 266.

That is, in a traditional ECMP routing scenario, when faced with a degraded link such as link 266, which has been reduced from 4×100 Gbps to 3×100 Gbps, a routing system must choose between two suboptimal options: either continue treating the link as fully operational and potentially oversubscribe it, or completely remove it from the routing table despite its remaining substantial capacity. Such a binary decision process fails to account for partial degradations where a link maintains significant but reduced bandwidth. Traditional ECMP lacks the granularity to adjust traffic proportionally to the actual available capacity, which can lead to inefficient network utilization, particularly in complex topologies where multiple alternate paths exist with varying capacities.

In particular, traditional ECMP could continue to direct the full quota of traffic through the degraded path, resulting in congestion at link 266 since it now has only 75% of its original capacity. Alternatively, traditional ECMP might completely prune the link from route consideration, wasting the remaining 300 Gbps of usable bandwidth and requiring network traffic to avoid core switch (C0) 224 and instead be routed to core switch (C1) 228. Neither outcome provides optimal network performance or resource utilization, especially in large-scale networks where efficient traffic management is desirable.

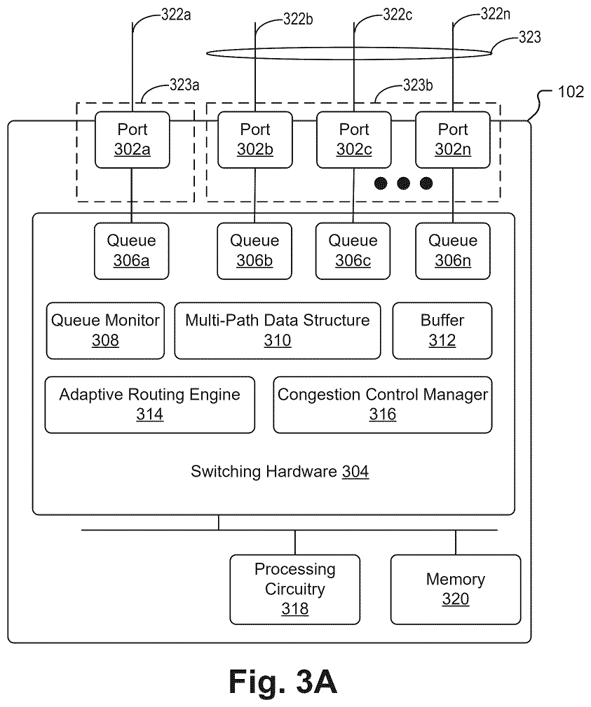

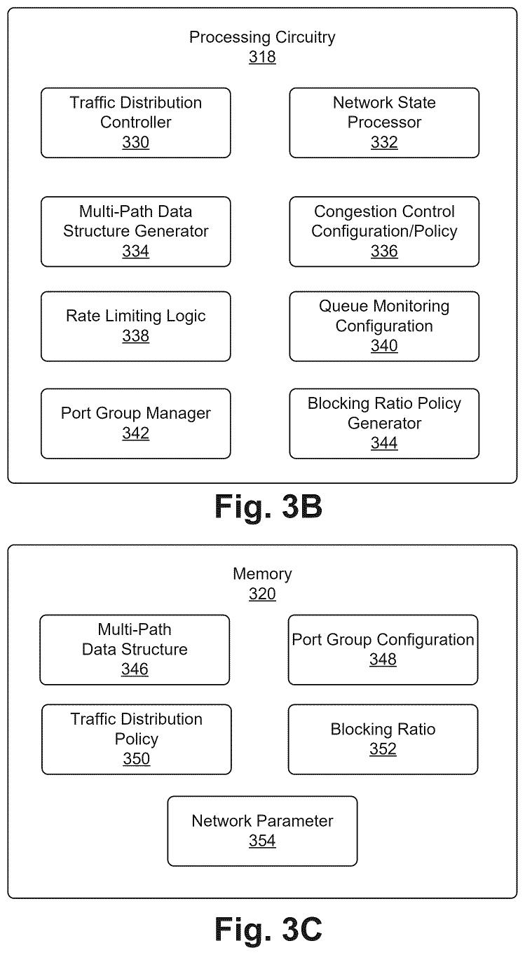

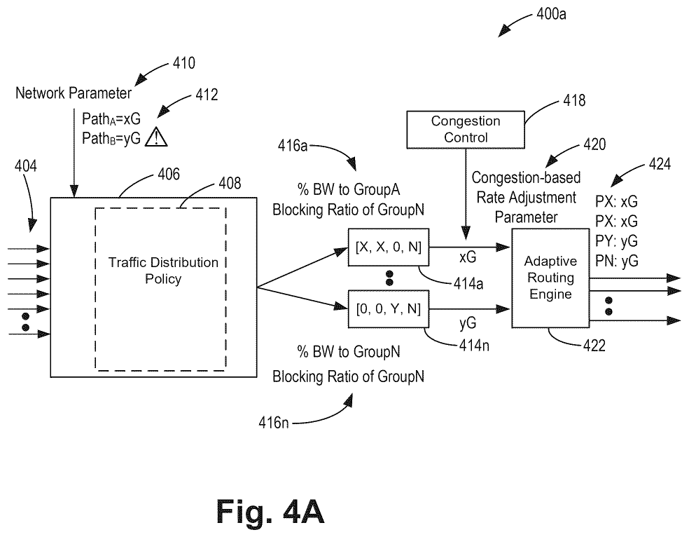

FIG. 3A depicts a block diagram of an interconnect device 102 that can implement weighted adaptive routing techniques in accordance with aspects of the present disclosure. In some aspects, the interconnect device 102 may represent any of the switching devices described with reference to FIG. 1, FIG. 2A, and/or FIG. 2B, such as a leaf switch, spine switch, or core switch.

In some aspects, an interconnect device 102 may include a plurality of ports 302a-302n, switching hardware 304, a queue monitor 308, a multi-path data structure 310, a buffer 312, an adaptive routing engine 324, a congestion control manager 316, processing circuitry 318, and/or memory 320 to implement one or more weighted adaptive routing approaches described herein. The interconnect device 102 may include one or more ports 302a-302n configured to send and receive data in the form of packets, frames, and/or other units of information. The ports 302a-302n may be referred to as hardware ports. A “hardware port” may refer to a physical interface on a network switching device (also referred to as a switch and a network switch herein), such as an Ethernet or fiber-optic port, through which network packets are transmitted and received over physical media. A hardware port may be distinct from a “logical port,” which may refer to a software-defined endpoint identified by a numerical designation used to facilitate protocol-specific communication between networked devices at the transport or application layer. Although aspects are discussed primarily involving hardware ports, some aspects of the present disclosure may also be applied to logical ports.

In some aspects, each port 302a-302n may support high-speed data transfers over physical cabling, such as copper or fiber-optic cables. In certain aspects, one or more ports 302a-302n may be compatible with one or more wireless transceivers. The ports 302a-302n may be configured to accommodate one or more communication standards and protocols, including Ethernet, InfiniBand, and/or proprietary link-layer protocols, thereby enabling flexible deployment in diverse networking environments. Each port 302a-302n may dynamically switch between ingress and egress functionality or operate in dedicated ingress or egress modes, depending on an overall configuration and management policies configured via, for example, software or firmware.

In some aspects, each port 302a-302n may incorporate physical layer devices (PHYs) and/or logic that perform signal encoding/decoding, clock and data recovery, and other low-level operations. Such PHY components may be integrated within the substrate via a circuit, such as within an ASIC, FPGA, or otherwise, or provided on separate modules. In certain implementations, one or more ports 302a-302n may further include on-chip or external memory elements to temporarily store incoming or outgoing data. The on-chip or external memory elements may work with larger shared resources, such as buffer 312, to provide efficient queuing and management of traffic. The configuration and operational status of each port 302a-302n, such as speed, duplex settings, or active/inactive state, may be monitored by the processing circuitry 318. Furthermore, ports 302a-302n may provide status indicators or counters (e.g., for packets transmitted or dropped) that can be accessed by higher-level software for analytics or troubleshooting. The ports 302a-302n may provide one or more interface points that connect the interconnect device 102 to external devices, thereby enabling one or more traffic management, congestion management, and/or load balancing techniques described herein.

In some aspects, the switching hardware 304 may include one or more integrated circuits, multiplexers, crossbar fabrics, or other data-forwarding components arranged to direct incoming data from a port (e.g., one or more ports 302a-302n) to one or more destination ports based on switching logic for Layer 2 forwarding and/or routing logic for Layer 3 processing. In some implementations, the switching hardware 304 may operate at line-rate speeds (e.g., processing packets at the maximum theoretical speed of the network interface), ensuring minimal latency while maintaining reliable throughput. The switching hardware 304 may incorporate dedicated forwarding tables or pipelines that analyze header information, such as media access control (MAC) addresses for Layer 2 switching, virtual local area network (VLAN) tags or network-layer identifiers such as Internet Protocol (IP) addresses for Layer 3 routing, to determine how to forward each data unit within the interconnect device 102. In addition, the switching hardware 304 may utilize programmable match-action stages (e.g., processing pipeline stages that compare incoming packet fields against predefined patterns and execute corresponding actions), enabling adaptation to evolving network needs through software-defined updates. For instance, a user could reconfigure the switching hardware 304 to implement different flow-control strategies, weighted adaptive routing approaches that can dynamically adjust to changing network conditions, advanced monitoring capabilities, or security filters without a redesign of the switching hardware 304.

In some aspects, link 322a represents a physical or logical connection between port 302a and another network device. Links 322b, 322c, and 322n similarly represent connections from other ports to external network elements. The links 322a-322n may represent physical or logical connections characterized by bandwidth parameters (e.g., 2×200 Gbps or 4×100 Gbps). In some aspects, the links 322a-322n may provide data transfer capabilities across different layers of the switching architecture as previously described with respect to FIGS. 1-2B. In some aspects, a port group 323 (e.g., port group 323a and 323b) may comprise one or more ports associated with one or more links 322a-322n, where a port group may provide aggregate connectivity between interconnect device 102 and other devices in the network.

In some aspects, the switching hardware 304 may implement weighted adaptive routing approaches by coordinating operations among the queues 306a-306n, queue monitor 308, buffer 312, adaptive routing engine 314, and congestion control manager 316. A queue 306a may be associated with a port, such as port 302a, and may serve as a temporary storage area for network packets awaiting transmission through the port. In some aspects, queue 306b, queue 306c, and queue 306n are similar buffer structures associated with ports 302b, 302c, and 302n, respectively. Each queue may function independently to manage traffic flow through its respective port. In some aspects, all queues (e.g., queues 306a-306n) may operate under the coordinated control of the switching hardware and associated traffic management components as further described herein.

The queue monitor 308 may represent a component within the switching hardware 304 that observes and tracks the status of each queue 306a-306n. The queue monitor 308 may collect various metrics such as current queue depth, input rate, output rate, packet drop statistics, and congestion indicators. The collected metrics may be input to the adaptive routing engine 314 and the congestion control manager 316 and enable the adaptive routing engine 314 and the congestion control manager 316 to make informed decisions about traffic distribution and flow control. The multi-path data structure 310 may implement a weighted adaptive routing functionality. The multi-path data structure 310, which may be implemented as one or more tables in memory (e.g., memory 320), may include entries that map between destination addresses and port groups. When implementing a weighted adaptive routing approach, in some aspects, the multi-path data structure 310 may assign different proportions of traffic to different port groups based on network parameters such as available bandwidth, congestion levels, or link failures. For example, if a link in the network has degraded from 400 Gbps to 300 Gbps capacity (e.g., due to the failure of one 100 Gbps link in a 4×100 Gbps configuration), the multi-path data structure 310 may allocate 75% of the traffic that would normally traverse that link, while redirecting the remaining 25% to alternative paths. This non-binary approach allows for more granular traffic management than traditional routing approaches that would either continue sending 100% of traffic through the degraded link (causing congestion) or completely prune the link (wasting the remaining 300 Gbps capacity). The multi-path data structure 310 may be dynamically updated based on network condition information received via network protocols such as BGP, enabling the switch to continuously optimize traffic distribution across available paths as network conditions change.

The buffer 312 may represent memory space within the switching hardware 304 that temporarily stores packets during processing operations. The buffer 312 may provide additional storage for data packets during transient congestion events, such as when multiple ports 302a-302n switch from idle to active states simultaneously and, in some instances, when one or more queues 306a-306n of the interconnect device 102 are congested. For example, in a scenario where a network experiences a microburst traffic pattern (for example, short, intense bursts of data), buffer 312 may absorb temporary traffic spikes from multiple ingress ports without packet loss. When implementing weighted adaptive routing, buffer 312 may assist in the management of oversubscribed port groups. For example, where link 266 between the core switch (C0) 224 and spine switch (S0) 240 of FIG. 2B has degraded from 4×100 Gbps to 3×100 Gbps, and the multi-path data structure 310 has assigned traffic proportionally, during periods when traffic momentarily exceeds the degraded link's capacity, the buffer 312 may temporarily hold excess packets until congestion subsides or until a congestion control manager (e.g., congestion control manager 316) indicates that controlled packet dropping should occur. Accordingly, buffering may work together with the adaptive routing engine 314 to ensure that traffic distribution across port groups remains at a desired level. In addition, buffering may provide some elasticity to accommodate normal traffic fluctuations that might otherwise trigger unnecessary rerouting decisions.

In some aspects, the adaptive routing engine 314 may select specific ports for packet forwarding based on real-time network conditions. For example, the adaptive routing engine 314 may receive input from the queue monitor 308. Using the input from the queue monitor 308, the adaptive routing engine 314 may dynamically adjust routing decisions to optimize traffic flow across the network. In some aspects, adaptive routing may refer to a network routing methodology that dynamically selects an optimal path for data packets based on current network conditions rather than relying solely on static routing tables. Unlike traditional routing approaches that use fixed paths determined at configuration time, adaptive routing may evaluate network metrics, such as congestion levels, queue depths, link utilization, and latency, to make intelligent data forwarding decisions.

Within the interconnect device 102, the adaptive routing engine 314 may implement an adaptive routing functionality by analyzing data from the queue monitor 308 to identify the least congested or most efficient path within assigned port groups. Thus, when a packet is allocated to a specific port group (e.g., port group 323a) by the multi-path data structure 310, the adaptive routing engine 314 may select the specific port within the port group for packet transmission. For example, if port group 323a contains ports 302a, 302b, and 302c, and the queue monitor 308 indicates that queue 306b is significantly less occupied than queues 306a and 306c, the adaptive routing engine 314 may preferentially route packets through port 302b to balance network traffic load.

The adaptive routing engine 314 may employ various selection algorithms, including round-robin distribution, random selection, weighted selection based on queue occupancy, or other algorithms that consider historical performance metrics. By operating within the context of port groups already assigned by a weighted distribution policy, the adaptive routing engine 314 may provide a second layer of traffic optimization that works in conjunction with the broader network-wide traffic distribution strategy implemented via the multi-path data structure 310.

In some aspects, a congestion control manager 316 may work in coordination with the adaptive routing engine 314 to manage network traffic during periods of congestion. When network conditions indicate that certain paths or ports are experiencing high utilization or approaching capacity limits, the congestion control manager 316 may work to regulate traffic flow. In some aspects, the congestion control manager 316 may operate to prevent network congestion from degrading overall performance and to support a weighted adaptive routing functionality. The congestion control manager 316 may employ various strategies to maintain optimal network throughput even when certain paths experience reduced capacity or increased load.

In some aspects, when implementing weighted adaptive routing, the congestion control manager 316 may manage intentional oversubscription scenarios. For example, in a network configuration where a link has degraded (such as link 266 in FIG. 2B, which has degraded from 400 Gbps to 300 Gbps), the congestion control manager 316 could deliberately allow controlled congestion on specific port groups to achieve a desired traffic shaping result. Rather than completely avoiding the degraded path, the congestion control manager 316 may permit a calculated amount of network traffic to be directed toward the degraded path, with the understanding that some portion of the network traffic will experience controlled packet drops or delays. The congestion control manager 316 may employ various techniques including, but not limited to, explicit congestion notification (ECN) marking of packets approaching congestion thresholds; selective backpressure signals to upstream devices; intelligent queue management algorithms like Random Early Detection (RED); traffic rate limiting on a per-port or per-flow basis; and/or credit-based flow control to manage bandwidth allocation across port groups.

For instance, when the multi-path data structure 310 has allocated traffic in specific proportions across port groups (e.g., 75% to one path and 25% to another), the congestion control manager 316 may enforce these proportions by regulating actual throughput, potentially dropping excess packets or signaling upstream devices to temporarily reduce transmission rates. A controlled congestion approach may enable more granular traffic management than traditional binary routing decisions, allowing the network to more fully utilize available bandwidth while avoiding uncontrolled congestion events.

In some aspects, the processing circuitry 318 may represent one or more computational elements of the interconnect device 102 that handle control-plane operations, management functions, and software processing. The processing circuitry 318 may comprise one or more processors, microcontrollers, digital signal processors (DSPs), or dedicated ASIC blocks configured to manage system-level operations of the interconnect device 102. In some implementations, the processing circuitry 318 may execute firmware stored in memory 320 to maintain routing tables, manage port configuration parameters (e.g., enabling or disabling specific ports 302a-302n), and apply quality-of-service policies. In weighted adaptive routing implementations, the processing circuitry 318 may be responsible for processing BGP updates or other network state information, calculating appropriate traffic distribution weights, and programming the multi-path data structure 310 accordingly. In addition, the processing circuitry 318 may coordinate directly with the queue monitor 308 to gather metrics on queue occupancy, data throughput, and errors, such as generating a congestion notification packet or adjusting load-balancing algorithms. Moreover, the processing circuitry 318 can interface with higher-level management tools, such as a network orchestration platform or a cloud-based controller, to convey telemetry data or receive updated traffic distribution policy rules on the fly. By offloading some decisions to the switching hardware 304, the processing circuitry 318 can remain available for more complex tasks, including congestion analytics, device configuration, and other diagnostic tasks (e.g., performing debugging of flow-control counters or verifying compliance with service-level agreements). Accordingly, the interconnect device 102 can maintain a high level of throughput while still providing congestion management and adaptive routing functionality.

In some aspects, memory 320 may provide storage for the interconnect device's operating system, configuration data, routing tables, and other information needed for device operation. The memory 320 may utilize one or more storage technologies, such as DRAM, SRAM, TCAM, or flash. In some aspects, DRAM may store large routing tables or buffering data, SRAM could serve as high-speed scratchpads for real-time operations, while TCAM could facilitate rapid lookups for routing or security rules. Regardless of the specific technology, memory 320 can be used to make configuration parameters, firmware images, and runtime data structures readily accessible to the processing circuitry 318.

In the context of weighted adaptive routing, memory 320 may store network parameters, port group configurations, traffic distribution policies, and historical data that inform adaptation decisions. In some aspects, memory 320 may maintain the multi-path data structure 310, which may contain the weighted ECMP tables that determine traffic distribution proportions across different port groups. When network conditions change (such as when a link degrades from 400 Gbps to 300 Gbps), the processing circuitry 318 may update these multi-path data structures in memory 320 to reflect new desired traffic distribution ratios. Memory 320 may also store multiple versions of these structures for different destination prefixes, allowing for destination-specific routing policies.

In some aspects, memory 320 may store and/or otherwise maintain the traffic distribution policies that govern how packets are apportioned across different port groups. In some aspects, a traffic distribution policy may be defined as rule sets that establish the proportional allocation of network traffic based on current network parameters and may provide a basis for the weighted adaptive routing system. The traffic distribution policies stored in memory 320 may include definitions of port groups, proportional allocation ratios, blocking ratios for oversubscribed links (and, in some cases, undersubscribed links), and conditional logic for adapting to specific network events. In some aspects, when the processing circuitry 318 receives network parameter updates (such as capacity changes via BGP), the processing circuitry 318 may consult a traffic distribution policy to determine how network traffic should be apportioned across port groups.

In certain aspects, memory 320 may include a lightweight operating system or embedded software stack that manages hardware resources and provides an interface for remote configuration and updates. Moreover, memory 320 may enable virtualization capabilities, allowing multiple logical partitions (or “slices”) of the device to operate independently, which may be useful in large-scale data centers or cloud environments, where different tenants or workloads may need isolated resources and custom flow-control settings. In some aspects, memory 320 may maintain the relationship between LPM (Longest Prefix Match) results and corresponding multi-path data structures, ensuring that packets with the same destination are processed according to current network distribution policies. As the processing circuitry 318 receives BGP updates indicating changes in link capacity or availability, it may perform calculations to determine the optimal traffic distribution and update relevant multi-path data structures in memory 320, enabling the switching hardware 304 to forward traffic according to the new weighted adaptive routing parameters.

FIG. 3B depicts a block diagram illustrating additional details of the processing circuitry 318, including one or more components for implementing weighted adaptive routing functionality in accordance with aspects of the present disclosure. In some aspects, the processing circuitry 318 may include software and/or firmware modules that work together to manage traffic distribution across the network.

The traffic distribution controller 330 may operate as a central coordination component of a weighted adaptive routing system. The traffic distribution controller 330 may orchestrate the activities of modules to implement a traffic distribution strategy across the network. The traffic distribution controller 330 may receive network state information, consult traffic distribution policies stored in memory 320, and determine how traffic should be proportionally allocated across available network paths. In some aspects, when network conditions change (such as when link degradation occurs), the traffic distribution controller 330 may determine appropriate traffic redistribution strategies and coordinate updates to routing structures, such as an ECMP table or multi-path data structure, that maps destination addresses to specific forwarding paths or port groups and guide how network packets are directed through the network device toward their destinations. For example, when link 266 in FIG. 2B degrades from 4×100 Gbps to 3×100 Gbps, the traffic distribution controller 330 could determine that traffic should be redistributed in a 75%/25% proportion to maintain the desired network utilization without causing uncontrolled congestion.

In some aspects, a network state processor 332 may process network condition updates. Network condition updates may be received from various protocols, such as but not limited to BGP. The network state processor 332 may monitor network status information, extract relevant parameters such as available bandwidth, link failures, or congestion levels, and transform the network status information from raw data into actionable intelligence for other components. The network state processor 332 may recognize patterns in network behavior, aggregate related notifications, and prioritize updates that may require immediate attention. For instance, when receiving a BGP update indicating partial link degradation, the network state processor 332 may calculate a capacity reduction and forward this information to the traffic distribution controller 330 and other components to trigger appropriate routing adjustments.

The multi-path data structure generator 334 may create and maintain weighted ECMP tables and other multi-path data structures that may be referenced to determine packet forwarding behavior. Based on input from the traffic distribution controller 330 and, in some instances, the blocking ratio policy generator 344, the multi-path data structure generator 334 may generate mapping tables that associate destination prefixes with port groups in proportion to their desired traffic allocation. For example, if a particular network path should receive 75% of traffic while another receives 25%, the multi-path data structure generator 334 may create a multi-path data structure, such as an ECMP table, where 75% of entries point to one port group and 25% point to another. The multi-path data structure may be stored in memory 320 for use by the switching hardware 304 during packet processing.

In some aspects, the congestion control configuration/policy component 336 may establish parameters and policies for managing network congestion, for example, in scenarios where controlled congestion is part of the weighted adaptive routing strategy. The congestion control configuration/policy component 336 may define thresholds, behaviors, and policies that determine how the congestion control manager 316 in the switching hardware 304 (e.g., FIG. 3A) should respond to various congestion scenarios. The congestion control configuration/policy component 336 may specify different congestion handling approaches based on traffic classes, port groups, or network conditions. In weighted adaptive routing implementations that intentionally oversubscribe certain paths to achieve a desired traffic distribution, the congestion control configuration/policy component 336 may configure appropriate congestion control mechanisms such as ECN marking thresholds, selective packet dropping strategies, or backpressure signals to upstream devices.

In some aspects, the processing circuitry 318 may include rate-limiting logic 338 that establishes parameters for traffic shaping and defining bandwidth allocation for different traffic flows or port groups. The rate-limiting logic 338 may translate high-level traffic distribution policies into specific rate control mechanisms that can be implemented by the switching hardware 304. The rate-limiting logic 338 may define rate limits on a per-port, per-flow, or per-traffic-class basis to ensure that actual traffic proportions match the intended distribution determined by the traffic distribution controller 330.

In some aspects, the queue monitoring configuration 340 may define one or more parameters for the queue monitor 308 in the switching hardware 304 (e.g., FIG. 3A), including thresholds for congestion detection, sampling intervals, and metrics collection strategies. The queue monitoring configuration 340 may enable the adaptive routing engine 314 to make informed decisions about port selection within designated port groups based on real-time queue status information. The queue monitoring configuration 340 may specify different monitoring approaches for different port groups or traffic classes, enabling a customized adaptive routing behavior based on varying performance requirements.

In some aspects, a port group manager 342 defines and maintains port groupings based on network topology and routing requirements. This port group manager 342 may determine which physical ports (e.g., ports 302a-302n of interconnect device 102 of FIG. 3A) belong to which logical port groups, establishing the boundaries within which adaptive routing decisions are made. The port group manager 342 may dynamically adjust port group membership based on changes in network topology, link status, or administrative policies. In some aspects, the port group definitions may be used for implementing weighted distribution policies, as they define the sets of ports across which traffic is to be proportionally distributed.

In some aspects, the processing circuitry 318 may include a blocking ratio policy generator 344 that calculates traffic distribution ratios based on network capacity information. For example, when network links experience partial degradation, the blocking ratio policy generator 344 may determine how much network traffic should be allocated to each available path. The blocking ratio policy generator 344 may enable non-binary traffic distribution decisions that more efficiently utilize available bandwidth compared to traditional binary pruning approaches. For instance, when a link degrades to 75% of its original capacity, the blocking ratio policy generator 344 could determine that traffic should be distributed in a 75%/25% proportion between two alternative paths, allowing the network to maintain optimal utilization while avoiding congestion.

The blocking ratio policy generator 344 may generate a blocking ratio as the relationship between the amount of oversubscribed network traffic versus the amount of data that can be transmitted through the port group. For example, where a reduction occurs such that the capacity of the network is reduced to ⅞ of what it was, the blocking ratio may be expressed as 8/7 if the path is intentionally oversubscribed or ⅞ if the path is undersubscribed. In some instances, the congestion control module may be responsible for further reduction in traffic when oversubscription occurs. Alternatively, or in addition, the blocking ratio may be defined as the amount of traffic relative to pathway capacity (e.g., 133.3 Gbps/100 Gbps, indicating 133.3 Gbps of traffic directed to a 100 Gbps pathway where such pathway is intentionally oversubscribed). In some instances, the blocking ratio may also indicate an undersubscribed line (e.g., 266.6 Gbps/300 Gbps, where such pathway has been degraded but is not fully utilized). The blocking ratio could function as either a parameter that guides desired oversubscription/undersubscription levels in the traffic distribution policy or as a calculated result that reflects the actual oversubscription/undersubscription level achieved by the system.

FIG. 3C illustrates a block diagram of memory 320 that stores data structures and configuration information for implementing weighted adaptive multi-path routing according to at least one aspect of the present disclosure. Memory 320 may reside within a network device such as interconnect device 102, described with reference to FIGS. 1-3B. Memory 320 may comprise one or more types of computer-readable storage media, including but not limited to dynamic random access memory (DRAM), static random access memory (SRAM), ternary content-addressable memory (TCAM), or flash memory. In some aspects, memory 320 may include specialized memory units dedicated to specific functions within the network device, such as high-speed table lookups or packet buffering.

As illustrated in FIG. 3C, memory 320 may include a multi-path data structure 346, port group configuration 348, traffic distribution policy 350, blocking ratio 352, and network parameter 354. Such components may collectively enable a network device to implement weighted adaptive routing functionality whereby network packets are distributed across port groups in proportions that reflect current network conditions.

In some aspects, the multi-path data structure 346 comprises one or more tables or other data structures that map packet destinations to specific routing actions. In some aspects, multi-path data structure 346 may be implemented as an ECMP table having a plurality of entries. Each entry in the multi-path data structure 346 may be associated with a rule or action that identifies a corresponding port group of a plurality of port groups. When a packet's destination address undergoes an LPM operation, the result may point to a multi-path data structure 346, which may then be used to determine routing behavior for the packet.

The multi-path data structure 346 may implement a network traffic distribution policy that apportions network packets across the plurality of port groups in proportions based on a network parameter. More specifically, the multi-path data structure 346 may map different entries to different port groups of the plurality of port groups. In some aspects, the multi-path data structure 346 may comprise an equal cost multi-path (ECMP) table having a plurality of entries, wherein different percentages of the plurality of entries are mapped to different port groups of the plurality of port groups. This weighted distribution enables traffic to be proportionally allocated according to network parameters. For example, if one network path has degraded to 75% of its original capacity due to a link failure, the multi-path data structure 346 may be configured such that 75% of its entries direct traffic to one port group and 25% to another, thereby ensuring that traffic load is proportionally distributed amongst available capacity.

In some aspects, each entry in the multi-path data structure 346 may be associated with at least one of a rule or an action that identifies a corresponding port group of the plurality of port groups, where the rule or action indicates which ports of the network device are included in the corresponding port group. For example, a rule might specify that port group A includes ports 0, 1, and 2, while port group B includes only port 3. Beyond port membership designations, rules or actions may include more complex routing behavior, such as but not limited to conditional routing logic that considers packet attributes like DSCP values or flow identifiers when selecting specific ports within the group; traffic classification rules that prioritize certain types of traffic within a port group for preferential handling during congestion; time-based routing policies that apply different port selection algorithms at different times of day or under different load conditions; bandwidth allocation parameters that specify relative weighting among ports within the same group; and congestion thresholds that trigger adaptive behavior within the port group, such as initiating alternate routing when queue depths exceed certain values. Additionally, rules may specify monitoring requirements, reporting thresholds, or marking behaviors to be applied to packets routed to a particular port group. In some aspects, the rule or action may be updated based on network asymmetry information received via BGP, allowing the system to dynamically adjust to changing network conditions.

In some aspects, the multi-path data structure 346 may be implemented as a hash table where incoming packets are hashed (based on header information such as source/destination addresses and ports) to select a specific entry. The selected entry may point to a corresponding port group for packet forwarding. By changing the distribution of entries that point to different port groups, the network device can obtain the desired traffic allocation ratio.

It should be noted that while the multi-path data structure 346 represents one implementation of a network traffic distribution policy that apportions network packets across port groups based on a network parameter, other algorithms or functions could be employed to achieve similar weighted distribution. For instance, a credit-based allocation system could assign different credit pools to different port groups and decrement credits as packets are forwarded, with larger credit pools resulting in proportionally more traffic allocation. Alternatively, a percentage-based forwarding algorithm could directly calculate forwarding decisions for each packet based on target distribution percentages without using a table-based approach. These alternative implementations could achieve the core functionality of apportioning network packets across the plurality of port groups in proportions based on a network parameter, such as network capacity.

In some aspects, the port group configuration 348 may define logical groupings of physical ports within the network device. Each port group may comprise one or more ports that share common characteristics, such as connectivity to a particular network path or next-hop device. The port group configuration 348 may include data structures that map physical port identifiers to logical group identifiers, along with metadata about each group, such as but not limited to an aggregate bandwidth capacity and/or operational status. In some aspects, the port group configuration 348 may define asymmetric port groups, wherein a first port group includes a single port, and a second port group includes at least two ports. Alternatively, port groups may be configured with varying numbers of ports based on network topology and routing requirements. The port group configuration 348 may establish boundaries within which adaptive routing decisions can be made and can provide a framework for implementing the proportional traffic distribution provided by the multi-path data structure 346, for example.

In some aspects, the traffic distribution policy 350 comprises rules and/or parameters that guide how network packets should be apportioned across different port groups based on network conditions. In some aspects, the traffic distribution policy 350 may include algorithmic definitions that translate network parameters (such as available bandwidth, link status, or congestion levels) into traffic distribution ratios. These policies may be implemented as executable code, lookup tables, or rule sets that the processing circuitry consults when determining routing behavior. In some aspects, the traffic distribution policy 350 may specify different distribution strategies for different traffic classes, destinations, or network scenarios. For example, traffic distribution policy 350 may specify that high-priority traffic follows one distribution pattern while lower-priority traffic follows another. The traffic distribution policy 350 may also define thresholds that trigger redistribution calculations and minimum bandwidth guarantees for some paths.

In some aspects, the blocking ratio 352 stores parameters that define the relationship between assigned traffic load and actual pathway capacity for each port group. The blocking ratio 352 may specify intentional oversubscription or undersubscription levels for different port groups. For example, a blocking ratio 352 may indicate that a particular port group should receive traffic at 133% of its actual capacity, with the understanding that congestion control mechanisms will manage the excess. In some aspects, the blocking ratio parameters may be expressed in various formats, such as ratios (e.g., 8/7 indicating assigned traffic is 8/7 times capacity), percentages, or absolute bandwidth values. Accordingly, the blocking ratio 352 may provide the ability to utilize fine-grained traffic management approaches that go beyond the binary “use/don't use” decisions of traditional routing approaches. In some aspects, at least one port group may be configured to receive an oversubscribed traffic load according to network parameters stored in blocking ratio 352, thereby creating controlled congestion that reduces overall traffic throughput by a specific amount corresponding to reduced capacity conditions in the network.

In some aspects, the network parameter 354 may store information about current network conditions that influence routing decisions. The network parameter 354 may include data structures that maintain current information about available bandwidth, congestion levels, link failures, quality of service requirements, or administrative weights assigned to particular network paths. The information in network parameter 354 may be derived from BGP updates, direct measurements, internal telemetry, or administrative configurations. In some aspects, the network parameter 354 may store link capacity information received via a BGP update message indicating link degradation or failure. For example, when a link in the network degrades from 400 Gbps to 300 Gbps capacity, this change could be reflected in network parameter 354, which may inform adjustments to the multi-path data structure 346 and blocking ratio 352.

In some aspects, BGP provides indications about network path degradation and capacity information through several extensions and mechanisms. While the base BGP protocol may not directly convey path quality metrics, extensions to BGP may handle additional capacity-like information in various ways. For example, a BGP Link-State (BGP-LS) extension may allow BGP to distribute link-state information collected by Interior Gateway Protocols (IGPs) such as Open Shortest Path First (OSPF) or Intermediate System to Intermediate System (IS-IS), including metrics about link bandwidth, utilization, and delay. Additionally, one or more BGP attributes, such as Multi-Exit Discriminator (MED) and Communities (both standard and extended), can convey performance information.

Other BGP-related mechanisms that may provide network parameter information include the BGP Monitoring Protocol (BMP), which may provide a way to monitor BGP sessions and collect routing information for analysis; Flow Specification (FlowSpec), which can be used to route traffic based on performance considerations; and Performance Routing (PfR) or Optimized Edge Routing (OER), which may use BGP to reroute traffic based on performance metrics like delay, jitter, and packet loss.

In some aspects, the network parameters (e.g., network parameter 354) may be updated as conditions change, providing real-time input to traffic distribution calculations. In some aspects, network parameter 354 may include various types of information that influence routing decisions. Available bandwidth information may indicate the current capacity of various network links or paths, allowing the network device to allocate traffic proportionally. Congestion levels may be measured at various points in the network, enabling the device to route traffic away from congested areas. Link failure information may indicate complete or partial degradation of network links, requiring traffic redistribution. Quality of service requirements may specify minimum performance guarantees for different traffic classes, influencing how traffic is apportioned across available paths. Administrative weights may be assigned to particular network paths based on policy considerations, such as cost, security, or performance preferences.

Thus, when the network device receives information indicating a change in network capacity (e.g., via a BGP update), this information is stored in network parameter 354. The processing circuitry (e.g., processing circuitry 318 of FIGS. 3A and 3B) may consult traffic distribution policy 350 to determine how traffic should be redistributed based on the updated network parameters. The processing circuitry 318 may then calculate appropriate traffic allocation proportions and update the multi-path data structure 346. The port group configuration 348 and blocking ratio 352 may inform these calculations by providing information about available port groups and desired oversubscription levels. By maintaining current information about network state, port groupings, and traffic distribution policies, memory 320 enables the network device to make intelligent routing decisions that optimize bandwidth utilization while avoiding uncontrolled congestion in complex, asymmetric network topologies.

In some aspects, memory 320 may further store historical data about network performance, which may be used to inform predictive routing decisions. The memory 320 may also maintain multiple versions of multi-path data structures for different destination prefixes, allowing for destination-specific routing policies. Additionally, memory 320 may store configuration parameters for congestion control mechanisms that work in conjunction with weighted adaptive routing to manage traffic flow during controlled oversubscription scenarios.

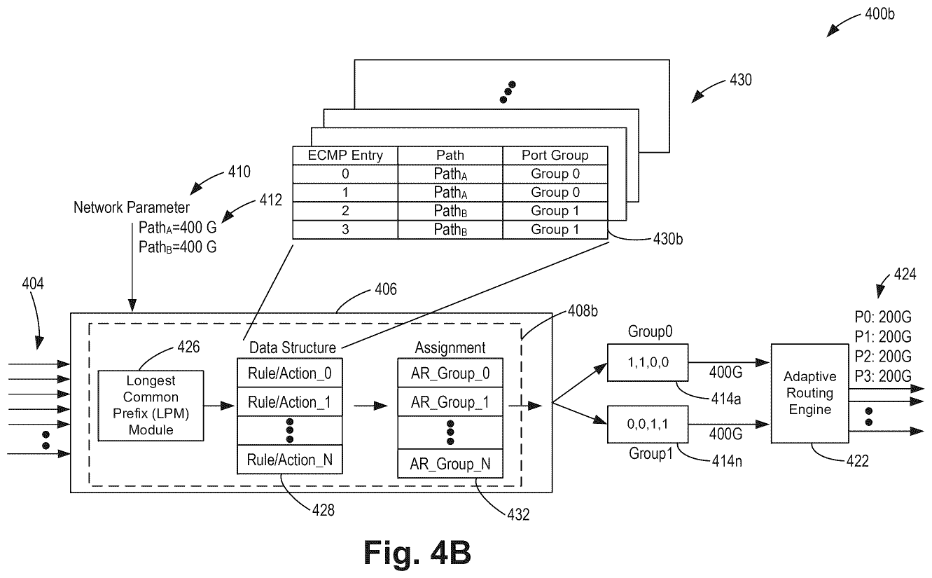

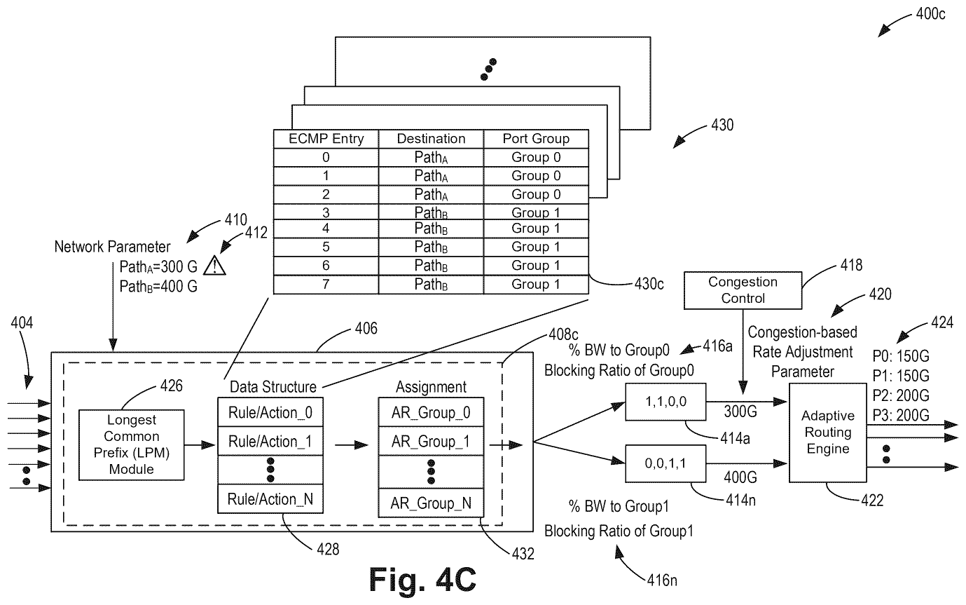

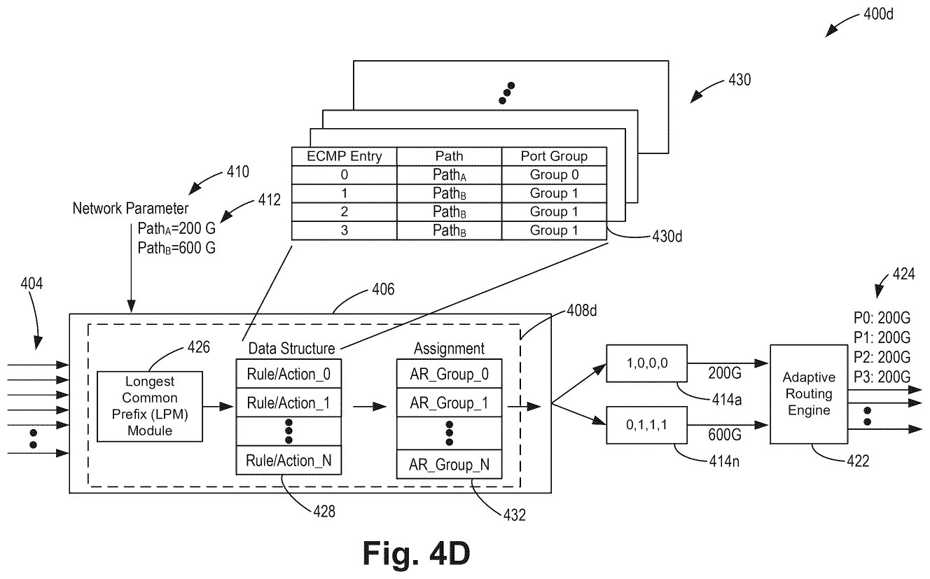

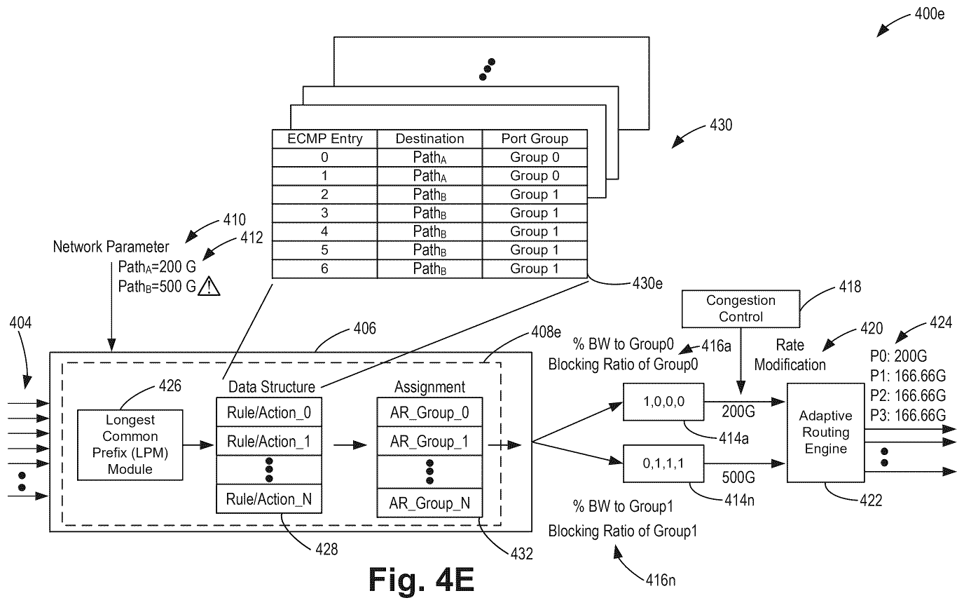

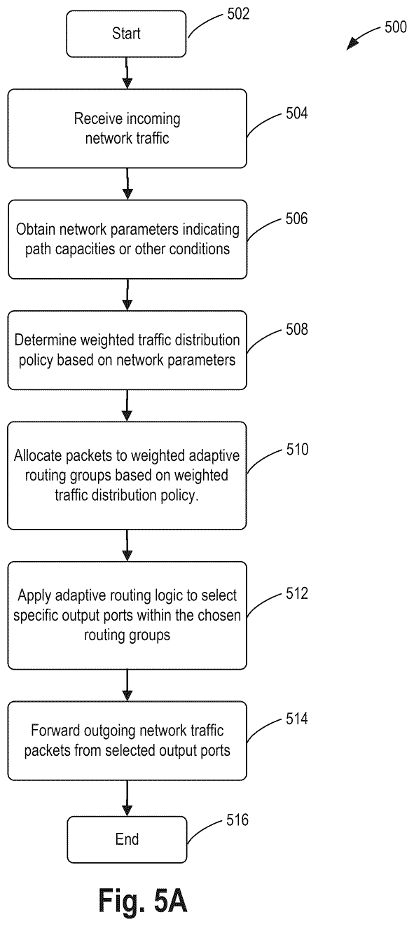

Referring now to FIG. 4A, an example of a weighted adaptive multi-path routing system 400a is illustrated in accordance with aspects of the present disclosure. In some aspects, the weighted adaptive multi-path routing system 400a may implement a non-binary traffic distribution and congestion management approach that overcomes limitations associated with traditional ECMP routing systems. The weighted adaptive multi-path routing system 400a may include a plurality of functional components that enable proportional traffic distribution across port groups based on network parameters. In some aspects, the weighted adaptive multi-path routing system 400a may be implemented within an interconnect device as described in FIGS. 3A-3C.

In some aspects, incoming network traffic 404 comprises data packets arriving at the network device via one or more ingress ports. The incoming network traffic 404 may originate from various hosts, NICs, or upstream network switches and may comprise multiple traffic flows destined for different network addresses or prefixes. The weighted adaptive multi-path routing system 400a may include a traffic distribution controller 406 configured to orchestrate the allocation of incoming network packets across multiple candidate paths or port groups. In some aspects, the traffic distribution controller 406 implements control-plane functionality that processes network parameters and adjusts traffic distribution to optimize network utilization, particularly in scenarios involving degraded or partially failed network links. Rather than implementing binary pruning decisions that either fully utilize or avoid specific links, the traffic distribution controller 406 may enable partial, proportional traffic allocation, which efficiently utilizes available network capacity.

In some aspects, a traffic distribution policy 408 provides rules and configurations that guide the traffic distribution controller 406 in apportioning traffic across different port groups. The traffic distribution policy 408 may define target proportions, minimum bandwidth guarantees, oversubscription parameters, or weighting factors for each port group. In some implementations, the traffic distribution policy 408 may be stored in memory, such as memory 320, as illustrated in FIG. 3C. The traffic distribution policy 408 may be periodically updated based on detected or announced changes in network capacity.

The weighted adaptive multi-path routing system 400a may include a network parameter 410 that represents real-time information about current conditions within the network. The network parameter 410 may include, but is not limited to, information regarding link and/or path bandwidth, link and/or path failures, congestion levels, or administrative weights assigned to particular paths. In some aspects, the network parameter 410 may be derived from external routing protocols (such as Border Gateway Protocol), internal telemetry systems, or direct measurements. The weighted adaptive multi-path routing system 400a may utilize the network parameter 410 to modify weighting assignments across various paths, ensuring that traffic allocation aligns with the actual available capacity of each route.

In some aspects, path capacity indicator 412 provides information regarding available or diminished bandwidth on particular network paths. For example, the path capacity indicator 412 may indicate that a link has degraded from full capacity (e.g., 4×100 Gbps) to partial capacity (e.g., 3×100 Gbps due to a single link failure). The path capacity indicator 412 enables the traffic distribution controller 406 to implement proportional traffic reduction rather than binary pruning decisions.

In some aspects, the weighted adaptive multi-path routing system 400a may include a plurality of weighted traffic groupings 414a-414n, wherein each grouping corresponds to a set of egress ports that may be used for packet forwarding. Unlike traditional equal-cost multi-path routing approaches that distribute traffic evenly across all potential paths, each weighted traffic grouping (e.g., 414a) may be allocated a fraction of the network traffic proportional to its capacity or other policy constraints.

As illustrated in FIG. 4A, weighted traffic grouping 414a has a port configuration represented as [X, X, 0, N], indicating which ports are active within this port group. Weighted traffic grouping 414n has a configuration of [0, 0, Y, N], representing a different set of active ports. The notation indicates that different physical ports may be included in different port groups, allowing for flexible traffic allocation across the network device's available ports.

In some aspects, group bandwidth and blocking ratio parameters 416a-416n define, for each weighted traffic grouping 414a-414n, respectively, traffic allocation characteristics, including how much traffic each group should carry and whether the group is deliberately oversubscribed. For example, a first port group might be configured to receive more traffic than its physical capacity can transmit, creating a controlled congestion scenario. By intentionally oversubscribing certain port groups while undersubscribing others, the system can abide by a global bandwidth usage that aligns with actual network conditions.

The weighted adaptive multi-path routing system 400a may include a congestion control module 418 configured to manage traffic flow through oversubscribed ports or port groups. When a port group receives more traffic than it can physically transmit, the congestion control module 418 may apply one or more congestion management techniques to ensure that excess traffic is appropriately throttled. Such techniques may include, but are not limited to, explicit congestion notification (ECN) marking, controlled packet dropping, and queue depth threshold management. These mechanisms ensure partial, non-binary throughput reduction on paths that have lost some capacity rather than completely disabling such paths.

In some aspects, a congestion-based rate adjustment parameter 420 may provide real-time or near-real-time signals that inform dynamic traffic distribution adjustments. These signals may include credit-based flow control metrics, ECN feedback, queue depth indicators, or other congestion measures that enable the congestion control module 418 and traffic distribution controller 406 to refine traffic allocation in response to actual network conditions. In certain implementations, these parameters may feed back into the traffic distribution policy 408, creating a dynamic control loop that continuously optimizes traffic distribution.

In some aspects, the weighted adaptive multi-path routing system 400a further includes an adaptive routing engine 422 configured to select specific physical ports for packet forwarding once packets have been allocated to port groups. The adaptive routing engine 422 may implement various selection algorithms, including but not limited to hashing, round-robin distribution, or real-time queue occupancy evaluation, to distribute traffic among ports within a single port group. As illustrated in FIG. 4A, the adaptive routing engine 422 routes packets are designated as PX through appropriate physical ports associated with their assigned port group, and similarly, route packets are designated as PY through physical ports associated with their respective port groups.

In some aspects, outgoing network traffic 424 represents the post-allocation, post-congestion-controlled data egressing from the network device toward downstream switches or end destinations. By the time network packets reach this stage, the forwarding paths have been determined and shaped according to the weighted routing approaches described herein. In some aspects, the outgoing traffic may be optimized for bandwidth utilization without the limitations of binary pruning decisions.

During operation, the weighted adaptive multi-path routing system 400a processes incoming network traffic 404 with reference to both the traffic distribution policy 408 and network parameter 410 to determine packet distribution among multiple candidate paths. The traffic distribution controller 406 may allocate traffic flows across weighted traffic groupings 414a-414n. In some aspects, the traffic distribution controller 406 may allocate traffic flows across weighted traffic groupings 414a-414n according to their associated group bandwidth and blocking ratio parameters 416a-416n. When a path capacity indicator 412 associated with the network parameter 410 indicates partial link degradation, the congestion control module 418 may ensure that traffic through oversubscribed paths is appropriately managed. In some aspects, the congestion control module 418 may take into account the congestion-based rate adjustment parameter 420 when performing and/or configuring congestion control according to one or more congestion control policies. In some aspects, the adaptive routing engine 422 may select specific egress ports within each assigned port group, thereby generating outgoing network traffic 424 that utilizes available bandwidth. In some aspects, the adaptive routing engine 422 may select specific egress ports within each assigned port group, thereby generating outgoing network traffic 424 that optimally utilizes available bandwidth without requiring binary link pruning.

In some aspects, the weighted adaptive multi-path routing system 400a may be implemented as a combination of hardware components (such as ASICs, FPGAs, or other integrated circuits), firmware, and/or software executing on one or more processing circuits. The functionality described herein may be distributed across multiple components of a network device, such as the interconnect device described with reference to FIGS. 3A-3C.

Referring now to FIG. 4B, an exemplary implementation of a weighted adaptive multi-path routing system 400b is illustrated in accordance with aspects of the present disclosure. FIG. 4B depicts a configuration of the weighted adaptive multi-path routing system 400a when no path degradation exists in the network, thereby illustrating a balanced distribution of network traffic across multiple port groups having equal capacity. In some aspects, incoming network traffic 404 enters the network device as described previously with reference to FIG. 4A. The network parameter 410 indicates current network conditions, which in this example shows that all paths can operate at full capacity (Path₀=400 Gbps, Path₁=400 Gbps), as indicated by path capacity indicator 412. Accordingly, network parameter 410 represents a network state wherein no degradation or partial link failures appear to be present.

The traffic distribution controller 406 implements a traffic distribution policy 408b that leverages multiple data structures to determine how incoming packets should be forwarded. In some aspects, the traffic distribution policy 408b comprises an LPM module 426, a multi-path data structure 428, and an adaptive routing group assignment data structure 432. The LPM module 426 may be configured to perform prefix-based lookups based on packet destination addresses. When a packet enters the network device, the LPM module 426 identifies the most specific network prefix that matches the packet's destination IP address. This LPM operation provides a result that points to a multi-path data structure, thereby enabling subsequent routing decisions.

The multi-path data structure 428 may include entries (Rule/Action_0, Rule/Action_1, . . . , Rule/Action_N) that define specific forwarding behaviors associated with each potential outcome of the ECMP table lookup. Each rule or action may identify a corresponding port group configuration and may include information about which physical ports belong to each group, quality of service parameters, or other forwarding attributes.

In some aspects, the multi-path data structure 428 is implemented as an ECMP table 430, which comprises a plurality of entries, as further illustrated in ECMP table 430b. Each entry in the ECMP table 430 may include an entry identifier (e.g., 0, 1, 2, 3), a corresponding path identifier (e.g., Path_{A}, Path_{B}), and an associated port group designation (e.g., Group 0, Group 1). As shown in the ECMP table 430b, entry zero and entry one map to Path_{A} and Group 0, while entry two and entry three map to Path_{B} and Group 1. Thus, two entries (representing approximately 50% of traffic) are directed to Group 0, while two entries (representing approximately 50% of traffic) are directed to Group 1. Such distribution may be predetermined based on network topology, administrative policies, or other factors and may be dynamically adjusted when network conditions change.

In some aspects, the adaptive routing group assignment data structure 432 maps the selected rule/action to specific port groups (AR_Group_0, AR_Group_1, . . . , AR_Group_N). This mapping may create logical groupings of physical ports that serve as candidates for packet forwarding. As illustrated, AR_Group_0 corresponds to a port configuration of [1,1,0,0], indicating that ports P0 and P1 are included in this group, while AR_Group_1 corresponds to a configuration of [0,0,1,1], indicating that ports P2 and P3 are included in this group. Following the adaptive routing group assignment, packets are directed to specific weighted traffic groupings 414a and 414n. As depicted in FIG. 4B, Group 0 (414a) has a port configuration of [1,1,0,0] with a combined bandwidth capacity of 400 Gbps, while Group 1 (414n) has a port configuration of [0,0,1,1] also with a bandwidth capacity of 400 Gbps.

Once a packet has been assigned to a specific port group, the adaptive routing engine 422 selects the specific port within that group for packet forwarding. As shown in 424, the network device includes four (or more) physical ports (P0: 200 Gbps, P1: 200 Gbps, P2: 200 Gbps, P3: 200 Gbps), each with a capacity of 200 Gbps, totaling 800 Gbps of forwarding bandwidth across all ports.

In some aspects, when a packet arrives, the packet's destination address undergoes an LPM lookup via LPM module 426, resulting in a pointer to an ECMP table 430b. An entry in the ECMP table 430b may be selected (e.g., based on a hash of the packet's header fields), which determines whether the packet will be forwarded through Group 0 or Group 1. In this balanced configuration with no path degradation, approximately 50% of traffic is directed to Group 0 (utilizing ports P0 and P1), and approximately 50% is directed to Group 1 (utilizing ports P2 and P3). This balanced distribution across equal-capacity port groups illustrates the weighted adaptive multi-path routing system 400b's operation in an optimal network state. When network conditions change (e.g. when path degradation occurs), the weighted adaptive multi-path routing system 400b can dynamically redistribute traffic by modifying the entries of a selected ECMP table 430b, adjusting the proportion of entries allocated to each port group to reflect actual available capacity, as previously described with reference to FIG. 4A. It should be understood that while FIG. 4B illustrates a specific configuration with four ECMP entries and two port groups, each containing two physical ports; the principles described herein may be applied to configurations having different numbers of ECMP entries, port groups, or physical ports without departing from the scope of the present disclosure.

Referring now to FIG. 4C, an exemplary implementation of a weighted adaptive multi-path routing system 400c, is illustrated in accordance with aspects of the present disclosure. FIG. 4C depicts a configuration of the weighted adaptive multi-path routing system 400a when path degradation exists in the network. Accordingly, and as depicted in FIG. 4C, the weighted adaptive multi-path routing system 400c may adaptively redistribute network traffic to accommodate reduced capacity on one or more network paths.

In some aspects, incoming network traffic 404 enters the network device as described previously with reference to FIGS. 4A and 4B. The network parameter 410 indicates current network conditions, which, in this example, shows that path degradation has occurred. Specifically, as indicated by path capacity indicator 412, Path_{B} maintains its full capacity of 400 Gbps, while Path_{A} has degraded to 300 Gbps. This represents a network state wherein a partial link failure or capacity reduction has affected one path but not the other.

The traffic distribution controller 406 may implement a traffic distribution policy 408c that utilizes multiple data structures to determine how incoming packets should be forwarded in light of the detected path degradation. Similar to the configuration shown in FIG. 4B, the traffic distribution policy 408c may comprise an LPM module 426, a multi-path data structure 428 implemented as an ECMP table 430c, and an adaptive routing group assignment data structure 432 for adaptive routing group assignment.

The LPM module 426 performs prefix-based lookups on packet destination addresses as previously described. However, in response to the detected path degradation, the entries of the resulting ECMP table 430c have been reconfigured to implement a weighted distribution that accounts for the reduced capacity of Path_{A}. As illustrated in ECMP table 430c, the ECMP table 430c now comprises eight entries, with entries zero, one, and two (representing approximately 37.5% of traffic) mapping to Path_{A} and Group 0, while entries three, four, five, six, and seven (representing approximately 62.5% of traffic) map to Path_{B} and Group 1. This represents a proportional adjustment from the balanced configuration shown in FIG. 4B, where 50% of traffic was directed to Group 0. The redistribution reflects the ratio of available bandwidth between Path_{A} (300 Gbps) and Path_{B} (400 Gbps), which is approximately 3:5, or 62.5% to 37.5%. This illustrates the system's ability to implement non-binary, proportional traffic distribution in response to partial path degradation.

In some aspects, the multi-path data structure 428 remains functionally similar to that described in FIG. 4B, though the specific actions taken may be updated to reflect the current network conditions. The adaptive routing group assignment data structure 432 maintains the mapping between selected rules/actions and specific adaptive routing groups (AR_Group_0, AR_Group_1, . . . , AR_Group_N).

Following the adaptive routing group assignment, packets may be directed to specific weighted traffic groupings 414a and 414n. In this example reflecting path degradation, Group 0 (414a) maintains its port configuration of [1,1,0,0] but operates with reduced capacity with a combined bandwidth capacity of 300 Gbps, as reflected by the “% BW to Group 0” and “Blocking Ratio of Group0” designations 416a. Similarly, Group 1 (414n) maintains its port configuration of [0,0,1,1] which is now deliberately oversubscribed, as indicated by “% BW to Group1” and “Blocking Ratio of Group1” designations 416n, for example, in the example depicted in FIG. 4C, the “% BW to Group 0” may be equal to 37.5% (e.g., 800 Gbps×37.5%=300 Gbps), and the “% BW to Group 1” may be equal to 62.5% (e.g., 800 Gbps×62.5%=500 Gbps). Thus, port group 1 may be deliberately oversubscribed and a blocking ratio may be equal to 500 Gbps/400 Gbps or 5/4. Alternatively, or in addition, the blocking ratio of port group 0 may be equal to 300 Gbps/400 Gbps or 3/4.

In response to path degradation, the congestion control module 418 may become actively engaged in managing traffic flow. Working in conjunction with the congestion-based rate adjustment parameter 420, the congestion control module 418 ensures that traffic allocated to each path remains within the path's actual capacity despite the intentional oversubscription applied to Group 1. As shown in 424, the network device's physical ports now reflect the path degradation condition. Ports P0 and P1 each maintain a 150 Gbps capacity for a total of 300 Gbps in Group 0, while ports P2 and P3 maintain their 200 Gbps capacity each for a total of 400 Gbps in Group 1. The total system capacity (based on ports P0-P3) is therefore reduced from 800 Gbps to 700 Gbps due to the path degradation.

In operation, when a packet arrives under these degraded network conditions, its destination address undergoes an LPM lookup via LPM module 426, resulting in a pointer to the reconfigured ECMP table 430c. A specific entry in the ECMP table is selected to determine whether the packet will be forwarded through Group 0 or Group 1. In this weighted configuration adjusted for path degradation, approximately 37.5% of traffic is directed to Group 0 (utilizing ports P0 and P1), while approximately 62.5% is directed to Group 1 (utilizing ports P2 and P3). The reconfigured distribution ensures that traffic is proportionally allocated based on actual available path capacity. The congestion control module 418 further manages any oversubscription, ensuring controlled congestion rather than unpredictable packet loss. This non-binary approach to traffic management when dealing with path degradation represents an improvement over traditional adaptive routing techniques that would either continue sending excess traffic to the degraded path (causing uncontrolled congestion) or avoid the degraded path (wasting remaining capacity).

It should be appreciated that while FIG. 4C illustrates a specific configuration with eight ECMP entries and a particular distribution ratio between two port groups; the principles described herein may be applied to configurations having different numbers of ECMP entries, port groups, physical ports, or distribution ratios without departing from the scope of the present disclosure. The weighted adaptive multi-path routing system 400c can dynamically recalculate and implement appropriate traffic distribution proportions based on the specific nature and extent of detected path degradations. As an example, an ECMP table may comprise seven entries, with entries zero, one, and two (representing approximately 42.9% of traffic) mapping to Path_{A} and Group 0, while entries three, four, five, and six (representing approximately 57.1% of traffic) map to Path_{B} and Group 1. Such a redistribution reflects the ratio of available bandwidth between Path_{A} (300 Gbps) and Path_{B} (400 Gbps), which is approximately 3:4, or 57.1% to 42.9%. The “% BW to Group 0” may be equal to 42.9% (e.g., 800 Gbps×42.9%=342.9 Gbps), and the “% BW to Group 1” may be equal to 57.1% (e.g., 800 Gbps×57.1%=457.1 Gbps). Thus, port group 0 and port group 1 may be deliberately oversubscribed, and a blocking ratio may be equal to 342.9 Gbps/400 Gbps for port group 0 and 457.1 Gbps/400 Gbps for port group 1. Thus, the congestion control module 418 may enforce rate limitations for both port group 0 and port group 1. Accordingly, and in some aspects, the group bandwidth and blocking ratio parameters 416a-416b and congestion-based rate adjustment parameter 420 may be a result of traffic distribution policy 408c and/or may drive or otherwise guide the traffic distribution policy 408c, where the traffic distribution policy 408c may be configured based on the group bandwidth and blocking ratio parameters 416a-416b, and congestion-based rate adjustment parameter 420.

Referring now to FIG. 4D, an exemplary implementation of a weighted adaptive multi-path routing system 400d is illustrated in accordance with aspects of the present disclosure. FIG. 4D depicts a specific configuration of the weighted adaptive multi-path routing system 400a, wherein no path degradation exists in the network, but traffic is, nevertheless, intentionally distributed asymmetrically across multiple port groups with equal capacity. In some aspects, incoming network traffic 404 enters the network device as described previously with reference to FIGS. 4A-4C. The network parameter 410 indicates current network conditions, which in this example depicts that all paths can operate at full capacity (Path_{A}=400 Gbps, Path_{B}=400 Gbps), as indicated by path capacity indicator 412. This represents a network state wherein no degradation or partial link failures appear to be present, similar to that described with reference to FIG. 4B.

The traffic distribution controller 406 may implement a traffic distribution policy 408d that utilizes multiple data structures to determine how incoming packets should be forwarded. In the illustrated example, the traffic distribution policy 408d comprises an LPM module, a multi-path data structure 428, and an adaptive routing group assignment data structure 432 for adaptive routing group assignment. Upon receiving a packet, the LPM module 426 performs prefix-based lookups on the packet's destination address. This LPM operation provides a result that points to a multi-path data structure, which may be implemented as a multi-path data structure 428, an example of which is ECMP table 430 comprising a plurality of entries as illustrated in the ECMP table 430d.

In contrast to the balanced configuration shown in FIG. 4B, the ECMP table 430d is configured to implement an intentionally asymmetric distribution despite all paths capable of operating at full capacity. As shown in the ECMP table 430d, entry zero maps to Path_{A} and Group 0, while entries one, two, and three maps to Path_{B} and are associated with Group 1. This configuration directs approximately 25% of network traffic to Group 0 and approximately 75% of traffic to Group 1.

Following the LPM operation, a specific entry in the ECMP table 430d is selected (e.g., based on a hash of the packet's header fields), which determines the rule/action to be applied. The selected rule/action can be mapped to a specific adaptive routing group via the adaptive routing group assignment data structure 432, which includes entries (AR_Group_0, AR_Group_1, . . . , AR_Group_N) that define logical groupings of physical ports.

As illustrated, weighted traffic grouping 414a corresponds to Group 0 with a port configuration of [1,0,0,0], indicating that only port P0 is included in this group. This single-port configuration provides a bandwidth capacity of 200 Gbps. Conversely, weighted traffic grouping 414n corresponds to Group 1 with a port configuration of [0,1,1,1], indicating that ports P1, P2, and P3 are included in this group, providing a combined bandwidth capacity of 600 Gbps.

In some aspects, the weighted adaptive multi-path routing system 400d intentionally allocates approximately 25% of traffic to a port group having 25% of the total port capacity (Group 0 with 200 Gbps out of 800 Gbps total), while approximately 75% of traffic is allocated to a port group having 75% of the total port capacity (Group 1 with 600 Gbps out of 800 Gbps total). This proportional allocation ensures that each port group receives traffic commensurate with its capacity, thereby balancing utilization across all ports despite the asymmetric grouping.

Once a packet has been assigned to a specific port group, the adaptive routing engine 422 selects the specific port within that group for packet forwarding. As shown in 424, the network device includes four physical ports (P0: 200 Gbps, P1: 200 Gbps, P2: 200 Gbps, P3: 200 Gbps), each with a capacity of 200 Gbps, totaling 800 Gbps of forwarding bandwidth across all ports.

In operation, packets directed to Group 0 (via the single entry in the ECMP table 430d that maps to Group 0) are forwarded through port P0, while packets directed to Group 1 (via the three entries in the ECMP table 430d that map to Group 1) are distributed among ports P1, P2, and P3 according to the adaptive routing algorithm. This configuration demonstrates the weighted adaptive multi-path routing system 400d's flexibility in implementing diverse traffic distribution policies even when all network paths are capable of operating at full capacity.

It should be understood that the configuration illustrated in FIG. 4D represents one possible implementation of weighted adaptive multi-path routing in a non-degraded network environment. The principles described herein may be applied to configurations having different numbers of ECMP entries, port groups, or physical ports, and different traffic distribution proportions, without departing from the scope of the present disclosure. Additionally, the system may dynamically transition between different configurations (such as those illustrated in FIGS. 4B, 4C, and 4D) in response to changing network conditions or administrative policies.

Referring now to FIG. 4E, an example implementation of a weighted adaptive multi-path routing system 400e is illustrated in accordance with aspects of the present disclosure. FIG. 4E depicts a configuration of the weighted adaptive multi-path routing system 400a that demonstrates its operation when path degradation exists in an asymmetric port group configuration, illustrating how the weighted adaptive multi-path routing system 400e dynamically adjusts traffic distribution to accommodate reduced capacity on one or more network paths.

In some aspects, incoming network traffic 404 enters the network device as described previously with reference to FIGS. 4A-4D. The network parameter 410 may indicate current network conditions, which in this example shows that a path degradation has occurred. Specifically, as indicated by path capacity indicator 412, Path_{A} maintains its full capacity of 200 Gbps, while Path_{B} has degraded to 500 G. This represents a network state wherein a partial link failure or capacity reduction has affected one path but not the other.

The traffic distribution controller 406 implements a traffic distribution policy 408e that utilizes multiple data structures to determine how incoming packets should be forwarded in light of the detected path degradation and the existing asymmetric port group configuration. Similar to the configurations shown in FIGS. 4B-4D, the traffic distribution policy 408e comprises an LPM module 426, a multi-path data structure 428, and an adaptive routing group assignment data structure 432 for adaptive routing group assignment.

In response to the detected path degradation, the resulting entries of the ECMP table 430e have been reconfigured to implement a weighted distribution that accounts for both the asymmetric port group configuration and the reduced capacity of Path_{B}. As illustrated in the ECMP table 430e, the ECMP table 430e now comprises seven entries (0-6), with entry zero (representing approximately 28.6% of traffic) mapping to Path₀ and Group 0, while entries two through six (representing approximately 71.4% of traffic) map to various instances of PathB and Group 1.

This weighted distribution represents an adjustment from the configuration shown in FIG. 4D, where 25% of traffic was directed to Group 0 and 75% to Group 1. The new distribution ratio of approximately 28.6% to 71.4% reflects the system's adaptive response to the path degradation, ensuring that traffic allocation aligns with actual available capacity across the asymmetric port groups. Following the adaptive routing group assignment, packets are directed to specific weighted traffic groupings 414a and 414n. For example, Group 0 (414a ) maintains its port configuration of [1,0,0,0] with a corresponding bandwidth designation of 200 Gbps, while Group 1 (414n) maintains its port configuration of [0,1,1,1] but now operates with a reduced capacity of 500 Gbps due to the path degradation.

The “% BW to Group0” and “Blocking Ratio of Group0” designations 416a indicate how traffic is proportionally allocated to Group 0, while the corresponding designations 416n for Group 1 reflect its allocation. These parameters depict that traffic distribution aligns with actual available capacity despite the asymmetric port group configuration and path degradation. The “% BW to Group 0” may be equal to 28.6% (e.g., 800 Gbps×28.6%=228.8 Gbps), and the “% BW to Group 1” may be equal to 71.4% (e.g., 800 Gbps×71.4%=571.1 Gbps). Thus, port group 0 may be deliberately oversubscribed, and a blocking ratio may be equal to 228.8 Gbps/200 Gbps for port group 0 and 571.1 Gbps/600 Gbps for port group 1. In some aspects, the congestion control module 418 may enforce rate limitations for both port group 0 and port group 1.

In response to the path degradation, the congestion control module 418 becomes actively engaged to manage traffic flow. Working in conjunction with the congestion-based rate adjustment parameter 420, the congestion control module 418 ensures that traffic allocated to each path remains within the path's actual capacity.

As shown in 424, the network device's physical ports now reflect both the asymmetric configuration and the path degradation condition. Port P0 maintains its 200 Gbps capacity for Group 0, while ports P1, P2, and P3 now operate at 166.66 Gbps each (reduced from their original 200 Gbps capacity) for a total of 500 Gbps in Group 1. The total system capacity is therefore reduced from 800 Gbps to 700 Gbps due to the path degradation.

In operation, when a packet arrives under degraded network conditions, its destination address undergoes an LPM lookup via LPM module 426, resulting in a pointer to the reconfigured ECMP table 430e. A specific entry in the ECMP table is selected, determining whether the packet will be forwarded through Group 0 or Group 1. In this weighted configuration adjusted for path degradation in an asymmetric setup, approximately 28.6% of traffic is directed to Group 0 (utilizing port P0), while approximately 71.4% is directed to Group 1 (utilizing ports P1, P2, and P3).

Once a packet has been assigned to a specific port group, the adaptive routing engine 422 selects the specific port within that group for packet forwarding. For packets assigned to Group 0, the selection is straightforward, as only one port (P0) is available. For packets assigned to Group 1, the adaptive routing engine 422 distributes traffic among ports P1, P2, and P3 according to the adaptive routing algorithm, taking into account their reduced capacity.

The reconfigured distribution ensures that traffic is proportionally allocated based on actual available path capacity while maintaining the asymmetric port group configuration. The congestion control module 418 further manages traffic flow to prevent uncontrolled congestion, implementing a non-binary approach to traffic management that represents an improvement over traditional adaptive routing techniques.

It should be appreciated that while FIG. 4E illustrates a specific configuration with seven ECMP entries and a particular distribution ratio between two asymmetric port groups under path degradation conditions, the principles described herein may be applied to configurations having different numbers of ECMP entries, port groups, physical ports, or distribution ratios without departing from the scope of the present disclosure. The weighted adaptive multi-path routing system 400e can dynamically recalculate and implement appropriate traffic distribution proportions based on the specific nature and extent of detected path degradations, while accommodating various port group configurations.

As an example, an ECMP table may comprise eight entries, with entries zero, one, and two (representing approximately 37.5% of traffic) mapping to Path_{A} and Group 0, while entries three, four, five, six, and seven (representing approximately 62.5% of traffic) map to Path_{B} and Group 1. Such a redistribution reflects the ratio of available bandwidth Path_{B} (e.g., 500 Gbps), which is approximately 5:3, or 62.5% to 37.5%. The “% BW to Group 0” may be equal to 37.5% (e.g., 800 Gbps×37.5%=300 Gbps), and the “% BW to Group 1” may be equal to 62.5% (e.g., 800 Gbps×62.5%=500 Gbps). Thus, port group 0 may be deliberately oversubscribed, and a blocking ratio may be equal to 300 Gbps/200 Gbps for port group 0 and 500 Gbps/600 Gbps for port group 1. Thus, the congestion control module 418 may enforce rate limitations for port group 0. In some aspects, the blocking ratio may be associated with the new network capacity and the old network capacity (e.g., 700 Gbps/800 Gbps=⅞).

In some aspects, the group bandwidth and blocking ratio parameters 416a-416b and congestion-based rate adjustment parameter 420 may be a result of traffic distribution policy 408c and/or may drive or otherwise guide the traffic distribution policy 408c, where the traffic distribution policy 408c may be configured based on the group bandwidth and blocking ratio parameters 416a-416b, and congestion-based rate adjustment parameter 420.

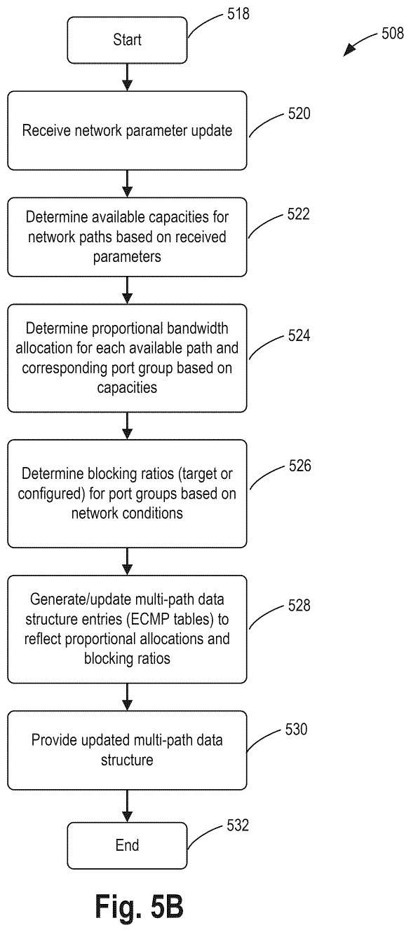

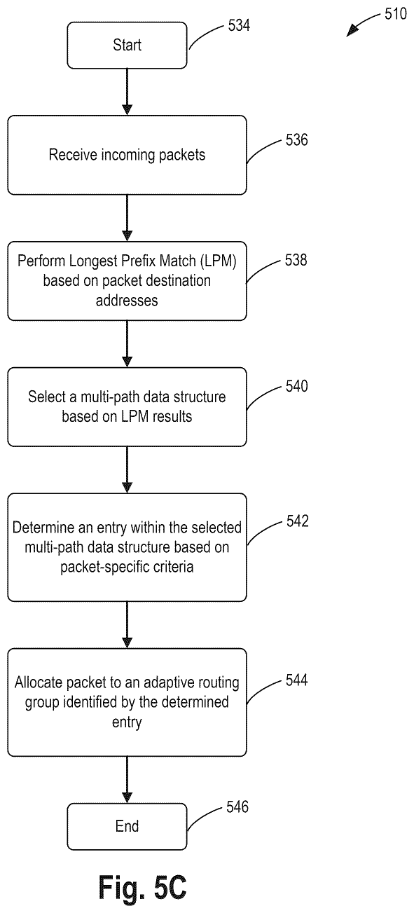

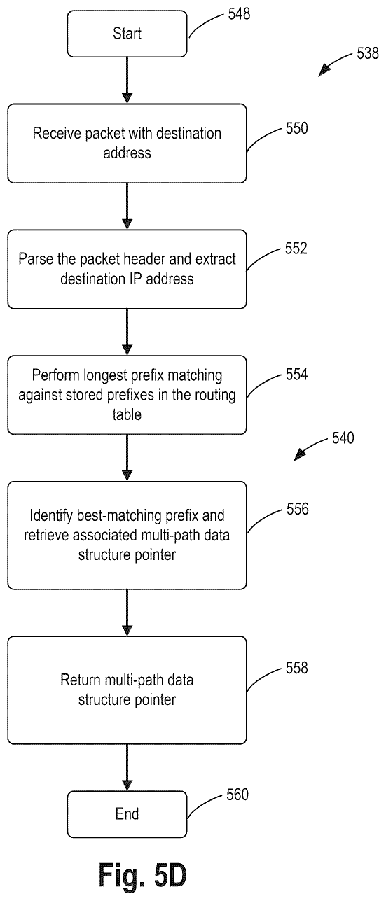

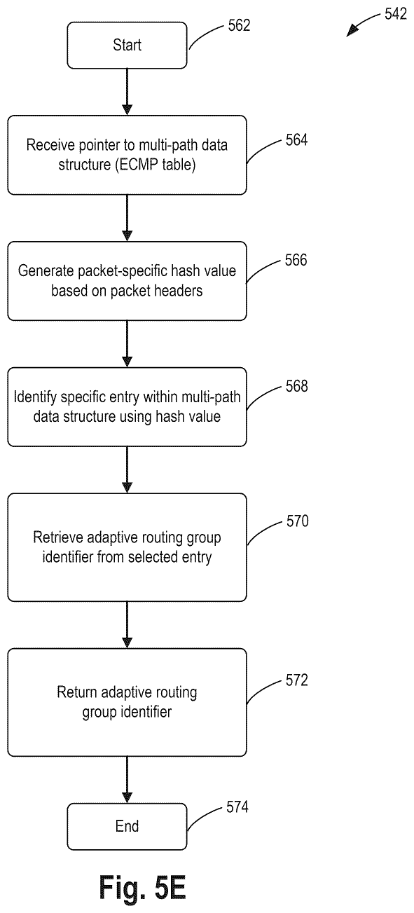

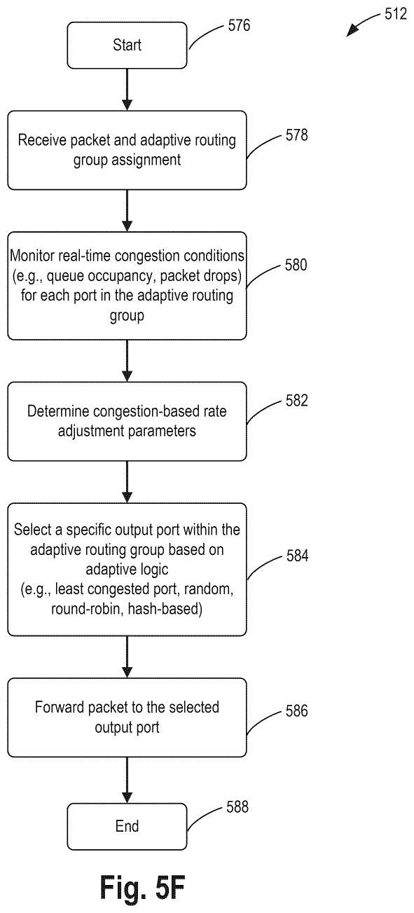

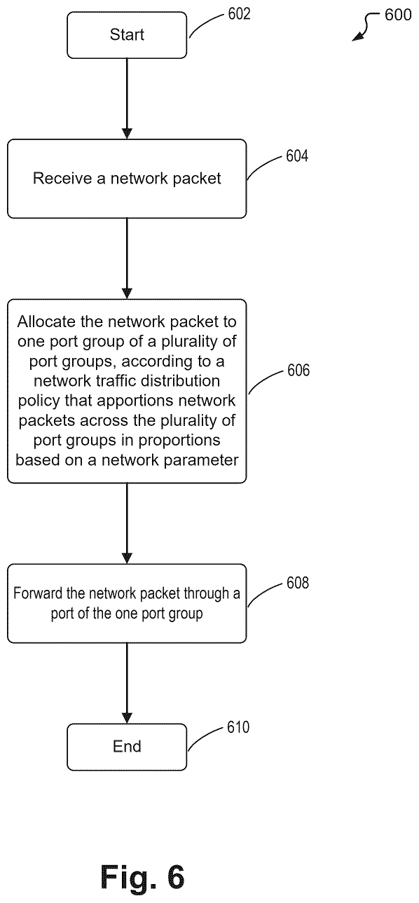

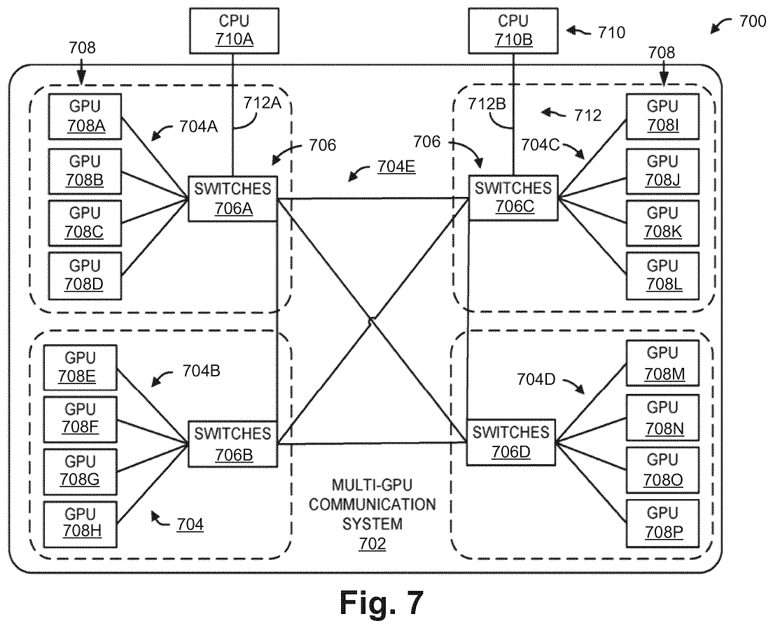

Methods according to aspects of the present disclosure will now be described with reference to FIGS. 5A-6. Such methods may be performed by one or more circuits described with reference to FIGS. 1-4, for example. In some examples, the one or more circuits comprise hardware (e.g., processing circuitry, logic, queues, memory) or a combination of hardware and software that implement weighted adaptive multi-path routing functions described herein. As may be appreciated, the one or more circuits may be included in an interconnect device 102 and correspond to or involve 302, 304, 318, and/or 320.

Referring now to FIG. 5A, a flowchart illustrates a method 500 for weighted adaptive multi-path routing in accordance with aspects of the present disclosure. Method 500 depicts a high-level process for implementing non-binary traffic distribution across multiple port groups based on network parameters.

Method 500 begins at the start of block 502, where a network device, such as an interconnect device 102, described with reference to FIGS. 1-3C, initializes its routing functionality. In some aspects, this initialization may involve setting up data structures for routing tables within memory 320, configuring port groups via the port group manager 342, and establishing initial traffic distribution parameters stored in memory 320 as traffic distribution policy 350.

At block 504, the network device receives incoming network traffic. This incoming traffic may comprise data packets arriving through ports 302a-302n of interconnect device 102. The packets may be destined for various network addresses or prefixes and may enter the switching hardware 304 for initial processing.

Proceeding to block 506, the network device obtains network parameters indicating path capacities or other network conditions. These parameters may be received via network protocols such as BGP and processed by the network state processor 332 of processing circuitry 318. The processed network parameters may then be stored in memory 320 as network parameter 354. In some aspects, queue monitor 308 may also provide internal telemetry data regarding congestion levels that can inform routing decisions.

At block 508, the network device determines a weighted traffic distribution policy based on the obtained network parameters. Portions of block 508 may involve the traffic distribution controller 330 calculating appropriate traffic allocation proportions, and may consult the blocking ratio policy generator 344 to determine proper traffic distribution ratios for different port groups. The resulting policy may be stored in memory 320 as traffic distribution policy 350.

Continuing to block 510, the network device allocates packets to weighted adaptive routing groups based on the weighted traffic distribution policy. This allocation may involve switching hardware 304 performing LPM operations on packet destination addresses, consulting the multi-path data structure 310 (such as ECMP tables), and directing packets to specific port groups according to the determined distribution proportions. The multi-path data structure generator 334 within processing circuitry 318 may update the multi-path data structure 346 stored in memory 320 to reflect current network conditions, ensuring proper traffic allocation.

At block 512, the network device applies adaptive routing logic to select specific output ports within the chosen routing groups. Portions of block 512 may involve the adaptive routing engine 314 taking the port group assignment from the previous block and determining the exact physical port through which each packet will be forwarded. The adaptive routing engine 314 may utilize information from queue monitor 308 to make informed port selection decisions within a group.

Proceeding to block 514, the network device forwards outgoing network traffic packets from the selected output ports. At this stage, packets egress the network device through the physical ports 302a-302n as determined in the previous blocks. The congestion control manager 316 may assist in this process, particularly for port groups experiencing controlled congestion, ensuring appropriate packet handling in accordance with congestion control configurations defined by congestion control configuration/policy component 336.

The method 500 concludes at end block 516. In some aspects, method 500 may operate continuously as new packets arrive at the network device. The blocks described may be repeated for each packet or group of packets processed by the device, with network parameters and traffic distribution policies being updated as conditions change.

By implementing method 500 using the components described in FIGS. 3A-3C, interconnect device 102 can achieve proportional traffic distribution across multiple paths based on their actual available capacity, providing improvements in network utilization and performance compared to traditional routing approaches that make binary include/exclude decisions regarding available paths.

Referring now to FIG. 5B, a flowchart illustrates a method 508 for determining a weighted traffic distribution policy based on network parameters in accordance with aspects of the present disclosure. Method 508 provides a detailed expansion of block 508 from FIG. 5A, illustrating specific operations performed to establish a weighted traffic distribution policy that optimally apportions network traffic across multiple paths based on their available capacities.

The method 508 begins at start block 518, which may be initiated when the traffic distribution controller 330 of processing circuitry 318 receives an indication that network conditions have changed, requiring recalculation of traffic distribution parameters.

At block 520, the network device receives a network parameter update. At least a portion of block 520 may be performed by the network state processor 332 within processing circuitry 318, which may receive and process updates from external protocols such as BGP. These updates may indicate changes in network topology, link status, or bandwidth availability. The network state processor 332 may extract relevant information from these updates and format it for use by other components of the system. The processed information may then be stored in memory 320 as updated network parameter 354 data.

Proceeding to block 522, the network device determines available capacities for network paths based on received parameters. Portions of block 522 may involve the traffic distribution controller 330 and network state processor 332 analyzing the received network parameters to calculate current available bandwidth for each potential path through the network. For example, if a BGP update indicates that a link has degraded from 400 Gbps to 300 Gbps, the traffic distribution controller 330 would identify the affected paths and their new capacity constraints. This information may be temporarily stored in memory 320 for use in subsequent calculations.

At block 524, the network device determines proportional bandwidth allocation for each available path and corresponding port group based on capacities. Portions of block 524 may be performed by the traffic distribution controller 330 in conjunction with the blocking ratio policy generator 344. Based on the available capacities determined in the previous blocks, these components calculate appropriate traffic distribution proportions that may optimize network utilization while avoiding uncontrolled congestion. For example, if one path has 400 Gbps available capacity while another has 300 Gbps, the system might determine a 4:3 ratio (or approximately 57%:43%) for traffic distribution between these paths.

Continuing to block 526, the network device determines blocking ratios (target or configured) for port groups based on network conditions. Portions of block 526 may involve the blocking ratio policy generator 344 calculating appropriate oversubscription or undersubscription levels for different port groups. The blocking ratio policy generator 344 may determine, for example, that a port group should receive traffic at 120% of its actual capacity, with the understanding that congestion control mechanisms will manage the excess. These blocking ratios may be stored in memory 320 as blocking ratio 352 for reference by other components of the system.

At block 528, the network device generates or updates multi-path data structure entries (e.g., ECMP tables) to reflect proportional allocations and blocking ratios. Portions of block 528 may be performed by the multi-path data structure generator 334 of processing circuitry 318, which creates or modifies entries in the multi-path data structure 346 stored in memory 320. The multi-path data structure generator 334 adjusts the distribution of entries in ECMP tables to align with the determined proportional bandwidth allocations. For example, if a 57%:43% traffic distribution is desired, the multi-path data structure generator 334 might allocate 4 entries to one port group and 3 entries to another in a 7-entry ECMP table.

Proceeding to block 530, the network device provides the updated multi-path data structure to the appropriate components for implementation. Portions of block 530 may involve the processing circuitry 318 programming the updated multi-path data structure into the switching hardware 304, particularly into the multi-path data structure 310 used by the hardware during packet processing. This ensures that subsequent packet forwarding decisions will reflect the newly calculated traffic distribution policy.

The method concludes at end block 532. In some aspects, method 508 may be executed periodically or whenever significant network changes are detected. By implementing method 508 using the components described in FIGS. 3A-3C, the network device can dynamically adapt its traffic distribution policies to optimize network utilization in the face of changing conditions, implementing non-binary, proportional traffic management that improves upon traditional routing approaches.

Referring now to FIG. 5C, a flowchart illustrates a method 510 for allocating packets to weighted adaptive routing groups based on a weighted traffic distribution policy in accordance with aspects of the present disclosure. Method 510 provides a detailed expansion of block 510 from FIG. 5A, illustrating operations performed to allocate incoming network packets to appropriate port groups according to the weighted distribution policy previously determined.

The method 510 begins at start block 534, which may be initiated when incoming packets are ready for processing according to the weighted adaptive routing approach. At block 536, the network device receives incoming packets. Portions of block 536 may be performed by the switching hardware 304 of interconnect device 102, which receives data packets through one or more ports 302a-302n. The incoming packets may be temporarily stored in buffer 312 while awaiting processing. In some implementations, the packets may be organized into queues 306a-306n, corresponding to their ingress ports before further processing.

Proceeding to block 538, the network device performs LPM based on packet destination addresses. Portions of block 538 may be executed by LPM circuitry within the switching hardware 304, which compares the destination IP address of each packet against entries in a routing table to identify the most specific matching network prefix. The LPM operation identifies the appropriate next-hop or forwarding behavior for each packet. In the context of weighted adaptive routing, the LPM result may point to a multi-path data structure that will guide further forwarding decisions.

At block 540, the network device may select a multi-path data structure based on LPM results. Portions of block 540 may involve the switching hardware 304 using the outcome of the LPM operation to identify and access a multi-path data structure 310, such as an ECMP table, relevant to the packet's destination. The multi-path data structure 310 may be maintained in hardware memory within switching hardware 304, with its contents obtained from the multi-path data structure 346 stored in memory 320 and programmed by the processing circuitry 318.

Continuing to block 542, the network device determines an entry within the selected multi-path data structure based on packet-specific criteria. Portions of block 542 may be performed by the switching hardware 304, which uses additional packet information (such as source/destination IP addresses, port numbers, or protocol identifiers) to compute a hash value or apply another selection algorithm. The computed value is then used to select a specific entry within the multi-path data structure 310. The entry selection process effectively distributes packets across multiple potential forwarding paths according to the weighted proportions established in the multi-path data structure, which was previously configured by the multi-path data structure generator 334 to reflect desired traffic distribution ratios.

At block 544, the network device allocates the packet to an adaptive routing group identified by the determined entry. Portions of block 544 may involve the switching hardware 304 mapping the selected entry to a specific port group configuration as defined by the port group manager 342. The port group configurations stored in memory 320 as port group configuration 348 define which physical ports belong to each logical group. By allocating the packet to a specific adaptive routing group, the network device effectively narrows down the set of egress ports that may be considered for packet forwarding, implementing the weighted traffic distribution policy established earlier.

The method concludes at end block 546. In some aspects, method 510 could be executed for each packet processed by the network device. Following the allocation of a packet to an adaptive routing group, the network device could proceed to select a specific port within that group (as detailed in block 512 of FIG. 5A) before ultimately forwarding the packet.

By implementing method 510 using the components described in FIGS. 3A-3C, the network device can efficiently allocate incoming packets to appropriate port groups according to weighted distribution policies that reflect actual network capacities. This approach ensures optimal utilization of available bandwidth while avoiding congestion that might result from binary routing decisions, particularly in scenarios involving partially degraded links or asymmetric network topologies.

Referring now to FIG. 5D, a flowchart illustrates a method 538 for performing an LPM operation in accordance with aspects of the present disclosure. Method 538 provides a detailed expansion of block 538 from FIG. 5C, illustrating specific operations performed to execute an LPM operation based on packet destination addresses.

The method 538 begins at start block 548, which may be initiated when a packet requires LPM processing to determine its forwarding path within the weighted adaptive routing system. At block 550, the network device receives a packet with a destination address. Portions of block 550 may be performed by the switching hardware 304 of interconnect device 102, which receives the packet from buffer 312 or directly from an ingress port via queues 306a-306n. The packet may have been initially received through one of the ports 302a-302n and queued for processing according to the device's packet handling pipeline.

Proceeding to block 552, the network device parses the packet header and extracts destination IP address. Portions of block 552 may be executed by packet processing circuitry within the switching hardware 304, which examines the packet's header structure to locate and extract the destination IP address field. Depending on the specific network protocols in use, this may involve parsing IPv4 or IPv6 headers, potentially navigating through encapsulation layers, and isolating the relevant address information for subsequent matching operations.

At block 554, the network device performs longest prefix matching against stored prefixes in the routing table. Portions of block 554 may involve LPM circuitry within the switching hardware 304, which compares the extracted destination IP address against a collection of network prefixes stored in high-speed memory such as TCAM (Ternary Content-Addressable Memory) or other optimized data structures. The routing table entries may be populated and maintained by the processing circuitry 318 based on routing protocol updates or administrative configurations. The LPM operation identifies the most specific (e.g., longest) prefix that matches the packet's destination IP address, which determines the appropriate forwarding behavior.

Continuing to block 556, the network device identifies matching prefix and retrieves associated multi-path data structure pointer. Portions of block 556 may be performed by the switching hardware 304, which, upon identifying the longest matching prefix, accesses the corresponding forwarding information. In the context of weighted adaptive routing, each prefix entry in the routing table typically points to a multi-path data structure 310 (such as an ECMP table) that contains multiple potential forwarding options. The multi-path data structure pointer essentially serves as a reference to the appropriate collection of weighted entries that will guide subsequent packet forwarding decisions.

At block 558, the network device returns the multi-path data structure pointer for use in subsequent blocks. Portions of block 558 may involve the switching hardware 304 passing the retrieved pointer to the next stage in the packet processing pipeline, where it will be used to access the multi-path data structure 310 identified by the LPM operation. The pointer enables the system to locate and utilize the correct set of weighted ECMP entries for the packet's destination, ensuring that traffic is distributed according to the weighted policy established for that particular network prefix.

The method 538 concludes at end block 560. In some aspects, the result of method 538 (the multi-path data structure pointer) could be used as input to subsequent packet processing steps (e.g., the selection of a multi-path data structure as detailed in block 540 of FIG. 5C).

By implementing method 538 using the components described in FIGS. 3A-3C, the network device can efficiently determine the appropriate forwarding path for each packet based on its destination address. The LPM operation may direct packets toward multi-path data structures that implement proportional traffic distribution according to network conditions and administrative policies. This approach ensures that packets destined for different network prefixes can be subject to different weighted distribution schemes, providing fine-grained control over traffic flow throughout the network.

Referring now to FIG. 5E, a flowchart illustrates a method 542 for determining an entry within a selected multi-path data structure based on packet-specific criteria in accordance with aspects of the present disclosure. Method 542 provides a detailed expansion of block 542 from FIG. 5C, illustrating operations performed to select an appropriate entry from a multi-path data structure, which may be needed to implement weighted traffic distribution across port groups.

The method 542 begins at start block 562, which may be initiated when a packet has undergone LPM processing and a specific multi-path data structure has been identified for further processing. At block 564, the network device receives a pointer to a multi-path data structure (ECMP table). Portions of block 564 may be performed by the switching hardware 304 of interconnect device 102, which receives the pointer from a previous processing stage, such as the LPM module described in FIG. 5D. The pointer identifies a specific multi-path data structure 310 within the switching hardware 304 that contains weighted entries for packet forwarding. This multi-path data structure may have been previously configured by the multi-path data structure generator 334 and programmed into the switching hardware 304 based on the multi-path data structure 346 stored in memory 320.

Proceeding to block 566, the network device generates a packet-specific hash value based on packet headers. Portions of block 566 may be executed by hashing circuitry within the switching hardware 304, which applies a hash function to selected fields from the packet header. These fields may include, but are not limited to, source IP address, destination IP address, source port, destination port, and protocol identifier—commonly referred to as a “five-tuple” hash. The hashing function may create a deterministic but pseudo-random value that serves to distribute similar packets across different forwarding paths while ensuring that packets belonging to the same flow (having identical header fields) consistently select the same path, thus maintaining flow integrity.

At block 568, the network device identifies an entry within the multi-path data structure using the hash value. Portions of block 568 may involve the switching hardware 304 using the generated hash value (or a portion of it) as an index or selector to identify a specific entry within the multi-path data structure 310. The multi-path data structure, previously configured according to the desired traffic distribution policy, may contain entries that map to different port groups in proportions that reflect their intended traffic allocation. By using a hash-based selection mechanism, the system ensures that traffic is distributed across entries according to their relative frequency in the table, implementing the weighted distribution policy established by the traffic distribution controller 330.

Continuing to block 570, the network device retrieves an adaptive routing group identifier from the selected entry. Portions of block 570 may be performed by the switching hardware 304, which extracts the port group identifier or adaptive routing group reference associated with the selected multi-path data structure entry. Each entry in the multi-path data structure 310 may correspond to a rule or action that identifies a port group as configured by the port group manager 342. The retrieved identifier may designate which logical grouping of physical ports should be considered for the packet's forwarding.

At block 572, the network device returns the adaptive routing group identifier for use in subsequent processing steps. Portions of block 572 may involve the switching hardware 304 passing the retrieved group identifier to the next stage in the packet processing pipeline, where it may be used to allocate the packet to the specified port group. The identifier enables the system to correctly associate the packet with a logical grouping of ports that has been configured to receive a specific proportion of network traffic, in accordance with the weighted distribution policy.

The method 542 concludes at end block 574. In some aspects, the result of method 542 (the adaptive routing group identifier) could be used as input to subsequent packet processing steps, particularly the allocation of the packet to an adaptive routing group as detailed in block 544 of FIG. 5C.

By implementing method 542 using the components described in FIGS. 3A-3C, the network device can efficiently implement weighted traffic distribution across port groups. The hash-based entry selection process ensures that packets are statistically distributed according to the proportions established in the multi-path data structure, which in turn reflects the weighted distribution policy derived from current network parameters. This approach enables non-binary traffic management that can optimize bandwidth utilization involving partially degraded links or asymmetric network topologies.

Referring now to FIG. 5F, a flowchart illustrates a method 512 for applying adaptive routing logic to select specific output ports within chosen routing groups in accordance with aspects of the present disclosure. Method 512 provides a detailed expansion of block 512 from FIG. 5A, illustrating operations performed to select an appropriate physical egress port from within an assigned adaptive routing group, representing a final routing decision before packet forwarding.

The method 512 begins at start block 576, which may be initiated when a packet has been allocated to a specific adaptive routing group and is awaiting final port selection for forwarding. At block 578, the network device receives a packet and adaptive routing group assignment. Portions of block 578 may be performed by the adaptive routing engine 314 within switching hardware 304 of interconnect device 102, which receives both the packet (or a reference to it) and an indication of which adaptive routing group the packet has been assigned to. The adaptive routing group assignment would have been determined in previous processing stages, particularly through the ECMP table selection and entry determination processes described in FIGS. 5C-5E. The adaptive routing group assignment may identify a logical grouping of physical ports configured by the port group manager 342, from which a specific egress port must now be selected.

Proceeding to block 580, the network device monitors real-time congestion conditions (e.g., queue occupancy, packet drops) for each port in the adaptive routing group. Portions of block 580 may be executed by the queue monitor 308 within switching hardware 304, which continuously tracks the status of queues 306a-306n associated with each physical port 302a-302n. The queue monitor 308 may collect various metrics including current queue depth, buffer utilization, recent packet drop rates, or explicit congestion notification (ECN) markings. These metrics may provide real-time insight into the congestion state of each port within the assigned adaptive routing group, enabling informed port selection decisions that can avoid or mitigate congestion.

At block 582, the network device determines congestion-based rate adjustment parameters. Portions of block 582 may involve the congestion control manager 316 within the switching hardware 304, which evaluates the congestion metrics collected by the queue monitor 308 and determines whether any rate adjustments may be needed. In some cases, the congestion control manager 316 may consult parameters or policies established by the congestion control configuration/policy component 336 or rate-limiting logic 338 within processing circuitry 318. These rate adjustment parameters may influence the subsequent port selection by identifying ports that are experiencing significant congestion and should be temporarily avoided or deprioritized.

Continuing to block 584, the network device selects a specific output port within the adaptive routing group based on adaptive logic (e.g., least congested port, random, round-robin, hash-based). Portions of block 584 may be performed by the adaptive routing engine 314, which may apply selection algorithms or policies to choose the most appropriate egress port from among those available in the assigned adaptive routing group. The adaptive routing engine 314 may consider the congestion-based rate adjustment parameters determined in the previous block, potentially favoring less congested ports. Depending on the configured policy, the selection might employ least-congested-port logic (actively selecting the port with the shortest queue), round-robin distribution (cycling through available ports in sequence), random selection (for simple load balancing), or hash-based approaches (for maintaining flow integrity while distributing traffic).

At block 586, the network device forwards the packet to the selected output port. Portions of block 586 may involve the switching hardware 304 directing the packet from buffer 312 to the queue 306a-306n associated with the selected physical port 302a-302n. The packet is then enqueued for transmission through the selected port, becoming part of the outgoing network traffic from the device. In scenarios where congestion control is active, the congestion control manager 316 may apply additional processing such as ECN marking or controlled dropping according to the determined congestion-based rate adjustment parameters.

The method concludes at end block 588. In some aspects, the method 512 could be executed for each packet that has been assigned to an adaptive routing group. By implementing method 512 using the components described in FIGS. 3A-3C, the network device can make intelligent, congestion-aware port selection decisions within the context of weighted traffic distribution established by earlier processing stages. This adaptive routing approach provides an additional layer of traffic optimization, ensuring efficient bandwidth utilization and minimizing congestion even within port groups that may be receiving different proportions of overall network traffic due to the weighted distribution policy.

FIG. 6 depicts a method 600 for weighted adaptive multi-path routing in a network device in accordance with at least one aspect of the present disclosure, at least some concepts of which have been discussed with reference to FIGS. 1-5F. In one aspect, method 600 can be implemented by the interconnect device 102 of FIG. 1 and FIG. 3A and/or processing circuitry 318 of FIG. 3A-3B.

Method 600 may begin at start block 602 and then flow to block 604 with receiving a network packet. In some aspects, and as described with respect to FIG. 3A, incoming network packets may arrive at one of the ports 302a-302n of the interconnect device 102 and enter the switching hardware 304 for processing. Further, as detailed in FIG. 4A, incoming network traffic 404 may initiate the weighted adaptive routing process.

Method 600 may then proceed to block 606 with allocating the network packet to one port group of a plurality of port groups, according to a network traffic distribution policy that apportions network packets across the plurality of port groups in proportions based on a network parameter. In some aspects, the multi-path data structure, as illustrated in FIGS. 4B-4E (ECMP table 430b, ECMP table 430c, ECMP table 430d, ECMP table 430e), may contain entries that point to different port groups in proportions that reflect a traffic distribution policy. The traffic distribution policy may be determined based on network parameters such as available bandwidth, link failures, and/or congestion levels, which may be received via network protocols such as BGP as described with respect to FIG. 3B and FIG. 5B.

Method 600 may then flow to block 608 with forwarding the network packet through a port of the one port group. In some aspects, an adaptive routing engine 314 may select a specific port from within the assigned port group based on real-time congestion conditions monitored by queue monitor 308. As illustrated in FIGS. 4A-4E, once a packet has been allocated to a specific port group (e.g., 414a or 414n), the adaptive routing engine 422 may select a physical port through which to forward the packet, completing the routing decision process. In scenarios where a port group is intentionally oversubscribed, as described with respect to FIG. 3A and FIG. 4C, the congestion control manager 316 may apply congestion control mechanisms to ensure appropriate traffic management.

Method 600 may then conclude at block 610.

In some aspects of method 600, the network traffic distribution policy comprises a multi-path data structure that maps different entries to different port groups of the plurality of port groups.

In some aspects of method 600, the multi-path data structure comprises an equal cost multi-path (ECMP) table having a plurality of entries, wherein different percentages of the plurality of entries are mapped to different port groups of the plurality of port groups.

In some aspects of method 600, the one or more circuits are further to: perform an LPM operation based on a destination address of the network packet to select the multi-path data structure from a plurality of multi-path data structures.

In some aspects, method 600 further comprises calculating a hash value based on information in the network packet; and selecting an entry from the plurality of entries in the multi-path data structure based on the hash value, wherein the selected entry determines a port group of the plurality of port groups for the network packet.

In some aspects of method 600, each entry in the multi-path data structure is associated with at least one of a rule or an action that identifies a corresponding port group of the plurality of port groups.

In some aspects of method 600, the rule or action indicates which ports of the network device are included in the corresponding port group.

In some aspects of method 600, the rule or action is updated based on network asymmetry information received via a BGP.

In some aspects of method 600, the plurality of port groups includes at least one port group configured to receive an oversubscribed traffic load according to the network parameter.

In some aspects of method 600, the network parameter comprises available capacity information for the plurality of port groups; and the proportions are determined to direct more traffic to another port group than to the at least one port group based on the available capacity information.

In some aspects, method 600 further comprises performing congestion control to limit an amount of traffic directed through at least one port group of the plurality of port groups.

In some aspects of method 600, the congestion control is further to: oversubscribe at least one port in at least one port group of the plurality of port groups to create controlled congestion; and reduce a total traffic throughput by a specific amount corresponding to a reduced capacity condition in a network.

In some aspects, method 600 further comprises: receiving network condition information indicating a change in network capacity; and adjusting the proportions in which network packets are apportioned across the plurality of port groups based on the network condition information.

In some aspects of method 600, the network condition information indicates a reduced capacity of a network path downstream from the network device.

In some aspects of method 600, the network condition information is received via a BGP update message indicating at least one of a link failure or a link degradation.

In some aspects of method 600, forwarding the network packet through the port of the one port group comprises selecting the port from multiple available ports in the one port group using at least one of: adaptive routing, random selection, round-robin selection, or hash-based forwarding.

In some aspects of method 600, the network parameter comprises at least one of: an available bandwidth of network link; a network congestion level; link failure information; a quality of service requirement; or an administrative weight assigned to a network path.

Method 600 provides beneficial technical effects, for example, by addressing the binary limitation of traditional routing approaches by enabling proportional traffic allocation based on actual link capacities. Unlike conventional ECMP implementations that either fully utilize or completely avoid specific links, method 600 allows for non-binary, granular traffic distribution that reflects actual network conditions. In scenarios involving partial link degradation, such as when a link drops from 400 Gbps to 300 Gbps capacity, as illustrated in FIG. 2B, non-binary, granular traffic distribution may allow a network to take advantage of the remaining network capacity even when a link may be degraded.

In some aspects, method 600 may optimize bandwidth utilization in asymmetric or partially degraded network topologies by controlling what proportion of traffic is sent to each available path. The network parameter-based allocation in step 606 helps to ensure that traffic distribution aligns with actual available capacity, avoiding both underutilization of healthy links and congestion on degraded links. This creates a technical solution that maximizes overall network throughput while maintaining predictable performance.

In some aspects, method 600 may not require hardware upgrades to existing network infrastructure since existing LPM, ECMP, and congestion control capabilities in current networking equipment may be utilized.

In view of the above, it should be appreciated that aspects of the present disclosure provide a network device comprising one or more circuits to: receive network packet flows; apportion network packets of the network packet flows across a plurality of port groups in proportions based on a network parameter; and forward the network packets through ports in the plurality of port groups. In some aspects, the one or more circuits are further to adjust the proportions in which the network packets are apportioned across the plurality of port groups in response to a change in the network parameter.

In view of the above, it should be appreciated that aspects of the present disclosure provide a system comprising: a first network device; and a second network device connected to the first network device via a plurality of network links, wherein the first network device comprises one or more circuits to: receive network traffic destined for the second network device; distribute the network traffic across the plurality of network links according to a traffic distribution policy that allocates different proportions of the network traffic to different subsets of the plurality of network links based on capacity information associated with the plurality of network links; and adjust the different proportions in response to a change in the capacity information.

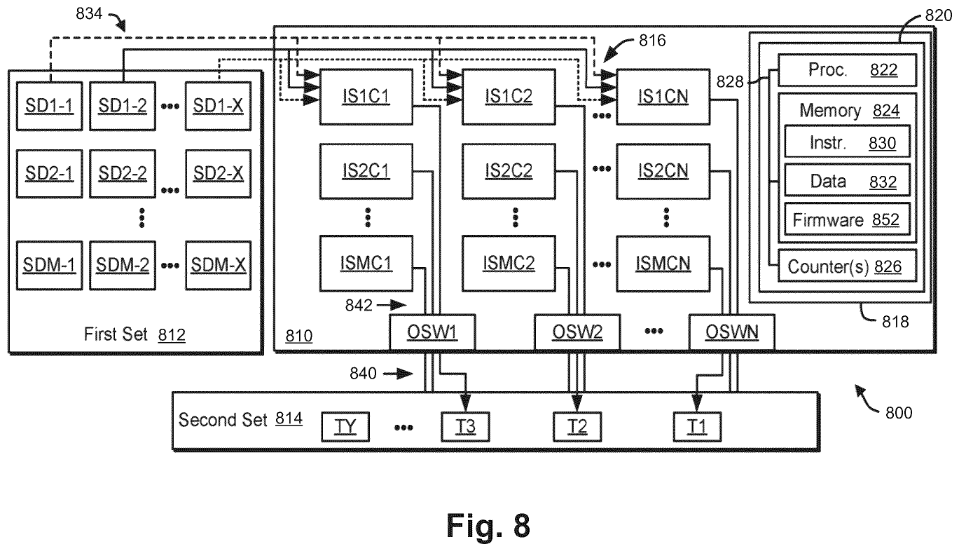

FIG. 7 illustrates a block diagram of a system 700 that includes switching circuitry 710 (sometimes referred to as a “fabric”) positioned between first and second sets 712 and 714 of devices, in accordance with at least one embodiment. By way of a non-limiting example, the system 700 may be implemented as a GPU-to-GPU link system (e.g., a NVLINK® GPU-to-GPU interconnect system) in which the switching circuitry 710 may include one or more GPU-to-GPU switches (e.g., one or more NVSWITCH™ switches). The system 700 may implement (e.g., be a component of) other systems, such as a data center, a cloud computing system, a machine learning system (e.g., utilizing one or more neural networks), an autonomous vehicle, medical imaging equipment, and/or the like.

Each of the first and second sets 712 and 714 may be implemented as a GPU, a parallel processing unit, a central processing unit (“CPU”), data processing unit (“DPU”), a controller, a switch, switching circuitry, a memory device, and/or the like. By way of a non-limiting example, the first set 712 has been illustrated as including a number “M*X” of devices, which are illustrated as devices SD1-1 to SDM-X. However, the set 712 may include any number of devices including a single device. For ease of illustration, in FIG. 7, the devices SD1-1 to SDM-X have been illustrated as being arranged in a two-dimensional array that includes a number “M” of rows and a number “X” of columns. The second set 714 has been illustrated as including a number “Y” of devices, which are illustrated as devices T1-TY, but the second set 714 may include any number of devices including a single device. Further, one or more devices may be members of both of the sets 712 and 714. Thus, the sets 712 and 714 are not mutually exclusive and may include one or more of the same devices. Therefore, in at least one embodiment, the switching circuitry 710 may allow any of the devices SD1-1 to SDM-X in the first set 712 to communicate with any of the devices SD1-1 to SDM-X in the first set 712 and/or any of the devices T1-TY in the second set 714. Further, in at least one embodiment, the switching circuitry 710 may allow any of the devices T1-TY in the second set 714 to communicate with any of the devices T1-TY in the second set 714 and/or any of the devices SD1-1 to SDM-X in the first set 712.

The switching circuitry 710 may include a number “N” of outbound switches OSW1-OSWN, a predetermined number “M*N” of internal switches IS1C1-ISMCN, signal conductors 716, and a route block 718 that controls the operations of the internal switches IS1C1-ISMCN. The route block 718 has been illustrated as including hardware 720 that may include at least one processor 722, memory 724, and one or more counters 726. In at least one embodiment, each of the processor(s) 722 may be implemented as one or more hardware state machines, one or more microprocessors, one or more microcontrollers, one or more controllers, or the like. The memory 724 (e.g., one or more non-transitory processor-readable medium) may be implemented, for example, using volatile memory (e.g., dynamic random-access memory (“DRAM”)) and/or nonvolatile memory (e.g., a hard drive, a solid state device (“SSD”), and/or the like).

The signal conductors 716 interconnect the first set 712, the second set 714, the internal switches IS1C1-ISMCN, and the outbound switches OSW1-OSWN. In the example illustrated, the signal conductors 716 may include any number of signal conductors. The signal conductors 716 may each be implemented as a wire, a trace, and/or any other type of electrical conductor. As a non-limiting example, one or more of the signal conductors 716 may each be implemented as a wire-based serial near-range communications link. By way of another non-limiting example, one or more of the signal conductors 716 may each be implemented as a Scalable Link Interface (“SLI”).

In the embodiment illustrated, the signal conductors 716 include signal conductors 734, 740, and 742. The signal conductors 734 connect the devices SD1-1 to SDM-X to the internal switches IS1C1-ISMCN. For ease of illustration, only those of the signal conductors 734 that connect each of the devices SD1-1 to SD1-X to the internal switches IS1C1-IS1CN have been illustrated in FIG. 7. In at least one embodiment, the internal switches IS1C1-IS1CN may each include a different port that is connected to each of at least a portion of the devices SD1-1 to SDM-X (e.g., the devices SD1-1 to SD1-X, respectively) by the signal conductors 734. Similarly, the internal switches IS2C1-IS2CN may each include a different internal port that is connected to each of at least a portion of the devices SD1-1 to SDM-X (e.g., the devices SD2-1 to SD2-X, respectively) by the signal conductors 734. Further, the internal switches ISMC1-ISMCN may each include a different internal port that is connected to each of at least a portion of the devices SD1-1 to SDM-X (e.g., the devices SDM-1 to SDM-X, respectively) by the signal conductors 734.

The signal conductors 742 connect the internal switches IS1C1-ISMCN to the outbound switches OSW1-OSWN. For example, at least one of the signal conductors 742 connects each of the internal switches IS1C1-ISMC1 to the outbound switch OSW1, at least one of the signal conductors 742 connects each of the internal switches IS1C2-ISMC2 to the outbound switch OSW2, and at least one of the signal conductors 742 connects each of the internal switches IS1CN-ISMCN to the outbound switch OSWN.

The signal conductors 740 connect the outbound switches OSW1-OSWN to the devices T1-TY. The outbound switches OSW1-OSWN may each include a different port that is connected by at least one of signal conductors 740 to at least one of the devices T1-TY.

While the switching circuitry 710 has been illustrated as including the internal switches IS1C1-ISMCN, the switching circuitry 710 may include any number of internal switches including a single internal switch. Further, the internal switches IS1C1-ISMCN have been illustrated as being arranged in a two-dimensional array that includes the number “M” of rows and the number “N” of columns. However, this is not a requirement and the internal switches IS1C1-ISMCN may positioned in alternate arrangements to implement any network topology, including a three-dimensional array. One or more of the internal switches IS1C1-ISMCN may be coupled to one another. For example, from the perspective of one of the internal switches IS1C1-ISMCN, one or more of the other internal switches IS1C1-ISMCN may be one of the devices T1-TY. Further, the switching circuitry 710 may be coupled to one or more switches (e.g., switching circuitry like the switching circuitry 710) that is/are external to the switching circuitry 710. For example, one or more of the devices SD1-1 to SDM-X and/or the devices T1-TY may each be implemented as an external switch.

The route block 718 may be connected to each of the internal switches IS1C1-ISMCN and/or each of at least a portion of the signal conductors 716 by one or more buses. For example, the processor(s) 722 and the memory 724 may be connected to one another by one or more buses 728. The bus(es) 728 may also connect the processor(s) 722 and the memory 724 to the internal switches IS1C1-ISMCN and/or each of at least a portion of the signal conductors 716. The memory 724 (e.g., a non-transitory processor readable media) stores instructions 730 that are executable by the processor(s) 722, data 732, and firmware 752, which may perform monitoring and data manipulation functions. For example, the firmware 752 may instruct the hardware 720 to transition one or more of the signal conductors 716, from the active state to the inactive state and vice versa.

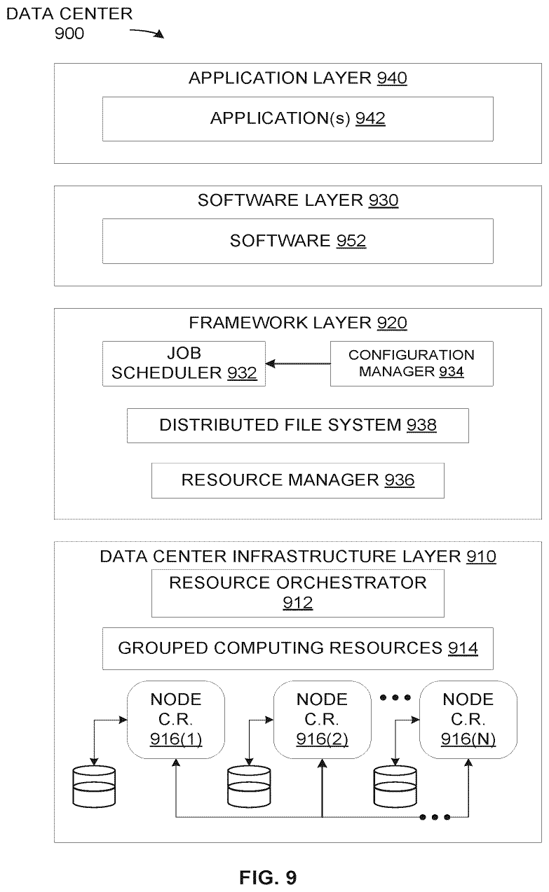

FIG. 8 illustrates a block diagram of an example system 800, in accordance with at least one embodiment. The system 800 may include, in at least one embodiment, one or more CPUs 810 connected to one or more multi-GPU communication systems (e.g., a multi-GPU communication system 802) by one or more signal conductors 812. In the embodiment illustrated in FIG. 8, the CPU(s) 810 include CPUs 810A and 810B, which are connected to the multi-GPU communication system 802 by signal conductors 812A and 812B, respectively. In FIG. 8, the multi-GPU communication system 802 includes GPUs 808 connected to one another by at least one switch 806 and at least one signal conductor 804. In the embodiment illustrated, the switch(es) 806 include switches 806A-806D, the GPUs 808 include GPUs 808A-208P, and the signal conductor(s) 804 include signal conductors 804A-204E.

The system 800 may be characterized as being an example implementation of the system 700 (see FIG. 7). For example, the CPU(s) 810 and/or the GPUs 808 may be implementations of the set 712 and/or the set 714. In at least one embodiment, the CPU(s) 810 may be substantially identical to the devices SD1-1 to SDM-X and/or the devices T1-TY. In at least one embodiment, the GPUs 808 may be substantially identical to the devices SD1-1 to SDM-X and/or the devices T1-TY. By way of another non-limiting example, the signal conductor(s) 804 and/or the signal conductor(s) 812 may be implementations of the signal conductors 716. In at least one embodiment, the signal conductor(s) 804 and/or the signal conductor(s) 812 may be substantially identical to the signal conductors 716. By way of yet another non-limiting example, the switch(es) 806 may be implementations of the internal switches IS1C1-ISMCN and/or the outbound switches OSW1-OSWN. In at least one embodiment, the switch(es) 806 may be substantially identical to the switches IS1C1-ISMCN (see FIG. 7) and/or the outbound switches OSW1-OSWN.

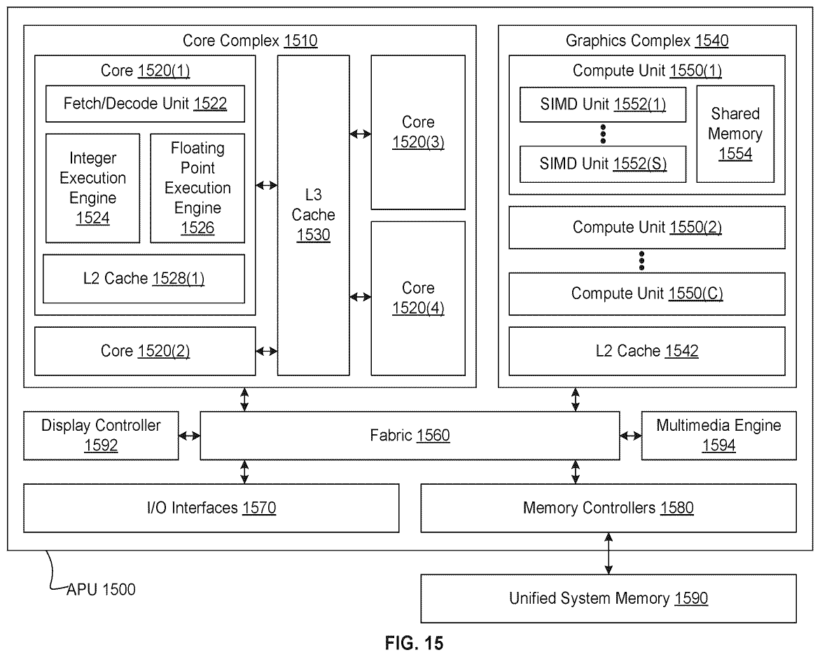

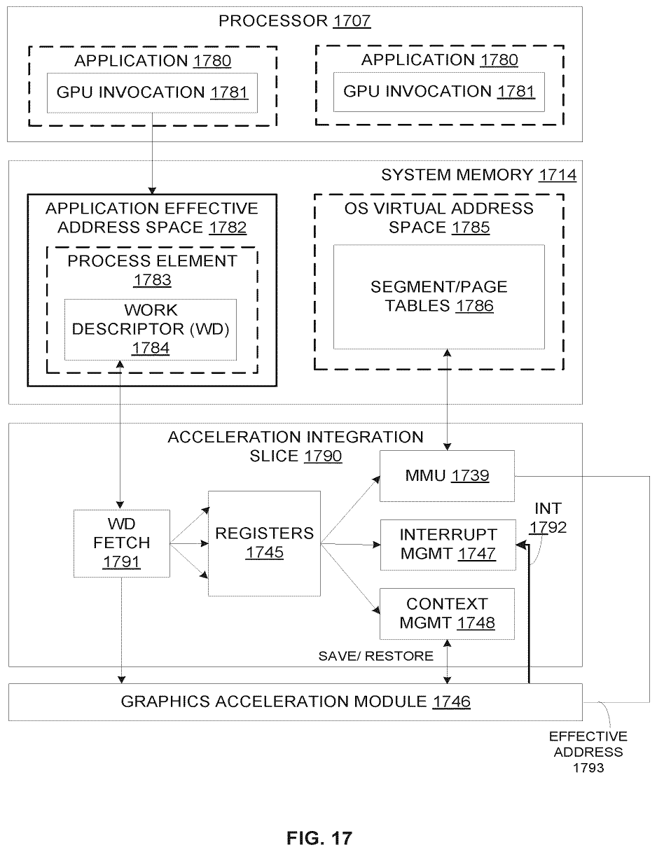

As a non-limiting example, the signal conductors 804 may link the GPUs 808 to the switch(es) 806, and the signal conductors 812A and 812B may link the at least one of the switch(es) 806 to one or more of the CPU(s) 810. As illustrated in FIG. 8, the CPUs 810A and 810B may connected to the switches 806A and 806C, respectively, by the signal conductors 812A and 812B, respectively. In at least one embodiment, one or more of the CPU(s) 810 may be implemented as a CPU 1600 illustrated in FIG. 16. One or more of the GPUs 808 may be implemented as one or more parallel processor(s) 1412 illustrated in FIG. 14.

The multi-GPU communication system 802 may implement a form of mesh networking, which may have a local area network topology in which infrastructure nodes or devices may be connected directly, dynamically, and non-hierarchically to other nodes and may cooperate with one another to efficiently route data. Examples of infrastructure devices may include bridges, the switch(es) 806, and/or other types of infrastructure devices. The multi-GPU communication system 802 may be referred to as a GPU-to-GPU System. By way of a non-limiting example, the multi-GPU communication system 802 may be implemented as a GPU-to-GPU link system (e.g., a NVLINK® GPU-to-GPU interconnect system) in which the switch(es) 806 may include one or more GPU-to-GPU switches (e.g., one or more NVSWITCH™ switches).

The switch 806A is connected to the GPUs 808A-208D by the signal conductors 804A, the switch 806B is connected to the GPUs 808E-808H by the signal conductors 804B, the switch 806C is connected to the GPUs 808I-808L by the signal conductors 804C, and the switch 806D is connected to the GPUs 808M-808P by the signal conductors 804D. The switches 806A-806D are connected to one another by signal conductors 804E. Each of the switch(es) 806 may act as a router and/or a connection between two endpoints within the system 800 for the duration of a dedicated connection. In at least one embodiment, one or more of the switch(es) 806 may be implemented using an on-node switch architecture (e.g., one or more NVSWITCH™ switches) that connects processing units (e.g., one or more GPUs, one or more CPUs, and/or one or more other types of processor) together. The system 800 may function as part of another system, such as a data center, which incorporates hardware, networking, software, and/or libraries, and executes applications, such applications perform inferences, for example by executing Artificial Intelligence (“AI”) or machine learning models.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. The systems and methods described herein may be used in augmented reality, virtual reality, mixed reality, robotics, security and surveillance, autonomous or semi-autonomous machine applications, and/or any other technology spaces in which one or more signal conductors may have at least two different states that consume different amounts of power.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, web-hosted services or web-hosted platforms, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, systems for implementing web-hosted services (e.g., for program optimization at runtime) or web-hosted platforms (e.g., integrated development environments that include program optimization as a service), as an application programming interface (“API”) between two or more separate applications or systems, and/or other types of systems.

### Data Center

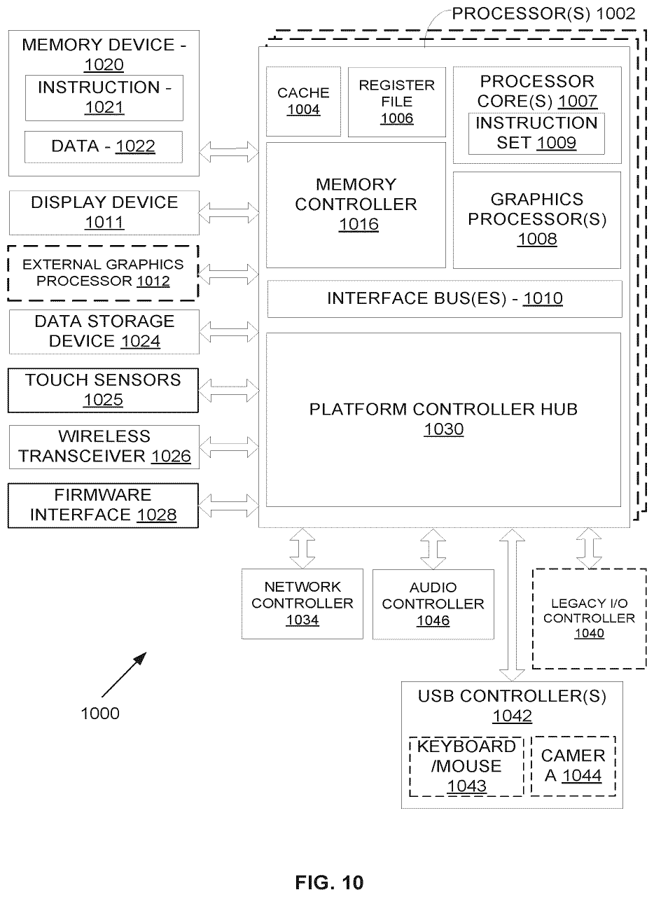

FIG. 9 illustrates an example data center 900, in accordance with at least one embodiment. In at least one embodiment, data center 900 includes, without limitation, a data center infrastructure layer 910, a framework layer 920, a software layer 930 and an application layer 940.

In at least one embodiment, as shown in FIG. 9, data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (“CPUs”) or other processors (including accelerators, field programmable gate arrays (“FPGAs”), data processing units (“DPUs”) in network devices, graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 916(1)-916(N) may be a server having one or more of above-mentioned computing resources.

In at least one embodiment, grouped computing resources 914 may include separate groupings of node C.R. s housed within one or more racks (not shown), or many racks housed in data centers at various geographical locations (also not shown). Separate groupings of node C.R.s within grouped computing resources 914 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 912 may configure or otherwise control one or more node C.R.s 916(1)-916(N) and/or grouped computing resources 914. In at least one embodiment, resource orchestrator 912 may include a software design infrastructure (“SDI”) management entity for data center 900. In at least one embodiment, resource orchestrator 912 may include hardware, software or some combination thereof.

In at least one embodiment, as shown in FIG. 9, framework layer 920 includes, without limitation, a job scheduler 932, a configuration manager 934, a resource manager 936 and a distributed file system 938. In at least one embodiment, framework layer 920 may include a framework to support software 952 of software layer 930 and/or one or more application(s) 942 of application layer 940. In at least one embodiment, software 952 or application(s) 942 may respectively include web-based service software or applications, such as those provided by Amazon Web Services, Google Cloud and Microsoft Azure. In at least one embodiment, framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 932 may include a Spark driver to facilitate scheduling of workloads supported by various layers of data center 900. In at least one embodiment, configuration manager 934 may be capable of configuring different layers such as software layer 930 and framework layer 920, including Spark and distributed file system 938 for supporting large-scale data processing. In at least one embodiment, resource manager 936 may be capable of managing clustered or grouped computing resources mapped to or allocated for support of distributed file system 938 and job scheduler 932. In at least one embodiment, clustered or grouped computing resources may include grouped computing resource 914 at data center infrastructure layer 910. In at least one embodiment, resource manager 936 may coordinate with resource orchestrator 912 to manage these mapped or allocated computing resources.

In at least one embodiment, software 952 included in software layer 930 may include software used by at least portions of node C.R.s 916(1)-916(N), grouped computing resources 914, and/or distributed file system 938 of framework layer 920. One or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. In at least one or more types of applications may include, without limitation, CUDA applications.

In at least one embodiment, any of configuration manager 934, resource manager 936, and resource orchestrator 912 may implement any number and type of self-modifying actions based on any amount and type of data acquired in any technically feasible fashion. In at least one embodiment, self-modifying actions may relieve a data center operator of data center 900 from making possibly bad configuration decisions and possibly avoiding underutilized and/or poor performing portions of a data center.

In at least one embodiment, the data center 900 may be used to implement the system 700 (see FIG. 7) and/or the system 800 (see FIG. 8). For example, the first set 712 and/or the second set 714 may include one or more of the grouped computing resources 914 and/or one or more of the C.R.s 916(1)-916(N). In at least one embodiment, one or more systems depicted in FIG. 9 are utilized to implement one or more systems and/or processes such as those described in connection with FIGS. 1-8.

### Computer-Based Systems

The following figures set forth, without limitation, example computer-based systems that can be used to implement at least one embodiment.

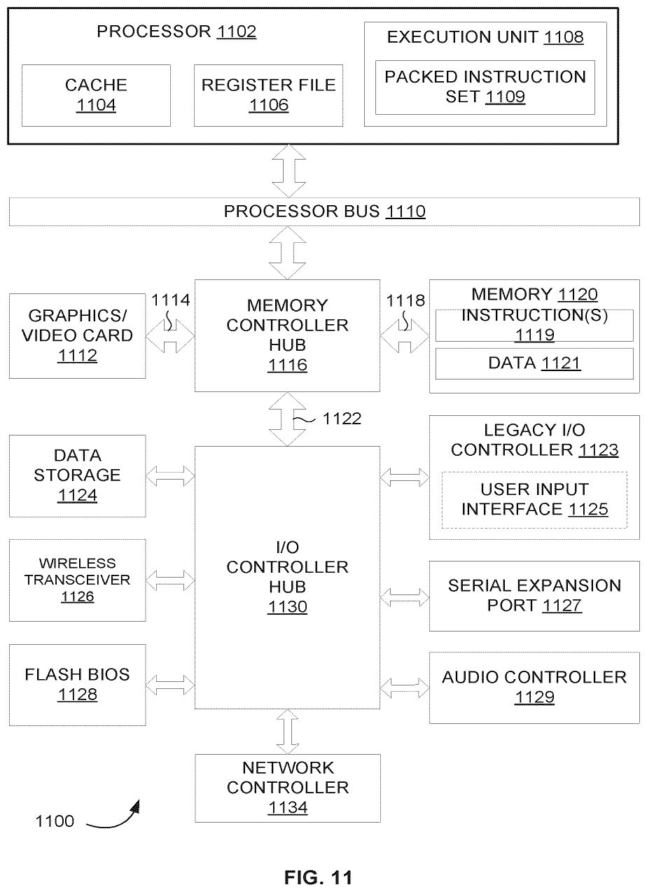

FIG. 10 illustrates a processing system 1000, in accordance with at least one embodiment. In at least one embodiment, processing system 1000 includes one or more processors 1002 and one or more graphics processors 1008, and may be a single processor desktop system, a multiprocessor workstation system, or a server system having a large number of processors 1002 or processor cores 1007. In at least one embodiment, processing system 1000 is a processing platform incorporated within a system-on-a-chip (“Sort”) integrated circuit for use in mobile, handheld, or embedded devices.

In at least one embodiment, processing system 1000 can include, or be incorporated within a server-based gaming platform, a game console, a media console, a mobile gaming console, a handheld game console, or an online game console. In at least one embodiment, processing system 1000 is a mobile phone, smart phone, tablet computing device or mobile Internet device. In at least one embodiment, processing system 1000 can also include, couple with, or be integrated within a wearable device, such as a smart watch wearable device, smart eyewear device, augmented reality device, or virtual reality device. In at least one embodiment, processing system 1000 is a television or set top box device having one or more processors 1002 and a graphical interface generated by one or more graphics processors 1008.

In at least one embodiment, one or more processors 1002 each include one or more processor cores 1007 to process instructions which, when executed, perform operations for system and user software. In at least one embodiment, each of one or more processor cores 1007 is configured to process a specific instruction set 1009. In at least one embodiment, instruction set 1009 may facilitate Complex Instruction Set Computing (“CISC”), Reduced Instruction Set Computing (“RISC”), or computing via a Very Long Instruction Word (“VLIW”). In at least one embodiment, processor cores 1007 may each process a different instruction set 1009, which may include instructions to facilitate emulation of other instruction sets. In at least one embodiment, processor core 1007 may also include other processing devices, such as a digital signal processor (“DSP”).

In at least one embodiment, processor 1002 includes cache memory (‘cache”) 1004. In at least one embodiment, processor 1002 can have a single internal cache or multiple levels of internal cache. In at least one embodiment, cache memory is shared among various components of processor 1002. In at least one embodiment, processor 1002 also uses an external cache (e.g., a Level 3 (“L3”) cache or Last Level Cache (“LLC”)) (not shown), which may be shared among processor cores 1007 using known cache coherency techniques. In at least one embodiment, register file 1006 is additionally included in processor 1002 which may include different types of registers for storing different types of data (e.g., integer registers, floating point registers, status registers, and an instruction pointer register). In at least one embodiment, register file 1006 may include general-purpose registers or other registers.

In at least one embodiment, one or more processor(s) 1002 are coupled with one or more interface bus(es) 1010 to transmit communication signals such as address, data, or control signals between processor 1002 and other components in processing system 1000. In at least one embodiment interface bus 1010, in one embodiment, can be a processor bus, such as a version of a Direct Media Interface (“DMI”) bus. In at least one embodiment, interface bus 1010 is not limited to a DMI bus and may include one or more Peripheral Component Interconnect buses (e.g., “PCI,” PCI Express (“PCIe”)), memory buses, or other types of interface buses. In at least one embodiment processor(s) 1002 include an integrated memory controller 1016 and a platform controller hub 1030. In at least one embodiment, memory controller 1016 facilitates communication between a memory device and other components of processing system 1000, while platform controller hub (“PCH”) 1030 provides connections to Input/Output (“I/O”) devices via a local I/O bus.

In at least one embodiment, memory device 1020 can be a dynamic random-access memory (“DRAM”) device, a static random-access memory (“SRAM”) device, flash memory device, phase-change memory device, or some other memory device having suitable performance to serve as processor memory. In at least one embodiment memory device 1020 can operate as system memory for processing system 1000, to store data 1022 and instructions 1021 for use when one or more processors 1002 executes an application or process. In at least one embodiment, memory controller 1016 also couples with an optional external graphics processor 1012, which may communicate with one or more graphics processors 1008 in processors 1002 to perform graphics and media operations. In at least one embodiment, a display device 1011 can connect to processor(s) 1002. In at least one embodiment display device 1011 can include one or more of an internal display device, as in a mobile electronic device or a laptop device or an external display device attached via a display interface (e.g., DisplayPort, etc.). In at least one embodiment, display device 1011 can include a head mounted display (“HMD”) such as a stereoscopic display device for use in virtual reality (“VR”) applications or augmented reality (“AR”) applications.

In at least one embodiment, platform controller hub 1030 enables peripherals to connect to memory device 1020 and processor 1002 via a high-speed I/O bus. In at least one embodiment, I/O peripherals include, but are not limited to, an audio controller 1046, a network controller 1034, a firmware interface 1028, a wireless transceiver 1026, touch sensors 1025, a data storage device 1024 (e.g., hard disk drive, flash memory, etc.). In at least one embodiment, data storage device 1024 can connect via a storage interface (e.g., SATA) or via a peripheral bus, such as PCI, or PCIe. In at least one embodiment, touch sensors 1025 can include touch screen sensors, pressure sensors, or fingerprint sensors. In at least one embodiment, wireless transceiver 1026 can be a Wi-Fi transceiver, a Bluetooth transceiver, or a mobile network transceiver such as a 3G, 4G, or Long Term Evolution (“LTE”) transceiver. In at least one embodiment, firmware interface 1028 enables communication with system firmware, and can be, for example, a unified extensible firmware interface (“UEFI”). In at least one embodiment, network controller 1034 can enable a network connection to a wired network. In at least one embodiment, a high-performance network controller (not shown) couples with interface bus 1010. In at least one embodiment, audio controller 1046 is a multi-channel high definition audio controller. In at least one embodiment, processing system 1000 includes an optional legacy I/O controller 1040 for coupling legacy (e.g., Personal System 2 (“PS/2”)) devices to processing system 1000. In at least one embodiment, platform controller hub 1030 can also connect to one or more Universal Serial Bus (“USB”) controllers 1042 connect input devices, such as keyboard and mouse 1043 combinations, a camera 1044, or other USB input devices.

In at least one embodiment, an instance of memory controller 1016 and platform controller hub 1030 may be integrated into a discreet external graphics processor, such as external graphics processor 1012. In at least one embodiment, platform controller hub 1030 and/or memory controller 1016 may be external to one or more processor(s) 1002. For example, in at least one embodiment, processing system 1000 can include an external memory controller 1016 and platform controller hub 1030, which may be configured as a memory controller hub and peripheral controller hub within a system chipset that is in communication with processor(s) 1002.

In at least one embodiment, the processing system 1000 may be used to implement the system 700 (see FIG. 7) and/or the system 800 (see FIG. 8). In at least one embodiment, the first set 712 and/or the second set 714 may include one or more of the processor(s) 1002, one or more of the processor core(s) 1007, and/or one or more of the graphics processor(s) 1008. In at least one embodiment, the interface bus 1010 may be used to implement the switching circuitry 710 (see FIG. 7), the bus(es) 728, and/or the signal conductors 734 and 740. In at least one embodiment, one or more systems depicted in FIG. 10 are utilized to implement one or more systems and/or processes such as those described in connection with FIGS. 1-8.

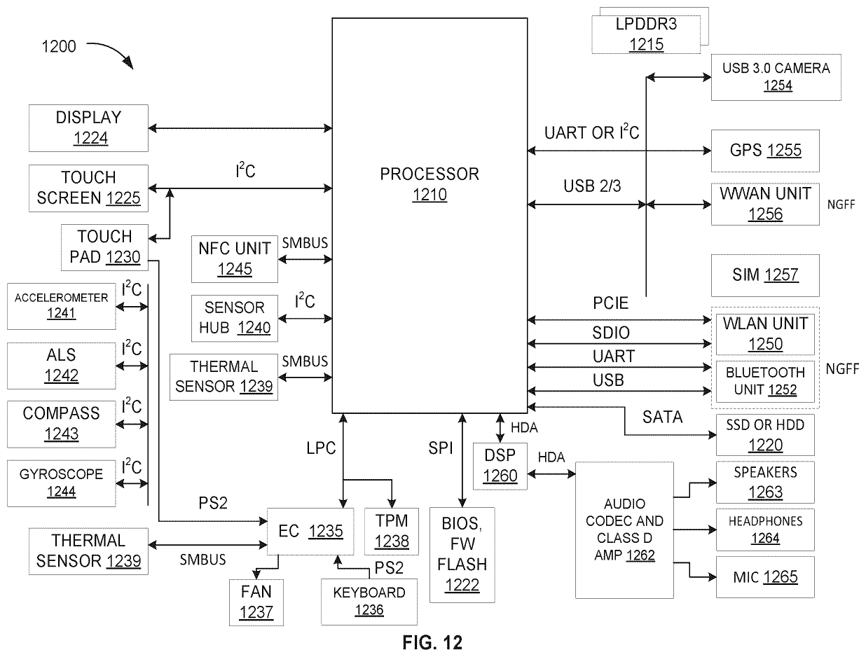

FIG. 11 illustrates a computer system 1100, in accordance with at least one embodiment. In at least one embodiment, computer system 1100 may be a system with interconnected devices and components, an SOC, or some combination. In at least on embodiment, computer system 1100 is formed with a processor 1102 that may include execution units to execute an instruction. In at least one embodiment, computer system 1100 may include, without limitation, a component, such as processor 1102 to employ execution units including logic to perform algorithms for processing data. In at least one embodiment, computer system 1100 may include processors, such as PENTIUM® Processor family, Xeon™, Itanium®, XScale™ and/or StrongArm™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 1100 may execute a version of WINDOWS' operating system available from Microsoft Corporation of Redmond, Wash., although other operating systems (UNIX and Linux for example), embedded software, and/or graphical user interfaces, may also be used.

In at least one embodiment, computer system 1100 may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (DSP), an SoC, network computers (“Net PCs”), set-top boxes, network hubs, wide area network (“WAN”) switches, or any other system that may perform one or more instructions.

In at least one embodiment, computer system 1100 may include, without limitation, processor 1102 that may include, without limitation, one or more execution units 1108 that may be configured to execute a Compute Unified Device Architecture (“CUDA”) (CUDA® is developed by NVIDIA Corporation of Santa Clara, CA) program. In at least one embodiment, a CUDA program is at least a portion of a software application written in a CUDA programming language. In at least one embodiment, computer system 1100 is a single processor desktop or server system. In at least one embodiment, computer system 1100 may be a multiprocessor system. In at least one embodiment, processor 1102 may include, without limitation, a CISC microprocessor, a RISC microprocessor, a VLIW microprocessor, a processor implementing a combination of instruction sets, or any other processor device, such as a digital signal processor, for example. In at least one embodiment, processor 1102 may be coupled to a processor bus 1110 that may transmit data signals between processor 1102 and other components in computer system 1100.

In at least one embodiment, processor 1102 may include, without limitation, a Level 1 (“L1”) internal cache memory (“cache”) 1104. In at least one embodiment, processor 1102 may have a single internal cache or multiple levels of internal cache. In at least one embodiment, cache memory may reside external to processor 1102. In at least one embodiment, processor 1102 may also include a combination of both internal and external caches. In at least one embodiment, a register file 1106 may store different types of data in various registers including, without limitation, integer registers, floating point registers, status registers, and instruction pointer register.

In at least one embodiment, execution unit 1108, including, without limitation, logic to perform integer and floating point operations, also resides in processor 1102. Processor 1102 may also include a microcode (“ucode”) read only memory (“ROM”) that stores microcode for certain macro instructions. In at least one embodiment, execution unit 1108 may include logic to handle a packed instruction set 1109. In at least one embodiment, by including packed instruction set 1109 in an instruction set of a general-purpose processor 1102, along with associated circuitry to execute instructions, operations used by many multimedia applications may be performed using packed data in a general-purpose processor 1102. In at least one embodiment, many multimedia applications may be accelerated and executed more efficiently by using full width of a processor's data bus for performing operations on packed data, which may eliminate a need to transfer smaller units of data across a processor's data bus to perform one or more operations one data element at a time.

In at least one embodiment, execution unit 1108 may also be used in microcontrollers, embedded processors, graphics devices, DSPs, and other types of logic circuits. In at least one embodiment, computer system 1100 may include, without limitation, a memory 1120. In at least one embodiment, memory 1120 may be implemented as a DRAM device, an SRAM device, flash memory device, or other memory device. Memory 1120 may store instruction(s) 1119 and/or data 1121 represented by data signals that may be executed by processor 1102.

In at least one embodiment, a system logic chip may be coupled to processor bus 1110 and memory 1120. In at least one embodiment, the system logic chip may include, without limitation, a memory controller hub (“MCH”) 1116, and processor 1102 may communicate with MCH 1116 via processor bus 1110. In at least one embodiment, MCH 1116 may provide a high bandwidth memory path 1118 to memory 1120 for instruction and data storage and for storage of graphics commands, data and textures. In at least one embodiment, MCH 1116 may direct data signals between processor 1102, memory 1120, and other components in computer system 1100 and to bridge data signals between processor bus 1110, memory 1120, and a system I/O 1122. In at least one embodiment, system logic chip may provide a graphics port for coupling to a graphics controller. In at least one embodiment, MCH 1116 may be coupled to memory 1120 through high bandwidth memory path 1118 and graphics/video card 1112 may be coupled to MCH 1116 through an Accelerated Graphics Port (“AGP”) interconnect 1114.

In at least one embodiment, computer system 1100 may use system I/O 1122 that is a proprietary hub interface bus to couple MCH 1116 to I/O controller hub (“ICH”) 1130. In at least one embodiment, ICH 1130 may provide direct connections to some I/O devices via a local I/O bus. In at least one embodiment, local I/O bus may include, without limitation, a high-speed I/O bus for connecting peripherals to memory 1120, a chipset, and processor 1102. Examples may include, without limitation, an audio controller 1129, a firmware hub (“flash BIOS”) 1128, a wireless transceiver 1126, a data storage 1124, a legacy I/O controller 1123 containing a user input interface 1125 and a keyboard interface, a serial expansion port 1127, such as a USB, and a network controller 1134. Data storage 1124 may comprise a hard disk drive, a floppy disk drive, a CD-ROM device, a flash memory device, or other mass storage device.

In at least one embodiment, FIG. 11 illustrates a system, which includes interconnected hardware devices or “chips.” In at least one embodiment, FIG. 11 may illustrate an example SoC. In at least one embodiment, devices illustrated in FIG. 11 may be interconnected with proprietary interconnects, standardized interconnects (e.g., PCIe), or some combination thereof. In at least one embodiment, one or more components of system 1100 are interconnected using compute express link (“CXL”) interconnects.

In at least one embodiment, the computer system 1100 may be used to implement the system 700 (see FIG. 7) and/or the system 800 (see FIG. 8). In at least one embodiment, the first set 712 and/or the second set 714 may include the processor 1102 and/or the graphics/video card 1112. In at least one embodiment, the processor bus 1110 may be used to implement the switching circuitry 710 (see FIG. 7), the bus(es) 728, and/or the signal conductors 734 and 740. In at least one embodiment, one or more systems depicted in FIG. 11 are utilized to implement one or more systems and/or processes such as those described in connection with FIGS. 1-8.

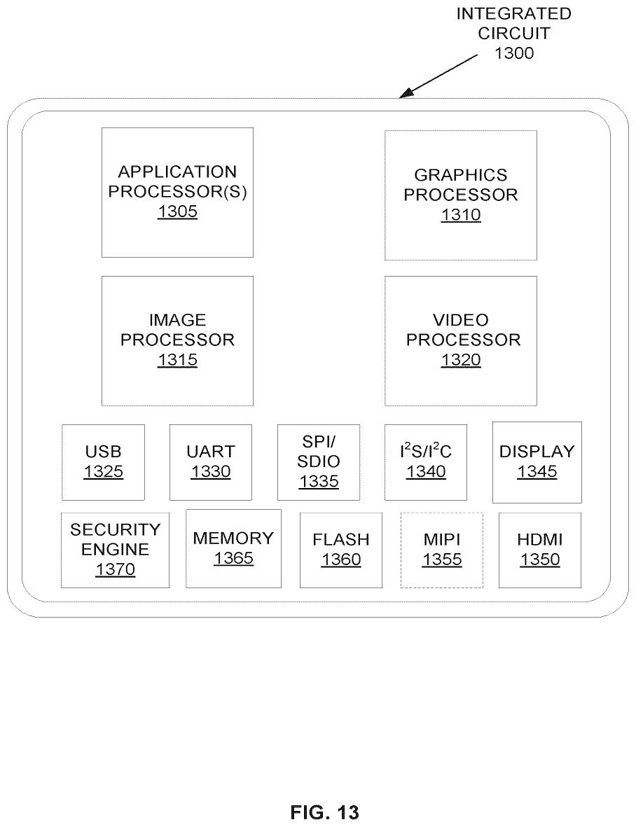

FIG. 12 illustrates a system 1200, in accordance with at least one embodiment. In at least one embodiment, system 1200 is an electronic device that utilizes a processor 1210. In at least one embodiment, system 1200 may be, for example and without limitation, a notebook, a tower server, a rack server, a blade server, an edge device communicatively coupled to one or more on-premise or cloud service providers, a laptop, a desktop, a tablet, a mobile device, a phone, an embedded computer, or any other suitable electronic device.

In at least one embodiment, system 1200 may include, without limitation, processor 1210 communicatively coupled to any suitable number or kind of components, peripherals, modules, or devices. In at least one embodiment, processor 1210 is coupled using a bus or interface, such as an I2C bus, a System Management Bus (“SMBus”), a Low Pin Count (“LPC”) bus, a Serial Peripheral Interface (“SPI”), a High Definition Audio (“HDA”) bus, a Serial Advance Technology Attachment (“SATA”) bus, a USB (versions 1, 2, 3) , or a Universal Asynchronous Receiver/Transmitter (“UART”) bus. In at least one embodiment, FIG. 12 illustrates a system which includes interconnected hardware devices or “chips.” In at least one embodiment, FIG. 12 may illustrate an example SoC. In at least one embodiment, devices illustrated in FIG. 12 may be interconnected with proprietary interconnects, standardized interconnects (e.g., PCIe) or some combination thereof. In at least one embodiment, one or more components of FIG. 12 are interconnected using CXL interconnects.

In at least one embodiment, FIG. 12 may include a display 1224, a touch screen 1225, a touch pad 1230, a Near Field Communications unit (“NFC”) 1245, a sensor hub 1240, a thermal sensor 1246, an Express Chipset (“EC”) 1235, a Trusted Platform Module (“TPM”) 1238, BIOS/firmware/flash memory (“BIOS, FW Flash”) 1222, a DSP 1260, a Solid State Disk (“SSD”) or Hard Disk Drive (“HDD”) 1220, a wireless local area network unit (“WLAN”) 1250, a Bluetooth unit 1252, a Wireless Wide Area Network unit (“WWAN”) 1256, a Global Positioning System (“GPS”) 1255, a camera (“USB 3.0 camera”) 1254 such as a USB 3.0 camera, or a Low Power Double Data Rate (“LPDDR”) memory unit (“LPDDR3”) 1215 implemented in, for example, LPDDR3 standard. These components may each be implemented in any suitable manner.

In at least one embodiment, other components may be communicatively coupled to processor 1210 through components discussed above. In at least one embodiment, an accelerometer 1241, an Ambient Light Sensor (“ALS”) 1242, a compass 1243, and a gyroscope 1244 may be communicatively coupled to sensor hub 1240. In at least one embodiment, a thermal sensor 1239, a fan 1237, a keyboard 1236, and a touch pad 1230 may be communicatively coupled to EC 1235. In at least one embodiment, a speaker 1263, a headphones 1264, and a microphone (“mic”) 1265 may be communicatively coupled to an audio unit (“audio codec and class d amp”) 1262, which may in turn be communicatively coupled to DSP 1260. In at least one embodiment, audio unit 1262 may include, for example and without limitation, an audio coder/decoder (“codec”) and a class D amplifier. In at least one embodiment, a SIM card (“SIM”) 1257 may be communicatively coupled to WWAN unit 1256. In at least one embodiment, components such as WLAN unit 1250 and Bluetooth unit 1252, as well as WWAN unit 1256 may be implemented in a Next Generation Form Factor (“NGFF”).

In at least one embodiment, the system 1200 may be used to implement the system 700 (see FIG. 7) and/or the system 800 (see FIG. 8). In at least one embodiment, a processor 722 (see FIG. 7) may be implemented using the processor 1210. In at least one embodiment, one or more systems depicted in FIG. 12 are utilized to implement one or more systems and/or processes such as those described in connection with FIGS. 1-8.

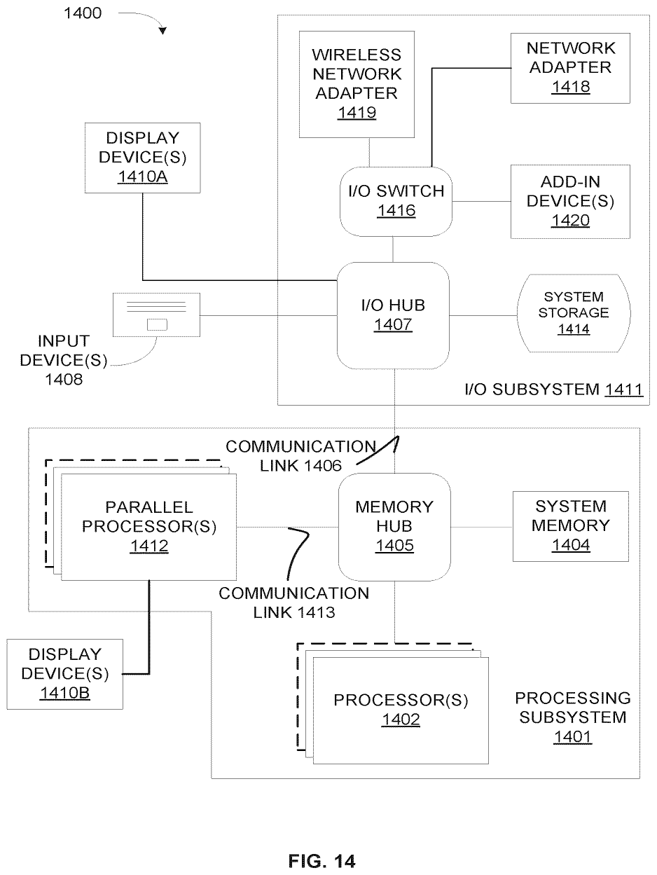

FIG. 13 illustrates an example integrated circuit 1300, in accordance with at least one embodiment. In at least one embodiment, example integrated circuit 1300 is an SoC that may be fabricated using one or more IP cores. In at least one embodiment, integrated circuit 1300 includes one or more application processor(s) 1305 (e.g., CPUs, DPUs), at least one graphics processor 1310, and may additionally include an image processor 1315 and/or a video processor 1320, any of which may be a modular IP core. In at least one embodiment, integrated circuit 1300 includes peripheral or bus logic including a USB controller 1325, a UART controller 1330, an SPI/SDIO controller 1335, and an I2S/I2C controller 1340. In at least one embodiment, integrated circuit 1300 can include a display device 1345 coupled to one or more of a high-definition multimedia interface (“HDMI”) controller 1350 and a mobile industry processor interface (“MIPI”) display interface 1355. In at least one embodiment, storage may be provided by a flash memory subsystem 1360 including flash memory and a flash memory controller. In at least one embodiment, a memory interface may be provided via a memory controller 1365 for access to SDRAM or SRAM memory devices. In at least one embodiment, some integrated circuits additionally include an embedded security engine 1370.

In at least one embodiment, the integrated circuit 1300 may be used to implement the system 700 (see FIG. 7) and/or the system 800 (see FIG. 8). In at least one embodiment, the first set 712 and/or the second set 714 may include one or more of the application processor(s) 1305, one or more of the graphics processor(s) 1310, the image processor 1315, and/or the video processor 1320. Referring to FIG. 7, in at least one embodiment, the peripheral or bus logic of the integrated circuit 1300 (see FIG. 13) may be used to implement the switching circuitry 710 (see FIG. 7), the bus(es) 728, and/or the signal conductors 734 and 740.

FIG. 14 illustrates a computing system 1400, according to at least one embodiment; In at least one embodiment, computing system 1400 includes a processing subsystem 1401 having one or more processor(s) 1402 and a system memory 1404 communicating via an interconnection path that may include a memory hub 1405. In at least one embodiment, memory hub 1405 may be a separate component within a chipset component or may be integrated within one or more processor(s) 1402. In at least one embodiment, memory hub 1405 couples with an I/O subsystem 1411 via a communication link 1406. In at least one embodiment, I/O subsystem 1411 includes an I/O hub 1407 that can enable computing system 1400 to receive input from one or more input device(s) 1408. In at least one embodiment, I/O hub 1407 can enable a display controller, which may be included in one or more processor(s) 1402, to provide outputs to one or more display device(s) 1410A. In at least one embodiment, one or more display device(s) 1410A coupled with I/O hub 1407 can include a local, internal, or embedded display device.

In at least one embodiment, processing subsystem 1401 includes one or more parallel processor(s) 1412 coupled to memory hub 1405 via a bus or other communication link 1413. In at least one embodiment, communication link 1413 may be one of any number of standards based communication link technologies or protocols, such as, but not limited to PCIe, or may be a vendor specific communications interface or communications fabric. In at least one embodiment, one or more parallel processor(s) 1412 form a computationally focused parallel or vector processing system that can include a large number of processing cores and/or processing clusters, such as a many integrated core processor. In at least one embodiment, one or more parallel processor(s) 1412 form a graphics processing subsystem that can output pixels to one of one or more display device(s) 1410A coupled via I/O Hub 1407. In at least one embodiment, one or more parallel processor(s) 1412 can also include a display controller and display interface (not shown) to enable a direct connection to one or more display device(s) 1410B.

In at least one embodiment, a system storage unit 1414 can connect to I/O hub 1407 to provide a storage mechanism for computing system 1400. In at least one embodiment, an I/O switch 1416 can be used to provide an interface mechanism to enable connections between I/O hub 1407 and other components, such as a network adapter 1418 and/or wireless network adapter 1419 that may be integrated into a platform, and various other devices that can be added via one or more add-in device(s) 1420. In at least one embodiment, network adapter 1418 can be an Ethernet adapter or another wired network adapter. In at least one embodiment, wireless network adapter 1419 can include one or more of a Wi-Fi, Bluetooth, NFC, or other network device that includes one or more wireless radios.

In at least one embodiment, computing system 1400 can include other components not explicitly shown, including USB or other port connections, optical storage drives, video capture devices, and the like, that may also be connected to I/O hub 1407. In at least one embodiment, communication paths interconnecting various components in FIG. 14 may be implemented using any suitable protocols, such as PCI based protocols (e.g., PCIe), or other bus or point-to-point communication interfaces and/or protocol(s), such as NVLink™ high-speed interconnect, or interconnect protocols.

In at least one embodiment, one or more parallel processor(s) 1412 incorporate circuitry optimized for graphics and video processing, including, for example, video output circuitry, and constitutes a graphics processing unit (“GPU”). In at least one embodiment, one or more parallel processor(s) 1412 incorporate circuitry optimized for general purpose processing. In at least embodiment, components of computing system 1400 may be integrated with one or more other system elements on a single integrated circuit. For example, in at least one embodiment, one or more parallel processor(s) 1412, memory hub 1405, processor(s) 1402, and I/O hub 1407 can be integrated into an SoC integrated circuit. In at least one embodiment, components of computing system 1400 can be integrated into a single package to form a system in package (“SIP”) configuration. In at least one embodiment, at least a portion of the components of computing system 1400 can be integrated into a multi-chip module (“MCM”), which can be interconnected with other multi-chip modules into a modular computing system. In at least one embodiment, I/O subsystem 1411 and display devices 1410B are omitted from computing system 1400.

In at least one embodiment, the computing system 1400 may be used to implement the system 700 (see FIG. 7) and/or the system 800 (see FIG. 8). In at least one embodiment, the first set 712 and/or the second set 714 may include one or more of the processor(s) 1402 and/or one or more of the one or more parallel processor(s) 1412. In at least one embodiment, the communication link 1413 may be used to implement the switching circuitry 710 (see FIG. 7), the bus(es) 728, and/or the signal conductors 734 and 740.

### Processing Systems

The following figures set forth, without limitation, example processing systems that can be used to implement at least one embodiment.

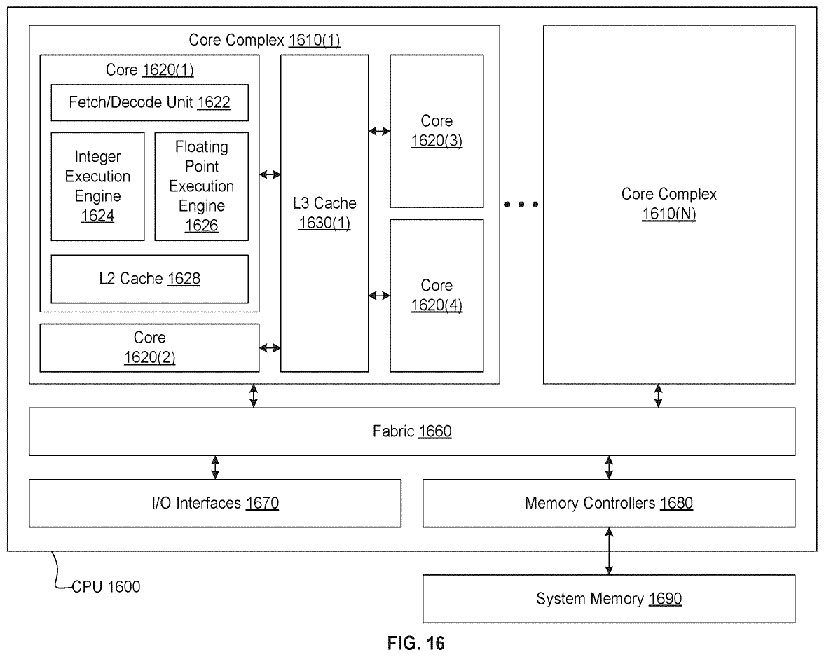

FIG. 15 illustrates an accelerated processing unit (“APU”) 1500, in accordance with at least one embodiment. In at least one embodiment, APU 1500 is developed by AMD Corporation of Santa Clara, CA. In at least one embodiment, APU 1500 can be configured to execute an application program, such as a CUDA program. In at least one embodiment, APU 1500 includes, without limitation, a core complex 1510, a graphics complex 1540, fabric 1560, I/O interfaces 1570, memory controllers 1580, a display controller 1592, and a multimedia engine 1594. In at least one embodiment, APU 1500 may include, without limitation, any number of core complexes 1510, any number of graphics complexes 1540, any number of display controllers 1592, and any number of multimedia engines 1594 in any combination. For explanatory purposes, multiple instances of like objects are denoted herein with reference numbers identifying the object and parenthetical numbers identifying the instance where needed.

In at least one embodiment, core complex 1510 is a CPU, graphics complex 1540 is a GPU, and APU 1500 is a processing unit that integrates, without limitation, 1510 and 1540 onto a single chip. In at least one embodiment, some tasks may be assigned to core complex 1510 and other tasks may be assigned to graphics complex 1540. In at least one embodiment, core complex 1510 is configured to execute main control software associated with APU 1500, such as an operating system. In at least one embodiment, core complex 1510 is the master processor of APU 1500, controlling and coordinating operations of other processors. In at least one embodiment, core complex 1510 issues commands that control the operation of graphics complex 1540. In at least one embodiment, core complex 1510 can be configured to execute host executable code derived from CUDA source code, and graphics complex 1540 can be configured to execute device executable code derived from CUDA source code.

In at least one embodiment, core complex 1510 includes, without limitation, cores 1520(1)-1520(4) and an L3 cache 1530. In at least one embodiment, core complex 1510 may include, without limitation, any number of cores 1520 and any number and type of caches in any combination. In at least one embodiment, cores 1520 are configured to execute instructions of a particular instruction set architecture (“ISA”). In at least one embodiment, each core 1520 is a CPU core.

In at least one embodiment, each core 1520 includes, without limitation, a fetch/decode unit 1522, an integer execution engine 1524, a floating point execution engine 1526, and an L2 cache 1528. In at least one embodiment, fetch/decode unit 1522 fetches instructions, decodes such instructions, generates micro-operations, and dispatches separate micro-instructions to integer execution engine 1524 and floating point execution engine 1526. In at least one embodiment, fetch/decode unit 1522 can concurrently dispatch one micro-instruction to integer execution engine 1524 and another micro-instruction to floating point execution engine 1526. In at least one embodiment, integer execution engine 1524 executes, without limitation, integer and memory operations. In at least one embodiment, floating point execution engine 1526 executes, without limitation, floating point and vector operations. In at least one embodiment, fetch/decode unit 1522 dispatches micro-instructions to a single execution engine that replaces both integer execution engine 1524 and floating point execution engine 1526.

In at least one embodiment, each core 1520(i), where i is an integer representing a particular instance of core 1520, may access L2 cache 1528(i) included in core 1520(i). In at least one embodiment, each core 1520 included in core complex 1510(j), where j is an integer representing a particular instance of core complex 1510, is connected to other cores 1520 included in core complex 1510(j) via L3 cache 1530(j) included in core complex 1510(j). In at least one embodiment, cores 1520 included in core complex 1510(j), where j is an integer representing a particular instance of core complex 1510, can access all of L3 cache 1530(j) included in core complex 1510(j). In at least one embodiment, L3 cache 1530 may include, without limitation, any number of slices.

In at least one embodiment, graphics complex 1540 can be configured to perform compute operations in a highly-parallel fashion. In at least one embodiment, graphics complex 1540 is configured to execute graphics pipeline operations such as draw commands, pixel operations, geometric computations, and other operations associated with rendering an image to a display. In at least one embodiment, graphics complex 1540 is configured to execute operations unrelated to graphics. In at least one embodiment, graphics complex 1540 is configured to execute both operations related to graphics and operations unrelated to graphics.

In at least one embodiment, graphics complex 1540 includes, without limitation, any number of compute units 1550 and an L2 cache 1542. In at least one embodiment, compute units 1550 share L2 cache 1542. In at least one embodiment, L2 cache 1542 is partitioned. In at least one embodiment, graphics complex 1540 includes, without limitation, any number of compute units 1550 and any number (including zero) and type of caches. In at least one embodiment, graphics complex 1540 includes, without limitation, any amount of dedicated graphics hardware.

In at least one embodiment, each compute unit 1550 includes, without limitation, any number of SIMD units 1552 and a shared memory 1554. In at least one embodiment, each SIMD unit 1552 implements a SIMD architecture and is configured to perform operations in parallel. In at least one embodiment, each compute unit 1550 may execute any number of thread blocks, but each thread block executes on a single compute unit 1550. In at least one embodiment, a thread block includes, without limitation, any number of threads of execution. In at least one embodiment, a workgroup is a thread block. In at least one embodiment, each SIMD unit 1552 executes a different warp. In at least one embodiment, a warp is a group of threads (e.g., 16 threads), where each thread in the warp belongs to a single thread block and is configured to process a different set of data based on a single set of instructions. In at least one embodiment, predication can be used to disable one or more threads in a warp. In at least one embodiment, a lane is a thread. In at least one embodiment, a work item is a thread. In at least one embodiment, a wavefront is a warp. In at least one embodiment, different wavefronts in a thread block may synchronize together and communicate via shared memory 1554.

In at least one embodiment, fabric 1560 is a system interconnect that facilitates data and control transmissions across core complex 1510, graphics complex 1540, I/O interfaces 1570, memory controllers 1580, display controller 1592, and multimedia engine 1594. In at least one embodiment, APU 1500 may include, without limitation, any amount and type of system interconnect in addition to or instead of fabric 1560 that facilitates data and control transmissions across any number and type of directly or indirectly linked components that may be internal or external to APU 1500. In at least one embodiment, I/O interfaces 1570 are representative of any number and type of I/O interfaces (e.g., PCI, PCI-Extended (“PCI-X”), PCIe, gigabit Ethernet (“GBE”), USB, etc.). In at least one embodiment, various types of peripheral devices are coupled to I/O interfaces 1570 In at least one embodiment, peripheral devices that are coupled to I/O interfaces 1570 may include, without limitation, keyboards, mice, printers, scanners, joysticks or other types of game controllers, media recording devices, external storage devices, network interface cards, and so forth.

In at least one embodiment, display controller AMD92 displays images on one or more display device(s), such as a liquid crystal display (“LCD”) device. In at least one embodiment, multimedia engine 1594 includes, without limitation, any amount and type of circuitry that is related to multimedia, such as a video decoder, a video encoder, an image signal processor, etc. In at least one embodiment, memory controllers 1580 facilitate data transfers between APU 1500 and a unified system memory 1590. In at least one embodiment, core complex 1510 and graphics complex 1540 share unified system memory 1590.

In at least one embodiment, APU 1500 implements a memory subsystem that includes, without limitation, any amount and type of memory controllers 1580 and memory devices (e.g., shared memory 1554) that may be dedicated to one component or shared among multiple components. In at least one embodiment, APU 1500 implements a cache subsystem that includes, without limitation, one or more cache memories (e.g., L2 caches 1628, L3 cache 1530, and L2 cache 1542) that may each be private to or shared between any number of components (e.g., cores 1520, core complex 1510, SIMD units 1552, compute units 1550, and graphics complex 1540).

In at least one embodiment, the APU 1500 may be used to implement the system 700 (see FIG. 7) and/or the system 800 (see FIG. 8). In at least one embodiment, the first set 712 and/or the second set 714 may include one or more components of the core complex 1510 and/or one or more components of the graphics complex 1540. In at least one embodiment, the fabric 1560 may be used to implement the switching circuitry 710. In at least one embodiment, one or more systems depicted in FIG. 15 are utilized to implement one or more systems and/or processes such as those described in connection with FIGS. 1-8.

FIG. 16 illustrates a CPU 1600, in accordance with at least one embodiment. In at least one embodiment, CPU 1600 is developed by AMD Corporation of Santa Clara, CA. In at least one embodiment, CPU 1600 can be configured to execute an application program. In at least one embodiment, CPU 1600 is configured to execute main control software, such as an operating system. In at least one embodiment, CPU 1600 issues commands that control the operation of an external GPU (not shown). In at least one embodiment, CPU 1600 can be configured to execute host executable code derived from CUDA source code, and an external GPU can be configured to execute device executable code derived from such CUDA source code. In at least one embodiment, CPU 1600 includes, without limitation, any number of core complexes 1610, fabric 1660, I/O interfaces 1670, and memory controllers 1680.

In at least one embodiment, core complex 1610 includes, without limitation, cores 1620(1)-1620(4) and an L3 cache 1630. In at least one embodiment, core complex 1610 may include, without limitation, any number of cores 1620 and any number and type of caches in any combination. In at least one embodiment, cores 1620 are configured to execute instructions of a particular ISA. In at least one embodiment, each core 1620 is a CPU core.

In at least one embodiment, each core 1620 includes, without limitation, a fetch/decode unit 1622, an integer execution engine 1624, a floating point execution engine 1626, and an L2 cache 1628. In at least one embodiment, fetch/decode unit 1622 fetches instructions, decodes such instructions, generates micro-operations, and dispatches separate micro-instructions to integer execution engine 1624 and floating point execution engine 1626. In at least one embodiment, fetch/decode unit 1622 can concurrently dispatch one micro-instruction to integer execution engine 1624 and another micro-instruction to floating point execution engine 1626. In at least one embodiment, integer execution engine 1624 executes, without limitation, integer and memory operations. In at least one embodiment, floating point engine 1626 executes, without limitation, floating point and vector operations. In at least one embodiment, fetch/decode unit 1622 dispatches micro-instructions to a single execution engine that replaces both integer execution engine 1624 and floating point execution engine 1626.

In at least one embodiment, each core 1620(i), where i is an integer representing a particular instance of core 1620, may access L2 cache 1628(i) included in core 1620(i). In at least one embodiment, each core 1620 included in core complex 1610(j), where j is an integer representing a particular instance of core complex 1610, is connected to other cores 1620 in core complex 1610(j) via L3 cache 1630(j) included in core complex 1610(j). In at least one embodiment, cores 1620 included in core complex 1610(j), where j is an integer representing a particular instance of core complex 1610, can access all of L3 cache 1630(j) included in core complex 1610(j). In at least one embodiment, L3 cache 1630 may include, without limitation, any number of slices.

In at least one embodiment, fabric 1660 is a system interconnect that facilitates data and control transmissions across core complexes 1610(1)-1610(N) (where N is an integer greater than zero), I/O interfaces 1670, and memory controllers 1680. In at least one embodiment, CPU 1600 may include, without limitation, any amount and type of system interconnect in addition to or instead of fabric 1660 that facilitates data and control transmissions across any number and type of directly or indirectly linked components that may be internal or external to CPU 1600. In at least one embodiment, I/O interfaces 1670 are representative of any number and type of I/O interfaces (e.g., PCI, PCI-X, PCIe, GBE, USB, etc.). In at least one embodiment, various types of peripheral devices are coupled to I/O interfaces 1670 In at least one embodiment, peripheral devices that are coupled to I/O interfaces 1670 may include, without limitation, displays, keyboards, mice, printers, scanners, joysticks or other types of game controllers, media recording devices, external storage devices, network interface cards, and so forth.

In at least one embodiment, memory controllers 1680 facilitate data transfers between CPU 1600 and a system memory 1690. In at least one embodiment, core complex 1610 and graphics complex 1640 share system memory 1690. In at least one embodiment, CPU 1600 implements a memory subsystem that includes, without limitation, any amount and type of memory controllers 1680 and memory devices that may be dedicated to one component or shared among multiple components. In at least one embodiment, CPU 1600 implements a cache subsystem that includes, without limitation, one or more cache memories (e.g., L2 caches 1628 and L3 caches 1630) that may each be private to or shared between any number of components (e.g., cores 1620 and core complexes 1610).

In at least one embodiment, the CPU 1600 may be used to implement the system 700 (see FIG. 7) and/or the system 800 (see FIG. 8). In at least one embodiment, the first set 712 and/or the second set 714 may include one or more of the core complexes 1610. In at least one embodiment, the fabric 1660 may be used to implement the switching circuitry 110. In at least one embodiment, one or more systems depicted in FIG. 16 are utilized to implement one or more systems and/or processes such as those described in connection with FIGS. 1-8.

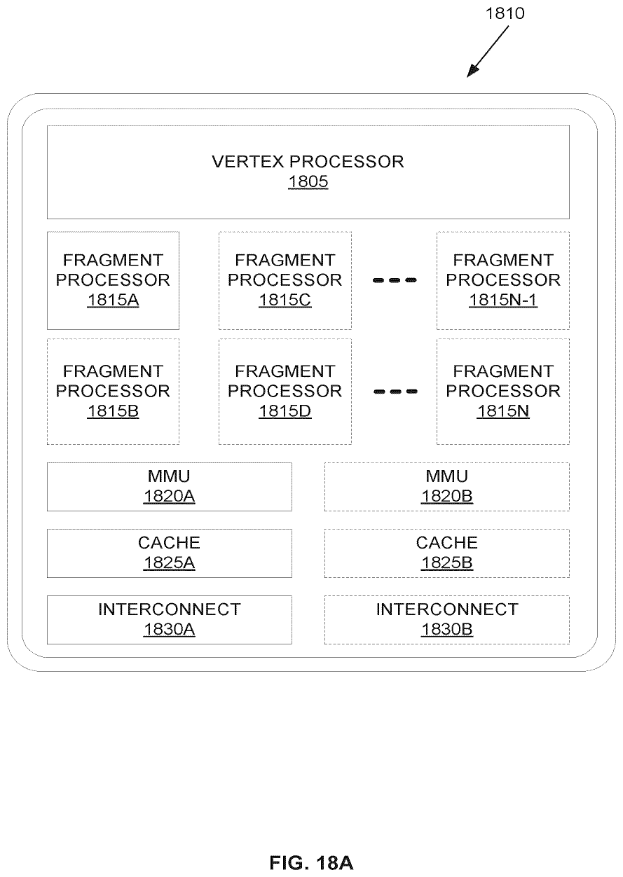

FIG. 17 illustrates an example accelerator integration slice 1790, in accordance with at least one embodiment. As used herein, a “slice” comprises a specified portion of processing resources of an accelerator integration circuit. In at least one embodiment, the accelerator integration circuit provides cache management, memory access, context management, and interrupt management services on behalf of multiple graphics processing engines included in a graphics acceleration module. The graphics processing engines may each comprise a separate GPU. Alternatively, the graphics processing engines may comprise different types of graphics processing engines within a GPU such as graphics execution units, media processing engines (e.g., video encoders/decoders), samplers, and blit engines. In at least one embodiment, the graphics acceleration module may be a GPU with multiple graphics processing engines. In at least one embodiment, the graphics processing engines may be individual GPUs integrated on a common package, line card, or chip.

An application effective address space 1782 within system memory 1714 stores process elements 1783. In one embodiment, process elements 1783 are stored in response to GPU invocations 1781 from applications 1780 executed on processor 1707. A process element 1783 contains process state for corresponding application 1780. A work descriptor (“WD”) 1784 contained in process element 1783 can be a single job requested by an application or may contain a pointer to a queue of jobs. In at least one embodiment, WD 1784 is a pointer to a job request queue in application effective address space 1782.

Graphics acceleration module 1746 and/or individual graphics processing engines can be shared by all or a subset of processes in a system. In at least one embodiment, an infrastructure for setting up process state and sending WD 1784 to graphics acceleration module 1746 to start a job in a virtualized environment may be included.

In at least one embodiment, a dedicated-process programming model is implementation-specific. In this model, a single process owns graphics acceleration module 1746 or an individual graphics processing engine. Because graphics acceleration module 1746 is owned by a single process, a hypervisor initializes an accelerator integration circuit for an owning partition and an operating system initializes accelerator integration circuit for an owning process when graphics acceleration module 1746 is assigned.

In operation, a WD fetch unit 1791 in accelerator integration slice 1790 fetches next WD 1784 which includes an indication of work to be done by one or more graphics processing engines of graphics acceleration module 1746. Data from WD 1784 may be stored in registers 1745 and used by a memory management unit (“MMU”) 1739, interrupt management circuit 1747 and/or context management circuit 1748 as illustrated. For example, one embodiment of MMU 1739 includes segment/page walk circuitry for accessing segment/page tables 1786 within OS virtual address space 1785. Interrupt management circuit 1747 may process interrupt events (“INT”) 1792 received from graphics acceleration module 1746. When performing graphics operations, an effective address 1793 generated by a graphics processing engine is translated to a real address by MMU 1739.

In one embodiment, a same set of registers 1745 are duplicated for each graphics processing engine and/or graphics acceleration module 1746 and may be initialized by a hypervisor or operating system. Each of these duplicated registers may be included in accelerator integration slice 1790. Example registers that may be initialized by a hypervisor are shown in Table 1.

### Table 1

### Hypervisor Initialized Registers

1 Slice Control Register
2 Real Address (RA) Scheduled Processes Area Pointer
3 Authority Mask Override Register
4 Interrupt Vector Table Entry Offset
5 Interrupt Vector Table Entry Limit
6 State Register
7 Logical Partition ID
8 Real address (RA) Hypervisor Accelerator Utilization Record Pointer
9 Storage Description Register

Example registers that may be initialized by an operating system are shown in Table 2.

### Table 2

### Operating System Initialized Registers

1 Process and Thread Identification
2 Effective Address (EA) Context Save/Restore Pointer
3 Virtual Address (VA) Accelerator Utilization Record Pointer
4 Virtual Address (VA) Storage Segment Table Pointer
5 Authority Mask
6 Work descriptor

In one embodiment, each WD 1784 is specific to a particular graphics acceleration module 1746 and/or a particular graphics processing engine. It contains all information required by a graphics processing engine to do work or it can be a pointer to a memory location where an application has set up a command queue of work to be completed.

In at least one embodiment, the accelerator integration slice 1790 may be used to implement the system 700 (see FIG. 7) and/or the system 800 (see FIG. 8). In at least one embodiment, the first set 712 and/or the second set 714 may include the processor 1707, the graphics acceleration module 1746, and/or individual graphics processing engines. In at least one embodiment, one or more systems depicted in FIG. 17 are utilized to implement one or more systems and/or processes such as those described in connection with FIGS. 1-8.

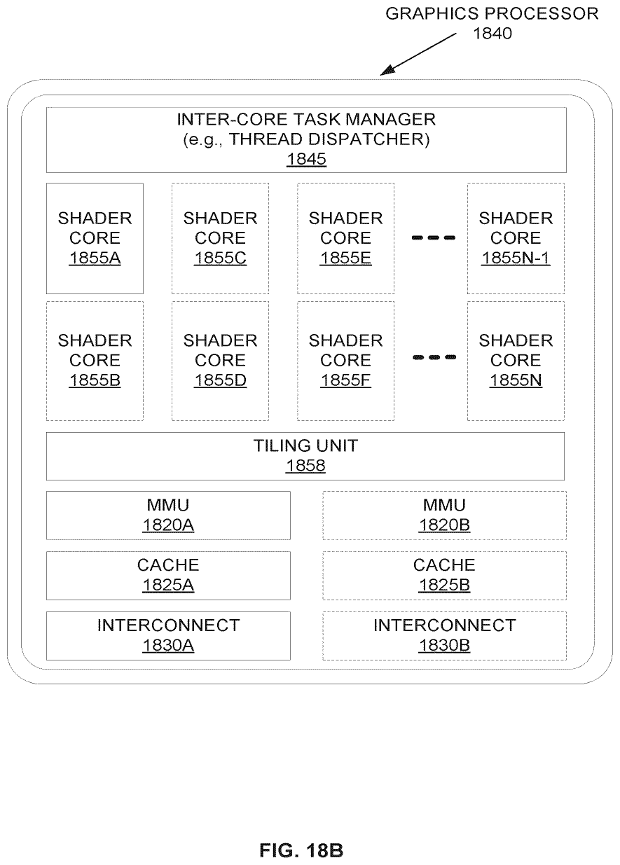

FIGS. 18A-18B illustrate example graphics processors, in accordance with at least one embodiment. In at least one embodiment, any of the example graphics processors may be fabricated using one or more IP cores. In addition to what is illustrated, other logic and circuits may be included in at least one embodiment, including additional graphics processors/cores, peripheral interface controllers, or general-purpose processor cores. In at least one embodiment, the example graphics processors are for use within an SoC.

FIG. 18A illustrates an example graphics processor 1810 of an SoC integrated circuit that may be fabricated using one or more IP cores, in accordance with at least one embodiment. FIG. 18B illustrates an additional example graphics processor 1840 of an SoC integrated circuit that may be fabricated using one or more IP cores, in accordance with at least one embodiment. In at least one embodiment, graphics processor 1810 of FIG. 18A is a low power graphics processor core. In at least one embodiment, graphics processor 1840 of FIG. 18B is a higher performance graphics processor core. In at least one embodiment, each of graphics processors 1810, 1840 can be variants of graphics processor 1310 of FIG. 13.

In at least one embodiment, graphics processor 1810 includes a vertex processor 1805 and one or more fragment processor(s) 1815A-1815N (e.g., 1815A, 1815B, 1815C, 1815D, through 1815N-1, and 1815N). In at least one embodiment, graphics processor 1810 can execute different shader programs via separate logic, such that vertex processor 1805 is optimized to execute operations for vertex shader programs, while one or more fragment processor(s) 1815A-1815N execute fragment (e.g., pixel) shading operations for fragment or pixel shader programs. In at least one embodiment, vertex processor 1805 performs a vertex processing stage of a 3D graphics pipeline and generates primitives and vertex data. In at least one embodiment, fragment processor(s) 1815A-1815N use primitive and vertex data generated by vertex processor 1805 to produce a framebuffer that is displayed on a display device. In at least one embodiment, fragment processor(s) 1815A-1815N are optimized to execute fragment shader programs as provided for in an OpenGL API, which may be used to perform similar operations as a pixel shader program as provided for in a Direct 3D API.

In at least one embodiment, graphics processor 1810 additionally includes one or more MMU(s) 1820A-1820B, cache(s) 1825A-1825B, and circuit interconnect(s) 1830A-1830B. In at least one embodiment, one or more MMU(s) 1820A-1820B provide for virtual to physical address mapping for graphics processor 1810, including for vertex processor 1805 and/or fragment processor(s) 1815A-1815N, which may reference vertex or image/texture data stored in memory, in addition to vertex or image/texture data stored in one or more cache(s) 1825A-1825B. In at least one embodiment, one or more MMU(s) 1820A-1820B may be synchronized with other MMUs within a system, including one or more MMUs associated with one or more application processor(s) 1305, image processors 1315, and/or video processors 1320 of FIG. 13, such that each processor 1305-1320 can participate in a shared or unified virtual memory system. In at least one embodiment, one or more circuit interconnect(s) 1830A-1830B enable graphics processor 1810 to interface with other IP cores within an SoC, either via an internal bus of the SoC or via a direct connection.

In at least one embodiment, graphics processor 1840 includes one or more MMU(s) 1820A-1820B, caches 1825A-1825B, and circuit interconnects 1830A-1830B of graphics processor 1810 of FIG. 18A. In at least one embodiment, graphics processor 1840 includes one or more shader core(s) 1855A-1855N (e.g., 1855A, 1855B, 1855C, 1855D, 1855E, 1855F, through 1855N-1, and 1855N), which provides for a unified shader core architecture in which a single core or type or core can execute all types of programmable shader code, including shader program code to implement vertex shaders, fragment shaders, and/or compute shaders. In at least one embodiment, a number of shader cores can vary. In at least one embodiment, graphics processor 1840 includes an inter-core task manager 1845, which acts as a thread dispatcher to dispatch execution threads to one or more shader cores 1855A-1855N and a tiling unit 1858 to accelerate tiling operations for tile-based rendering, in which rendering operations for a scene are subdivided in image space, for example to exploit local spatial coherence within a scene or to optimize use of internal caches.

In at least one embodiment, the first set 712 (see FIG. 7) and/or the second set 714 (see FIG. 7) may include one or more of the graphics core 1800 and/or one or more of the graphics processor 1840. In at least one embodiment, the first set 712 and/or the second set 714 may include the vertex processor 1805 and/or one or more of the fragment processor(s) 1815A-1815N. In at least one embodiment, the first set 712 and/or the second set 714 may include the inter-core task manager 1845 and/or one or more of the shader core(s) 1855A-1855N. In at least one embodiment, one or more systems depicted in FIGS. 18A-18B are utilized to implement one or more systems and/or processes such as those described in connection with FIGS. 1-8.

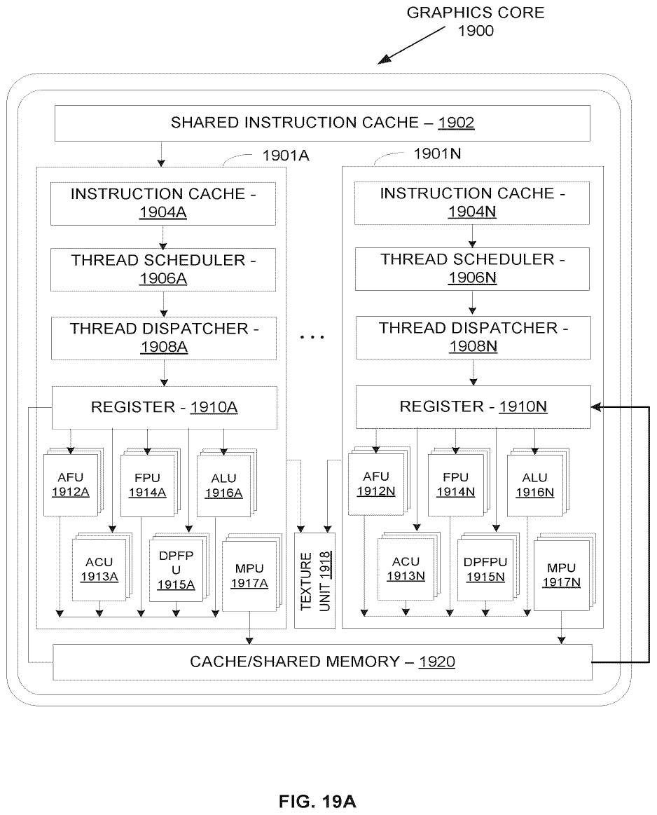

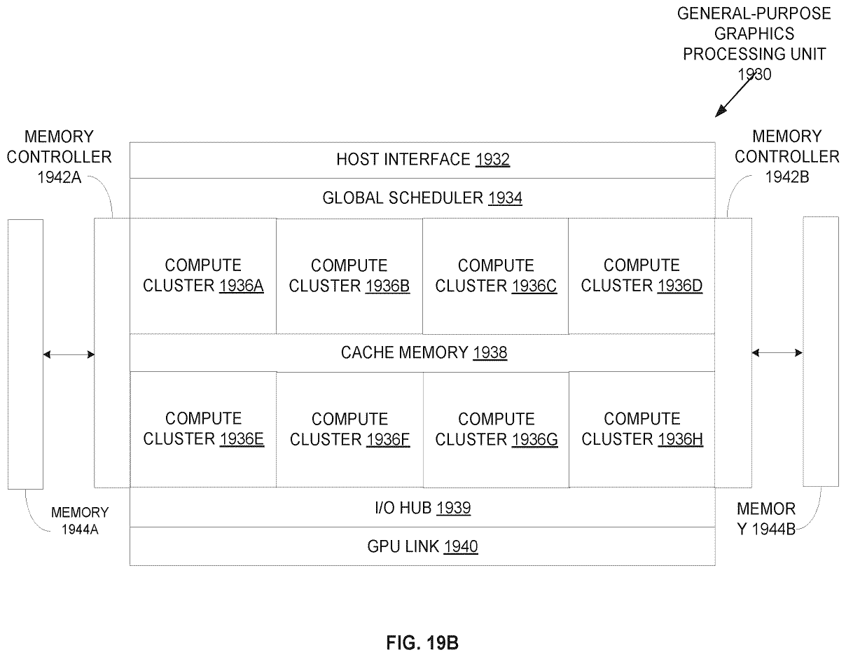

FIG. 19A illustrates a graphics core 1900, in accordance with at least one embodiment. In at least one embodiment, graphics core 1900 may be included within graphics processor 1310 of FIG. 13. In at least one embodiment, graphics core 1900 may be a unified shader core 1855A-1855N as in FIG. 18B. In at least one embodiment, graphics core 1900 includes a shared instruction cache 1902, a texture unit 1918, and a cache/shared memory 1920 that are common to execution resources within graphics core 1900. In at least one embodiment, graphics core 1900 can include multiple slices 1901A-1901N or partition for each core, and a graphics processor can include multiple instances of graphics core 1900. Slices 1901A-1901N can include support logic including a local instruction cache 1904A-1904N, a thread scheduler 1906A-1906N, a thread dispatcher 1908A-1908N, and a set of registers 1910A-1910N. In at least one embodiment, slices 1901A-1901N can include a set of additional function units (“AFUs”) 1912A-1912N, floating-point units (“FPUs”) 1914A-1914N, integer arithmetic logic units (“ALUs”) 1916-1916N, address computational units (“ACUs”) 1913A-1913N, double-precision floating-point units (“DPFPUs”) 1915A-1915N, and matrix processing units (“MPUs”) 1917A-1917N.

In at least one embodiment, FPUs 1914A-1914N can perform single-precision (32-bit) and half-precision (16-bit) floating point operations, while DPFPUs 1915A-1915N perform double precision (64-bit) floating point operations. In at least one embodiment, ALUs 1916A-1916N can perform variable precision integer operations at 8-bit, 16-bit, and 32-bit precision, and can be configured for mixed precision operations. In at least one embodiment, MPUs 1917A-1917N can also be configured for mixed precision matrix operations, including half-precision floating point and 8-bit integer operations. In at least one embodiment, MPUs 1917-1917N can perform a variety of matrix operations to accelerate CUDA programs, including enabling support for accelerated general matrix to matrix multiplication (“GEMM”). In at least one embodiment, AFUs 1912A-1912N can perform additional logic operations not supported by floating-point or integer units, including trigonometric operations (e.g., Sine, Cosine, etc.).

FIG. 19B illustrates a general-purpose graphics processing unit (“GPGPU”) 1930, in accordance with at least one embodiment. In at least one embodiment, GPGPU 1930 is highly-parallel and suitable for deployment on a multi-chip module. In at least one embodiment, GPGPU 1930 can be configured to enable highly-parallel compute operations to be performed by an array of GPUs. In at least one embodiment, GPGPU 1930 can be linked directly to other instances of GPGPU 1930 to create a multi-GPU cluster to improve execution time for CUDA programs. In at least one embodiment, GPGPU 1930 includes a host interface 1932 to enable a connection with a host processor. In at least one embodiment, host interface 1932 is a PCIe interface. In at least one embodiment, host interface 1932 can be a vendor specific communications interface or communications fabric. In at least one embodiment, GPGPU 1930 receives commands from a host processor and uses a global scheduler 1934 to distribute execution threads associated with those commands to a set of compute clusters 1936A-1936H. In at least one embodiment, compute clusters 1936A-1936H share a cache memory 1938. In at least one embodiment, cache memory 1938 can serve as a higher-level cache for cache memories within compute clusters 1936A-1936H.

In at least one embodiment, GPGPU 1930 includes memory 1944A-1944B coupled with compute clusters 1936A-1936H via a set of memory controllers 1942A-1942B. In at least one embodiment, memory 1944A-1944B can include various types of memory devices including DRAM or graphics random access memory, such as synchronous graphics random access memory (“SGRAM”), including graphics double data rate (“GDDR”) memory.

In at least one embodiment, compute clusters 1936A-1936H each include a set of graphics cores, such as graphics core 1900 of FIG. 19A, which can include multiple types of integer and floating point logic units that can perform computational operations at a range of precisions including suited for computations associated with CUDA programs. For example, in at least one embodiment, at least a subset of floating point units in each of compute clusters 1936A-1936H can be configured to perform 16-bit or 32-bit floating point operations, while a different subset of floating point units can be configured to perform 64-bit floating point operations.

In at least one embodiment, multiple instances of GPGPU 1930 can be configured to operate as a compute cluster. Compute clusters 1936A-1936H may implement any technically feasible communication techniques for synchronization and data exchange. In at least one embodiment, multiple instances of GPGPU 1930 communicate over host interface 1932. In at least one embodiment, GPGPU 1930 includes an I/O hub 1939 that couples GPGPU 1930 with a GPU link 1940 that enables a direct connection to other instances of GPGPU 1930. In at least one embodiment, GPU link 1940 is coupled to a dedicated GPU-to-GPU bridge that enables communication and synchronization between multiple instances of GPGPU 1930. In at least one embodiment GPU link 1940 couples with a high speed interconnect to transmit and receive data to other GPGPUs 1930 or parallel processors. In at least one embodiment, multiple instances of GPGPU 1930 are located in separate data processing systems and communicate via a network device that is accessible via host interface 1932. In at least one embodiment GPU link 1940 can be configured to enable a connection to a host processor in addition to or as an alternative to host interface 1932. In at least one embodiment, GPGPU 1930 can be configured to execute a CUDA program.

In at least one embodiment, one or more systems depicted in FIG. 19A-19B are utilized to detect and/or predict signals conducted by a signal conductor (e.g., within a multi-GPU system) and transition the signal conductor between active and inactive states with various algorithms, formulas, and/or processes, such as those described in connection with FIGS. 1-8 and/or otherwise perform operations described herein. In at least one embodiment, one or more of the GPU 808(s) (see FIG. 8) may be implemented using the general-purpose graphics processing unit 1930. In at least one embodiment, one or more systems depicted in FIG. 19A-19B are utilized to implement one or more systems and/or processes such as those described in connection with FIGS. 1-8.

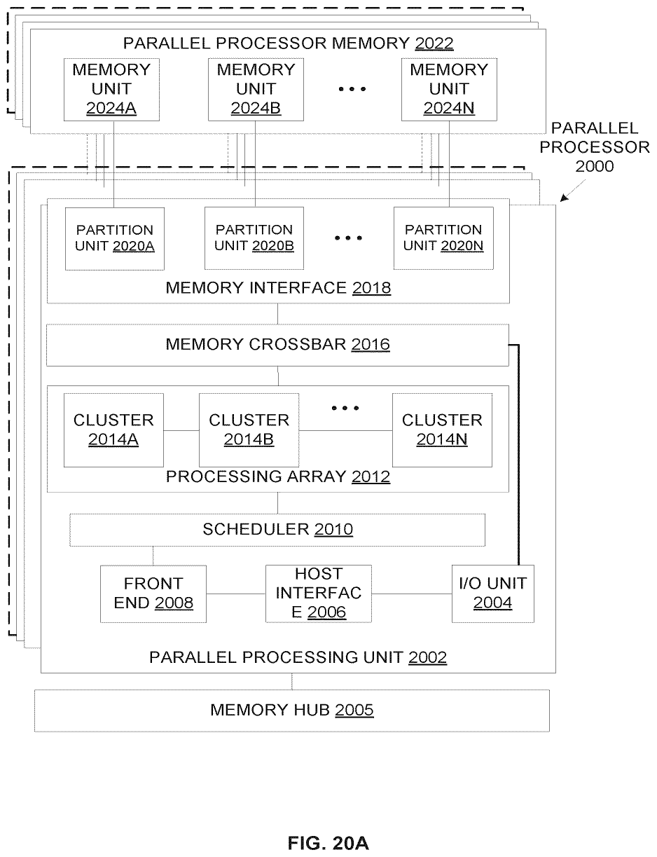

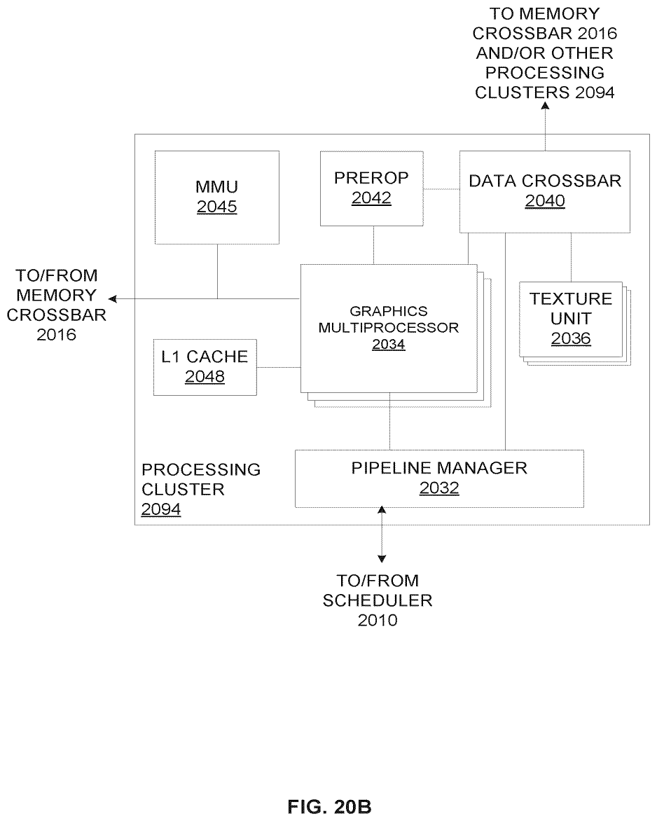

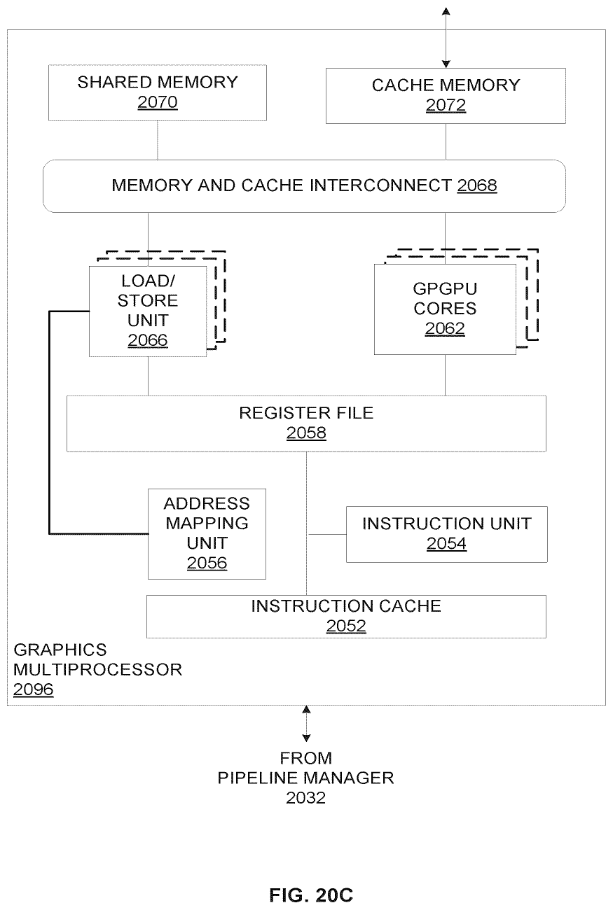

FIG. 20A illustrates a parallel processor 2000, in accordance with at least one embodiment. In at least one embodiment, various components of parallel processor 2000 may be implemented using one or more integrated circuit devices, such as programmable processors, application specific integrated circuits (“ASICs”), or FPGAs.

In at least one embodiment, parallel processor 2000 includes a parallel processing unit 2002. In at least one embodiment, parallel processing unit 2002 includes an I/O unit 2004 that enables communication with other devices, including other instances of parallel processing unit 2002. In at least one embodiment, I/O unit 2004 may be directly connected to other devices. In at least one embodiment, I/O unit 2004 connects with other devices via use of a hub or switch interface, such as memory hub 2005. In at least one embodiment, connections between memory hub 2005 and I/O unit 2004 form a communication link. In at least one embodiment, I/O unit 2004 connects with a host interface 2006 and a memory crossbar 2016, where host interface 2006 receives commands directed to performing processing operations and memory crossbar 2016 receives commands directed to performing memory operations.

In at least one embodiment, when host interface 2006 receives a command buffer via I/O unit 2004, host interface 2006 can direct work operations to perform those commands to a front end 2008. In at least one embodiment, front end 2008 couples with a scheduler 2010, which is configured to distribute commands or other work items to a processing array 2012. In at least one embodiment, scheduler 2010 ensures that processing array 2012 is properly configured and in a valid state before tasks are distributed to processing array 2012. In at least one embodiment, scheduler 2010 is implemented via firmware logic executing on a microcontroller. In at least one embodiment, microcontroller implemented scheduler 2010 is configurable to perform complex scheduling and work distribution operations at coarse and fine granularity, enabling rapid preemption and context switching of threads executing on processing array 2012. In at least one embodiment, host software can prove workloads for scheduling on processing array 2012 via one of multiple graphics processing doorbells. In at least one embodiment, workloads can then be automatically distributed across processing array 2012 by scheduler 2010 logic within a microcontroller including scheduler 2010.

In at least one embodiment, processing array 2012 can include up to “N” clusters (e.g., cluster 2014A, cluster 2014B, through cluster 2014N). In at least one embodiment, each cluster 2014A-2014N of processing array 2012 can execute a large number of concurrent threads. In at least one embodiment, scheduler 2010 can allocate work to clusters 2014A-2014N of processing array 2012 using various scheduling and/or work distribution algorithms, which may vary depending on the workload arising for each type of program or computation. In at least one embodiment, scheduling can be handled dynamically by scheduler 2010 or can be assisted in part by compiler logic during compilation of program logic configured for execution by processing array 2012. In at least one embodiment, different clusters 2014A-2014N of processing array 2012 can be allocated for processing different types of programs or for performing different types of computations.

In at least one embodiment, processing array 2012 can be configured to perform various types of parallel processing operations. In at least one embodiment, processing array 2012 is configured to perform general-purpose parallel compute operations. For example, in at least one embodiment, processing array 2012 can include logic to execute processing tasks including filtering of video and/or audio data, performing modeling operations, including physics operations, and performing data transformations.

In at least one embodiment, processing array 2012 is configured to perform parallel graphics processing operations. In at least one embodiment, processing array 2012 can include additional logic to support execution of such graphics processing operations, including, but not limited to texture sampling logic to perform texture operations, as well as tessellation logic and other vertex processing logic. In at least one embodiment, processing array 2012 can be configured to execute graphics processing related shader programs such as, but not limited to vertex shaders, tessellation shaders, geometry shaders, and pixel shaders. In at least one embodiment, parallel processing unit 2002 can transfer data from system memory via I/O unit 2004 for processing. In at least one embodiment, during processing, transferred data can be stored to on-chip memory (e.g., a parallel processor memory 2022) during processing, then written back to system memory.

In at least one embodiment, when parallel processing unit 2002 is used to perform graphics processing, scheduler 2010 can be configured to divide a processing workload into approximately equal sized tasks, to enable distribution of graphics processing operations to multiple clusters 2014A-2014N of processing array 2012. In at least one embodiment, portions of processing array 2012 can be configured to perform different types of processing. For example, in at least one embodiment, a first portion may be configured to perform vertex shading and topology generation, a second portion may be configured to perform tessellation and geometry shading, and a third portion may be configured to perform pixel shading or other screen space operations, to produce a rendered image for display. In at least one embodiment, intermediate data produced by one or more of clusters 2014A-2014N may be stored in buffers to allow intermediate data to be transmitted between clusters 2014A-2014N for further processing.

In at least one embodiment, processing array 2012 can receive processing tasks to be executed via scheduler 2010, which receives commands defining processing tasks from front end 2008. In at least one embodiment, processing tasks can include indices of data to be processed, e.g., surface (patch) data, primitive data, vertex data, and/or pixel data, as well as state parameters and commands defining how data is to be processed (e.g., what program is to be executed). In at least one embodiment, scheduler 2010 may be configured to fetch indices corresponding to tasks or may receive indices from front end 2008. In at least one embodiment, front end 2008 can be configured to ensure processing array 2012 is configured to a valid state before a workload specified by incoming command buffers (e.g., batch-buffers, push buffers, etc.) is initiated.

In at least one embodiment, each of one or more instances of parallel processing unit 2002 can couple with parallel processor memory 2022. In at least one embodiment, parallel processor memory 2022 can be accessed via memory crossbar 2016, which can receive memory requests from processing array 2012 as well as I/O unit 2004. In at least one embodiment, memory crossbar 2016 can access parallel processor memory 2022 via a memory interface 2018. In at least one embodiment, memory interface 2018 can include multiple partition units (e.g., a partition unit 2020A, partition unit 2020B, through partition unit 2020N) that can each couple to a portion (e.g., memory unit) of parallel processor memory 2022. In at least one embodiment, a number of partition units 2020A-2020N is configured to be equal to a number of memory units, such that a first partition unit 2020A has a corresponding first memory unit 2024A, a second partition unit 2020B has a corresponding memory unit 2024B, and an Nth partition unit 2020N has a corresponding Nth memory unit 2024N. In at least one embodiment, a number of partition units 2020A-2020N may not be equal to a number of memory devices.

In at least one embodiment, memory units 2024A-2024N can include various types of memory devices, including DRAM or graphics random access memory, such as SGRAM, including GDDR memory. In at least one embodiment, memory units 2024A-2024N may also include 3D stacked memory, including but not limited to high bandwidth memory (“HBM”). In at least one embodiment, render targets, such as frame buffers or texture maps may be stored across memory units 2024A-2024N, allowing partition units 2020A-2020N to write portions of each render target in parallel to efficiently use available bandwidth of parallel processor memory 2022. In at least one embodiment, a local instance of parallel processor memory 2022 may be excluded in favor of a unified memory design that utilizes system memory in conjunction with local cache memory.

In at least one embodiment, any one of clusters 2014A-2014N of processing array 2012 can process data that will be written to any of memory units 2024A-2024N within parallel processor memory 2022. In at least one embodiment, memory crossbar 2016 can be configured to transfer an output of each cluster 2014A-2014N to any partition unit 2020A-2020N or to another cluster 2014A-2014N, which can perform additional processing operations on an output. In at least one embodiment, each cluster 2014A-2014N can communicate with memory interface 2018 through memory crossbar 2016 to read from or write to various external memory devices. In at least one embodiment, memory crossbar 2016 has a connection to memory interface 2018 to communicate with I/O unit 2004, as well as a connection to a local instance of parallel processor memory 2022, enabling processing units within different clusters 2014A-2014N to communicate with system memory or other memory that is not local to parallel processing unit 2002. In at least one embodiment, memory crossbar 2016 can use virtual channels to separate traffic streams between clusters 2014A-2014N and partition units 2020A-2020N.

In at least one embodiment, multiple instances of parallel processing unit 2002 can be provided on a single add-in card, or multiple add-in cards can be interconnected. In at least one embodiment, different instances of parallel processing unit 2002 can be configured to interoperate even if different instances have different numbers of processing cores, different amounts of local parallel processor memory, and/or other configuration differences. For example, in at least one embodiment, some instances of parallel processing unit 2002 can include higher precision floating point units relative to other instances. In at least one embodiment, systems incorporating one or more instances of parallel processing unit 2002 or parallel processor 2000 can be implemented in a variety of configurations and form factors, including but not limited to desktop, laptop, or handheld personal computers, servers, workstations, game consoles, and/or embedded systems.

In at least one embodiment, the first set 712 (see FIG. 7) and/or the second set 714 (see FIG. 7) may include one or more of the parallel processor 2000. In at least one embodiment, one or more systems depicted in FIG. 20A are utilized to detect and/or predict signals conducted by a signal conductor (e.g., within a multi-GPU system) and transition the signal conductor between active and inactive states with various algorithms, formulas, and/or processes, such as those described in connection with FIGS. 1-8 and/or otherwise perform operations described herein. In at least one embodiment, one or more systems depicted in FIG. 20A are utilized to implement one or more systems and/or processes such as those described in connection with FIGS. 1-8.

FIG. 20B illustrates a processing cluster 2094, in accordance with at least one embodiment. In at least one embodiment, processing cluster 2094 is included within a parallel processing unit. In at least one embodiment, processing cluster 2094 is one of processing clusters 2014A-2014N of FIG. 20A. In at least one embodiment, processing cluster 2094 can be configured to execute many threads in parallel, where the term “thread” refers to an instance of a particular program executing on a particular set of input data. In at least one embodiment, single instruction, multiple data (“SIMD”) instruction issue techniques are used to support parallel execution of a large number of threads without providing multiple independent instruction units. In at least one embodiment, single instruction, multiple thread (“SIMT”) techniques are used to support parallel execution of a large number of generally synchronized threads, using a common instruction unit configured to issue instructions to a set of processing engines within each processing cluster 2094.

In at least one embodiment, operation of processing cluster 2094 can be controlled via a pipeline manager 2032 that distributes processing tasks to SIMT parallel processors. In at least one embodiment, pipeline manager 2032 receives instructions from scheduler 2010 of FIG. 20A and manages execution of those instructions via a graphics multiprocessor 2034 and/or a texture unit 2036. In at least one embodiment, graphics multiprocessor 2034 is an example instance of a SIMT parallel processor. However, in at least one embodiment, various types of SIMT parallel processors of differing architectures may be included within processing cluster 2094. In at least one embodiment, one or more instances of graphics multiprocessor 2034 can be included within processing cluster 2094. In at least one embodiment, graphics multiprocessor 2034 can process data and a data crossbar 2040 can be used to distribute processed data to one of multiple possible destinations, including other shader units. In at least one embodiment, pipeline manager 2032 can facilitate distribution of processed data by specifying destinations for processed data to be distributed via data crossbar 2040.

In at least one embodiment, each graphics multiprocessor 2034 within processing cluster 2094 can include an identical set of functional execution logic (e.g., arithmetic logic units, load/store units (“LSUs”), etc.). In at least one embodiment, functional execution logic can be configured in a pipelined manner in which new instructions can be issued before previous instructions are complete. In at least one embodiment, functional execution logic supports a variety of operations including integer and floating point arithmetic, comparison operations, Boolean operations, bit-shifting, and computation of various algebraic functions. In at least one embodiment, same functional-unit hardware can be leveraged to perform different operations and any combination of functional units may be present.

In at least one embodiment, instructions transmitted to processing cluster 2094 constitute a thread. In at least one embodiment, a set of threads executing across a set of parallel processing engines is a thread group. In at least one embodiment, a thread group executes a program on different input data. In at least one embodiment, each thread within a thread group can be assigned to a different processing engine within graphics multiprocessor 2034. In at least one embodiment, a thread group may include fewer threads than a number of processing engines within graphics multiprocessor 2034. In at least one embodiment, when a thread group includes fewer threads than a number of processing engines, one or more of the processing engines may be idle during cycles in which that thread group is being processed. In at least one embodiment, a thread group may also include more threads than a number of processing engines within graphics multiprocessor 2034. In at least one embodiment, when a thread group includes more threads than the number of processing engines within graphics multiprocessor 2034, processing can be performed over consecutive clock cycles. In at least one embodiment, multiple thread groups can be executed concurrently on graphics multiprocessor 2034.

In at least one embodiment, graphics multiprocessor 2034 includes an internal cache memory to perform load and store operations. In at least one embodiment, graphics multiprocessor 2034 can forego an internal cache and use a cache memory (e.g., L1 cache 2048) within processing cluster 2094. In at least one embodiment, each graphics multiprocessor 2034 also has access to Level 2 (“L2”) caches within partition units (e.g., partition units 2020A-2020N of FIG. 20A) that are shared among all processing clusters 2094 and may be used to transfer data between threads. In at least one embodiment, graphics multiprocessor 2034 may also access off-chip global memory, which can include one or more of local parallel processor memory and/or system memory. In at least one embodiment, any memory external to parallel processing unit 2002 may be used as global memory. In at least one embodiment, processing cluster 2094 includes multiple instances of graphics multiprocessor 2034 that can share common instructions and data, which may be stored in L1 cache 2048.

In at least one embodiment, each processing cluster 2094 may include an MMU 2045 that is configured to map virtual addresses into physical addresses. In at least one embodiment, one or more instances of MMU 2045 may reside within memory interface 2018 of FIG. 20A. In at least one embodiment, MMU 2045 includes a set of page table entries (“PTEs”) used to map a virtual address to a physical address of a tile and optionally a cache line index. In at least one embodiment, MMU 2045 may include address translation lookaside buffers (“TLBs”) or caches that may reside within graphics multiprocessor 2034 or L1 cache 2048 or processing cluster 2094. In at least one embodiment, a physical address is processed to distribute surface data access locality to allow efficient request interleaving among partition units. In at least one embodiment, a cache line index may be used to determine whether a request for a cache line is a hit or miss.

In at least one embodiment, processing cluster 2094 may be configured such that each graphics multiprocessor 2034 is coupled to a texture unit 2036 for performing texture mapping operations, e.g., determining texture sample positions, reading texture data, and filtering texture data. In at least one embodiment, texture data is read from an internal texture L1 cache (not shown) or from an L1 cache within graphics multiprocessor 2034 and is fetched from an L2 cache, local parallel processor memory, or system memory, as needed. In at least one embodiment, each graphics multiprocessor 2034 outputs a processed task to data crossbar 2040 to provide the processed task to another processing cluster 2094 for further processing or to store the processed task in an L2 cache, a local parallel processor memory, or a system memory via memory crossbar 2016. In at least one embodiment, a pre-raster operations unit (“preROP”) 2042 is configured to receive data from graphics multiprocessor 2034, direct data to ROP units, which may be located with partition units as described herein (e.g., partition units 2020A-2020N of FIG. 20A). In at least one embodiment, PreROP 2042 can perform optimizations for color blending, organize pixel color data, and perform address translations.

FIG. 20C illustrates a graphics multiprocessor 2096, in accordance with at least one embodiment. In at least one embodiment, graphics multiprocessor 2096 is graphics multiprocessor 2034 of FIG. 20B. In at least one embodiment, graphics multiprocessor 2096 couples with pipeline manager 2032 of processing cluster 2094. In at least one embodiment, graphics multiprocessor 2096 has an execution pipeline including but not limited to an instruction cache 2052, an instruction unit 2054, an address mapping unit 2056, a register file 2058, one or more GPGPU cores 2062, and one or more LSUs 2066. GPGPU cores 2062 and LSUs 2066 are coupled with cache memory 2072 and shared memory 2070 via a memory and cache interconnect 2068.

In at least one embodiment, instruction cache 2052 receives a stream of instructions to execute from pipeline manager 2032. In at least one embodiment, instructions are cached in instruction cache 2052 and dispatched for execution by instruction unit 2054. In at least one embodiment, instruction unit 2054 can dispatch instructions as thread groups (e.g., warps), with each thread of a thread group assigned to a different execution unit within GPGPU core 2062. In at least one embodiment, an instruction can access any of a local, shared, or global address space by specifying an address within a unified address space. In at least one embodiment, address mapping unit 2056 can be used to translate addresses in a unified address space into a distinct memory address that can be accessed by LSUs 2066.

In at least one embodiment, register file 2058 provides a set of registers for functional units of graphics multiprocessor 2096. In at least one embodiment, register file 2058 provides temporary storage for operands connected to data paths of functional units (e.g., GPGPU cores 2062, LSUs 2066) of graphics multiprocessor 2096. In at least one embodiment, register file 2058 is divided between each of functional units such that each functional unit is allocated a dedicated portion of register file 2058. In at least one embodiment, register file 2058 is divided between different thread groups being executed by graphics multiprocessor 2096.

In at least one embodiment, GPGPU cores 2062 can each include FPUs and/or integer ALUs that are used to execute instructions of graphics multiprocessor 2096. GPGPU cores 2062 can be similar in architecture or can differ in architecture. In at least one embodiment, a first portion of GPGPU cores 2062 include a single precision FPU and an integer ALU while a second portion of GPGPU cores 2062 include a double precision FPU. In at least one embodiment, FPUs can implement IEEE 754-2008 standard for floating point arithmetic or enable variable precision floating point arithmetic. In at least one embodiment, graphics multiprocessor 2096 can additionally include one or more fixed function or special function units to perform specific functions such as copy rectangle or pixel blending operations. In at least one embodiment one or more of GPGPU cores 2062 can also include fixed or special function logic.

In at least one embodiment, GPGPU cores 2062 include SIMD logic capable of performing a single instruction on multiple sets of data. In at least one embodiment GPGPU cores 2062 can physically execute SIMD4, SIMD8, and SIMD16 instructions and logically execute SIMD1, SIMD2, and SIMD32 instructions. In at least one embodiment, SIMD instructions for GPGPU cores 2062 can be generated at compile time by a shader compiler or automatically generated when executing programs written and compiled for single program multiple data (“SPMD”) or SIMT architectures. In at least one embodiment, multiple threads of a program configured for an SIMT execution model can executed via a single SIMD instruction. For example, in at least one embodiment, eight SIMT threads that perform the same or similar operations can be executed in parallel via a single SIMD8 logic unit.

In at least one embodiment, memory and cache interconnect 2068 is an interconnect network that connects each functional unit of graphics multiprocessor 2096 to register file 2058 and to shared memory 2070. In at least one embodiment, memory and cache interconnect 2068 is a crossbar interconnect that allows LSU 2066 to implement load and store operations between shared memory 2070 and register file 2058. In at least one embodiment, register file 2058 can operate at a same frequency as GPGPU cores 2062, thus data transfer between GPGPU cores 2062 and register file 2058 is very low latency. In at least one embodiment, shared memory 2070 can be used to enable communication between threads that execute on functional units within graphics multiprocessor 2096. In at least one embodiment, cache memory 2072 can be used as a data cache for example, to cache texture data communicated between functional units and texture unit 2036. In at least one embodiment, shared memory 2070 can also be used as a program managed cached. In at least one embodiment, threads executing on GPGPU cores 2062 can programmatically store data within shared memory in addition to automatically cached data that is stored within cache memory 2072.

In at least one embodiment, a parallel processor or GPGPU as described herein is communicatively coupled to host/processor cores to accelerate graphics operations, machine-learning operations, pattern analysis operations, and various general purpose GPU (GPGPU) functions. In at least one embodiment, a GPU may be communicatively coupled to host processor/cores over a bus or other interconnect (e.g., a high-speed interconnect such as PCIe or NVLink™). In at least one embodiment, a GPU may be integrated on the same package or chip as cores and communicatively coupled to cores over a processor bus/interconnect that is internal to a package or a chip. In at least one embodiment, regardless of the manner in which a GPU is connected, processor cores may allocate work to the GPU in the form of sequences of commands/instructions contained in a WD. In at least one embodiment, the GPU then uses dedicated circuitry/logic for efficiently processing these commands/instructions.

In at least one embodiment, one or more systems depicted in FIG. 20A-20C are utilized to detect and/or predict signals conducted by a signal conductor (e.g., within a multi-GPU system) and transition the signal conductor between active and inactive states with various algorithms, formulas, and/or processes, such as those described in connection with FIGS. 1-8 and/or otherwise perform operations described herein. In at least one embodiment, one or more systems depicted in FIG. 20A-20C are utilized to implement one or more systems and/or processes such as those described in connection with FIGS. 1-8.

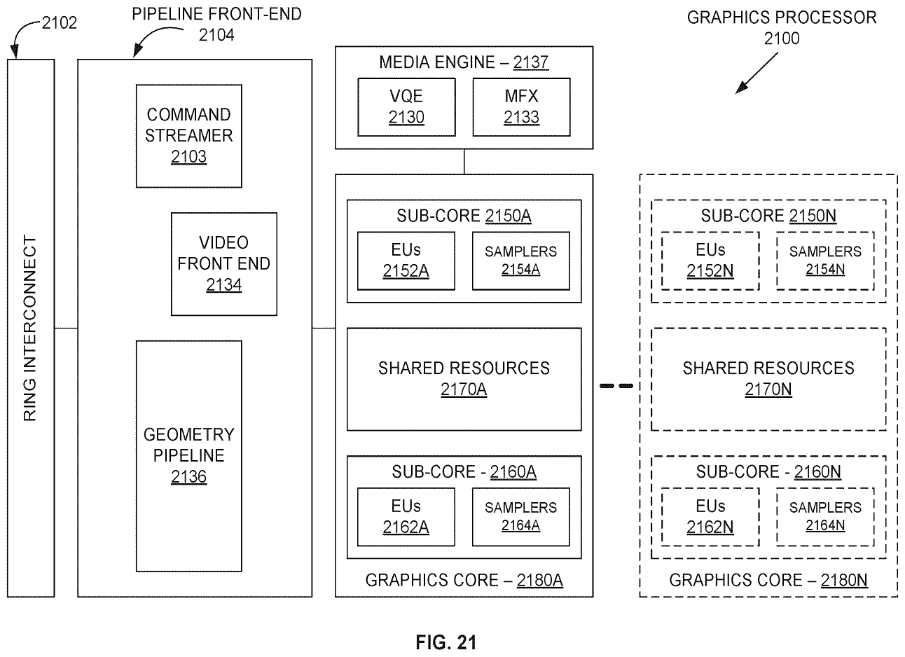

FIG. 21 illustrates a graphics processor 2100, in accordance with at least one embodiment. In at least one embodiment, graphics processor 2100 includes a ring interconnect 2102, a pipeline front-end 2104, a media engine 2137, and graphics cores 2180A-2180N. In at least one embodiment, ring interconnect 2102 couples graphics processor 2100 to other processing units, including other graphics processors or one or more general-purpose processor cores. In at least one embodiment, graphics processor 2100 is one of many processors integrated within a multi-core processing system.

In at least one embodiment, graphics processor 2100 receives batches of commands via ring interconnect 2102. In at least one embodiment, incoming commands are interpreted by a command streamer 2103 in pipeline front-end 2104. In at least one embodiment, graphics processor 2100 includes scalable execution logic to perform 3D geometry processing and media processing via graphics core(s) 2180A-2180N. In at least one embodiment, for 3D geometry processing commands, command streamer 2103 supplies commands to geometry pipeline 2136. In at least one embodiment, for at least some media processing commands, command streamer 2103 supplies commands to a video front end 2134, which couples with a media engine 2137. In at least one embodiment, media engine 2137 includes a Video Quality Engine (“VQE”) 2130 for video and image post-processing and a multi-format encode/decode (“MFX”) engine 2133 to provide hardware-accelerated media data encode and decode. In at least one embodiment, geometry pipeline 2136 and media engine 2137 each generate execution threads for thread execution resources provided by at least one graphics core 2180A.

In at least one embodiment, graphics processor 2100 includes scalable thread execution resources featuring modular graphics cores 2180A-2180N (sometimes referred to as core slices), each having multiple sub-cores 2150A-550N, 2160A-2160N (sometimes referred to as core sub-slices). In at least one embodiment, graphics processor 2100 can have any number of graphics cores 2180A through 2180N. In at least one embodiment, graphics processor 2100 includes a graphics core 2180A having at least a first sub-core 2150A and a second sub-core 2160A. In at least one embodiment, graphics processor 2100 is a low power processor with a single sub-core (e.g., sub-core 2150A). In at least one embodiment, graphics processor 2100 includes multiple graphics cores 2180A-2180N, each including a set of first sub-cores 2150A-2150N and a set of second sub-cores 2160A-2160N. In at least one embodiment, each sub-core in first sub-cores 2150A-2150N includes at least a first set of execution units (“EUs”) 2152A-2152N and media/texture samplers 2154A-2154N. In at least one embodiment, each sub-core in second sub-cores 2160A-2160N includes at least a second set of execution units 2162A-2162N and samplers 2164A-2164N. In at least one embodiment, each sub-core 2150A-2150N, 2160A-2160N shares a set of shared resources 2170A-2170N. In at least one embodiment, shared resources 2170 include shared cache memory and pixel operation logic.

In at least one embodiment, the first set 712 (see FIG. 7) and/or the second set 714 (see FIG. 7) may include one or more of the graphics processor 2100. In at least one embodiment, one or more systems depicted in FIG. 21 are utilized detect and/or predict signals conducted by a signal conductor (e.g., within a multi-GPU system) and transition the signal conductor between active and inactive states with various algorithms, formulas, and/or processes, such as those described in connection with FIGS. 1-8 and/or otherwise perform operations described herein. In at least one embodiment, one or more systems depicted in FIG. 21 are utilized to implement one or more systems and/or processes such as those described in connection with FIGS. 1-8.

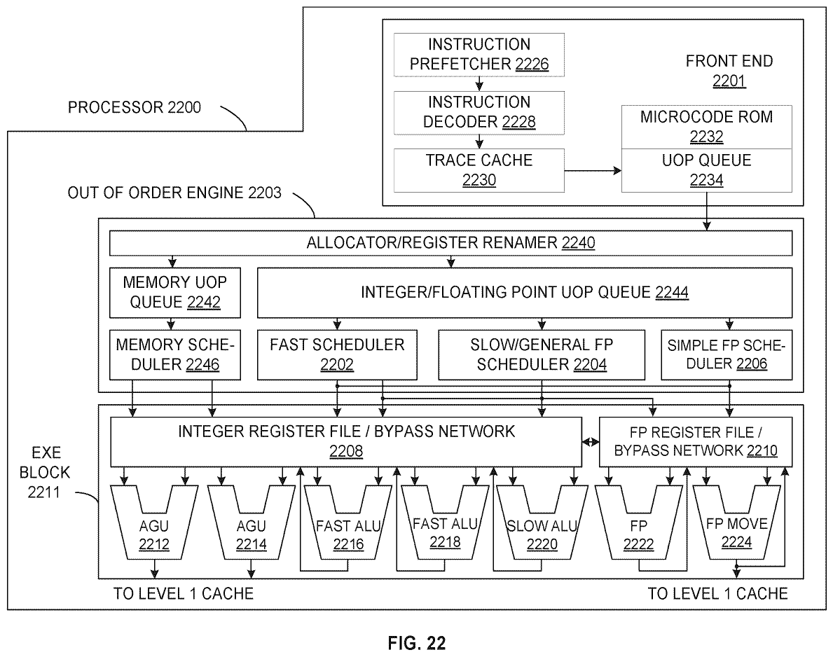

FIG. 22 illustrates a processor 2200, in accordance with at least one embodiment. In at least one embodiment, processor 2200 may include, without limitation, logic circuits to perform instructions. In at least one embodiment, processor 2200 may perform instructions, including x86 instructions, ARM instructions, specialized instructions for ASICs, etc. In at least one embodiment, processor 2200 may include registers to store packed data, such as 64-bit wide MMX™ registers in microprocessors enabled with MMX technology from Intel Corporation of Santa Clara, Calif. In at least one embodiment, MMX registers, available in both integer and floating point forms, may operate with packed data elements that accompany SIMD and streaming SIMD extensions (“SSE”) instructions. In at least one embodiment, 128-bit wide XMM registers relating to SSE2, SSE3, SSE4, AVX, or beyond (referred to generically as “SSEx”) technology may hold such packed data operands. In at least one embodiment, processors 2200 may perform instructions to accelerate CUDA programs.

In at least one embodiment, processor 2200 includes an in-order front end (“front end”) 2201 to fetch instructions to be executed and prepare instructions to be used later in processor pipeline. In at least one embodiment, front end 2201 may include several units. In at least one embodiment, an instruction prefetcher 2226 fetches instructions from memory and feeds instructions to an instruction decoder 2228 which in turn decodes or interprets instructions. For example, in at least one embodiment, instruction decoder 2228 decodes a received instruction into one or more operations called “micro-instructions” or “micro-operations” (also called “micro ops” or “uops”) for execution. In at least one embodiment, instruction decoder 2228 parses instruction into an opcode and corresponding data and control fields that may be used by micro-architecture to perform operations. In at least one embodiment, a trace cache 2230 may assemble decoded uops into program ordered sequences or traces in a uop queue 2234 for execution. In at least one embodiment, when trace cache 2230 encounters a complex instruction, a microcode ROM 2232 provides uops needed to complete an operation.

In at least one embodiment, some instructions may be converted into a single micro-op, whereas others need several micro-ops to complete full operation. In at least one embodiment, if more than four micro-ops are needed to complete an instruction, instruction decoder 2228 may access microcode ROM 2232 to perform instruction. In at least one embodiment, an instruction may be decoded into a small number of micro-ops for processing at instruction decoder 2228. In at least one embodiment, an instruction may be stored within microcode ROM 2232 should a number of micro-ops be needed to accomplish operation. In at least one embodiment, trace cache 2230 refers to an entry point programmable logic array (“PLA”) to determine a correct micro-instruction pointer for reading microcode sequences to complete one or more instructions from microcode ROM 2232. In at least one embodiment, after microcode ROM 2232 finishes sequencing micro-ops for an instruction, front end 2201 of machine may resume fetching micro-ops from trace cache 2230.

In at least one embodiment, out-of-order execution engine (“out of order engine”) 2203 may prepare instructions for execution. In at least one embodiment, out-of-order execution logic has a number of buffers to smooth out and re-order the flow of instructions to optimize performance as they go down a pipeline and get scheduled for execution. Out-of-order execution engine 2203 includes, without limitation, an allocator/register renamer 2240, a memory uop queue 2242, an integer/floating point uop queue 2244, a memory scheduler 2246, a fast scheduler 2202, a slow/general floating point scheduler (“slow/general FP scheduler”) 2204, and a simple floating point scheduler (“simple FP scheduler”) 2206. In at least one embodiment, fast schedule 2202, slow/general floating point scheduler 2204, and simple floating point scheduler 2206 are also collectively referred to herein as “uop schedulers 2202, 2204, 2206.” Allocator/register renamer 2240 allocates machine buffers and resources that each uop needs in order to execute. In at least one embodiment, allocator/register renamer 2240 renames logic registers onto entries in a register file. In at least one embodiment, allocator/register renamer 2240 also allocates an entry for each uop in one of two uop queues, memory uop queue 2242 for memory operations and integer/floating point uop queue 2244 for non-memory operations, in front of memory scheduler 2246 and uop schedulers 2202, 2204, 2206. In at least one embodiment, uop schedulers 2202, 2204, 2206, determine when a uop is ready to execute based on readiness of their dependent input register operand sources and availability of execution resources uops need to complete their operation. In at least one embodiment, fast scheduler 2202 of at least one embodiment may schedule on each half of main clock cycle while slow/general floating point scheduler 2204 and simple floating point scheduler 2206 may schedule once per main processor clock cycle. In at least one embodiment, uop schedulers 2202, 2204, 2206 arbitrate for dispatch ports to schedule uops for execution.

In at least one embodiment, execution block 2211 includes, without limitation, an integer register file/bypass network 2208, a floating point register file/bypass network (“FP register file/bypass network”) 2210, address generation units (“AGUs”) 2212 and 2214, fast ALUs 2216 and 2218, a slow ALU 2220, a floating point ALU (“FP”) 2222, and a floating point move unit (“FP move”) 2224. In at least one embodiment, integer register file/bypass network 2208 and floating point register file/bypass network 2210 are also referred to herein as “register files 2208, 2210.” In at least one embodiment, AGUs 2212 and 2214, fast ALUs 2216 and 2218, slow ALU 2220, floating point ALU 2222, and floating point move unit 2224 are also referred to herein as “execution units 2212, 2214, 2216, 2218, 2220, 2222, and 2224.” In at least one embodiment, an execution block may include, without limitation, any number (including zero) and type of register files, bypass networks, address generation units, and execution units, in any combination.

In at least one embodiment, register files 2208, 2210 may be arranged between uop schedulers 2202, 2204, 2206, and execution units 2212, 2214, 2216, 2218, 2220, 2222, and 2224. In at least one embodiment, integer register file/bypass network 2208 performs integer operations. In at least one embodiment, floating point register file/bypass network 2210 performs floating point operations. In at least one embodiment, each of register files 2208, 2210 may include, without limitation, a bypass network that may bypass or forward just completed results that have not yet been written into register file to new dependent uops. In at least one embodiment, register files 2208, 2210 may communicate data with each other. In at least one embodiment, integer register file/bypass network 2208 may include, without limitation, two separate register files, one register file for low-order thirty-two bits of data and a second register file for high order thirty-two bits of data. In at least one embodiment, floating point register file/bypass network 2210 may include, without limitation, 128-bit wide entries because floating point instructions typically have operands from 64 to 128 bits in width.

In at least one embodiment, execution units 2212, 2214, 2216, 2218, 2220, 2222, 2224 may execute instructions. In at least one embodiment, register files 2208, 2210 store integer and floating point data operand values that micro-instructions need to execute. In at least one embodiment, processor 2200 may include, without limitation, any number and combination of execution units 2212, 2214, 2216, 2218, 2220, 2222, 2224. In at least one embodiment, floating point ALU 2222 and floating point move unit 2224 may execute floating point, MMX, SIMD, AVX and SSE, or other operations. In at least one embodiment, floating point ALU 2222 may include, without limitation, a 64-bit by 64-bit floating point divider to execute divide, square root, and remainder micro ops. In at least one embodiment, instructions involving a floating-point value may be handled with floating point hardware. In at least one embodiment, ALU operations may be passed to fast ALUs 2216, 2218. In at least one embodiment, fast ALUS 2216, 2218 may execute fast operations with an effective latency of half a clock cycle. In at least one embodiment, most complex integer operations go to slow ALU 2220 as slow ALU 2220 may include, without limitation, integer execution hardware for long-latency type of operations, such as a multiplier, shifts, flag logic, and branch processing. In at least one embodiment, memory load/store operations may be executed by AGUs 2212, 2214. In at least one embodiment, fast ALU 2216, fast ALU 2218, and slow ALU 2220 may perform integer operations on 64-bit data operands. In at least one embodiment, fast ALU 2216, fast ALU 2218, and slow ALU 2220 may be implemented to support a variety of data bit sizes including sixteen, thirty-two, 128, 256, etc. In at least one embodiment, floating point ALU 2222 and floating point move unit 2224 may be implemented to support a range of operands having bits of various widths. In at least one embodiment, floating point ALU 2222 and floating point move unit 2224 may operate on 128-bit wide packed data operands in conjunction with SIMD and multimedia instructions.

In at least one embodiment, uop schedulers 2202, 2204, 2206 dispatch dependent operations before parent load has finished executing. In at least one embodiment, as uops may be speculatively scheduled and executed in processor 2200, processor 2200 may also include logic to handle memory misses. In at least one embodiment, if a data load misses in a data cache, there may be dependent operations in flight in pipeline that have left a scheduler with temporarily incorrect data. In at least one embodiment, a replay mechanism tracks and re-executes instructions that use incorrect data. In at least one embodiment, dependent operations might need to be replayed and independent ones may be allowed to complete. In at least one embodiment, schedulers and replay mechanisms of at least one embodiment of a processor may also be designed to catch instruction sequences for text string comparison operations.

In at least one embodiment, the term “registers” may refer to on-board processor storage locations that may be used as part of instructions to identify operands. In at least one embodiment, registers may be those that may be usable from outside of a processor (from a programmer's perspective). In at least one embodiment, registers might not be limited to a particular type of circuit. Rather, in at least one embodiment, a register may store data, provide data, and perform functions described herein. In at least one embodiment, registers described herein may be implemented by circuitry within a processor using any number of different techniques, such as dedicated physical registers, dynamically allocated physical registers using register renaming, combinations of dedicated and dynamically allocated physical registers, etc. In at least one embodiment, integer registers store 32-bit integer data. A register file of at least one embodiment also contains eight multimedia SIMD registers for packed data.

In at least one embodiment, the first set 712 (see FIG. 7) and/or the second set 714 (see FIG. 7) may include one or more of the processor 2200. In at least one embodiment, one or more systems depicted in FIG. 22 are utilized to detect and/or predict signals conducted by a signal conductor (e.g., within a multi-GPU system) and transition the signal conductor between active and inactive states with various algorithms, formulas, and/or processes, such as those described in connection with FIGS. 1-8 and/or otherwise perform operations described herein. In at least one embodiment, one or more systems depicted in FIG. 22 are utilized to implement one or more systems and/or processes such as those described in connection with FIGS. 1-8.

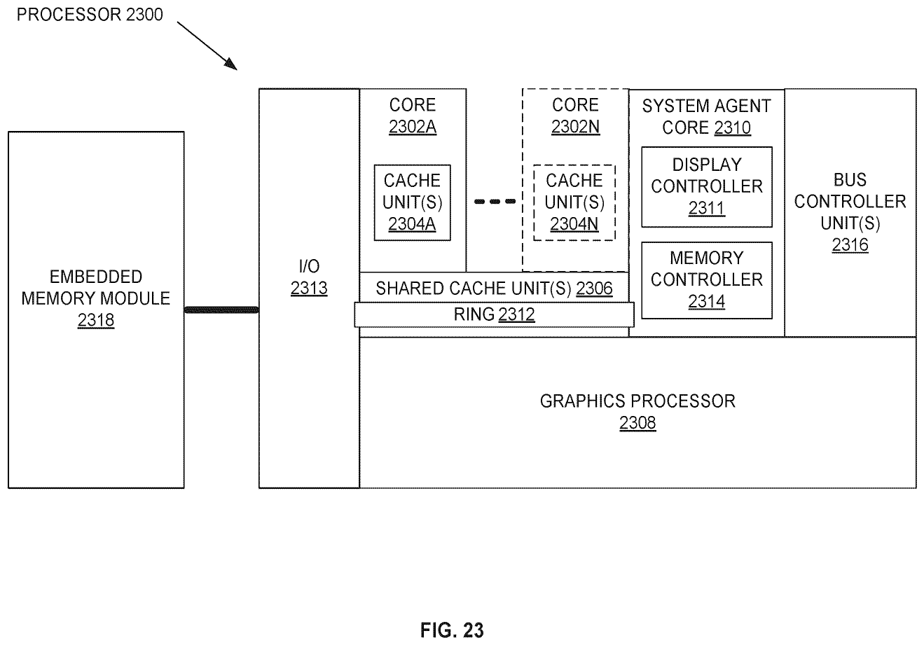

FIG. 23 illustrates a processor 2300, in accordance with at least one embodiment. In at least one embodiment, processor 2300 includes, without limitation, one or more processor cores (“cores”) 2302A-2302N, an integrated memory controller 2314, and an integrated graphics processor 2308. In at least one embodiment, processor 2300 can include additional cores up to and including additional processor core 2302N represented by dashed lined boxes. In at least one embodiment, each of processor cores 2302A-2302N includes one or more internal cache units 2304A-2304N. In at least one embodiment, each processor core also has access to one or more shared cache units 2306.

In at least one embodiment, internal cache units 2304A-2304N and shared cache units 2306 represent a cache memory hierarchy within processor 2300. In at least one embodiment, cache memory units 2304A-2304N may include at least one level of instruction and data cache within each processor core and one or more levels of shared mid-level cache, such as an L2, L3, Level 4 (“L4”), or other levels of cache, where a highest level of cache before external memory is classified as an LLC. In at least one embodiment, cache coherency logic maintains coherency between various shared cache units 2306 and 2304A-2304N.

In at least one embodiment, processor 2300 may also include a set of one or more bus controller units 2316 and a system agent core 2310. In at least one embodiment, one or more bus controller units 2316 manage a set of peripheral buses, such as one or more PCI or PCI express buses. In at least one embodiment, system agent core 2310 provides management functionality for various processor components. In at least one embodiment, system agent core 2310 includes one or more integrated memory controllers 2314 to manage access to various external memory devices (not shown).

In at least one embodiment, one or more of processor cores 2302A-2302N include support for simultaneous multi-threading. In at least one embodiment, system agent core 2310 includes components for coordinating and operating processor cores 2302A-2302N during multi-threaded processing. In at least one embodiment, system agent core 2310 may additionally include a power control unit (“PCU”), which includes logic and components to regulate one or more power states of processor cores 2302A-2302N and graphics processor 2308.

In at least one embodiment, processor 2300 additionally includes graphics processor 2308 to execute graphics processing operations. In at least one embodiment, graphics processor 2308 couples with shared cache units 2306, and system agent core 2310, including one or more integrated memory controllers 2314. In at least one embodiment, system agent core 2310 also includes a display controller 2311 to drive graphics processor output to one or more coupled displays. In at least one embodiment, display controller 2311 may also be a separate module coupled with graphics processor 2308 via at least one interconnect, or may be integrated within graphics processor 2308.

In at least one embodiment, a ring based interconnect unit 2312 is used to couple internal components of processor 2300. In at least one embodiment, an alternative interconnect unit may be used, such as a point-to-point interconnect, a switched interconnect, or other techniques. In at least one embodiment, graphics processor 2308 couples with ring interconnect 2312 via an I/O link 2313.

In at least one embodiment, I/O link 2313 represents at least one of multiple varieties of I/O interconnects, including an on package I/O interconnect which facilitates communication between various processor components and a high-performance embedded memory module 2318, such as an eDRAM module. In at least one embodiment, each of processor cores 2302A-2302N and graphics processor 2308 use embedded memory modules 2318 as a shared LLC.

In at least one embodiment, processor cores 2302A-2302N are homogeneous cores executing a common instruction set architecture. In at least one embodiment, processor cores 2302A-2302N are heterogeneous in terms of ISA, where one or more of processor cores 2302A-2302N execute a common instruction set, while one or more other cores of processor cores 2302A-23-02N executes a subset of a common instruction set or a different instruction set. In at least one embodiment, processor cores 2302A-2302N are heterogeneous in terms of microarchitecture, where one or more cores having a relatively higher power consumption couple with one or more cores having a lower power consumption. In at least one embodiment, processor 2300 can be implemented on one or more chips or as an SoC integrated circuit.

In at least one embodiment, the first set 712 (see FIG. 7) and/or the second set 714 (see FIG. 7) may include one or more of the processor 2300. In at least one embodiment, the first set 712 (see FIG. 7) and/or the second set 714 (see FIG. 7) may include the integrated graphics processor 2308 and/or one or more of the processor core(s) 2302A-2302N. In at least one embodiment, the ring interconnect 2312 may be used to implement the switching circuitry 110. In at least one embodiment, one or more systems depicted in FIG. 23 are utilized to detect and/or predict signals conducted by a signal conductor (e.g., within a multi-GPU system) and transition the signal conductor between active and inactive states with various algorithms, formulas, and/or processes, such as those described in connection with FIGS. 1-8 and/or otherwise perform operations described herein. In at least one embodiment, one or more systems depicted in FIG. 23 are utilized to implement one or more systems and/or processes such as those described in connection with FIGS. 1-8.

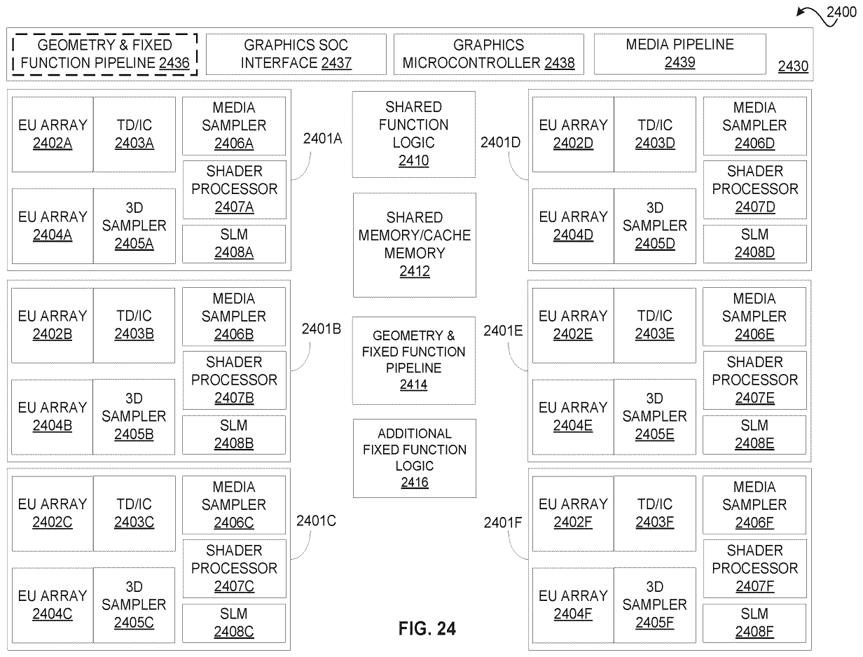

FIG. 24 illustrates a graphics core 2400, in accordance with at least one embodiment described. In at least one embodiment, graphics core 2400 is included within a graphics core array. In at least one embodiment, graphics core 2400, sometimes referred to as a core slice, can be one or multiple graphics cores within a modular graphics processor. In at least one embodiment, graphics core 2400 is example of one graphics core slice, and a graphics processor as described herein may include multiple graphics core slices based on target power and performance envelopes. In at least one embodiment, each graphics core 2400 can include a fixed function block 2430 coupled with multiple sub-cores 2401A-2401F, also referred to as sub-slices, that include modular blocks of general-purpose and fixed function logic.

In at least one embodiment, fixed function block 2430 includes a geometry and fixed function pipeline 2436 that can be shared by all sub-cores in graphics core 2400, for example, in lower performance and/or lower power graphics processor implementations. In at least one embodiment, geometry and fixed function pipeline 2436 includes a 3D fixed function pipeline, a video front-end unit, a thread spawner and thread dispatcher, and a unified return buffer manager, which manages unified return buffers.

In at least one embodiment, fixed function block 2430 also includes a graphics SoC interface 2437, a graphics microcontroller 2438, and a media pipeline 2439. Graphics SoC interface 2437 provides an interface between graphics core 2400 and other processor cores within an SoC integrated circuit. In at least one embodiment, graphics microcontroller 2438 is a programmable sub-processor that is configurable to manage various functions of graphics core 2400, including thread dispatch, scheduling, and pre-emption. In at least one embodiment, media pipeline 2439 includes logic to facilitate decoding, encoding, pre-processing, and/or post-processing of multimedia data, including image and video data. In at least one embodiment, media pipeline 2439 implements media operations via requests to compute or sampling logic within sub-cores 2401-2401F.

In at least one embodiment, SoC interface 2437 enables graphics core 2400 to communicate with general-purpose application processor cores (e.g., CPUs) and/or other components within an SoC, including memory hierarchy elements such as a shared LLC memory, system RAM, and/or embedded on-chip or on-package DRAM. In at least one embodiment, SoC interface 2437 can also enable communication with fixed function devices within an SoC, such as camera imaging pipelines, and enables use of and/or implements global memory atomics that may be shared between graphics core 2400 and CPUs within an SoC. In at least one embodiment, SoC interface 2437 can also implement power management controls for graphics core 2400 and enable an interface between a clock domain of graphics core 2400 and other clock domains within an SoC. In at least one embodiment, SoC interface 2437 enables receipt of command buffers from a command streamer and global thread dispatcher that are configured to provide commands and instructions to each of one or more graphics cores within a graphics processor. In at least one embodiment, commands and instructions can be dispatched to media pipeline 2439, when media operations are to be performed, or a geometry and fixed function pipeline (e.g., geometry and fixed function pipeline 2436, geometry and fixed function pipeline 2414) when graphics processing operations are to be performed.

In at least one embodiment, graphics microcontroller 2438 can be configured to perform various scheduling and management tasks for graphics core 2400. In at least one embodiment, graphics microcontroller 2438 can perform graphics and/or compute workload scheduling on various graphics parallel engines within execution unit (EU) arrays 2402A-2402F, 2404A-2404F within sub-cores 2401A-2401F. In at least one embodiment, host software executing on a CPU core of an SoC including graphics core 2400 can submit workloads one of multiple graphic processor doorbells, which invokes a scheduling operation on an appropriate graphics engine. In at least one embodiment, scheduling operations include determining which workload to run next, submitting a workload to a command streamer, pre-empting existing workloads running on an engine, monitoring progress of a workload, and notifying host software when a workload is complete. In at least one embodiment, graphics microcontroller 2438 can also facilitate low-power or idle states for graphics core 2400, providing graphics core 2400 with an ability to save and restore registers within graphics core 2400 across low-power state transitions independently from an operating system and/or graphics driver software on a system.

In at least one embodiment, graphics core 2400 may have greater than or fewer than illustrated sub-cores 2401A-2401F, up to N modular sub-cores. For each set of N sub-cores, in at least one embodiment, graphics core 2400 can also include shared function logic 2410, shared and/or cache memory 2412, a geometry and fixed function pipeline 2414, as well as additional fixed function logic 2416 to accelerate various graphics and compute processing operations. In at least one embodiment, shared function logic 2410 can include logic units (e.g., sampler, math, and/or inter-thread communication logic) that can be shared by each N sub-cores within graphics core 2400. Shared and/or cache memory 2412 can be an LLC for N sub-cores 2401A-2401F within graphics core 2400 and can also serve as shared memory that is accessible by multiple sub-cores. In at least one embodiment, geometry and fixed function pipeline 2414 can be included instead of geometry and fixed function pipeline 2436 within fixed function block 2430 and can include same or similar logic units.

In at least one embodiment, graphics core 2400 includes additional fixed function logic 2416 that can include various fixed function acceleration logic for use by graphics core 2400. In at least one embodiment, additional fixed function logic 2416 includes an additional geometry pipeline for use in position only shading. In position-only shading, at least two geometry pipelines exist, whereas in a full geometry pipeline within geometry and fixed function pipeline 2414, 2436, and a cull pipeline, which is an additional geometry pipeline which may be included within additional fixed function logic 2416. In at least one embodiment, cull pipeline is a trimmed down version of a full geometry pipeline. In at least one embodiment, a full pipeline and a cull pipeline can execute different instances of an application, each instance having a separate context. In at least one embodiment, position only shading can hide long cull runs of discarded triangles, enabling shading to be completed earlier in some instances. For example, in at least one embodiment, cull pipeline logic within additional fixed function logic 2416 can execute position shaders in parallel with a main application and generally generates critical results faster than a full pipeline, as a cull pipeline fetches and shades position attribute of vertices, without performing rasterization and rendering of pixels to a frame buffer. In at least one embodiment, a cull pipeline can use generated critical results to compute visibility information for all triangles without regard to whether those triangles are culled. In at least one embodiment, a full pipeline (which in this instance may be referred to as a replay pipeline) can consume visibility information to skip culled triangles to shade only visible triangles that are finally passed to a rasterization phase.

In at least one embodiment, additional fixed function logic 2416 can also include general purpose processing acceleration logic, such as fixed function matrix multiplication logic, for accelerating CUDA programs.

In at least one embodiment, each graphics sub-core 2401A-2401F includes a set of execution resources that may be used to perform graphics, media, and compute operations in response to requests by graphics pipeline, media pipeline, or shader programs. In at least one embodiment, graphics sub-cores 2401A-2401F include multiple EU arrays 2402A-2402F, 2404A-2404F, thread dispatch and inter-thread communication (“TD/IC”) logic 2403A-2403F, a 3D (e.g., texture) sampler 2405A-2405F, a media sampler 2406A-2406F, a shader processor 2407A-2407F, and shared local memory (“SLM”) 2408A-2408F. EU arrays 2402A-2402F, 2404A-2404F each include multiple execution units, which are GPGPUs capable of performing floating-point and integer/fixed-point logic operations in service of a graphics, media, or compute operation, including graphics, media, or compute shader programs. In at least one embodiment, TD/IC logic 2403A-2403F performs local thread dispatch and thread control operations for execution units within a sub-core and facilitate communication between threads executing on execution units of a sub-core. In at least one embodiment, 3D sampler 2405A-2405F can read texture or other 3D graphics related data into memory. In at least one embodiment, 3D sampler can read texture data differently based on a configured sample state and texture format associated with a given texture. In at least one embodiment, media sampler 2406A-2406F can perform similar read operations based on a type and format associated with media data. In at least one embodiment, each graphics sub-core 2401A-2401F can alternately include a unified 3D and media sampler. In at least one embodiment, threads executing on execution units within each of sub-cores 2401A-2401F can make use of shared local memory 2408A-2408F within each sub-core, to enable threads executing within a thread group to execute using a common pool of on-chip memory.

In at least one embodiment, the first set 712 (see FIG. 7) and/or the second set 714 (see FIG. 7) may include one or more of the graphics processor core 2400. In at least one embodiment, one or more systems depicted in FIG. 24 are utilized to detect and/or predict signals conducted by a signal conductor (e.g., within a multi-GPU system) and transition the signal conductor between active and inactive states with various algorithms, formulas, and/or processes, such as those described in connection with FIGS. 1-8 and/or otherwise perform operations described herein. In at least one embodiment, one or more systems depicted in FIG. 24 are utilized to implement one or more systems and/or processes such as those described in connection with FIGS. 1-8.

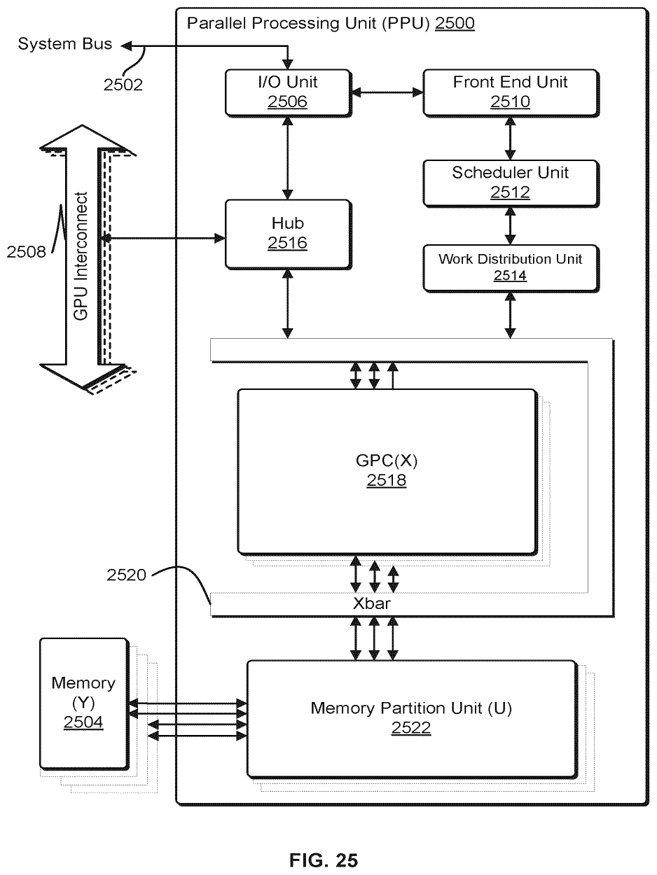

FIG. 25 illustrates a parallel processing unit (“PPU”) 2500, in accordance with at least one embodiment. In at least one embodiment, PPU 2500 is configured with machine-readable code that, if executed by PPU 2500, causes PPU 2500 to perform some or all of processes and techniques described herein. In at least one embodiment, PPU 2500 is a multi-threaded processor that is implemented on one or more integrated circuit devices and that utilizes multithreading as a latency-hiding technique designed to process computer-readable instructions (also referred to as machine-readable instructions or simply instructions) on multiple threads in parallel. In at least one embodiment, a thread refers to a thread of execution and is an instantiation of a set of instructions configured to be executed by PPU 2500. In at least one embodiment, PPU 2500 is a GPU configured to implement a graphics rendering pipeline for processing three-dimensional (“3D”) graphics data in order to generate two-dimensional (“2D”) image data for display on a display device such as an LCD device. In at least one embodiment, PPU 2500 is utilized to perform computations such as linear algebra operations and machine-learning operations. FIG. 25 illustrates an example parallel processor for illustrative purposes only and should be construed as a non-limiting example of a processor architecture that may be implemented in at least one embodiment.

In at least one embodiment, one or more PPUs 2500 are configured to accelerate High Performance Computing (“HPC”), data center, and machine learning applications. In at least one embodiment, one or more PPUs 2500 are configured to accelerate CUDA programs. In at least one embodiment, PPU 2500 includes, without limitation, an I/O unit 2506, a front-end unit 2510, a scheduler unit 2512, a work distribution unit 2514, a hub 2516, a crossbar (“Xbar”) 2520, one or more general processing clusters (“GPCs”) 2518, and one or more partition units (“memory partition units”) 2522. In at least one embodiment, PPU 2500 is connected to a host processor or other PPUs 2500 via one or more high-speed GPU interconnects (“GPU interconnects”) 2508. In at least one embodiment, PPU 2500 is connected to a host processor or other peripheral devices via a system bus or interconnect 2502. In at least one embodiment, PPU 2500 is connected to a local memory comprising one or more memory (“memory devices”) 2504. In at least one embodiment, memory 2504 may include, without limitation, one or more dynamic random access memory (DRAM) devices. In at least one embodiment, one or more DRAM devices are configured and/or configurable as high-bandwidth memory (“HBM”) subsystems, with multiple DRAM dies stacked within each device.

In at least one embodiment, high-speed GPU interconnect 2508 may refer to a wire-based multi-lane communications link that is used by systems to scale and include one or more PPUs 2500 combined with one or more CPUs, supports cache coherence between PPUs 2500 and CPUs, and CPU mastering. In at least one embodiment, data and/or commands are transmitted by high-speed GPU interconnect 2508 through hub 2516 to/from other units of PPU 2500 such as one or more copy engines, video encoders, video decoders, power management units, and other components which may not be explicitly illustrated in FIG. 25.

In at least one embodiment, I/O unit 2506 is configured to transmit and receive communications (e.g., commands, data) from a host processor (not illustrated in FIG. 25) over system bus 2502. In at least one embodiment, I/O unit 2506 communicates with host processor directly via system bus 2502 or through one or more intermediate devices such as a memory bridge. In at least one embodiment, I/O unit 2506 may communicate with one or more other processors, such as one or more of PPUs 2500 via system bus 2502. In at least one embodiment, I/O unit 2506 implements a PCIe interface for communications over a PCIe bus. In at least one embodiment, I/O unit 2506 implements interfaces for communicating with external devices.

In at least one embodiment, I/O unit 2506 decodes packets received via system bus 2502. In at least one embodiment, at least some packets represent commands configured to cause PPU 2500 to perform various operations. In at least one embodiment, I/O unit 2506 transmits decoded commands to various other units of PPU 2500 as specified by commands. In at least one embodiment, commands are transmitted to front-end unit 2510 and/or transmitted to hub 2516 or other units of PPU 2500 such as one or more copy engines, a video encoder, a video decoder, a power management unit, etc. (not explicitly illustrated in FIG. 25). In at least one embodiment, I/O unit 2506 is configured to route communications between and among various logical units of PPU 2500.

In at least one embodiment, a program executed by host processor encodes a command stream in a buffer that provides workloads to PPU 2500 for processing. In at least one embodiment, a workload comprises instructions and data to be processed by those instructions. In at least one embodiment, buffer is a region in a memory that is accessible (e.g., read/write) by both a host processor and PPU 2500—a host interface unit may be configured to access buffer in a system memory connected to system bus 2502 via memory requests transmitted over system bus 2502 by I/O unit 2506. In at least one embodiment, a host processor writes a command stream to a buffer and then transmits a pointer to the start of the command stream to PPU 2500 such that front-end unit 2510 receives pointers to one or more command streams and manages one or more command streams, reading commands from command streams and forwarding commands to various units of PPU 2500.

In at least one embodiment, front-end unit 2510 is coupled to scheduler unit 2512 that configures various GPCs 2518 to process tasks defined by one or more command streams. In at least one embodiment, scheduler unit 2512 is configured to track state information related to various tasks managed by scheduler unit 2512 where state information may indicate which of GPCs 2518 a task is assigned to, whether task is active or inactive, a priority level associated with task, and so forth. In at least one embodiment, scheduler unit 2512 manages execution of a plurality of tasks on one or more of GPCs 2518.

In at least one embodiment, scheduler unit 2512 is coupled to work distribution unit 2514 that is configured to dispatch tasks for execution on GPCs 2518. In at least one embodiment, work distribution unit 2514 tracks a number of scheduled tasks received from scheduler unit 2512 and work distribution unit 2514 manages a pending task pool and an active task pool for each of GPCs 2518. In at least one embodiment, pending task pool comprises a number of slots (e.g., 32 slots) that contain tasks assigned to be processed by a particular GPC 2518; active task pool may comprise a number of slots (e.g., 4 slots) for tasks that are actively being processed by GPCs 2518 such that as one of GPCs 2518 completes execution of a task, that task is evicted from active task pool for GPC 2518 and one of other tasks from pending task pool is selected and scheduled for execution on GPC 2518. In at least one embodiment, if an active task is idle on GPC 2518, such as while waiting for a data dependency to be resolved, then the active task is evicted from GPC 2518 and returned to a pending task pool while another task in the pending task pool is selected and scheduled for execution on GPC 2518.

In at least one embodiment, work distribution unit 2514 communicates with one or more GPCs 2518 via XBar 2520. In at least one embodiment, XBar 2520 is an interconnect network that couples many units of PPU 2500 to other units of PPU 2500 and can be configured to couple work distribution unit 2514 to a particular GPC 2518. In at least one embodiment, one or more other units of PPU 2500 may also be connected to XBar 2520 via hub 2516.

In at least one embodiment, tasks are managed by scheduler unit 2512 and dispatched to one of GPCs 2518 by work distribution unit 2514. GPC 2518 is configured to process task and generate results. In at least one embodiment, results may be consumed by other tasks within GPC 2518, routed to a different GPC 2518 via XBar 2520, or stored in memory 2504. In at least one embodiment, results can be written to memory 2504 via partition units 2522, which implement a memory interface for reading and writing data to/from memory 2504. In at least one embodiment, results can be transmitted to another PPU 2500 or CPU via high-speed GPU interconnect 2508. In at least one embodiment, PPU 2500 includes, without limitation, a number U of partition units 2522 that is equal to number of separate and distinct memory 2504 coupled to PPU 2500.

In at least one embodiment, a host processor executes a driver kernel that implements an application programming interface (“API”) that enables one or more applications executing on host processor to schedule operations for execution on PPU 2500. In at least one embodiment, multiple compute applications are simultaneously executed by PPU 2500 and PPU 2500 provides isolation, quality of service (“QoS”), and independent address spaces for multiple compute applications. In at least one embodiment, an application generates instructions (e.g., in the form of API calls) that cause a driver kernel to generate one or more tasks for execution by PPU 2500 and the driver kernel outputs tasks to one or more streams being processed by PPU 2500. In at least one embodiment, each task comprises one or more groups of related threads, which may be referred to as a warp. In at least one embodiment, a warp comprises a plurality of related threads (e.g., 32 threads) that can be executed in parallel. In at least one embodiment, cooperating threads can refer to a plurality of threads including instructions to perform a task and that exchange data through shared memory.

In at least one embodiment, the first set 712 (see FIG. 7) and/or the second set 714 (see FIG. 7) may include one or more of the PPU 2500. In at least one embodiment, one or more systems depicted in FIG. 25 are utilized to detect and/or predict signals conducted by a signal conductor (e.g., within a multi-GPU system) and transition the signal conductor between active and inactive states with various algorithms, formulas, and/or processes, such as those described in connection with FIGS. 1-8 and/or otherwise perform operations described herein. In at least one embodiment, one or more systems depicted in FIG. 25 are utilized to implement one or more systems and/or processes such as those described in connection with FIGS. 1-8.

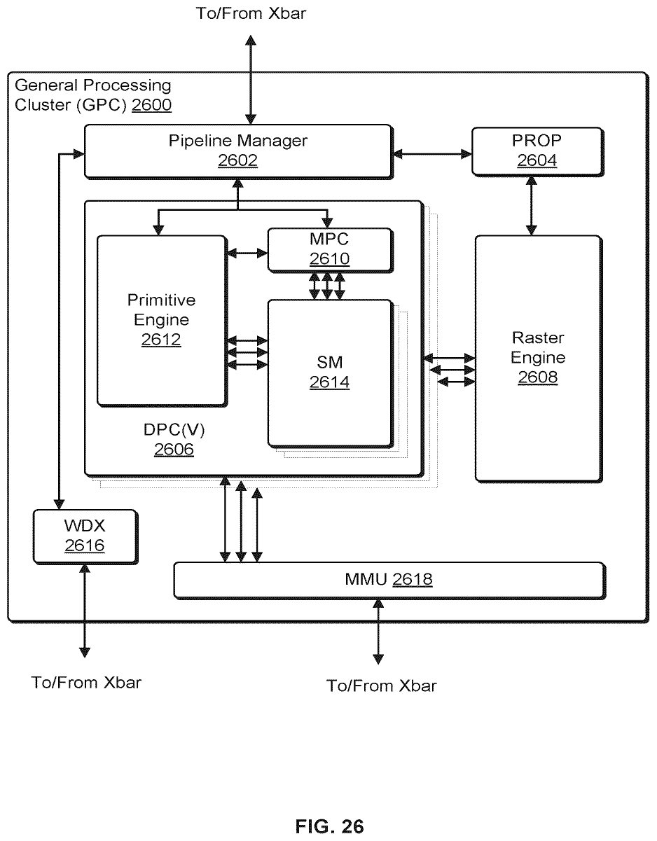

FIG. 26 illustrates a GPC 2600, in accordance with at least one embodiment. In at least one embodiment, GPC 2600 is GPC 2518 of FIG. 25. In at least one embodiment, each GPC 2600 includes, without limitation, a number of hardware units for processing tasks and each GPC 2600 includes, without limitation, a pipeline manager 2602, a pre-raster operations unit (“PROP”) 2604, a raster engine 2608, a work distribution crossbar (“WDX”) 2616, an MMU 2618, one or more Data Processing Clusters (“DPCs”) 2606, and any suitable combination of parts.

In at least one embodiment, operation of GPC 2600 is controlled by pipeline manager 2602. In at least one embodiment, pipeline manager 2602 manages configuration of one or more DPCs 2606 for processing tasks allocated to GPC 2600. In at least one embodiment, pipeline manager 2602 configures at least one of one or more DPCs 2606 to implement at least a portion of a graphics rendering pipeline. In at least one embodiment, DPC 2606 is configured to execute a vertex shader program on a programmable streaming multiprocessor (“SM”) 2614. In at least one embodiment, pipeline manager 2602 is configured to route packets received from a work distribution unit to appropriate logical units within GPC 2600 and, in at least one embodiment, some packets may be routed to fixed function hardware units in PROP 2604 and/or raster engine 2608 while other packets may be routed to DPCs 2606 for processing by a primitive engine 2612 or SM 2614. In at least one embodiment, pipeline manager 2602 configures at least one of DPCs 2606 to implement a computing pipeline. In at least one embodiment, pipeline manager 2602 configures at least one of DPCs 2606 to execute at least a portion of a CUDA program.

In at least one embodiment, PROP unit 2604 is configured to route data generated by raster engine 2608 and DPCs 2606 to a Raster Operations (“ROP”) unit in a partition unit, such as memory partition unit 2522 described in more detail above in conjunction with FIG. 25. In at least one embodiment, PROP unit 2604 is configured to perform optimizations for color blending, organize pixel data, perform address translations, and more. In at least one embodiment, raster engine 2608 includes, without limitation, a number of fixed function hardware units configured to perform various raster operations and, in at least one embodiment, raster engine 2608 includes, without limitation, a setup engine, a coarse raster engine, a culling engine, a clipping engine, a fine raster engine, a tile coalescing engine, and any suitable combination thereof. In at least one embodiment, a setup engine receives transformed vertices and generates plane equations associated with geometric primitive defined by vertices; plane equations are transmitted to a coarse raster engine to generate coverage information (e.g., an x, y coverage mask for a tile) for a primitive; the output of the coarse raster engine is transmitted to a culling engine where fragments associated with a primitive that fail a z-test are culled, and transmitted to a clipping engine where fragments lying outside a viewing frustum are clipped. In at least one embodiment, fragments that survive clipping and culling are passed to a fine raster engine to generate attributes for pixel fragments based on plane equations generated by a setup engine. In at least one embodiment, the output of raster engine 2608 comprises fragments to be processed by any suitable entity such as by a fragment shader implemented within DPC 2606.

In at least one embodiment, each DPC 2606 included in GPC 2600 comprise, without limitation, an M-Pipe Controller (“MPC”) 2610; primitive engine 2612; one or more SMs 2614; and any suitable combination thereof. In at least one embodiment, MPC 2610 controls operation of DPC 2606, routing packets received from pipeline manager 2602 to appropriate units in DPC 2606. In at least one embodiment, packets associated with a vertex are routed to primitive engine 2612, which is configured to fetch vertex attributes associated with vertex from memory; in contrast, packets associated with a shader program may be transmitted to SM 2614.

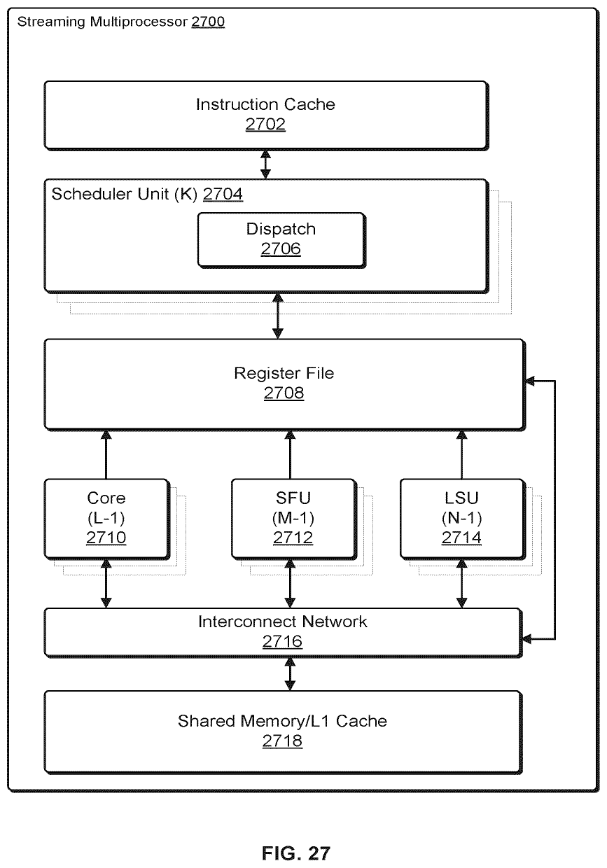

In at least one embodiment, SM 2614 comprises, without limitation, a programmable streaming processor that is configured to process tasks represented by a number of threads. In at least one embodiment, SM 2614 is multi-threaded and configured to execute a plurality of threads (e.g., 32 threads) from a particular group of threads concurrently and implements a SIMD architecture where each thread in a group of threads (e.g., a warp) is configured to process a different set of data based on same set of instructions. In at least one embodiment, all threads in group of threads execute same instructions. In at least one embodiment, SM 2614 implements a SIMT architecture wherein each thread in a group of threads is configured to process a different set of data based on same set of instructions, but where individual threads in group of threads are allowed to diverge during execution. In at least one embodiment, a program counter, a call stack, and an execution state is maintained for each warp, enabling concurrency between warps and serial execution within warps when threads within a warp diverge. In another embodiment, a program counter, a call stack, and an execution state is maintained for each individual thread, enabling equal concurrency between all threads, within and between warps. In at least one embodiment, an execution state is maintained for each individual thread and threads executing the same instructions may be converged and executed in parallel for better efficiency. At least one embodiment of SM 2614 is described in more detail in conjunction with FIG. 27.

In at least one embodiment, MMU 2618 provides an interface between GPC 2600 and a memory partition unit (e.g., partition unit 2522 of FIG. 25) and MMU 2618 provides translation of virtual addresses into physical addresses, memory protection, and arbitration of memory requests. In at least one embodiment, MMU 2618 provides one or more translation lookaside buffers (TLBs) for performing translation of virtual addresses into physical addresses in memory.

In at least one embodiment, the first set 712 (see FIG. 7) and/or the second set 714 (see FIG. 7) may include one or more of the GPC 2600. In at least one embodiment, the Xbar illustrated in FIG. 26 may be used to implement the switching circuitry 110. In at least one embodiment, one or more systems depicted in FIG. 26 are utilized to detect and/or predict signals conducted by a signal conductor (e.g., within a multi-GPU system) and transition the signal conductor between active and inactive states with various algorithms, formulas, and/or processes, such as those described in connection with FIGS. 1-8 and/or otherwise perform operations described herein. In at least one embodiment, one or more systems depicted in FIG. 26 are utilized to implement one or more systems and/or processes such as those described in connection with FIGS. 1-8.

FIG. 27 illustrates a streaming multiprocessor (“SM”) 2700, in accordance with at least one embodiment. In at least one embodiment, SM 2700 is SM 2614 of FIG. 26. In at least one embodiment, SM 2700 includes, without limitation, an instruction cache 2702; one or more scheduler units 2704; a register file 2708; one or more processing cores (“cores”) 2710; one or more special function units (“SFUs”) 2712; one or more LSUs 2714; an interconnect network 2716; a shared memory/L1 cache 2718; and any suitable combination thereof. In at least one embodiment, a work distribution unit dispatches tasks for execution on GPCs of parallel processing units (PPUs) and each task is allocated to a particular Data Processing Cluster (DPC) within a GPC and, if a task is associated with a shader program, then the task is allocated to one of SMs 2700. In at least one embodiment, scheduler unit 2704 receives tasks from a work distribution unit and manages instruction scheduling for one or more thread blocks assigned to SM 2700. In at least one embodiment, scheduler unit 2704 schedules thread blocks for execution as warps of parallel threads, wherein each thread block is allocated at least one warp. In at least one embodiment, each warp executes threads. In at least one embodiment, scheduler unit 2704 manages a plurality of different thread blocks, allocating warps to different thread blocks and then dispatching instructions from a plurality of different cooperative groups to various functional units (e.g., processing cores 2710, SFUs 2712, and LSUs 2714) during each clock cycle.

In at least one embodiment, “cooperative groups” may refer to a programming model for organizing groups of communicating threads that allows developers to express granularity at which threads are communicating, enabling expression of richer, more efficient parallel decompositions. In at least one embodiment, cooperative launch APIs support synchronization amongst thread blocks for execution of parallel algorithms. In at least one embodiment, APIs of conventional programming models provide a single, simple construct for synchronizing cooperating threads: a barrier across all threads of a thread block (e.g., syncthreads() function). However, in at least one embodiment, programmers may define groups of threads at smaller than thread block granularities and synchronize within defined groups to enable greater performance, design flexibility, and software reuse in the form of collective group-wide function interfaces. In at least one embodiment, cooperative groups enable programmers to define groups of threads explicitly at sub-block and multi-block granularities, and to perform collective operations such as synchronization on threads in a cooperative group. In at least one embodiment, a sub-block granularity is as small as a single thread. In at least one embodiment, a programming model supports clean composition across software boundaries, so that libraries and utility functions can synchronize safely within their local context without having to make assumptions about convergence. In at least one embodiment, cooperative group primitives enable new patterns of cooperative parallelism, including, without limitation, producer-consumer parallelism, opportunistic parallelism, and global synchronization across an entire grid of thread blocks.

In at least one embodiment, a dispatch unit 2706 is configured to transmit instructions to one or more of functional units and scheduler unit 2704 includes, without limitation, two dispatch units 2706 that enable two different instructions from same warp to be dispatched during each clock cycle. In at least one embodiment, each scheduler unit 2704 includes a single dispatch unit 2706 or additional dispatch units 2706.

In at least one embodiment, each SM 2700, in at least one embodiment, includes, without limitation, register file 2708 that provides a set of registers for functional units of SM 2700. In at least one embodiment, register file 2708 is divided between each of the functional units such that each functional unit is allocated a dedicated portion of register file 2708. In at least one embodiment, register file 2708 is divided between different warps being executed by SM 2700 and register file 2708 provides temporary storage for operands connected to data paths of functional units. In at least one embodiment, each SM 2700 comprises, without limitation, a plurality of L processing cores 2710. In at least one embodiment, SM 2700 includes, without limitation, a large number (e.g., 128 or more) of distinct processing cores 2710. In at least one embodiment, each processing core 2710 includes, without limitation, a fully-pipelined, single-precision, double-precision, and/or mixed precision processing unit that includes, without limitation, a floating point arithmetic logic unit and an integer arithmetic logic unit. In at least one embodiment, floating point arithmetic logic units implement IEEE 754-2008 standard for floating point arithmetic. In at least one embodiment, processing cores 2710 include, without limitation, 64 single-precision (32-bit) floating point cores, 64 integer cores, 32 double-precision (64-bit) floating point cores, and 8 tensor cores.

In at least one embodiment, tensor cores are configured to perform matrix operations. In at least one embodiment, one or more tensor cores are included in processing cores 2710. In at least one embodiment, tensor cores are configured to perform deep learning matrix arithmetic, such as convolution operations for neural network training and inferencing. In at least one embodiment, each tensor core operates on a 4×4 matrix and performs a matrix multiply and accumulate operation D=A×B+C, where A, B, C, and D are 4×4 matrices.

In at least one embodiment, matrix multiply inputs A and B are 16-bit floating point matrices and accumulation matrices C and D are 16-bit floating point or 32-bit floating point matrices. In at least one embodiment, tensor cores operate on 16-bit floating point input data with 32-bit floating point accumulation. In at least one embodiment, 16-bit floating point multiply uses 64 operations and results in a full precision product that is then accumulated using 32-bit floating point addition with other intermediate products for a 4×4×4 matrix multiply. Tensor cores are used to perform much larger two-dimensional or higher dimensional matrix operations, built up from these smaller elements, in at least one embodiment. In at least one embodiment, an API, such as a CUDA-C++ API, exposes specialized matrix load, matrix multiply and accumulate, and matrix store operations to efficiently use tensor cores from a CUDA-C++ program. In at least one embodiment, at the CUDA level, a warp-level interface assumes 16×16 size matrices spanning all 32 threads of a warp.

In at least one embodiment, each SM 2700 comprises, without limitation, M SFUs 2712 that perform special functions (e.g., attribute evaluation, reciprocal square root, and like). In at least one embodiment, SFUs 2712 include, without limitation, a tree traversal unit configured to traverse a hierarchical tree data structure. In at least one embodiment, SFUs 2712 include, without limitation, a texture unit configured to perform texture map filtering operations. In at least one embodiment, texture units are configured to load texture maps (e.g., a 2D array of texels) from memory and sample texture maps to produce sampled texture values for use in shader programs executed by SM 2700. In at least one embodiment, texture maps are stored in shared memory/L1 cache 2718. In at least one embodiment, texture units implement texture operations such as filtering operations using mip-maps (e.g., texture maps of varying levels of detail). In at least one embodiment, each SM 2700 includes, without limitation, two texture units.

In at least one embodiment, each SM 2700 comprises, without limitation, N LSUs 2714 that implement load and store operations between shared memory/L1 cache 2718 and register file 2708. In at least one embodiment, each SM 2700 includes, without limitation, interconnect network 2716 that connects each of the functional units to register file 2708 and LSU 2714 to register file 2708 and shared memory/L1 cache 2718. In at least one embodiment, interconnect network 2716 is a crossbar that can be configured to connect any of the functional units to any of the registers in register file 2708 and connect LSUs 2714 to register file 2708 and memory locations in shared memory/L1 cache 2718.

In at least one embodiment, shared memory/L1 cache 2718 is an array of on-chip memory that allows for data storage and communication between SM 2700 and a primitive engine and between threads in SM 2700. In at least one embodiment, shared memory/L1 cache 2718 comprises, without limitation, 128 KB of storage capacity and is in a path from SM 2700 to a partition unit. In at least one embodiment, shared memory/L1 cache 2718 is used to cache reads and writes. In at least one embodiment, one or more of shared memory/L1 cache 2718, L2 cache, and memory are backing stores.

In at least one embodiment, combining data cache and shared memory functionality into a single memory block provides improved performance for both types of memory accesses. In at least one embodiment, capacity is used or is usable as a cache by programs that do not use shared memory, such as if shared memory is configured to use half of capacity, texture and load/store operations can use remaining capacity. In at least one embodiment, integration within shared memory/L1 cache 2718 enables shared memory/L1 cache 2718 to function as a high-throughput conduit for streaming data while simultaneously providing high-bandwidth and low-latency access to frequently reused data. In at least one embodiment, when configured for general purpose parallel computation, a simpler configuration can be used compared with graphics processing. In at least one embodiment, fixed function GPUs are bypassed, creating a much simpler programming model. In at least one embodiment and in a general purpose parallel computation configuration, a work distribution unit assigns and distributes blocks of threads directly to DPCs. In at least one embodiment, threads in a block execute the same program, using a unique thread ID in a calculation to ensure each thread generates unique results, using SM 2700 to execute a program and perform calculations, shared memory/L1 cache 2718 to communicate between threads, and LSU 2714 to read and write global memory through shared memory/L1 cache 2718 and a memory partition unit. In at least one embodiment, when configured for general purpose parallel computation, SM 2700 writes commands that scheduler unit 2704 can use to launch new work on DPCs.

In at least one embodiment, PPU is included in or coupled to a desktop computer, a laptop computer, a tablet computer, servers, supercomputers, a smart-phone (e.g., a wireless, hand-held device), a PDA, a digital camera, a vehicle, a head mounted display, a hand-held electronic device, and more. In at least one embodiment, PPU is embodied on a single semiconductor substrate. In at least one embodiment, PPU is included in an SoC along with one or more other devices such as additional PPUs, memory, a RISC CPU, an MMU, a digital-to-analog converter (“DAC”), and like.

In at least one embodiment, PPU may be included on a graphics card that includes one or more memory devices. In at least one embodiment, a graphics card may be configured to interface with a PCIe slot on a motherboard of a desktop computer. In at least one embodiment, PPU may be an integrated GPU (“iGPU”) included in chipset of motherboard.

In at least one embodiment, the first set 712 (see FIG. 7) and/or the second set 714 (see FIG. 7) may include one or more of the SM 2700. In at least one embodiment, one or more systems depicted in FIG. 27 are utilized to detect and/or predict signals conducted by a signal conductor (e.g., within a multi-GPU system) and transition the signal conductor between active and inactive states with various algorithms, formulas, and/or processes, such as those described in connection with FIGS. 1-8 and/or otherwise perform operations described herein. In at least one embodiment, one or more systems depicted in FIG. 27 are utilized to implement one or more systems and/or processes such as those described in connection with FIGS. 1-8.

### Software Constructions for General-Purpose Computing

The following figures set forth, without limitation, example software constructs for implementing at least one embodiment.

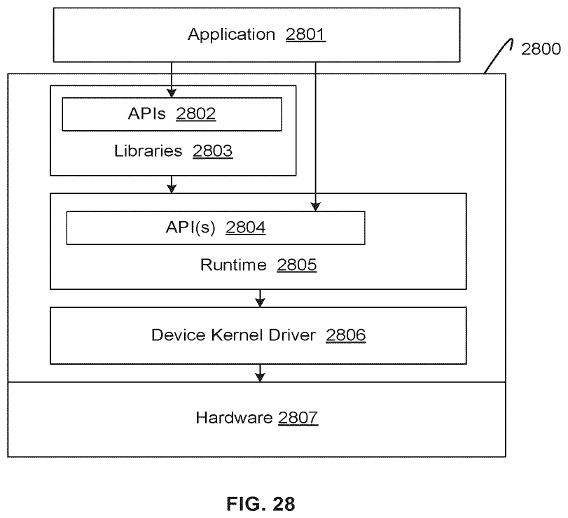

FIG. 28 illustrates a software stack of a programming platform, in accordance with at least one embodiment. In at least one embodiment, a programming platform is a platform for leveraging hardware on a computing system to accelerate computational tasks. A programming platform may be accessible to software developers through libraries, compiler directives, and/or extensions to programming languages, in at least one embodiment. In at least one embodiment, a programming platform may be, but is not limited to, CUDA, Radeon Open Compute Platform (“ROCm”), OpenCL (OpenCL™ is developed by Khronos group), SYCL, or Intel One API.

In at least one embodiment, a software stack 2800 of a programming platform provides an execution environment for an application 2801. In at least one embodiment, application 2801 may include any computer software capable of being launched on software stack 2800. In at least one embodiment, application 2801 may include, but is not limited to, an artificial intelligence (“AI”)/machine learning (“ML”) application, a high performance computing (“HPC”) application, a virtual desktop infrastructure (“VDI”), or a data center workload.

In at least one embodiment, application 2801 and software stack 2800 run on hardware 2807. Hardware 2807 may include one or more GPUs, CPUs, FPGAs, AI engines, and/or other types of compute devices that support a programming platform, in at least one embodiment. In at least one embodiment, such as with CUDA, software stack 2800 may be vendor specific and compatible with only devices from particular vendor(s). In at least one embodiment, such as in with OpenCL, software stack 2800 may be used with devices from different vendors. In at least one embodiment, hardware 2807 includes a host connected to one more devices that can be accessed to perform computational tasks via application programming interface (“API”) calls. A device within hardware 2807 may include, but is not limited to, a GPU, FPGA, AI engine, or other compute device (but may also include a CPU) and its memory, as opposed to a host within hardware 2807 that may include, but is not limited to, a CPU (but may also include a compute device) and its memory, in at least one embodiment.

In at least one embodiment, software stack 2800 of a programming platform includes, without limitation, a number of libraries 2803, a runtime 2805, and a device kernel driver 2806. Each of libraries 2803 may include data and programming code that can be used by computer programs and leveraged during software development, in at least one embodiment. In at least one embodiment, libraries 2803 may include, but are not limited to, pre-written code and subroutines, classes, values, type specifications, configuration data, documentation, help data, and/or message templates. In at least one embodiment, libraries 2803 include functions that are optimized for execution on one or more types of devices. In at least one embodiment, libraries 2803 may include, but are not limited to, functions for performing mathematical, deep learning, and/or other types of operations on devices. In at least one embodiment, libraries 2803 are associated with corresponding APIs 2802, which may include one or more APIs, that expose functions implemented in libraries 2803.

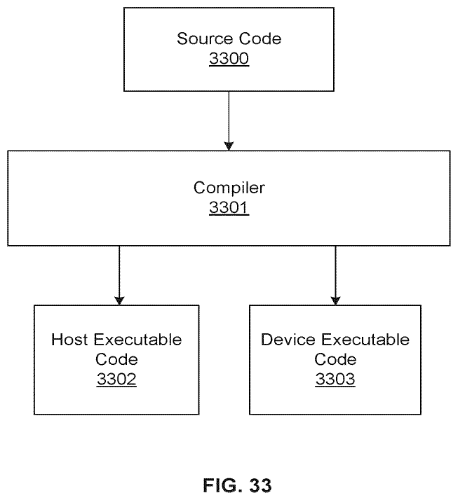

In at least one embodiment, application 2801 is written as source code that is compiled into executable code, as discussed in greater detail below in conjunction with FIGS. 33-35. Executable code of application 2801 may run, at least in part, on an execution environment provided by software stack 2800, in at least one embodiment. In at least one embodiment, during execution of application 2801, code may be reached that needs to run on a device, as opposed to a host. In such a case, runtime 2805 may be called to load and launch requisite code on the device, in at least one embodiment. In at least one embodiment, runtime 2805 may include any technically feasible runtime system that is able to support execution of application S01.

In at least one embodiment, runtime 2805 is implemented as one or more runtime libraries associated with corresponding APIs, which are shown as API(s) 2804. One or more of such runtime libraries may include, without limitation, functions for memory management, execution control, device management, error handling, and/or synchronization, among other things, in at least one embodiment. In at least one embodiment, memory management functions may include, but are not limited to, functions to allocate, deallocate, and copy device memory, as well as transfer data between host memory and device memory. In at least one embodiment, execution control functions may include, but are not limited to, functions to launch a function (sometimes referred to as a “kernel” when a function is a global function callable from a host) on a device and set attribute values in a buffer maintained by a runtime library for a given function to be executed on a device.

Runtime libraries and corresponding API(s) 2804 may be implemented in any technically feasible manner, in at least one embodiment. In at least one embodiment, one (or any number of) API may expose a low-level set of functions for fine-grained control of a device, while another (or any number of) API may expose a higher-level set of such functions. In at least one embodiment, a high-level runtime API may be built on top of a low-level API. In at least one embodiment, one or more of runtime APIs may be language-specific APIs that are layered on top of a language-independent runtime API.

In at least one embodiment, device kernel driver 2806 is configured to facilitate communication with an underlying device. In at least one embodiment, device kernel driver 2806 may provide low-level functionalities upon which APIs, such as API(s) 2804, and/or other software relies. In at least one embodiment, device kernel driver 2806 may be configured to compile intermediate representation (“IR”) code into binary code at runtime. For CUDA, device kernel driver 2806 may compile Parallel Thread Execution (“PTX”) IR code that is not hardware specific into binary code for a specific target device at runtime (with caching of compiled binary code), which is also sometimes referred to as “finalizing” code, in at least one embodiment. Doing so may permit finalized code to run on a target device, which may not have existed when source code was originally compiled into PTX code, in at least one embodiment. Alternatively, in at least one embodiment, device source code may be compiled into binary code offline, without requiring device kernel driver 2806 to compile IR code at runtime.

In at least one embodiment, at least a portion of the software stack 2800 may be used to implement the system 700 (see FIG. 7) and/or the system 800 (see FIG. 8). In at least one embodiment, one or more systems depicted in FIG. 28 are utilized to detect and/or predict signals conducted by a signal conductor (e.g., within a multi-GPU system) and transition the signal conductor between active and inactive states with various algorithms, formulas, and/or processes, such as those described in connection with FIGS. 1-8 and/or otherwise perform operations described herein. In at least one embodiment, one or more systems depicted in FIG. 28 are utilized to implement one or more systems and/or processes such as those described in connection with FIGS. 1-8.

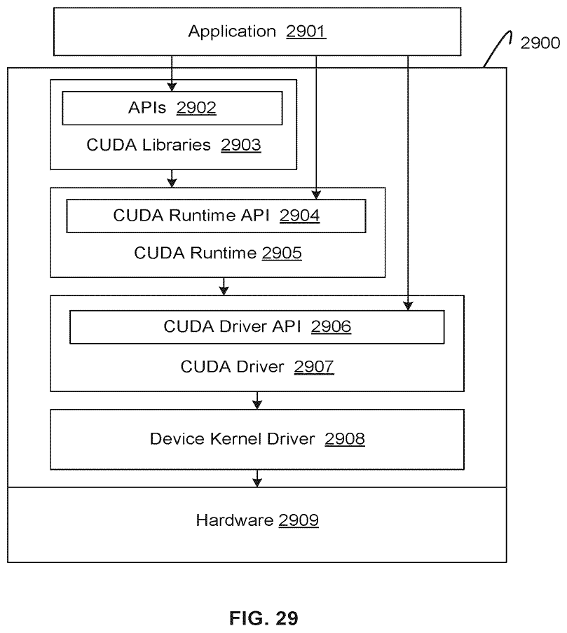

FIG. 29 illustrates a CUDA implementation of software stack 2800 of FIG. 28, in accordance with at least one embodiment. In at least one embodiment, a CUDA software stack 2900, on which an application 2901 may be launched, includes CUDA libraries 2903, a CUDA runtime 2905, a CUDA driver 2907, and a device kernel driver 2908. In at least one embodiment, CUDA software stack 2900 executes on hardware 2909, which may include a GPU that supports CUDA and is developed by NVIDIA Corporation of Santa Clara, CA.

In at least one embodiment, application 2901, CUDA runtime 2905, and device kernel driver 2908 may perform similar functionalities as application 2801, runtime 2805, and device kernel driver 2806, respectively, which are described above in conjunction with FIG. 28. In at least one embodiment, CUDA driver 2907 includes a library (libcuda.so) that implements a CUDA driver API 2906. Similar to a CUDA runtime API 2904 implemented by a CUDA runtime library (cudart), CUDA driver API 2906 may, without limitation, expose functions for memory management, execution control, device management, error handling, synchronization, and/or graphics interoperability, among other things, in at least one embodiment. In at least one embodiment, CUDA driver API 2906 differs from CUDA runtime API 2904 in that CUDA runtime API 2904 simplifies device code management by providing implicit initialization, context (analogous to a process) management, and module (analogous to dynamically loaded libraries) management. In contrast to high-level CUDA runtime API 2904, CUDA driver API 2906 is a low-level API providing more fine-grained control of the device, particularly with respect to contexts and module loading, in at least one embodiment. In at least one embodiment, CUDA driver API 2906 may expose functions for context management that are not exposed by CUDA runtime API 2904. In at least one embodiment, CUDA driver API 2906 is also language-independent and supports, e.g., OpenCL in addition to CUDA runtime API 2904. Further, in at least one embodiment, development libraries, including CUDA runtime 2905, may be considered as separate from driver components, including user-mode CUDA driver 2907 and device kernel driver 2908 (also sometimes referred to as a “display” driver).

In at least one embodiment, CUDA libraries 2903 may include, but are not limited to, mathematical libraries, deep learning libraries, parallel algorithm libraries, and/or signal/image/video processing libraries, which parallel computing applications such as application 2901 may utilize. In at least one embodiment, CUDA libraries 2903 may include mathematical libraries such as a cuBLAS library that is an implementation of Basic Linear Algebra Subprograms (“BLAS”) for performing linear algebra operations, a cuFFT library for computing fast Fourier transforms (“FFTs”), and a cuRAND library for generating random numbers, among others. In at least one embodiment, CUDA libraries 2903 may include deep learning libraries such as a cuDNN library of primitives for deep neural networks and a TensorRT platform for high-performance deep learning inference, among others.

In at least one embodiment, at least a portion of the CUDA software stack 2900 may be used to implement the system 700 (see FIG. 7) and/or the system 800 (see FIG. 8). In at least one embodiment, one or more systems depicted in FIG. 29 are utilized to detect and/or predict signals conducted by a signal conductor (e.g., within a multi-GPU system) and transition the signal conductor between active and inactive states with various algorithms, formulas, and/or processes, such as those described in connection with FIGS. 1-8 and/or otherwise perform operations described herein. In at least one embodiment, one or more systems depicted in FIG. 29 are utilized to implement one or more systems and/or processes such as those described in connection with FIGS. 1-8.

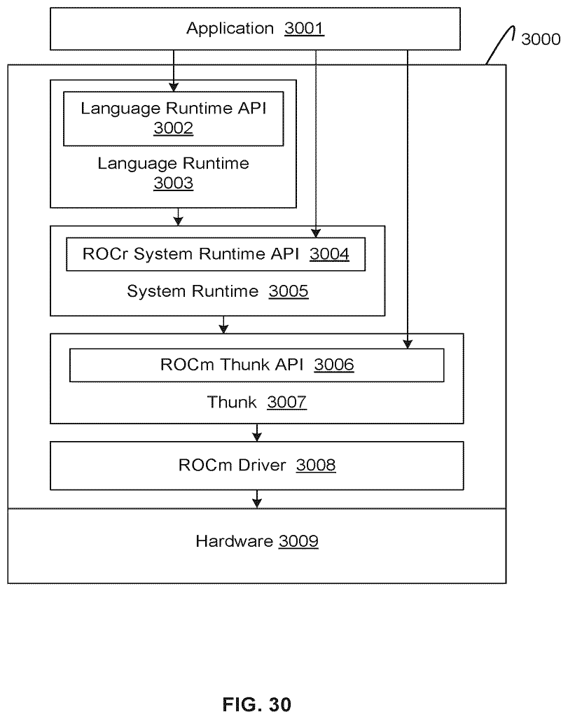

FIG. 30 illustrates a ROCm implementation of software stack 2800 of FIG. 28, in accordance with at least one embodiment. In at least one embodiment, a ROCm software stack 3000, on which an application 3001 may be launched, includes a language runtime 3003, a system runtime 3005, a thunk 3007, and a ROCm kernel driver 3008. In at least one embodiment, ROCm software stack 3000 executes on hardware 3009, which may include a GPU that supports ROCm and is developed by AMD Corporation of Santa Clara, CA.

In at least one embodiment, application 3001 may perform similar functionalities as application 2801 discussed above in conjunction with FIG. 28. In addition, language runtime 3003 and system runtime 3005 may perform similar functionalities as runtime 2805 discussed above in conjunction with FIG. 28, in at least one embodiment. In at least one embodiment, language runtime 3003 and system runtime 3005 differ in that system runtime 3005 is a language-independent runtime that implements a ROCr system runtime API 3004 and makes use of a Heterogeneous System Architecture (“HSA”) Runtime API. HSA runtime API is a thin, user-mode API that exposes interfaces to access and interact with an AMD GPU, including functions for memory management, execution control via architected dispatch of kernels, error handling, system and agent information, and runtime initialization and shutdown, among other things, in at least one embodiment. In contrast to system runtime 3005, language runtime 3003 is an implementation of a language-specific runtime API 3002 layered on top of ROCr system runtime API 3004, in at least one embodiment. In at least one embodiment, language runtime API may include, but is not limited to, a Heterogeneous compute Interface for Portability (“HIP”) language runtime API, a Heterogeneous Compute Compiler (“HCC”) language runtime API, or an OpenCL API, among others. HIP language in particular is an extension of C++ programming language with functionally similar versions of CUDA mechanisms, and, in at least one embodiment, a HIP language runtime API includes functions that are similar to those of CUDA runtime API 2904 discussed above in conjunction with FIG. 29, such as functions for memory management, execution control, device management, error handling, and synchronization, among other things.

In at least one embodiment, thunk (ROCt) 3007 is an interface 3006 that can be used to interact with underlying ROCm driver 3008. In at least one embodiment, ROCm driver 3008 is a ROCk driver, which is a combination of an AMDGPU driver and an HSA kernel driver (AMDKFD). In at least one embodiment, AMDGPU driver is a device kernel driver for GPUs developed by AMD that performs similar functionalities as device kernel driver 2806 discussed above in conjunction with FIG. 28. In at least one embodiment, HSA kernel driver is a driver permitting different types of processors to share system resources more effectively via hardware features.

In at least one embodiment, various libraries (not shown) may be included in ROCm software stack 3000 above language runtime 3003 and provide functionality similarity to CUDA libraries 2903, discussed above in conjunction with FIG. 29. In at least one embodiment, various libraries may include, but are not limited to, mathematical, deep learning, and/or other libraries such as a hipBLAS library that implements functions similar to those of CUDA cuBLAS, a rocFFT library for computing FFTs that is similar to CUDA cuFFT, among others.

In at least one embodiment, one or more systems depicted in FIG. 30 are utilized to detect and/or predict signals conducted by a signal conductor (e.g., within a multi-GPU system) and transition the signal conductor between active and inactive states with various algorithms, formulas, and/or processes, such as those described in connection with FIGS. 1-8 and/or otherwise perform operations described herein. In at least one embodiment, one or more systems depicted in FIG. 30 are utilized to implement one or more systems and/or processes such as those described in connection with FIGS. 1-8.

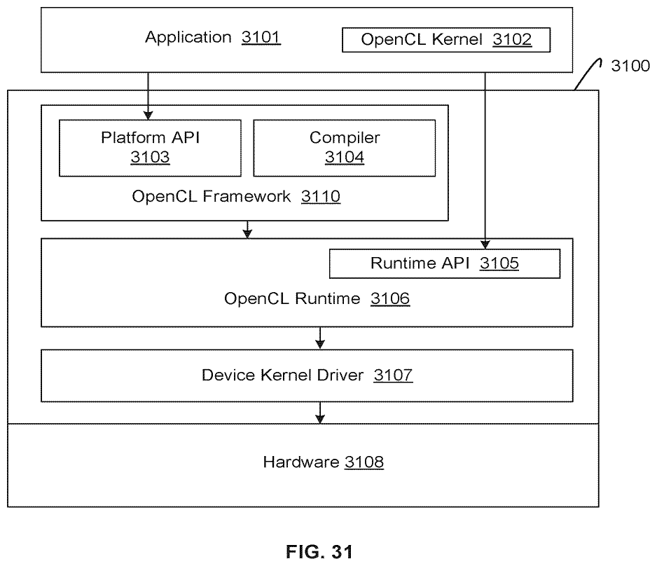

FIG. 31 illustrates an OpenCL implementation of software stack 2800 of FIG. 28, in accordance with at least one embodiment. In at least one embodiment, an OpenCL software stack 3100, on which an application 3101 may be launched, includes an OpenCL framework 3110, an OpenCL runtime 3106, and a device kernel driver 3107. In at least one embodiment, OpenCL software stack 3100 executes on hardware 2909 that is not vendor-specific. As OpenCL is supported by devices developed by different vendors, specific OpenCL drivers may be required to interoperate with hardware from such vendors, in at least one embodiment.

In at least one embodiment, application 3101, OpenCL runtime 3106, device kernel driver 3107, and hardware 3108 may perform similar functionalities as application 2801, runtime 2805, device kernel driver 2806, and hardware 2807, respectively, that are discussed above in conjunction with FIG. 28. In at least one embodiment, application 3101 further includes an OpenCL kernel 3102 with code that is to be executed on a device.

In at least one embodiment, OpenCL defines a “platform” that allows a host to control devices connected to the host. In at least one embodiment, an OpenCL framework provides a platform layer API and a runtime API, shown as platform API 3103 and runtime API 3105. In at least one embodiment, runtime API 3105 uses contexts to manage execution of kernels on devices. In at least one embodiment, each identified device may be associated with a respective context, which runtime API 3105 may use to manage command queues, program objects, and kernel objects, share memory objects, among other things, for that device. In at least one embodiment, platform API 3103 exposes functions that permit device contexts to be used to select and initialize devices, submit work to devices via command queues, and enable data transfer to and from devices, among other things. In addition, OpenCL framework provides various built-in functions (not shown), including math functions, relational functions, and image processing functions, among others, in at least one embodiment.

In at least one embodiment, a compiler 3104 is also included in OpenCL framework 3110. Source code may be compiled offline prior to executing an application or online during execution of an application, in at least one embodiment. In contrast to CUDA and ROCm, OpenCL applications in at least one embodiment may be compiled online by compiler 3104, which is included to be representative of any number of compilers that may be used to compile source code and/or IR code, such as Standard Portable Intermediate Representation (“SPIR-V”) code, into binary code. Alternatively, in at least one embodiment, OpenCL applications may be compiled offline, prior to execution of such applications.

In at least one embodiment, one or more systems depicted in FIG. 31 are utilized to detect and/or predict signals conducted by a signal conductor (e.g., within a multi-GPU system) and transition the signal conductor between active and inactive states with various algorithms, formulas, and/or processes, such as those described in connection with FIGS. 1-8 and/or otherwise perform operations described herein. In at least one embodiment, one or more systems depicted in FIG. 31 are utilized to implement one or more systems and/or processes such as those described in connection with FIGS. 1-8.

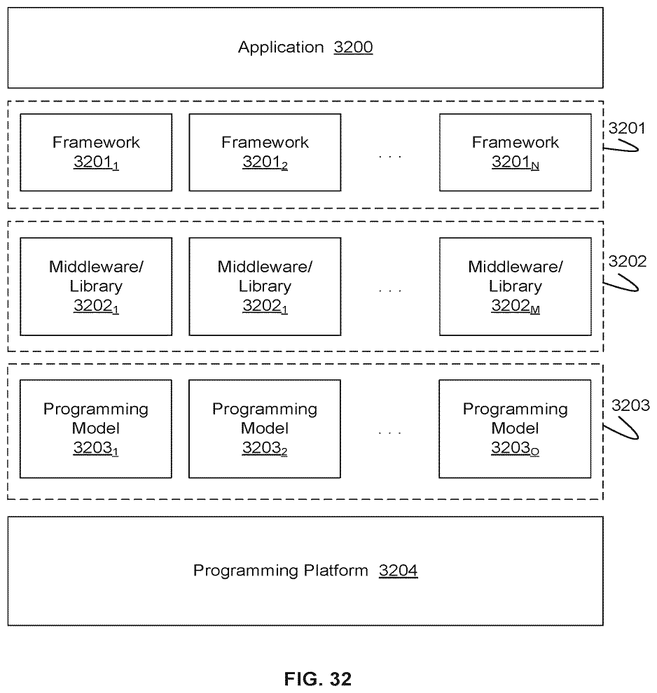

FIG. 32 illustrates software that is supported by a programming platform, in accordance with at least one embodiment. In at least one embodiment, a programming platform 3204 is configured to support various programming models 3203, middlewares and/or libraries 3202, and frameworks 3201 that an application 3200 may rely upon. In at least one embodiment, application 3200 may be an AI/ML application implemented using, for example, a deep learning framework such as MXNet, PyTorch, or TensorFlow, which may rely on libraries such as cuDNN, NVIDIA Collective Communications Library (“NCCL”), and/or NVIDA Developer Data Loading Library (“DALI”) CUDA libraries to provide accelerated computing on underlying hardware.

In at least one embodiment, programming platform 3204 may be one of a CUDA, ROCm, or OpenCL platform described above in conjunction with FIG. 29, FIG. 30, and FIG. 31, respectively. In at least one embodiment, programming platform 3204 supports multiple programming models 3203, which are abstractions of an underlying computing system permitting expressions of algorithms and data structures. Programming models 3203 may expose features of underlying hardware in order to improve performance, in at least one embodiment. In at least one embodiment, programming models 3203 may include, but are not limited to, CUDA, HIP, OpenCL, C++ Accelerated Massive Parallelism (“C++ AMP”), Open Multi-Processing (“OpenMP”), Open Accelerators (“OpenACC”), and/or Vulcan Compute.

In at least one embodiment, middleware and/or library 3202 provide implementations of abstractions of programming models 3204. In at least one embodiment, such libraries include data and programming code that may be used by computer programs and leveraged during software development. In at least one embodiment, such middlewares include software that provides services to applications beyond those available from programming platform 3204. In at least one embodiment, middleware and/or library 3202 may include, but are not limited to, cuBLAS, cuFFT, cuRAND, and other CUDA libraries, or rocBLAS, rocFFT, rocRAND, and other ROCm libraries. In addition, in at least one embodiment, middleware and/or library 3202 may include NCCL and ROCm Communication Collectives Library (“RCCL”) libraries providing communication routines for GPUs, a MIOpen library for deep learning acceleration, and/or an Eigen library for linear algebra, matrix and vector operations, geometrical transformations, numerical solvers, and related algorithms.

In at least one embodiment, application frameworks 3201 depend on middleware and/or library 3202. In at least one embodiment, each of application frameworks 3201 is a software framework used to implement a standard structure of application software. Returning to the AI/ML example discussed above, an AI/ML application may be implemented using a framework such as Caffe, Caffe2, TensorFlow, Keras, PyTorch, or MxNet deep learning frameworks, in at least one embodiment.

In at least one embodiment, one or more systems depicted in FIG. 32 are utilized to detect and/or predict signals conducted by a signal conductor (e.g., within a multi-GPU system) and transition the signal conductor between active and inactive states with various algorithms, formulas, and/or processes, such as those described in connection with FIGS. 1-8 and/or otherwise perform operations described herein. In at least one embodiment, one or more systems depicted in FIG. 32 are utilized to implement one or more systems and/or processes such as those described in connection with FIGS. 1-8.

FIG. 33 illustrates compiling code to execute on one of programming platforms of FIGS. 28-31, in accordance with at least one embodiment. In at least one embodiment, a compiler 3301 receives source code 3300 that includes both host code as well as device code. In at least one embodiment, compiler 3301 is configured to convert source code 3300 into host executable code 3302 for execution on a host and device executable code 3303 for execution on a device. In at least one embodiment, source code 3300 may either be compiled offline prior to execution of an application, or online during execution of an application.

In at least one embodiment, source code 3300 may include code in any programming language supported by compiler 3301, such as C++, C, Fortran, etc. In at least one embodiment, source code 3300 may be included in a single-source file having a mixture of host code and device code, with locations of device code being indicated therein. In at least one embodiment, a single-source file may be a.cu file that includes CUDA code or a.hip.cpp file that includes HIP code. Alternatively, in at least one embodiment, source code 3300 may include multiple source code files, rather than a single-source file, into which host code and device code are separated.

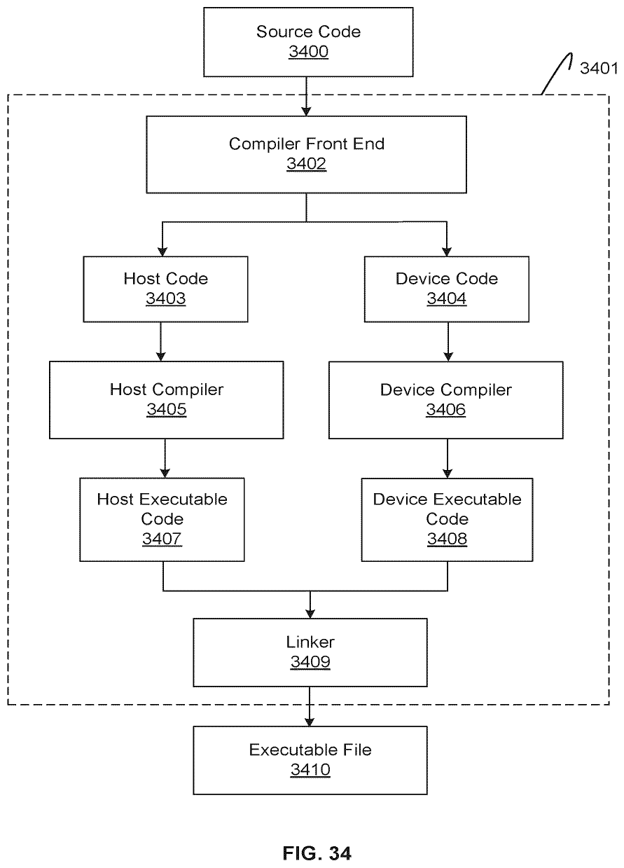

In at least one embodiment, compiler 3301 is configured to compile source code 3300 into host executable code 3302 for execution on a host and device executable code 3303 for execution on a device. In at least one embodiment, compiler 3301 performs operations including parsing source code 3300 into an abstract system tree (AST), performing optimizations, and generating executable code. In at least one embodiment in which source code 3300 includes a single-source file, compiler 3301 may separate device code from host code in such a single-source file, compile device code and host code into device executable code 3303 and host executable code 3302, respectively, and link device executable code 3303 and host executable code 3302 together in a single file, as discussed in greater detail below with respect to FIG. 34.

In at least one embodiment, host executable code 3302 and device executable code 3303 may be in any suitable format, such as binary code and/or IR code. In the case of CUDA, host executable code 3302 may include native object code and device executable code 3303 may include code in PTX intermediate representation, in at least one embodiment. In the case of ROCm, both host executable code 3302 and device executable code 3303 may include target binary code, in at least one embodiment.

In at least one embodiment, one or more systems depicted in FIG. 33 are utilized to detect and/or predict signals conducted by a signal conductor (e.g., within a multi-GPU system) and transition the signal conductor between active and inactive states with various algorithms, formulas, and/or processes, such as those described in connection with FIGS. 1-8 and/or otherwise perform operations described herein. In at least one embodiment, one or more systems depicted in FIG. 33 are utilized to implement one or more systems and/or processes such as those described in connection with FIGS. 1-8.

FIG. 34 is a more detailed illustration of compiling code to execute on one of programming platforms of FIGS. 28-31, in accordance with at least one embodiment. In at least one embodiment, a compiler 3401 is configured to receive source code 3400, compile source code 3400, and output an executable file 3410. In at least one embodiment, source code 3400 is a single-source file, such as a.cu file, a.hip.cpp file, or a file in another format, that includes both host and device code. In at least one embodiment, compiler 3401 may be, but is not limited to, an NVIDIA CUDA compiler (“NVCC”) for compiling CUDA code in.cu files, or an HCC compiler for compiling HIP code in.hip.cpp files.

In at least one embodiment, compiler 3401 includes a compiler front end 3402, a host compiler 3405, a device compiler 3406, and a linker 3409. In at least one embodiment, compiler front end 3402 is configured to separate device code 3404 from host code 3403 in source code 3400. Device code 3404 is compiled by device compiler 3406 into device executable code 3408, which as described may include binary code or IR code, in at least one embodiment. Separately, host code 3403 is compiled by host compiler 3405 into host executable code 3407, in at least one embodiment. For NVCC, host compiler 3405 may be, but is not limited to, a general purpose C/C++ compiler that outputs native object code, while device compiler 3406 may be, but is not limited to, a Low Level Virtual Machine (“LLVM”)-based compiler that forks a LLVM compiler infrastructure and outputs PTX code or binary code, in at least one embodiment. For HCC, both host compiler 3405 and device compiler 3406 may be, but are not limited to, LLVM-based compilers that output target binary code, in at least one embodiment.

Subsequent to compiling source code 3400 into host executable code 3407 and device executable code 3408, linker 3409 links host executable code 3407 and device executable code 3408 together in executable file 3410, in at least one embodiment. In at least one embodiment, native object code for a host and PTX or binary code for a device may be linked together in an Executable and Linkable Format (“ELF”) file, which is a container format used to store object code.

In at least one embodiment, one or more systems depicted in FIG. 34 are utilized to detect and/or predict signals conducted by a signal conductor (e.g., within a multi-GPU system) and transition the signal conductor between active and inactive states with various algorithms, formulas, and/or processes, such as those described in connection with FIGS. 1-8 and/or otherwise perform operations described herein. In at least one embodiment, one or more systems depicted in FIG. 34 are utilized to implement one or more systems and/or processes such as those described in connection with FIGS. 1-8.

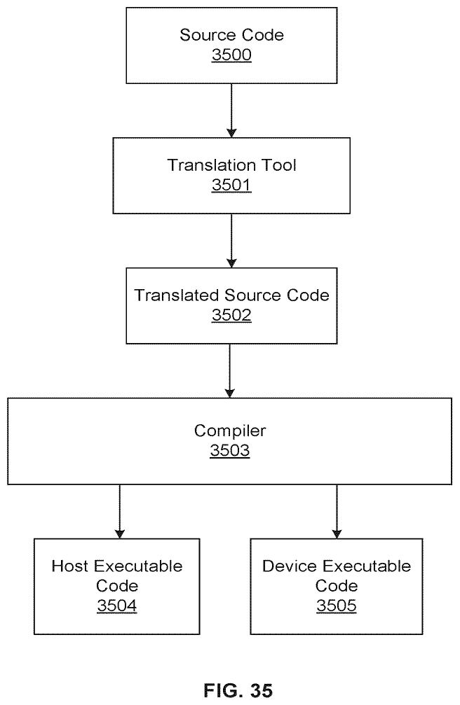

FIG. 35 illustrates translating source code prior to compiling source code, in accordance with at least one embodiment. In at least one embodiment, source code 3500 is passed through a translation tool 3501, which translates source code 3500 into translated source code 3502. In at least one embodiment, a compiler 3503 is used to compile translated source code 3502 into host executable code 3504 and device executable code 3505 in a process that is similar to compilation of source code 3300 by compiler 3301 into host executable code 3302 and device executable code 3303, as discussed above in conjunction with FIG. 33.

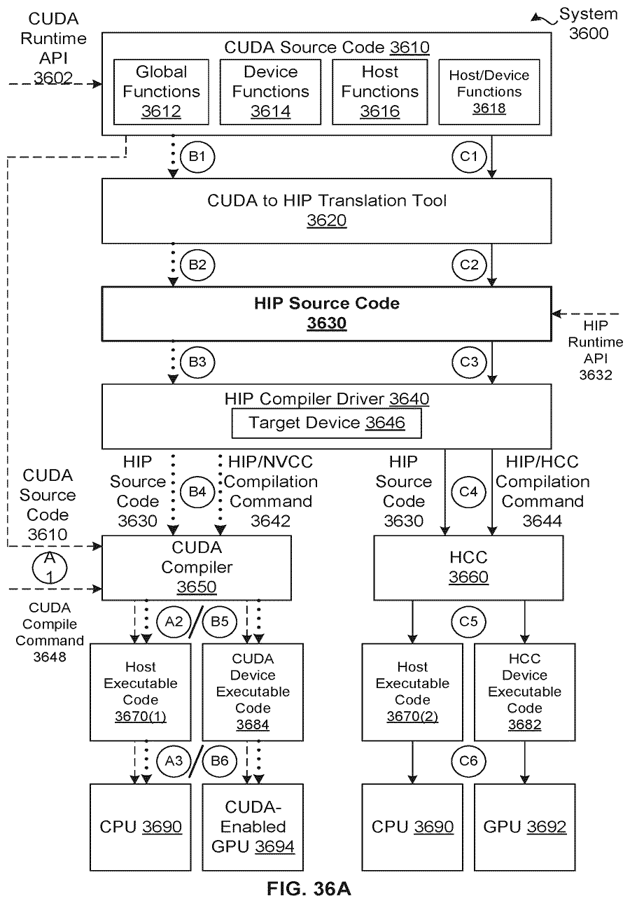

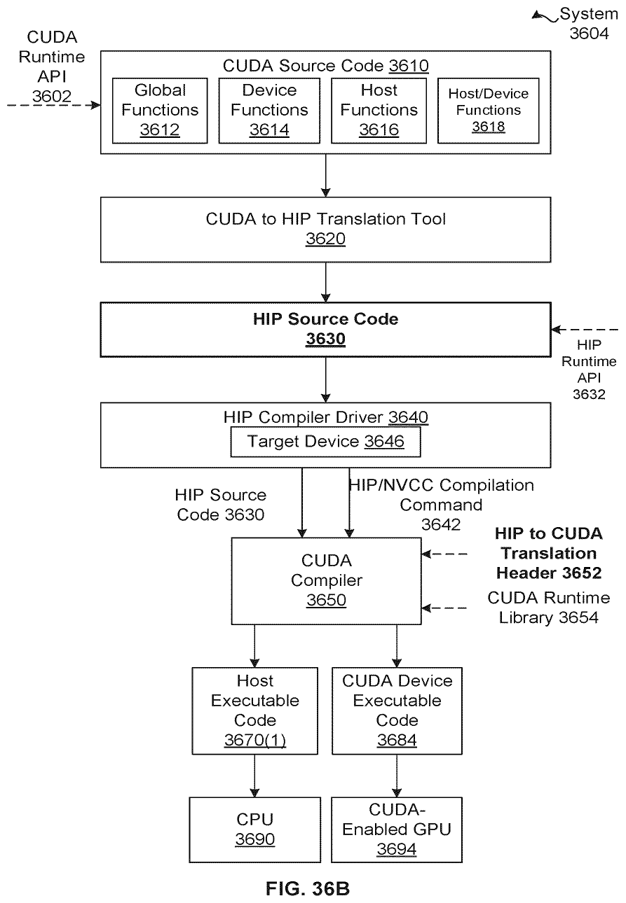

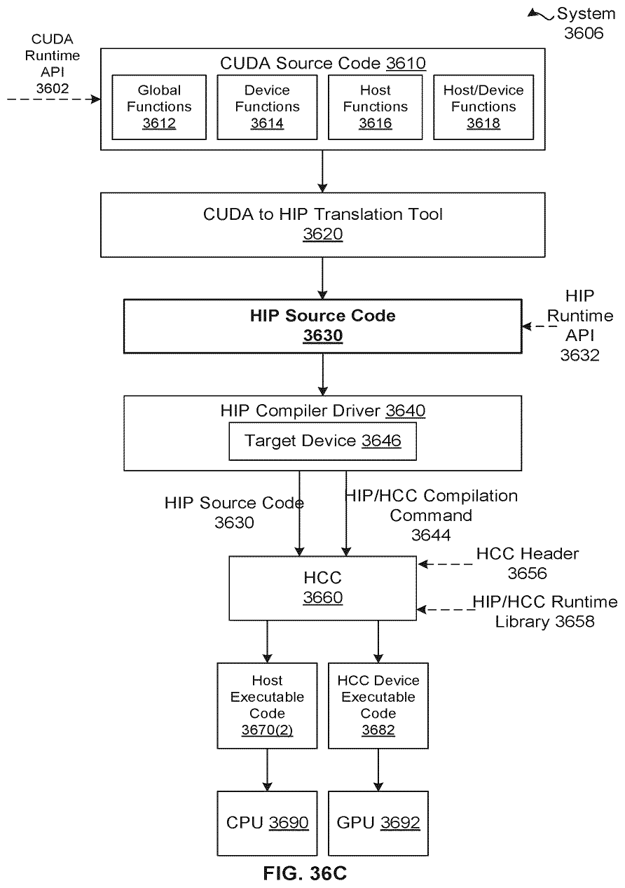

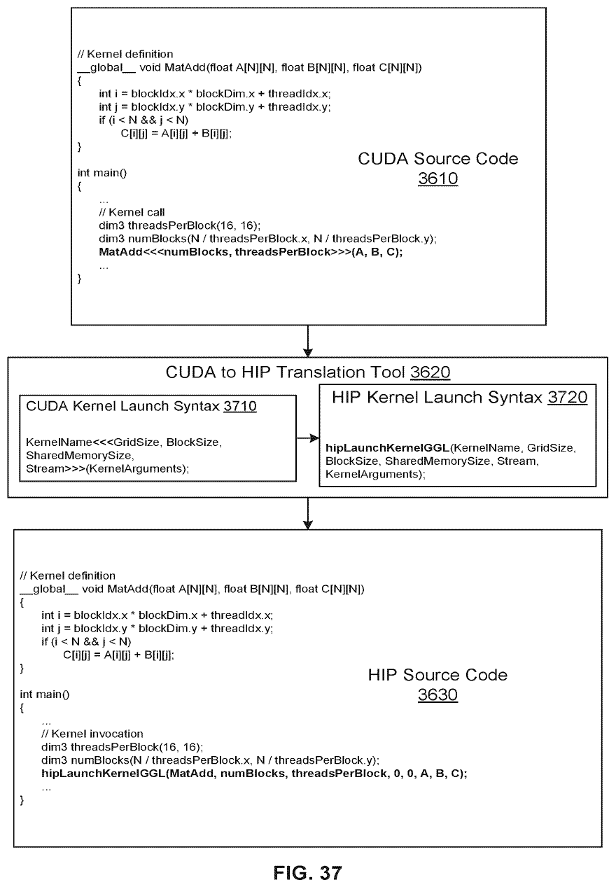

In at least one embodiment, a translation performed by translation tool 3501 is used to port source 3500 for execution in a different environment than that in which it was originally intended to run. In at least one embodiment, translation tool 3501 may include, but is not limited to, a HIP translator that is used to “hipify” CUDA code intended for a CUDA platform into HIP code that can be compiled and executed on a ROCm platform. In at least one embodiment, translation of source code 3500 may include parsing source code 3500 and converting calls to API(s) provided by one programming model (e.g., CUDA) into corresponding calls to API(s) provided by another programming model (e.g., HIP), as discussed in greater detail below in conjunction with FIGS. 36A-37. Returning to the example of hipifying CUDA code, calls to CUDA runtime API, CUDA driver API, and/or CUDA libraries may be converted to corresponding HIP API calls, in at least one embodiment. In at least one embodiment, automated translations performed by translation tool 3501 may sometimes be incomplete, requiring additional, manual effort to fully port source code 3500.

In at least one embodiment, one or more systems depicted in FIG. 35 are utilized to detect and/or predict signals conducted by a signal conductor (e.g., within a multi-GPU system) and transition the signal conductor between active and inactive states with various algorithms, formulas, and/or processes, such as those described in connection with FIGS. 1-8 and/or otherwise perform operations described herein. In at least one embodiment, one or more systems depicted in FIG. 35 are utilized to implement one or more systems and/or processes such as those described in connection with FIGS. 1-8.

### Configuring GPUS for General-Purpose Computing

The following figures set forth, without limitation, example architectures for compiling and executing compute source code, in accordance with at least one embodiment.

FIG. 36A illustrates a system 36A00 configured to compile and execute CUDA source code 3610 using different types of processing units, in accordance with at least one embodiment. In at least one embodiment, system 36A00 includes, without limitation, CUDA source code 3610, a CUDA compiler 3650, host executable code 3670(1), host executable code 3670(2), CUDA device executable code 3684, a CPU 3690, a CUDA-enabled GPU 3694, a GPU 3692, a CUDA to HIP translation tool 3620, HIP source code 3630, a HIP compiler driver 3640, an HCC 3660, and HCC device executable code 3682.

In at least one embodiment, CUDA source code 3610 is a collection of human-readable code in a CUDA programming language. In at least one embodiment, CUDA code is human-readable code in a CUDA programming language. In at least one embodiment, a CUDA programming language is an extension of the C++ programming language that includes, without limitation, mechanisms to define device code and distinguish between device code and host code. In at least one embodiment, device code is source code that, after compilation, is executable in parallel on a device. In at least one embodiment, a device may be a processor that is optimized for parallel instruction processing, such as CUDA-enabled CPU 3690, GPU 3692, or another GPGPU, etc. In at least one embodiment, host code is source code that, after compilation, is executable on a host. In at least one embodiment, a host is a processor that is optimized for sequential instruction processing, such as CPU 3690.

In at least one embodiment, CUDA source code 3610 includes, without limitation, any number (including zero) of global functions 3612, any number (including zero) of device functions 3614, any number (including zero) of host functions 3616, and any number (including zero) of host/device functions 3618. In at least one embodiment, global functions 3612, device functions 3614, host functions 3616, and host/device functions 3618 may be mixed in CUDA source code 3610. In at least one embodiment, each of global functions 3612 is executable on a device and callable from a host. In at least one embodiment, one or more of global functions 3612 may therefore act as entry points to a device. In at least one embodiment, each of global functions 3612 is a kernel. In at least one embodiment and in a technique known as dynamic parallelism, one or more of global functions 3612 defines a kernel that is executable on a device and callable from such a device. In at least one embodiment, a kernel is executed N (where N is any positive integer) times in parallel by N different threads on a device during execution.

In at least one embodiment, each of device functions 3614 is executed on a device and callable from such a device only. In at least one embodiment, each of host functions 3616 is executed on a host and callable from such a host only. In at least one embodiment, each of host/device functions 3616 defines both a host version of a function that is executable on a host and callable from such a host only and a device version of the function that is executable on a device and callable from such a device only.

In at least one embodiment, CUDA source code 3610 may also include, without limitation, any number of calls to any number of functions that are defined via a CUDA runtime API 3602. In at least one embodiment, CUDA runtime API 3602 may include, without limitation, any number of functions that execute on a host to allocate and deallocate device memory, transfer data between host memory and device memory, manage systems with multiple devices, etc. In at least one embodiment, CUDA source code 3610 may also include any number of calls to any number of functions that are specified in any number of other CUDA APIs. In at least one embodiment, a CUDA API may be any API that is designed for use by CUDA code. In at least one embodiment, CUDA APIs include, without limitation, CUDA runtime API 3602, a CUDA driver API, APIs for any number of CUDA libraries, etc. In at least one embodiment and relative to CUDA runtime API 3602, a CUDA driver API is a lower-level API but provides finer-grained control of a device. In at least one embodiment, examples of CUDA libraries include, without limitation, cuBLAS, cuFFT, cuRAND, cuDNN, etc.

In at least one embodiment, CUDA compiler 3650 compiles input CUDA code (e.g., CUDA source code 3610) to generate host executable code 3670(1) and CUDA device executable code 3684. In at least one embodiment, CUDA compiler 3650 is NVCC. In at least one embodiment, host executable code 3670(1) is a compiled version of host code included in input source code that is executable on CPU 3690. In at least one embodiment, CPU 3690 may be any processor that is optimized for sequential instruction processing.

In at least one embodiment, CUDA device executable code 3684 is a compiled version of device code included in input source code that is executable on CUDA-enabled GPU 3694. In at least one embodiment, CUDA device executable code 3684 includes, without limitation, binary code. In at least one embodiment, CUDA device executable code 3684 includes, without limitation, IR code, such as PTX code, that is further compiled at runtime into binary code for a specific target device (e.g., CUDA-enabled GPU 3694) by a device driver. In at least one embodiment, CUDA-enabled GPU 3694 may be any processor that is optimized for parallel instruction processing and that supports CUDA. In at least one embodiment, CUDA-enabled GPU 3694 is developed by NVIDIA Corporation of Santa Clara, CA.

In at least one embodiment, CUDA to HIP translation tool 3620 is configured to translate CUDA source code 3610 to functionally similar HIP source code 3630. In a least one embodiment, HIP source code 3630 is a collection of human-readable code in a HIP programming language. In at least one embodiment, HIP code is human-readable code in a HIP programming language. In at least one embodiment, a HIP programming language is an extension of the C++ programming language that includes, without limitation, functionally similar versions of CUDA mechanisms to define device code and distinguish between device code and host code. In at least one embodiment, a HIP programming language may include a subset of functionality of a CUDA programming language. In at least one embodiment, for example, a HIP programming language includes, without limitation, mechanism(s) to define global functions 3612, but such a HIP programming language may lack support for dynamic parallelism and therefore global functions 3612 defined in HIP code may be callable from a host only.

In at least one embodiment, HIP source code 3630 includes, without limitation, any number (including zero) of global functions 3612, any number (including zero) of device functions 3614, any number (including zero) of host functions 3616, and any number (including zero) of host/device functions 3618. In at least one embodiment, HIP source code 3630 may also include any number of calls to any number of functions that are specified in a HIP runtime API 3632. In at least one embodiment, HIP runtime API 3632 includes, without limitation, functionally similar versions of a subset of functions included in CUDA runtime API 3602. In at least one embodiment, HIP source code 3630 may also include any number of calls to any number of functions that are specified in any number of other HIP APIs. In at least one embodiment, a HIP API may be any API that is designed for use by HIP code and/or ROCm. In at least one embodiment, HIP APIs include, without limitation, HIP runtime API 3632, a HIP driver API, APIs for any number of HIP libraries, APIs for any number of ROCm libraries, etc.

In at least one embodiment, CUDA to HIP translation tool 3620 converts each kernel call in CUDA code from a CUDA syntax to a HIP syntax and converts any number of other CUDA calls in CUDA code to any number of other functionally similar HIP calls. In at least one embodiment, a CUDA call is a call to a function specified in a CUDA API, and a HIP call is a call to a function specified in a HIP API. In at least one embodiment, CUDA to HIP translation tool 3620 converts any number of calls to functions specified in CUDA runtime API 3602 to any number of calls to functions specified in HIP runtime API 3632.

In at least one embodiment, CUDA to HIP translation tool 3620 is a tool known as hipify-perl that executes a text-based translation process. In at least one embodiment, CUDA to HIP translation tool 3620 is a tool known as hipify-clang that, relative to hipify-perl, executes a more complex and more robust translation process that involves parsing CUDA code using clang (a compiler front-end) and then translating resulting symbols. In at least one embodiment, properly converting CUDA code to HIP code may require modifications (e.g., manual edits) in addition to those performed by CUDA to HIP translation tool 3620.

In at least one embodiment, HIP compiler driver 3640 is a front end that determines a target device 3646 and then configures a compiler that is compatible with target device 3646 to compile HIP source code 3630. In at least one embodiment, target device 3646 is a processor that is optimized for parallel instruction processing. In at least one embodiment, HIP compiler driver 3640 may determine target device 3646 in any technically feasible fashion.

In at least one embodiment, if target device 3646 is compatible with CUDA (e.g., CUDA-enabled GPU 3694), then HIP compiler driver 3640 generates a HIP/NVCC compilation command 3642. In at least one embodiment and as described in greater detail in conjunction with FIG. 36B, HIP/NVCC compilation command 3642 configures CUDA compiler 3650 to compile HIP source code 3630 using, without limitation, a HIP to CUDA translation header and a CUDA runtime library. In at least one embodiment and in response to HIP/NVCC compilation command 3642, CUDA compiler 3650 generates host executable code 3670(1) and CUDA device executable code 3684.

In at least one embodiment, if target device 3646 is not compatible with CUDA, then HIP compiler driver 3640 generates a HIP/HCC compilation command 3644. In at least one embodiment and as described in greater detail in conjunction with FIG. 36C, HIP/HCC compilation command 3644 configures HCC 3660 to compile HIP source code 3630 using, without limitation, an HCC header and a HIP/HCC runtime library. In at least one embodiment and in response to HIP/HCC compilation command 3644, HCC 3660 generates host executable code 3670(2) and HCC device executable code 3682. In at least one embodiment, HCC device executable code 3682 is a compiled version of device code included in HIP source code 3630 that is executable on GPU 3692. In at least one embodiment, GPU 3692 may be any processor that is optimized for parallel instruction processing, is not compatible with CUDA, and is compatible with HCC. In at least one embodiment, GPU 3692 is developed by AMD Corporation of Santa Clara, CA. In at least one embodiment GPU, 3692 is a non-CUDA-enabled GPU 3692.

For explanatory purposes only, three different flows that may be implemented in at least one embodiment to compile CUDA source code 3610 for execution on CPU 3690 and different devices are depicted in FIG. 36A. In at least one embodiment, a direct CUDA flow compiles CUDA source code 3610 for execution on CPU 3690 and CUDA-enabled GPU 3694 without translating CUDA source code 3610 to HIP source code 3630. In at least one embodiment, an indirect CUDA flow translates CUDA source code 3610 to HIP source code 3630 and then compiles HIP source code 3630 for execution on CPU 3690 and CUDA-enabled GPU 3694. In at least one embodiment, a CUDA/HCC flow translates CUDA source code 3610 to HIP source code 3630 and then compiles HIP source code 3630 for execution on CPU 3690 and GPU 3692.

A direct CUDA flow that may be implemented in at least one embodiment is depicted via dashed lines and a series of bubbles annotated A1-A3. In at least one embodiment and as depicted with bubble annotated A1, CUDA compiler 3650 receives CUDA source code 3610 and a CUDA compile command 3648 that configures CUDA compiler 3650 to compile CUDA source code 3610. In at least one embodiment, CUDA source code 3610 used in a direct CUDA flow is written in a CUDA programming language that is based on a programming language other than C++ (e.g., C, Fortran, Python, Java, etc.). In at least one embodiment and in response to CUDA compile command 3648, CUDA compiler 3650 generates host executable code 3670(1) and CUDA device executable code 3684 (depicted with bubble annotated A2). In at least one embodiment and as depicted with bubble annotated A3, host executable code 3670(1) and CUDA device executable code 3684 may be executed on, respectively, CPU 3690 and CUDA-enabled GPU 3694. In at least one embodiment, CUDA device executable code 3684 includes, without limitation, binary code. In at least one embodiment, CUDA device executable code 3684 includes, without limitation, PTX code and is further compiled into binary code for a specific target device at runtime.

An indirect CUDA flow that may be implemented in at least one embodiment is depicted via dotted lines and a series of bubbles annotated B1-B6. In at least one embodiment and as depicted with bubble annotated B1, CUDA to HIP translation tool 3620 receives CUDA source code 3610. In at least one embodiment and as depicted with bubble annotated B2, CUDA to HIP translation tool 3620 translates CUDA source code 3610 to HIP source code 3630. In at least one embodiment and as depicted with bubble annotated B3, HIP compiler driver 3640 receives HIP source code 3630 and determines that target device 3646 is CUDA-enabled.

In at least one embodiment and as depicted with bubble annotated B4, HIP compiler driver 3640 generates HIP/NVCC compilation command 3642 and transmits both HIP/NVCC compilation command 3642 and HIP source code 3630 to CUDA compiler 3650. In at least one embodiment and as described in greater detail in conjunction with FIG. 36B, HIP/NVCC compilation command 3642 configures CUDA compiler 3650 to compile HIP source code 3630 using, without limitation, a HIP to CUDA translation header and a CUDA runtime library. In at least one embodiment and in response to HIP/NVCC compilation command 3642, CUDA compiler 3650 generates host executable code 3670(1) and CUDA device executable code 3684 (depicted with bubble annotated B5). In at least one embodiment and as depicted with bubble annotated B6, host executable code 3670(1) and CUDA device executable code 3684 may be executed on, respectively, CPU 3690 and CUDA-enabled GPU 3694. In at least one embodiment, CUDA device executable code 3684 includes, without limitation, binary code. In at least one embodiment, CUDA device executable code 3684 includes, without limitation, PTX code and is further compiled into binary code for a specific target device at runtime.

A CUDA/HCC flow that may be implemented in at least one embodiment is depicted via solid lines and a series of bubbles annotated C1-C6. In at least one embodiment and as depicted with bubble annotated C1, CUDA to HIP translation tool 3620 receives CUDA source code 3610. In at least one embodiment and as depicted with bubble annotated C2, CUDA to HIP translation tool 3620 translates CUDA source code 3610 to HIP source code 3630. In at least one embodiment and as depicted with bubble annotated C3, HIP compiler driver 3640 receives HIP source code 3630 and determines that target device 3646 is not CUDA-enabled.

In at least one embodiment, HIP compiler driver 3640 generates HIP/HCC compilation command 3644 and transmits both HIP/HCC compilation command 3644 and HIP source code 3630 to HCC 3660 (depicted with bubble annotated C4). In at least one embodiment and as described in greater detail in conjunction with FIG. 36C, HIP/HCC compilation command 3644 configures HCC 3660 to compile HIP source code 3630 using, without limitation, an HCC header and a HIP/HCC runtime library. In at least one embodiment and in response to HIP/HCC compilation command 3644, HCC 3660 generates host executable code 3670(2) and HCC device executable code 3682 (depicted with bubble annotated C5). In at least one embodiment and as depicted with bubble annotated C6, host executable code 3670(2) and HCC device executable code 3682 may be executed on, respectively, CPU 3690 and GPU 3692.

In at least one embodiment, after CUDA source code 3610 is translated to HIP source code 3630, HIP compiler driver 3640 may subsequently be used to generate executable code for either CUDA-enabled GPU 3694 or GPU 3692 without re-executing CUDA to HIP translation tool 3620. In at least one embodiment, CUDA to HIP translation tool 3620 translates CUDA source code 3610 to HIP source code 3630 that is then stored in memory. In at least one embodiment, HIP compiler driver 3640 then configures HCC 3660 to generate host executable code 3670(2) and HCC device executable code 3682 based on HIP source code 3630. In at least one embodiment, HIP compiler driver 3640 subsequently configures CUDA compiler 3650 to generate host executable code 3670(1) and CUDA device executable code 3684 based on stored HIP source code 3630.

FIG. 36B illustrates a system 3604 configured to compile and execute CUDA source code 3610 of FIG. 36 A using CPU 3690 and CUDA-enabled GPU 3694, in accordance with at least one embodiment. In at least one embodiment, system 3604 includes, without limitation, CUDA source code 3610, CUDA to HIP translation tool 3620, HIP source code 3630, HIP compiler driver 3640, CUDA compiler 3650, host executable code 3670(1), CUDA device executable code 3684, CPU 3690, and CUDA-enabled GPU 3694.

In at least one embodiment and as described previously herein in conjunction with FIG. 36A, CUDA source code 3610 includes, without limitation, any number (including zero) of global functions 3612, any number (including zero) of device functions 3614, any number (including zero) of host functions 3616, and any number (including zero) of host/device functions 3618. In at least one embodiment, CUDA source code 3610 also includes, without limitation, any number of calls to any number of functions that are specified in any number of CUDA APIs.

In at least one embodiment, CUDA to HIP translation tool 3620 translates CUDA source code 3610 to HIP source code 3630. In at least one embodiment, CUDA to HIP translation tool 3620 converts each kernel call in CUDA source code 3610 from a CUDA syntax to a HIP syntax and converts any number of other CUDA calls in CUDA source code 3610 to any number of other functionally similar HIP calls.

In at least one embodiment, HIP compiler driver 3640 determines that target device 3646 is CUDA-enabled and generates HIP/NVCC compilation command 3642. In at least one embodiment, HIP compiler driver 3640 then configures CUDA compiler 3650 via HIP/NVCC compilation command 3642 to compile HIP source code 3630. In at least one embodiment, HIP compiler driver 3640 provides access to a HIP to CUDA translation header 3652 as part of configuring CUDA compiler 3650. In at least one embodiment, HIP to CUDA translation header 3652 translates any number of mechanisms (e.g., functions) specified in any number of HIP APIs to any number of mechanisms specified in any number of CUDA APIs. In at least one embodiment, CUDA compiler 3650 uses HIP to CUDA translation header 3652 in conjunction with a CUDA runtime library 3654 corresponding to CUDA runtime API 3602 to generate host executable code 3670(1) and CUDA device executable code 3684. In at least one embodiment, host executable code 3670(1) and CUDA device executable code 3684 may then be executed on, respectively, CPU 3690 and CUDA-enabled GPU 3694. In at least one embodiment, CUDA device executable code 3684 includes, without limitation, binary code. In at least one embodiment, CUDA device executable code 3684 includes, without limitation, PTX code and is further compiled into binary code for a specific target device at runtime.

FIG. 36C illustrates a system 3606 configured to compile and execute CUDA source code 3610 of FIG. 36A using CPU 3690 and non-CUDA-enabled GPU 3692, in accordance with at least one embodiment. In at least one embodiment, system 3606 includes, without limitation, CUDA source code 3610, CUDA to HIP translation tool 3620, HIP source code 3630, HIP compiler driver 3640, HCC 3660, host executable code 3670(2), HCC device executable code 3682, CPU 3690, and GPU 3692.

In at least one embodiment and as described previously herein in conjunction with FIG. 36A, CUDA source code 3610 includes, without limitation, any number (including zero) of global functions 3612, any number (including zero) of device functions 3614, any number (including zero) of host functions 3616, and any number (including zero) of host/device functions 3618. In at least one embodiment, CUDA source code 3610 also includes, without limitation, any number of calls to any number of functions that are specified in any number of CUDA APIs.

In at least one embodiment, CUDA to HIP translation tool 3620 translates CUDA source code 3610 to HIP source code 3630. In at least one embodiment, CUDA to HIP translation tool 3620 converts each kernel call in CUDA source code 3610 from a CUDA syntax to a HIP syntax and converts any number of other CUDA calls in source code 3610 to any number of other functionally similar HIP calls.

In at least one embodiment, HIP compiler driver 3640 subsequently determines that target device 3646 is not CUDA-enabled and generates HIP/HCC compilation command 3644. In at least one embodiment, HIP compiler driver 3640 then configures HCC 3660 to execute HIP/HCC compilation command 3644 to compile HIP source code 3630. In at least one embodiment, HIP/HCC compilation command 3644 configures HCC 3660 to use, without limitation, a HIP/HCC runtime library 3658 and an HCC header 3656 to generate host executable code 3670(2) and HCC device executable code 3682. In at least one embodiment, HIP/HCC runtime library 3658 corresponds to HIP runtime API 3632. In at least one embodiment, HCC header 3656 includes, without limitation, any number and type of interoperability mechanisms for HIP and HCC. In at least one embodiment, host executable code 3670(2) and HCC device executable code 3682 may be executed on, respectively, CPU 3690 and GPU 3692.

In at least one embodiment, the first set 712 (see FIG. 7) and/or the second set 714 (see FIG. 7) may include one or more of the CPU 3690, one or more of the GPU 3692, and/or one or more of the CUDA-enabled GPU 3694. In at least one embodiment, one or more systems depicted in FIGS. 36A-36C are utilized to detect and/or predict signals conducted by a signal conductor (e.g., within a multi-GPU system) and transition the signal conductor between active and inactive states with various algorithms, formulas, and/or processes, such as those described in connection with FIGS. 1-8 and/or otherwise perform operations described herein. In at least one embodiment, one or more systems depicted in FIGS. 36A-36C are utilized to implement one or more systems and/or processes such as those described in connection with FIGS. 1-8.

FIG. 37 illustrates an example kernel translated by CUDA-to-HIP translation tool 3620 of FIG. 36C, in accordance with at least one embodiment. In at least one embodiment, CUDA source code 3610 partitions an overall problem that a given kernel is designed to solve into relatively coarse sub-problems that can independently be solved using thread blocks. In at least one embodiment, each thread block includes, without limitation, any number of threads. In at least one embodiment, each sub-problem is partitioned into relatively fine pieces that can be solved cooperatively in parallel by threads within a thread block. In at least one embodiment, threads within a thread block can cooperate by sharing data through shared memory and by synchronizing execution to coordinate memory accesses.

In at least one embodiment, CUDA source code 3610 organizes thread blocks associated with a given kernel into a one-dimensional, a two-dimensional, or a three-dimensional grid of thread blocks. In at least one embodiment, each thread block includes, without limitation, any number of threads, and a grid includes, without limitation, any number of thread blocks.

In at least one embodiment, a kernel is a function in device code that is defined using a “_global_” declaration specifier. In at least one embodiment, the dimension of a grid that executes a kernel for a given kernel call and associated streams are specified using a CUDA kernel launch syntax 3710. In at least one embodiment, CUDA kernel launch syntax 3710 is specified as “KernelName<<<GridSize, BlockSize, SharedMemory Size, Stream>>>(KernelArguments);”. In at least one embodiment, an execution configuration syntax is a “<<< . . . >>>” construct that is inserted between a kernel name (“KernelName”) and a parenthesized list of kernel arguments (“KernelArguments”). In at least one embodiment, CUDA kernel launch syntax 3710 includes, without limitation, a CUDA launch function syntax instead of an execution configuration syntax.

In at least one embodiment, “GridSize” is of a type dim3 and specifies the dimension and size of a grid. In at least one embodiment, type dim3 is a CUDA-defined structure that includes, without limitation, unsigned integers x, y, and z. In at least one embodiment, if z is not specified, then z defaults to one. In at least one embodiment, if y is not specified, then y defaults to one. In at least one embodiment, the number of thread blocks in a grid is equal to the product of GridSize.x, GridSize.y, and GridSize.z. In at least one embodiment, “BlockSize” is of type dim3 and specifies the dimension and size of each thread block. In at least one embodiment, the number of threads per thread block is equal to the product of BlockSize.x, BlockSize.y, and BlockSize.z. In at least one embodiment, each thread that executes a kernel is given a unique thread ID that is accessible within the kernel through a built-in variable (e.g., “threadIdx”).

In at least one embodiment and with respect to CUDA kernel launch syntax 3710, “SharedMemorySize” is an optional argument that specifies a number of bytes in a shared memory that is dynamically allocated per thread block for a given kernel call in addition to statically allocated memory. In at least one embodiment and with respect to CUDA kernel launch syntax 3710, SharedMemorySize defaults to zero. In at least one embodiment and with respect to CUDA kernel launch syntax 3710, “Stream” is an optional argument that specifies an associated stream and defaults to zero to specify a default stream. In at least one embodiment, a stream is a sequence of commands (possibly issued by different host threads) that execute in order. In at least one embodiment, different streams may execute commands out of order with respect to one another or concurrently.

In at least one embodiment, CUDA source code 3610 includes, without limitation, a kernel definition for an example kernel “MatAdd” and a main function. In at least one embodiment, main function is host code that executes on a host and includes, without limitation, a kernel call that causes kernel MatAdd to execute on a device. In at least one embodiment and as shown, kernel MatAdd adds two matrices A and B of size N×N, where N is a positive integer, and stores the result in a matrix C. In at least one embodiment, main function defines a threadsPerBlock variable as 16 by 16 and a numBlocks variable as N/16 by N/16. In at least one embodiment, main function then specifies kernel call “MatAdd<<<numBlocks, threadsPerBlock>>>(A, B, C);”. In at least one embodiment and as per CUDA kernel launch syntax 3710, kernel MatAdd is executed using a grid of thread blocks having a dimension N/16 by N/16, where each thread block has a dimension of 16 by 16. In at least one embodiment, each thread block includes 256 threads, a grid is created with enough blocks to have one thread per matrix element, and each thread in such a grid executes kernel MatAdd to perform one pair-wise addition.

In at least one embodiment, while translating CUDA source code 3610 to HIP source code 3630, CUDA to HIP translation tool 3620 translates each kernel call in CUDA source code 3610 from CUDA kernel launch syntax 3710 to a HIP kernel launch syntax 3720 and converts any number of other CUDA calls in source code 3610 to any number of other functionally similar HIP calls. In at least one embodiment, HIP kernel launch syntax 3720 is specified as “hipLaunchKernelGGL(KernelName, GridSize, BlockSize, SharedMemorySize, Stream, KernelArguments);”. In at least one embodiment, each of KernelName, GridSize, BlockSize, ShareMemorySize, Stream, and KernelArguments has the same meaning in HIP kernel launch syntax 3720 as in CUDA kernel launch syntax 3710 (described previously herein). In at least one embodiment, arguments SharedMemorySize and Stream are required in HIP kernel launch syntax 3720 and are optional in CUDA kernel launch syntax 3710.

In at least one embodiment, a portion of HIP source code 3630 depicted in FIG. 37 is identical to a portion of CUDA source code 3610 depicted in FIG. 37 except for a kernel call that causes kernel MatAdd to execute on a device. In at least one embodiment, kernel MatAdd is defined in HIP source code 3630 with the same “_global_” declaration specifier with which kernel MatAdd is defined in CUDA source code 3610. In at least one embodiment, a kernel call in HIP source code 3630 is “hipLaunchKernelGGL(MatAdd, numBlocks, threadsPerBlock, 0, 0, A, B, C);”, while a corresponding kernel call in CUDA source code 3610 is “MatAdd<<<numBlocks, threadsPerBlock>>>(A, B, C);”.

In at least one embodiment, one or more systems depicted in FIG. 37 are utilized to detect and/or predict signals conducted by a signal conductor (e.g., within a multi-GPU system) and transition the signal conductor between active and inactive states with various algorithms, formulas, and/or processes, such as those described in connection with FIGS. 1-8 and/or otherwise perform operations described herein. In at least one embodiment, one or more systems depicted in FIG. 37 are utilized to implement one or more systems and/or processes such as those described in connection with FIGS. 1-8.

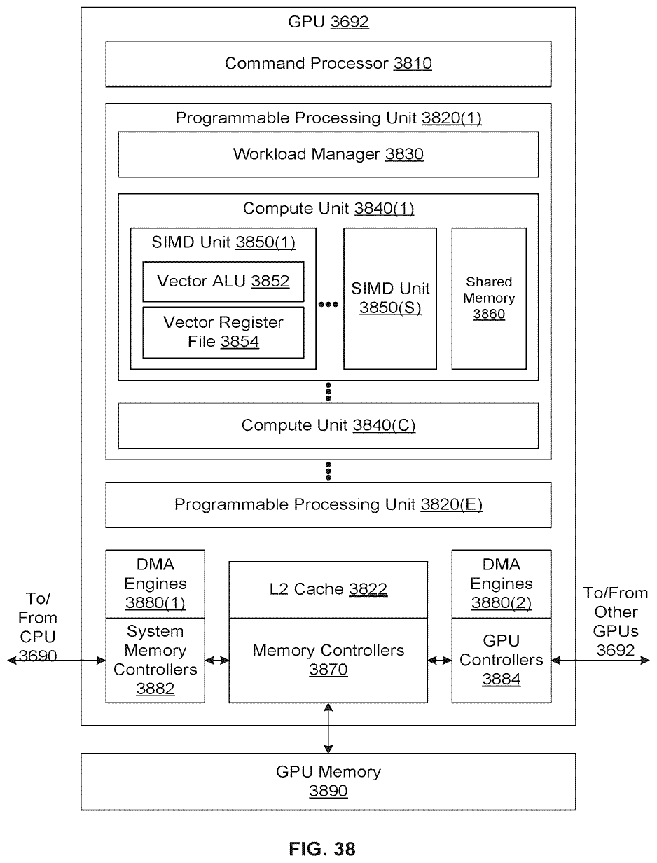

FIG. 38 illustrates non-CUDA-enabled GPU 3692 of FIG. 36C in greater detail, in accordance with at least one embodiment. In at least one embodiment, GPU 3692 is developed by AMD corporation of Santa Clara. In at least one embodiment, GPU 3692 can be configured to perform compute operations in a highly-parallel fashion. In at least one embodiment, GPU 3692 is configured to execute graphics pipeline operations such as draw commands, pixel operations, geometric computations, and other operations associated with rendering an image to a display. In at least one embodiment, GPU 3692 is configured to execute operations unrelated to graphics. In at least one embodiment, GPU 3692 is configured to execute both operations related to graphics and operations unrelated to graphics. In at least one embodiment, GPU 3692 can be configured to execute device code included in HIP source code 3630.

In at least one embodiment, GPU 3692 includes, without limitation, any number of programmable processing units 3820, a command processor 3810, an L2 cache 3822, memory controllers 3870, DMA engines 3880(1), system memory controllers 3882, DMA engines 3880(2), and GPU controllers 3884. In at least one embodiment, each programmable processing unit 3820 includes, without limitation, a workload manager 3830 and any number of compute units 3840. In at least one embodiment, command processor 3810 reads commands from one or more command queues (not shown) and distributes commands to workload managers 3830. In at least one embodiment, for each programmable processing unit 3820, associated workload manager 3830 distributes work to compute units 3840 included in programmable processing unit 3820. In at least one embodiment, each compute unit 3840 may execute any number of thread blocks, but each thread block executes on a single compute unit 3840. In at least one embodiment, a workgroup is a thread block.

In at least one embodiment, each compute unit 3840 includes, without limitation, any number of SIMD units 3850 and a shared memory 3860. In at least one embodiment, each SIMD unit 3850 implements a SIMD architecture and is configured to perform operations in parallel. In at least one embodiment, each SIMD unit 3850 includes, without limitation, a vector ALU 3852 and a vector register file 3854. In at least one embodiment, each SIMD unit 3850 executes a different warp. In at least one embodiment, a warp is a group of threads (e.g., 16 threads), where each thread in the warp belongs to a single thread block and is configured to process a different set of data based on a single set of instructions. In at least one embodiment, predication can be used to disable one or more threads in a warp. In at least one embodiment, a lane is a thread. In at least one embodiment, a work item is a thread. In at least one embodiment, a wavefront is a warp. In at least one embodiment, different wavefronts in a thread block may synchronize together and communicate via shared memory 3860.

In at least one embodiment, programmable processing units 3820 are referred to as “shader engines.” In at least one embodiment, each programmable processing unit 3820 includes, without limitation, any amount of dedicated graphics hardware in addition to compute units 3840. In at least one embodiment, each programmable processing unit 3820 includes, without limitation, any number (including zero) of geometry processors, any number (including zero) of rasterizers, any number (including zero) of render back ends, workload manager 3830, and any number of compute units 3840.

In at least one embodiment, compute units 3840 share L2 cache 3822. In at least one embodiment, L2 cache 3822 is partitioned. In at least one embodiment, a GPU memory 3890 is accessible by all compute units 3840 in GPU 3692. In at least one embodiment, memory controllers 3870 and system memory controllers 3882 facilitate data transfers between GPU 3692 and a host, and DMA engines 3880(1) enable asynchronous memory transfers between GPU 3692 and such a host. In at least one embodiment, memory controllers 3870 and GPU controllers 3884 facilitate data transfers between GPU 3692 and other GPUs 3692, and DMA engines 3880(2) enable asynchronous memory transfers between GPU 3692 and other GPUs 3692.

In at least one embodiment, GPU 3692 includes, without limitation, any amount and type of system interconnect that facilitates data and control transmissions across any number and type of directly or indirectly linked components that may be internal or external to GPU 3692. In at least one embodiment, GPU 3692 includes, without limitation, any number and type of I/O interfaces (e.g., PCIe) that are coupled to any number and type of peripheral devices. In at least one embodiment, GPU 3692 may include, without limitation, any number (including zero) of display engines and any number (including zero) of multimedia engines. In at least one embodiment, GPU 3692 implements a memory subsystem that includes, without limitation, any amount and type of memory controllers (e.g., memory controllers 3870 and system memory controllers 3882) and memory devices (e.g., shared memories 3860) that may be dedicated to one component or shared among multiple components. In at least one embodiment, GPU 3692 implements a cache subsystem that includes, without limitation, one or more cache memories (e.g., L2 cache 3822) that may each be private to or shared between any number of components (e.g., SIMD units 3850, compute units 3840, and programmable processing units 3820).

In at least one embodiment, one or more systems depicted in FIG. 38 are utilized to detect and/or predict signals conducted by a signal conductor (e.g., within a multi-GPU system) and transition the signal conductor between active and inactive states with various algorithms, formulas, and/or processes, such as those described in connection with FIGS. 1-8 and/or otherwise perform operations described herein. In at least one embodiment, one or more systems depicted in FIG. 38 are utilized to implement one or more systems and/or processes such as those described in connection with FIGS. 1-8.

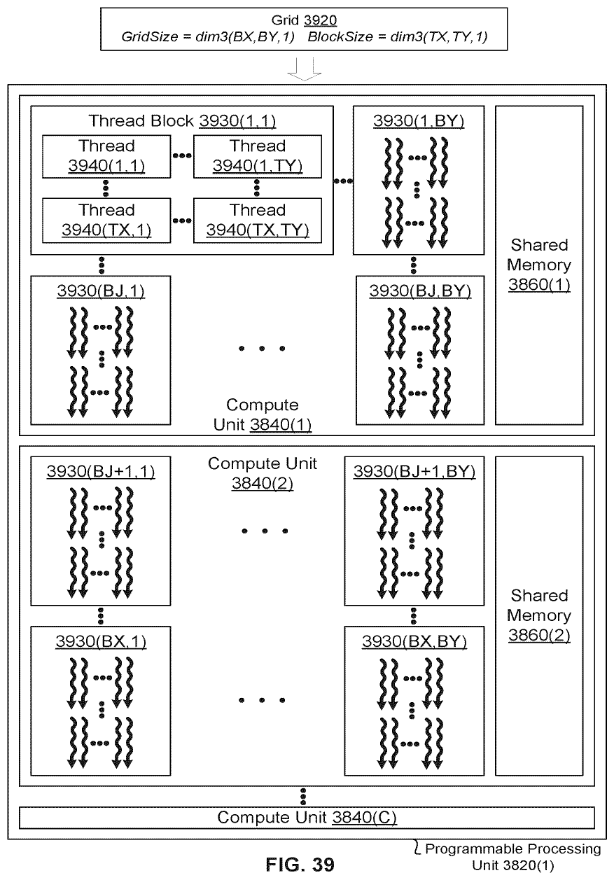

FIG. 39 illustrates how threads of an example CUDA grid 3920 are mapped to different compute units 3840 of FIG. 38, in accordance with at least one embodiment. In at least one embodiment and for explanatory purposes only, grid 3920 has a GridSize of BX by BY by 1 and a BlockSize of TX by TY by 1. In at least one embodiment, grid 3920 therefore includes, without limitation, (BX*BY) thread blocks 3930 and each thread block 3930 includes, without limitation, (TX*TY) threads 3940. Threads 3940 are depicted in FIG. 39 as squiggly arrows.

In at least one embodiment, grid 3920 is mapped to programmable processing unit 3820(1) that includes, without limitation, compute units 3840(1)-3840(C). In at least one embodiment and as shown, (BJ*BY) thread blocks 3930 are mapped to compute unit 3840(1), and the remaining thread blocks 3930 are mapped to compute unit 3840(2). In at least one embodiment, each thread block 3930 may include, without limitation, any number of warps, and each warp is mapped to a different SIMD unit 3850 of FIG. 38.

In at least one embodiment, warps in a given thread block 3930 may synchronize together and communicate through shared memory 3860 included in associated compute unit 3840. For example and in at least one embodiment, warps in thread block 3930(BJ,1) can synchronize together and communicate through shared memory 3860(1). For example and in at least one embodiment, warps in thread block 3930(BJ+1,1) can synchronize together and communicate through shared memory 3860(2).

In at least one embodiment, one or more systems depicted in FIG. 39 are utilized to detect and/or predict signals conducted by a signal conductor (e.g., within a multi-GPU system) and transition the signal conductor between active and inactive states with various algorithms, formulas, and/or processes, such as those described in connection with FIGS. 1-8 and/or otherwise perform operations described herein. In at least one embodiment, one or more systems depicted in FIG. 39 are utilized to implement one or more systems and/or processes such as those described in connection with FIGS. 1-8.

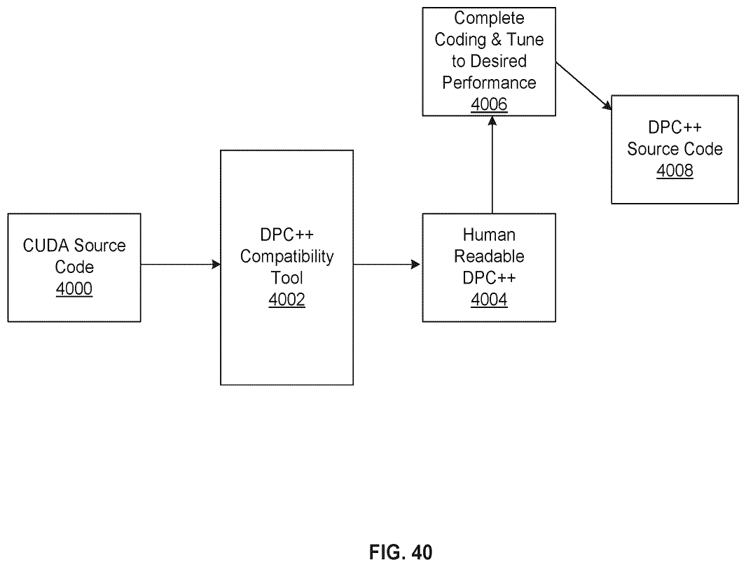

FIG. 40 illustrates how to migrate existing CUDA code to Data Parallel C++ code, in accordance with at least one embodiment. Data Parallel C++ (DPC++) may refer to an open, standards-based alternative to single-architecture proprietary languages that allows developers to reuse code across hardware targets (CPUs and accelerators such as GPUs and FPGAs) and also perform custom tuning for a specific accelerator. DPC++ use similar and/or identical C and C++ constructs in accordance with ISO C++ which developers may be familiar with. DPC++ incorporates standard SYCL from The Khronos Group to support data parallelism and heterogeneous programming. SYCL refers to a cross-platform abstraction layer that builds on underlying concepts, portability and efficiency of OpenCL that enables code for heterogeneous processors to be written in a “single-source” style using standard C++. SYCL may enable single source development where C++ template functions can contain both host and device code to construct complex algorithms that use OpenCL acceleration, and then re-use them throughout their source code on different types of data.

In at least one embodiment, a DPC++ compiler is used to compile DPC++ source code which can be deployed across diverse hardware targets. In at least one embodiment, a DPC++ compiler is used to generate DPC++ applications that can be deployed across diverse hardware targets and a DPC++ compatibility tool can be used to migrate CUDA applications to a multiplatform program in DPC++. In at least one embodiment, a DPC++ base tool kit includes a DPC++ compiler to deploy applications across diverse hardware targets; a DPC++ library to increase productivity and performance across CPUs, GPUs, and FPGAs; a DPC++ compatibility tool to migrate CUDA applications to multi-platform applications; and any suitable combination thereof.

In at least one embodiment, a DPC++ programming model is utilized to simply one or more aspects relating to programming CPUs and accelerators by using modern C++ features to express parallelism with a programming language called Data Parallel C++. DPC++ programming language may be utilized to code reuse for hosts (e.g., a CPU) and accelerators (e.g., a GPU or FPGA) using a single source language, with execution and memory dependencies being clearly communicated. Mappings within DPC++ code can be used to transition an application to run on a hardware or set of hardware devices that best accelerates a workload. A host may be available to simplify development and debugging of device code, even on platforms that do not have an accelerator available.

In at least one embodiment, CUDA source code 4000 is provided as an input to a DPC++ compatibility tool 4002 to generate human readable DPC++ 4004. In at least one embodiment, human readable DPC++ 4004 includes inline comments generated by DPC++ compatibility tool 4002 that guides a developer on how and/or where to modify DPC++ code to complete coding and tuning to desired performance 4006, thereby generating DPC++ source code 4008.

In at least one embodiment, CUDA source code 4000 is or includes a collection of human-readable source code in a CUDA programming language. In at least one embodiment, CUDA source code 4000 is human-readable source code in a CUDA programming language. In at least one embodiment, a CUDA programming language is an extension of the C++ programming language that includes, without limitation, mechanisms to define device code and distinguish between device code and host code. In at least one embodiment, device code is source code that, after compilation, is executable on a device (e.g., GPU or FPGA) and may include or more parallelizable workflows that can be executed on one or more processor cores of a device. In at least one embodiment, a device may be a processor that is optimized for parallel instruction processing, such as CUDA-enabled GPU, GPU, or another GPGPU, etc. In at least one embodiment, host code is source code that, after compilation, is executable on a host. In least one embodiment, some or all of host code and device code can be executed in parallel across a CPU and GPU/FPGA. In at least one embodiment, a host is a processor that is optimized for sequential instruction processing, such as CPU. CUDA source code 4000 described in connection with FIG. 40 may be in accordance with those discussed elsewhere in this document.

In at least one embodiment, DPC++ compatibility tool 4002 refers to an executable tool, program, application, or any other suitable type of tool that is used to facilitate migration of CUDA source code 4000 to DPC++ source code 4008. In at least one embodiment, DPC++ compatibility tool 4002 is a command-line-based code migration tool available as part of a DPC++ tool kit that is used to port existing CUDA sources to DPC++. In at least one embodiment, DPC++ compatibility tool 4002 converts some or all source code of a CUDA application from CUDA to DPC++ and generates a resulting file that is written at least partially in DPC++, referred to as human readable DPC++ 4004. In at least one embodiment, human readable DPC++ 4004 includes comments that are generated by DPC++ compatibility tool 4002 to indicate where user intervention may be necessary. In at least one embodiment, user intervention is necessary when CUDA source code 4000 calls a CUDA API that has no analogous DPC++ API; other examples where user intervention is required are discussed later in greater detail.

In at least one embodiment, a workflow for migrating CUDA source code 4000 (e.g., application or portion thereof) includes creating one or more compilation database files; migrating CUDA to DPC++ using a DPC++ compatibility tool 4002; completing migration and verifying correctness, thereby generating DPC++ source code 4008; and compiling DPC++ source code source code 4008 with a DPC++ compiler to generate a DPC++ application. In at least one embodiment, a compatibility tool provides a utility that intercepts commands used when Makefile executes and stores them in a compilation database file. In at least one embodiment, a file is stored in JSON format. In at least one embodiment, an intercept-built command converts Makefile command to a DPC compatibility command.

In at least one embodiment, intercept-build is a utility script that intercepts a build process to capture compilation options, macro defs, and include paths, and writes this data to a compilation database file. In at least one embodiment, a compilation database file is a JSON file. In at least one embodiment, DPC++ compatibility tool 4002 parses a compilation database and applies options when migrating input sources. In at least one embodiment, use of intercept-build is optional, but highly recommended for Make or CMake based environments. In at least one embodiment, a migration database includes commands, directories, and files: command may include necessary compilation flags; directory may include paths to header files; file may include paths to CUDA files.

In at least one embodiment, DPC++ compatibility tool 4002 migrates CUDA code (e.g., applications) written in CUDA to DPC++ by generating DPC++ wherever possible. In at least one embodiment, DPC++ compatibility tool 4002 is available as part of a tool kit. In at least one embodiment, a DPC++ tool kit includes an intercept-build tool. In at least one embodiment, an intercept-built tool creates a compilation database that captures compilation commands to migrate CUDA files. In at least one embodiment, a compilation database generated by an intercept-built tool is used by DPC++ compatibility tool 4002 to migrate CUDA code to DPC++. In at least one embodiment, non-CUDA C++ code and files are migrated as is. In at least one embodiment, DPC++ compatibility tool 4002 generates human readable DPC++ 4004 which may be DPC++ code that, as generated by DPC++ compatibility tool 4002, cannot be compiled by DPC++ compiler and requires additional plumbing for verifying portions of code that were not migrated correctly, and may involve manual intervention, such as by a developer. In at least one embodiment, DPC++ compatibility tool 4002 provides hints or tools embedded in code to help developers manually migrate additional code that could not be migrated automatically. In at least one embodiment, migration is a one-time activity for a source file, project, or application.

In at least one embodiment, DPC++ compatibility tool 40002 is able to successfully migrate all portions of CUDA code to DPC++ and there may simply be an optional step for manually verifying and tuning performance of DPC++ source code that was generated. In at least one embodiment, DPC++ compatibility tool 4002 directly generates DPC++ source code 4008 which is compiled by a DPC++ compiler without requiring or utilizing human intervention to modify DPC++ code generated by DPC++ compatibility tool 4002. In at least one embodiment, DPC++ compatibility tool generates compile-able DPC++ code which can be optionally tuned by a developer for performance, readability, maintainability, other various considerations; or any combination thereof.

In at least one embodiment, one or more CUDA source files are migrated to DPC++ source files at least partially using DPC++ compatibility tool 4002. In at least one embodiment, CUDA source code includes one or more header files which may include CUDA header files. In at least one embodiment, a CUDA source file includes a <cuda.h> header file and a <stdio.h> header file which can be used to print text. In at least one embodiment, a portion of a vector addition kernel CUDA source file may be written as or related to:
#include <cuda.h>
#include <stdio.h>
#define VECTOR_SIZE 256
[] global—void VectorAddKernel(float* A, float* B, float* C)
{
   A[threadIdx.x]=threadIdx.x+1.0f;
   B[threadIdx.x]=threadIdx.x+1.0f;
   C[threadIdx.x]=A[threadIdx.x]+B[threadIdx.x];
}
int main()
{
   float *d_A, *d_B, *d_C;
   cudaMalloc(&d_A, VECTOR_SIZE*sizeof(float));
   cudaMalloc(&d_B, VECTOR_SIZE*sizeof(float));
   cudaMalloc(&d_C, VECTOR_SIZE*sizeof(float));
   VectorAddKernel<<<1, VECTOR_SIZE>>>(d_A, d_B, d_C);
   float Result[VECTOR_SIZE]={};
   cudaMemcpy(Result, d_C, VECTOR_SIZE*sizeof(float), cudaMemcpyDeviceToHost);
   cudaFree(d_A);
   cudaFree(d_B);
   cudaFree(d_C);
   for (int i=0; i<VECTOR_SIZE; i++{
      if (i % 16==0) {
         printf(“\n”);
      }
      printf(“%f”, Result[i]);
   }
   return 0;
}

In at least one embodiment and in connection with CUDA source file presented above, DPC++ compatibility tool 4002 parses a CUDA source code and replaces header files with appropriate DPC++ and SYCL header files. In at least one embodiment, DPC++ header files includes helper declarations. In CUDA, there is a concept of a thread ID and correspondingly, in DPC++ or SYCL, for each element there is a local identifier.

In at least one embodiment and in connection with CUDA source file presented above, there are two vectors A and B which are initialized and a vector addition result is put into vector C as part of VectorAddKernel(). In at least one embodiment, DPC++ compatibility tool 4002 converts CUDA thread IDs used to index work elements to SYCL standard addressing for work elements via a local ID as part of migrating CUDA code to DPC++ code. In at least one embodiment, DPC++ code generated by DPC++ compatibility tool 4002 can be optimized—for example, by reducing dimensionality of an nd_item, thereby increasing memory and/or processor utilization.

In at least one embodiment and in connection with CUDA source file presented above, memory allocation is migrated. In at least one embodiment, cudaMalloc() is migrated to a unified shared memory SYCL call malloc_device() to which a device and context is passed, relying on SYCL concepts such as platform, device, context, and queue. In at least one embodiment, a SYCL platform can have multiple devices (e.g., host and GPU devices); a device may have multiple queues to which jobs can be submitted; each device may have a context; and a context may have multiple devices and manage shared memory objects.

In at least one embodiment and in connection with CUDA source file presented above, a main() function invokes or calls VectorAddKernel() to add two vectors A and B together and store result in vector C. In at least one embodiment, CUDA code to invoke VectorAddKernel() is replaced by DPC++ code to submit a kernel to a command queue for execution. In at least one embodiment, a command group handler cgh passes data, synchronization, and computation that is submitted to the queue, parallel_for is called for a number of global elements and a number of work items in that work group where VectorAddKernel() is called.

In at least one embodiment and in connection with CUDA source file presented above, CUDA calls to copy device memory and then free memory for vectors A, B, and C are migrated to corresponding DPC++ calls. In at least one embodiment, C++ code (e.g., standard ISO C++ code for printing a vector of floating point variables) is migrated as is, without being modified by DPC++ compatibility tool 4002. In at least one embodiment, DPC++ compatibility tool 4002 modify CUDA APIs for memory setup and/or host calls to execute kernel on the acceleration device. In at least one embodiment and in connection with CUDA source file presented above, a corresponding human readable DPC++ 4004 (e.g., which can be compiled) is written as or related to:
#include <CL/sycl.hpp>
#include <dpct/dpct.hpp>
#define VECTOR_SIZE 256
void VectorAddKernel(float* A, float* B, float* C,
   sycl::nd_item<3> item_ct1)
{
   A[item_ct1.get_local_id(2)]=item_ct1.get_local_id(2)+1.0f;
   B[item_ct1.get_local_id(2)]=item_ct1.get_local_id(2)+1.0f;
   C[item_ct1.get_local_id(2)]=
      A[item_ct1.get_local_id(2)]+B[item_ct1.get_local_id(2)];
}
int main()
{
   float *d_A, *d_B, *d_C;
   d_A=(float *)sycl::malloc_device(VECTOR_SIZE*sizeof(float),
      dpct::get_current_device(),
      dpct::get_default_context());
   d_B=(float *)sycl::malloc_device(VECTOR_SIZE*sizeof(float),
      dpct::get_current_device(),
      dpct::get_default_context());
   d_C=(float *)sycl::malloc_device(VECTOR_SIZE*sizeof(float),
      dpct::get_current_device(),
      dpct::get_default_context());
   dpct::get_default_queue_wait().submit([&](sycl::handler &cgh) {
      cgh.parallel_for(
         sycl::nd_range<3>(sycl::range<3>(1, 1, 1) *
         sycl::range<3>(1, 1, VECTOR_SIZE) *
         sycl::range<3>(1, 1, VECTOR_SIZE)),
         [=](sycl::nd_items<3>item_ct1) {
         VectorAddKernel(d_A, d_B, d_C, item_ct1);
         });
   });
   float Result[VECTOR_SIZE]={};
   dpct::get_default_queue_wait()
      .memcpy(Result, d_C, VECTOR_SIZE*sizeof(float))
      .wait();
   sycl::free(d_A, dpct::get_default_context());
   sycl::free(d_B, dpct::get_default_context());
   sycl::free(d_C, dpct::get_default_context());
   for (int i=0; i<VECTOR_SIZE; i++{
      if (i % 16==0) {
         printf(“\n”);
      }
      printf(“%f”, Result[i]);
   }
   return 0;
}

In at least one embodiment, human readable DPC++ 4004 refers to output generated by DPC++ compatibility tool 4002 and may be optimized in one manner or another. In at least one embodiment, human readable DPC++ 4004 generated by DPC++ compatibility tool 4002 can be manually edited by a developer after migration to make it more maintainable, performance, or other considerations. In at least one embodiment, DPC++ code generated by DPC++ compatibility tool 40002 such as DPC++ disclosed can be optimized by removing repeat calls to get_current_device() and/or get_default_context() for each malloc_device() call. In at least one embodiment, DPC++ code generated above uses a 3 dimensional nd_range which can be refactored to use only a single dimension, thereby reducing memory usage. In at least one embodiment, a developer can manually edit DPC++ code generated by DPC++ compatibility tool 4002 replace uses of unified shared memory with accessors. In at least one embodiment, DPC++ compatibility tool 4002 has an option to change how it migrates CUDA code to DPC++ code. In at least one embodiment, DPC++ compatibility tool 4002 is verbose because it is using a general template to migrate CUDA code to DPC++ code that works for a large number of cases.

In at least one embodiment, a CUDA to DPC++ migration workflow includes steps to: prepare for migration using intercept-build script; perform migration of CUDA projects to DPC++ using DPC++ compatibility tool 4002; review and edit migrated source files manually for completion and correctness; and compile final DPC++ code to generate a DPC++ application. In at least one embodiment, manual review of DPC++ source code may be required in one or more scenarios including but not limited to: migrated API does not return error code (CUDA code can return an error code which can then be consumed by the application but SYCL uses exceptions to report errors, and therefore does not use error codes to surface errors); CUDA compute capability dependent logic is not supported by DPC++; statement could not be removed. In at least one embodiment, scenarios in which DPC++ code requires manual intervention may include, without limitation: error code logic replaced with (*,0) code or commented out; equivalent DPC++ API not available; CUDA compute capability-dependent logic; hardware-dependent API (clock()); missing features unsupported API; execution time measurement logic; handling built-in vector type conflicts; migration of cuBLAS API; and more.

In at least one embodiment, one or more systems depicted in FIG. 40 are utilized to implement weighted adaptive multi-path routing in network devices using various algorithms, formulas, and/or processes, such as those described in connection with FIGS. 1-6, including proportionally distributing network packets across port groups based on network parameters. In at least one embodiment, one or more systems depicted in FIG. 40 are utilized to implement one or more systems and/or processes, such as longest prefix matching operations, multi-path data structure management, network parameter-based traffic distribution, and adaptive routing within port groups, as further discussed in FIGS. 1-6.

In at least one embodiment, one or more techniques described herein utilize a oneAPI programming model. In at least one embodiment, a oneAPI programming model refers to a programming model for interacting with various compute accelerator architectures. In at least one embodiment, oneAPI refers to an application programming interface (API) designed to interact with various compute accelerator architectures. In at least one embodiment, a oneAPI programming model utilizes a DPC++ programming language. In at least one embodiment, a DPC++ programming language refers to a high-level language for data parallel programming productivity. In at least one embodiment, a DPC++ programming language is based at least in part on C and/or C++ programming languages. In at least one embodiment, a oneAPI programming model is a programming model such as those developed by Intel Corporation of Santa Clara, CA.

In at least one embodiment, oneAPI and/or oneAPI programming model is utilized to interact with various accelerator, GPU, processor, and/or variations thereof, architectures. In at least one embodiment, oneAPI includes a set of libraries that implement various functionalities. In at least one embodiment, oneAPI includes at least a oneAPI DPC++ library, a oneAPI math kernel library, a oneAPI data analytics library, a oneAPI deep neural network library, a oneAPI collective communications library, a oneAPI threading building blocks library, a oneAPI video processing library, and/or variations thereof.

In at least one embodiment, a oneAPI DPC++ library, also referred to as oneDPL, is a library that implements algorithms and functions to accelerate DPC++ kernel programming. In at least one embodiment, oneDPL implements one or more standard template library (STL) functions. In at least one embodiment, oneDPL implements one or more parallel STL functions. In at least one embodiment, oneDPL provides a set of library classes and functions such as parallel algorithms, iterators, function object classes, range-based API, and/or variations thereof. In at least one embodiment, oneDPL implements one or more classes and/or functions of a C++ standard library. In at least one embodiment, oneDPL implements one or more random number generator functions.

In at least one embodiment, a oneAPI math kernel library, also referred to as oneMKL, is a library that implements various optimized and parallelized routines for various mathematical functions and/or operations. In at least one embodiment, oneMKL implements one or more basic linear algebra subprograms (BLAS) and/or linear algebra package (LAPACK) dense linear algebra routines. In at least one embodiment, oneMKL implements one or more sparse BLAS linear algebra routines. In at least one embodiment, oneMKL implements one or more random number generators (RNGs). In at least one embodiment, oneMKL implements one or more vector mathematics (VM) routines for mathematical operations on vectors. In at least one embodiment, oneMKL implements one or more Fast Fourier Transform (FFT) functions.

In at least one embodiment, a oneAPI data analytics library, also referred to as oneDAL, is a library that implements various data analysis applications and distributed computations. In at least one embodiment, oneDAL implements various algorithms for preprocessing, transformation, analysis, modeling, validation, and decision making for data analytics, in batch, online, and distributed processing modes of computation. In at least one embodiment, oneDAL implements various C++ and/or Java APIs and various connectors to one or more data sources. In at least one embodiment, oneDAL implements DPC++ API extensions to a traditional C++ interface and enables GPU usage for various algorithms.

In at least one embodiment, a oneAPI deep neural network library, also referred to as oneDNN, is a library that implements various deep learning functions. In at least one embodiment, oneDNN implements various neural network, machine learning, and deep learning functions, algorithms, and/or variations thereof.

In at least one embodiment, a oneAPI collective communications library, also referred to as oneCCL, is a library that implements various applications for deep learning and machine learning workloads. In at least one embodiment, oneCCL is built upon lower-level communication middleware, such as message passing interface (MPI) and libfabrics. In at least one embodiment, oneCCL enables a set of deep learning specific optimizations, such as prioritization, persistent operations, out of order executions, and/or variations thereof. In at least one embodiment, oneCCL implements various CPU and GPU functions.

In at least one embodiment, a oneAPI threading building blocks library, also referred to as oneTBB, is a library that implements various parallelized processes for various applications. In at least one embodiment, oneTBB is utilized for task-based, shared parallel programming on a host. In at least one embodiment, oneTBB implements generic parallel algorithms. In at least one embodiment, oneTBB implements concurrent containers. In at least one embodiment, oneTBB implements a scalable memory allocator. In at least one embodiment, oneTBB implements a work-stealing task scheduler. In at least one embodiment, oneTBB implements low-level synchronization primitives. In at least one embodiment, oneTBB is compiler-independent and usable on various processors, such as GPUs, PPUs, CPUs, and/or variations thereof.

In at least one embodiment, a oneAPI video processing library, also referred to as oneVPL, is a library that is utilized for accelerating video processing in one or more applications. In at least one embodiment, oneVPL implements various video decoding, encoding, and processing functions. In at least one embodiment, oneVPL implements various functions for media pipelines on CPUs, GPUs, and other accelerators. In at least one embodiment, oneVPL implements device discovery and selection in media centric and video analytics workloads. In at least one embodiment, oneVPL implements API primitives for zero-copy buffer sharing.

In at least one embodiment, a oneAPI programming model utilizes a DPC++ programming language. In at least one embodiment, a DPC++ programming language is a programming language that includes, without limitation, functionally similar versions of CUDA mechanisms to define device code and distinguish between device code and host code. In at least one embodiment, a DPC++ programming language may include a subset of functionality of a CUDA programming language. In at least one embodiment, one or more CUDA programming model operations are performed using a oneAPI programming model using a DPC++ programming language.

It should be noted that, while example embodiments described herein may relate to a CUDA programming model, techniques described herein can be utilized with any suitable programming model, such HIP, oneAPI (e.g., using oneAPI-based programming to perform or implement a method disclosed herein), and/or variations thereof.

In at least one embodiment, one or more components of systems and/or processors disclosed above can communicate with one or more CPUs, ASICs, GPUs, FPGAs, or other hardware, circuitry, or integrated circuit components that include, e.g., an upscaler or upsampler to upscale an image, an image blender or image blender component to blend, mix, or add images together, a sampler to sample an image (e.g., as part of a DSP), a neural network circuit that is configured to perform an upscaler to upscale an image (e.g., from a low resolution image to a high resolution image), or other hardware to modify or generate an image, frame, or video to adjust its resolution, size, or pixels; one or more components of systems and/or processors disclosed above can use components described in this disclosure to perform methods, operations, or instructions that generate or modify an image.

It is to be appreciated that any feature described herein can be claimed in combination with any other feature(s) as described herein, regardless of whether the features come from the same described embodiment.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art. It is to be appreciated that any feature described herein can be claimed in combination with any other feature(s) as described herein, regardless of whether the features come from the same described embodiment.

What is claimed is:

1. A network device comprising one or more circuits to:
receive a network packet;
allocate the network packet to one port group of a plurality of port groups, according to a network traffic distribution policy that apportions network packets across the plurality of port groups in proportions based on a network parameter; and
forward the network packet through a port of the one port group.

2. The network device of claim 1, wherein the network traffic distribution policy comprises a multi-path data structure that maps different entries to different port groups of the plurality of port groups.

3. The network device of claim 2, wherein the multi-path data structure comprises an equal cost multi-path (ECMP) table having a plurality of entries, wherein different percentages of the plurality of entries are mapped to different port groups of the plurality of port groups.

4. The network device of claim 3, wherein the one or more circuits are further to:
perform a Longest Prefix Match (LPM) operation based on a destination address of the network packet to select the multi-path data structure from a plurality of multi-path data structures.

5. The network device of claim 4, wherein the one or more circuits are further to:
calculate a hash value based on information in the network packet; and
select an entry from the plurality of entries in the multi-path data structure based on the hash value, wherein the selected entry determines a port group of the plurality of port groups for the network packet.

6. The network device of claim 2, wherein each entry in the multi-path data structure is associated with at least one of a rule or an action that identifies a corresponding port group of the plurality of port groups.

7. The network device of claim 6, wherein the rule or action indicates which ports of the network device are included in the corresponding port group.

8. The network device of claim 7, wherein the rule or action is updated based on network asymmetry information received via a Border Gateway Protocol (BGP).

9. The network device of claim 1, wherein the plurality of port groups includes at least one port group configured to receive an oversubscribed traffic load according to the network parameter.

10. The network device of claim 9, wherein:
the network parameter comprises available capacity information for the plurality of port groups; and
the proportions are determined to direct more traffic to another port group than to the at least one port group based on the available capacity information.

11. The network device of claim 1, wherein the one or more circuits are further to perform congestion control to limit an amount of traffic directed through at least one port group of the plurality of port groups.

12. The network device of claim 11, wherein the congestion control is further to:
oversubscribe at least one port in at least one port group of the plurality of port groups to create controlled congestion; and
reduce a total traffic throughput by a specific amount corresponding to a reduced capacity condition in a network.

13. The network device of claim 1, wherein the one or more circuits are further to:
receive network condition information indicating a change in network capacity; and
adjust the proportions in which network packets are apportioned across the plurality of port groups based on the network condition information.

14. The network device of claim 13, wherein the network condition information indicates a reduced capacity of a network path downstream from the network device.

15. The network device of claim 14, wherein the network condition information is received via a Border Gateway Protocol (BGP) update message indicating at least one of a link failure or a link degradation.

16. The network device of claim 1, wherein to forward the network packet through the port of the one port group comprises to select the port from multiple available ports in the one port group using at least one of: adaptive routing, random selection, round-robin selection, or hash-based forwarding.

17. The network device of claim 1, wherein the network parameter comprises at least one of:
an available bandwidth of network link;
a network congestion level;
link failure information;
a quality of service requirement; or
an administrative weight assigned to a network path.

18. A network device comprising one or more circuits to:
receive network packet flows;
apportion network packets of the network packet flows across a plurality of port groups in proportions based on a network parameter; and
forward the network packets through ports in the plurality of port groups.

19. The network device of claim 18, wherein the one or more circuits are further to adjust the proportions in which the network packets are apportioned across the plurality of port groups in response to a change in the network parameter.

20. A system comprising:
a first network device; and
a second network device connected to the first network device via a plurality of network links,
wherein the first network device comprises one or more circuits to:
receive network traffic destined for the second network device;
distribute the network traffic across the plurality of network links according to a traffic distribution policy that allocates different proportions of the network traffic to different subsets of the plurality of network links based on capacity information associated with the plurality of network links; and
adjust the different proportions in response to a change in the capacity information.
